(19) United States
(12) Patent Application Publication
(10) Pub. No.: US 2008/0155915 A1
(43) Pub. Date: Jul. 3, 2008

(54) Power and Communication Distribution Using a Structural Channel Stystem

(76) Inventors: Russel Howe, Montrose, CA (US); Daniel W. Hillis, Encino, CA (US); Robert W. Insalaco, Holland, MI (US); James B. Long, Kentwood, MI (US)

Correspondence Address: COURTNEY N. LAPEKES;VARNUM, RIDDERING, SCHMIDT & HOWLETT LLP, BRIDGEWATER PLACE, POST OFFICE BOX 352, GRAND RAPIDS, MICHIGAN, MI, 49501-0352, US

(21) Appl. No.: 11/659,127

(22) PCT Filed: Aug. 5, 2005
(86) PCT No.: PCT/US05/28022

§ 371 Date: Oct. 5, 2007

Related U.S. Application Data
(60) Provisional application No. 60/599,447, filed on Aug. 5, 2004.

(51) Int. Cl. E04C 3/08; A47F 5/01; F16M 13/02; E04C 3/04; E04B 9/18; H02G 3/36

(52) U.S. Cl. 52/220.3; 52/506.06; 248/343; 248/207; 174/40 R

(57) ABSTRACT

A structural channel system (100) includes a main structural channel rail (102), cross-channels (104) and cross-rails (106). A modular plug assembly (130) couples electrical power and communication signals to connector modules (132, 140, 144) which, in turn, control application of power to application devices (939, 969) based on the communication signals.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFISHE APPENDIX

Not applicable.

### BACKGROUND OF THE INVENTION

1. Field of the Invention

The invention relates to overhead structures for commercial interiors (i.e., commercial, industrial and office environments) requiring power for energizing lighting, audio-visual, acoustical management, security and other applications and, more particularly, to a distributed power and communications network using a structural channel system which permits electrical and mechanical interconnections (and reconfiguration of electrical and mechanical interconnections) of various applications, and communications (including programmed reconfiguration of controlled/controlling relationships) among application devices.

2. Background Art

Building infrastructure continue to evolve in today's commercial, industrial and office environments. For purposes of description in this specification, the term “commercial interiors” shall be used to collectively designate these environments. Such environments may include, but are clearly not limited to, retail facilities, medical and other health care operations, educational, religious and governmental institutions, factories and others. Historically, infrastructure consisted of large rooms with fixed walls and doors. Lighting, heating and cooling (if any) were often centrally controlled. Commercial interiors would often be composed of large, heavy and “stand-alone” equipment and operations, such as in factories (e.g., machinery and assembly lines), offices (desks and files), retail (built-in counters and shelves) and the like. Commercial interiors were frequently constructed with very dedicated purposes in mind. Given the use of stationary walls and heavy equipment, any reconfiguration of a commercial interior was a time-consuming and costly undertaking.

In the latter part of the 20th century, commercial interiors began to change. A major impetus for this change was the need to accommodate the increasing “automation” that was being introduced in the commercial interiors and, with such automation, the need for electrical power to support the same. The automation took many forms, including: (i) increasingly sophisticated machine tools and powered equipment in factories; (ii) electronic cash registers and security equipment in retail establishments; (iii) electronic monitoring devices in health care institutions; and (iv) copy machines and electric typewriters requiring high voltage power supplies in office environments. In addition, during this period of increased automation, other infrastructure advancements occurred. For example, alternative lighting approaches (e.g., track lighting with dimmer control switches) and improved air ventilation technologies were introduced, thereby placing additional demands on power availability and access.

In recent decades, information technology has become commonplace throughout commercial interiors. Computer and computer-related technologies have become ubiquitous. As an example, computer-numerically-controlled (CNC) production equipment has been applied extensively in factory environments. Point-of-sale electronic registers and scanners are commonplace in retail establishments. Sophisticated computer simulation and examination devices are used throughout medical institutions. Increased sophistication of computer ?? electronics associated with the examination devices is particularly increasing rapidly, with regard to the greater use of “noninvasive” procedures. Modular “systems” furniture has evolved to support the computers and related hardware used throughout office environments. The proliferation of computers and information technology has resulted not only in additional demands for power access and availability, but also in a profusion of wires needed to power and connect these devices into communications networks. These factors have added considerably to the complexity of planning and managing commercial interiors.

The foregoing conditions can be characterized as comprising: dedicated interior structures with central control systems; increasing needs for power and ready access for power; and information networks and the need to manage all of the resulting wire and cable. The confluence of these conditions has resulted in commercial interiors being inflexible and difficult and costly to change. Today's world requires businesses and institutions to respond quickly to “fast-changing” commercial interior needs.

Commercial interiors may be structurally designed by architects and engineers, and initially laid out in a desired format with respect to building walls, lighting fixtures, switches, data lines and other functional accessories and infrastructure. However, when these structures, which can be characterized as somewhat “permanent” in most buildings, are designed, the actual occupants may not move into the building for several months or even years. Designers almost need to “anticipate” the requirements of future occupants of the building being designed. Needless to say, in situations where the building will not be commissioned for a substantial period of time after the design phase, the infrastructure of the building may not be appropriately laid out for the actual occupants. That is, the prospective tenants' needs may be substantially different from the designers' ideas and concepts. However, most commercial interiors permit little reconfiguration after completion of the initial design. Reconfiguring a structure for the needs of a particular tenant can be extremely expensive and time consuming. During structural modifications, the commercial interior is essentially “down” and provides no positive cash flow to the buildings' owners.

It would be advantageous to always have the occupants' activities and needs “drive” the structures and functions of the infrastructure layout. Today, however, relatively “stationary” (in function and structure) infrastructure essentially operate in reverse. That is, it is not uncommon for prospective tenants to evaluate a building's infrastructure and determine how to “fit” their needs (retail sales areas, point-of-sale centers, conference rooms, lighting, HVAC, and the like) into the existing infrastructure.

Further, and again in today's business climate, a prospective occupant may have had an opportunity to be involved in the design of a building's commercial interior, so that the commercial interior is advantageously “set up” for the occupant. However, many organizations today experience relatively rapid changes in growth, both positively and negatively. When these changes occur, again it may be difficult to appropriately modify the commercial interior so as to permit the occupant to expand beyond its original commercial interior or, alternatively, be reduced in size such that unused space can then be occupied by another tenant.

Other problems also exist with respect to the layout and organization of today's commercial interiors. For example, accessories such as switches and lights may be relatively “set” with regard to locations and particular controlling relationships between such switches and lights. That is, one or more particular switches may control one or more particular lights. To modify these control relationships in most commercial interiors requires significant efforts. In this regard, a commercial interior can be characterized as being “delivered” to original occupants in a particular “initial state.” This initial state is defined by not only the physical locations of functional accessories, but also the control relationships among switches, lights and the like. It would be advantageous to provide means for essentially “changing” the commercial interior in a relatively rapid manner, without requiring physical rewiring or similar activities. In addition, it would also be advantageous to have the capability of modifying physical locations of various application devices, without requiring additional electrical wiring, substantial assembly or disassembly of component parts, or the like. Also, and of primary importance, it would be advantageous to provide a commercial interior which permits not only physical relocation or reconfiguration of functional application devices, but also permits and facilitates reconfiguring control among devices. Still further, it would be advantageous if users of a particular commercial interior could affect control relationships among devices and other utilitarian elements at the location of the commercial interior itself.

Numerous types of commercial interiors would benefit from the capability of relatively rapid reconfiguration of physical location of mechanical and electrical elements, as well as the capability of reconfiguring the “logical” relationship among controlling/controlled devices associated with the system. As one example, reference was previously made to advantages of a retail establishment reconfiguring shelving, cabinetry and other system elements, based on seasonal requirements. Further, a retail establishment may require different locations and different numbers of point-of-sale systems, based on seasons, currently existing advertised sales and other factors. Also a retail establishment may wish to physically and logically reconfigure other mechanical and electrical structure and applications, for purposes of controlling traffic flow through lighting configurations, varying acoustical parameters through sound management and undertaking similar activities. Current systems do not provide for any relatively easy “reconfiguration,” either with respect to electrical or “logical” relationships (e.g. the control of a particular bank of lights by a particular set of switches), or mechanical structure.

A significant amount of work is currently being performed in technologies associated with control of what can be characterized as “environmental” systems. The systems may be utilized in commercial and industrial buildings, residential facilities, and other environments. Control functions may vary from relatively conventional thermostat/temperature control to extremely sophisticated systems. Development is also being undertaken in the field of network technologies for controlling environmental systems. References are often currently made to “smart” buildings or rooms having automated functionality. This technology provides for networks controlling a number of separate and independent functions, including temperature, lighting and the like.

In this regard, it would be advantageous for certain functions associated with environmental control to be readily usable by the occupants, without requiring technical expertise or any substantial training. Also, as previously described, it would be advantageous for the capability of initial configuration or reconfiguration of environmental control to occur within the proximity of the controlled and controlling apparatus, rather than at a centralized or other remote location.

When developing systems for use in commercial interiors for providing electrical power and the like, other considerations are also relevant. For example, strict guidelines exist in the form of governmental and institutional regulations and standards associated with electrical power, mechanical support of overhead structures and the like. These regulations and standards come from the NEC, ANSI, UL and others. This often results in difficulty with respect to providing power and communications distribution throughout locations within a commercial interior. For example, structural elements carrying power or other electrical signals are strictly regulated as to mechanical load-bearing parameters. It may therefore be difficult to establish a “mechanically efficient” system for carrying electrical power, and yet still meet appropriate codes and regulations. Other regulations exist with respect to separation and electrical isolation of cables carrying power and other electrical signals from different sources. Regulations and standards directed to these and similar issues have made it substantially difficult to develop efficient power and communications distribution systems.

Other difficulties also exist. As a further example, if applications are to be “hung” from an overhead structure, and extend below a threshold distance above floor level, such applications must be supported in a “breakaway” structure. That is, if substantial forces are exerted on the applications, they must be capable of breaking away from the supporting structure, without causing the supporting structure to fall or otherwise be severely damaged. This is particularly important where the supporting structure is correspondingly carrying electrical power. With respect to other issues associated with providing a distributed power structure, the carrying of high voltage lines are subject to a number of relatively restrictive codes and regulations. For example, electrical codes usually include stringent requirements regarding isolation and shielding of high voltage lines.

Still further, to provide for a distributed power and communication system for reconfigurable applications, physically realizable limitations exist with respect to system size. For example, and particularly with respect to DC communication signals, limitations exist on the transmission length of such signals, regarding attenuation, S/N ratio, etc. Such limitations may correspondingly limit the physical size of the structure carrying power and communications signals.

Other difficulties may also arise with respect to overhead systems for distributing power. For example, in certain instances, it may be desirable to have the capability of lifting or lowering the height of the entirety of the overhead structure above floor level. Also, when considering an overhead structure, it is advantageous for certain elements to have the capability of extending downwardly from a building structure through the overhead supporting structure. For example, such a configuration may be required for fire sprinkling systems and the like.

Other issues and concerns must also be taken into account. For example, when considering a power distribution structure, it is particularly advantageous to provide not only for distribution of AC power, but also generation of DC power (for operating processor configurations and other components of the communications system and network, and for potentially providing DC power for various application devices interconnected to the network) and distribution of digital communications signals. However, extremely strict building codes exist with respect to any type of overhead structures carrying AC electrical power, particularly high voltage power. Further, although it would be advantageous to carry AC power, DC power and digital communication signals in relatively close proximity within an overhead structure, again building codes and electrical codes forbid many types of configurations where there is significant potential of AC power carrying elements coming into contact with components carrying DC signals, either in the form of power or communication signals. In accordance with the foregoing, it would be advantageous to provide for power distribution, and distribution of communication signals throughout a mechanical “grid.” For such a grid to be practical, it would be necessary for the mechanical grid to accommodate distribution of communication signals and power of appropriate strength (both in terms of amplitude and density) while still meeting requisite building, electrical and other governmental codes and regulations. Still further, however, although such a mechanical grid may be capable of physical realization in particular structures, the grid should advantageously be relatively light weight, inexpensive and capable of permitting reconfiguration of associated application devices. Also, it would be advantageous for such a mechanical grid to be capable of reconfiguration (in addition to reconfiguration of control/controlling relationships of application devices), without requiring assembly, disassembly or any significant modifications to the building infrastructure. Still further, it would be advantageous for such a mechanical grid, along with the power and communications distribution network, to be in the form of an “open” system, thereby permitting additional growth.

A number of systems have been developed which are directed to one or more of the aforedescribed issues. For example, Jones et al., U.S. Pat. No. 3,996,458, issued Dec. 7, 1976, is primarily directed to an illuminated ceiling structure and associated components, with the components being adapted to varying requirements of structure and appearance. Jones et al. disclose the concept that the use of inverted T-bar grids for supporting pluralities of pre-formed integral panels is well known. Jones et al. further disclose the use of T-bar runners having a vertical orientation, with T-bar cross members. The cross members are supported by hangers, in a manner so as to provide an open space or plenum thereabove in which lighting fixtures may be provided. An acrylic horizontal sheet is opaque and light transmitting areas are provided within cells, adding a cube-like configuration. Edges of the acrylic sheet are carried by the horizontal portions of the T-bar runners and cross runners.

Balinski, U.S. Pat. No. 4,034,531, issued Jul. 12, 1977 is directed to a suspended ceiling system having a particular support arrangement. The support arrangement is disclosed as overcoming a deficiency in prior art systems, whereby exposure to heat causes T-runners to expand and deform, with ceiling tiles thus falling from the T-runners as a result of the deformation.

The Balinski ceiling system employs support wires attached to its supporting structure. The support wires hold inverted-T-runners, which may employ enlarged upper portions for stiffening the runners. An exposed flange provides a decorative surface underneath the T-runners. A particular flange disclosed by Balinski includes a longitudinally extending groove on the underneath portion, so as to create a shadow effect. Ceiling tiles are supported on the inverted-T-runners and may include a cut up portion, so as to enable the bottom surface to be flush with the bottom surface of the exposed flange. The inverted-T-runners are connected to one another through the use of flanges. The flanges provide for one end of one inverted-T-runner to engage a slot in a second T-runner. The inverted-T-runners are connected to the decorative flanges through the use of slots within the tops of the decorative flanges, with the slots having a generally triangular cross-section and with the inverted-T-runner having its bottom cross member comprising opposing ends formed over the exposed flange. In this manner, the inverted-T-runner engages the top of the exposed flange in a supporting configuration.

Balinski also shows the decorative exposed flange as being hollow and comprising a U-shaped member, with opposing ends bent outwardly and upwardly, and then inwardly and outwardly of the extreme end portions. In this manner, engagement is provided by the ends of the inverted-T-runner cross members. A particular feature of the Balinski arrangement is that when the system is subjected to extreme heat, and the decorative trim drops away due to the heat, the inverted-T-configuration separates and helps to hold the ceiling tiles in place. In general, Balinski discloses inverted-T-runners supporting ceiling structures.

Balinski et al., U.S. Pat. No. 4,063,391 shows the use of support runners for suspended grid systems. The support runner includes a spline member. An inverted T-runner is engaged with the spline, in a manner so that when the ceiling system is exposed to heat, the inverted T-runner continues to hold the ceiling panels even, although the spline loses structural integrity and may disengage from the trim.

Csenky, U.S. Pat. No. 4,074,092 issued Feb. 14, 1978, discloses a power track system for carrying light fixtures and a light source. The system includes a U-shaped supporting rail, with the limbs of the same being inwardly bent. An insulating lining fits into the rail, and includes at least one current conductor. A grounding member is connected to the ends of the rail limbs, and a second current conductor is mounted on an externally inaccessible portion of the lining that faces inwardly of the rail.

Botty, U.S. Pat. No. 4,533,190 issued Aug. 6, 1985, describes an electrical power track system having an elongated track with a series of longitudinal slots opening outwardly. The slots provide access to a series of offset electrical conductors or bus bars. The slots are shaped in a manner so as to prevent straight-in access to the conductors carried by the track.

Greenberg, U.S. Pat. No. 4,475,226 describes a sound and light track system, with each of the sound or light fixtures being independently mounted for movement on the track. A bus bar assembly includes audio bus bar conductors and power bus bar conductors.

### SUMMARY OF THE INVENTION

In accordance with the invention, an overhead system is used within a building infrastructure for supporting a series of application devices. The system includes a series of main rails interconnected so as to form a structural grid. The grid forms at least one visual plane relative to the building infrastructure. The grid also includes a series of panel insert areas open to the building infrastructure. A series of panels are inserted into the panel insert areas, and the panels limit access to space above the visual plane from below the visual plane. The main rails include means for permitting passage of cablings from above the visual plane to below the visual plane, in the absence of requiring any of the cabling to be passed through apertures of any of the panels.

Still further, the overhead system can include at least one main structural channel rail for providing a mechanical structure for the system. Support means are included for supporting the main rail from the building infrastructure. Power distribution means are electrically connected to a source of electrical power, for distributing the electrical power along the main structural channel rail. The power distribution means includes a series of modular sections connectable to each other, connectable to the structural channel rail and to the source of electrical power, for providing access to the electrical power by the application devices at selected and spaced apart positions along the structural channel rail. Still further, the modular sections can be selectively connectable, if desired, to individual lengths of the main structural channel rail.

In accordance with another aspect of the invention, the system can include connector means coupled to the structural channel rail for supporting vertically disposed functional elements below the structural channel rail. The functional elements can include one or more space dividers. The system can also include a series of structural channel rails, with connector means connected to the series of structural channel rails for supporting horizontally disposed functional elements from the structural channel rails. These functional elements can comprise visual shields. Also, the functional elements can consist of one or more of the following group: space dividers; visual shields; projection screens; visual projectors; and electric motors.

In accordance with another aspect of the invention, the system can include at least one elongated main structural channel assembly, with the assembly including a series of main structural channel rail lengths. Each of the lengths includes a longitudinally extending upper portion and a series of spaced apart upper apertures extending through the upper portion. The upper apertures function so as to permit passage of cables from above and from below the rail length. A pair of opposing side panels extend downwardly from opposing lateral edges of the upper portion, and the side panels include first and second side panels. A series of spaced apart side plug assembly apertures extend through the first side panel and/or the second side panel. At least one modular plug assembly includes a plurality of plug assembly sections, each section including a series of spaced apart, principal electrical dividers positioned along at least one elongated side of the section. Channels are formed within the principal electrical dividers for carrying communication cables and power cables. A series of modular plugs are coupled to the section and spaced apart on the same side of the section as the side carrying the principal electrical dividers. The modular plugs are spaced intermediate adjacent lengths of the principal electrical dividers. Each of the modular plugs is electrically connected to communication cables and to power cables. The plugs function so as to provide access to communication signals carried on the communication cables and to power signals carried on the power cables.

In accordance with another aspect of the invention, the channel assembly includes a first main structural channel rail. A series of modular plugs are coupled to the modular plug assembly section, and are spaced apart along the section. The plugs are adapted to extend inwardly through the side plug assembly apertures of the first main structural channel rail, and into a spatial region formed between the pair of side panels. The system also includes electrical connector means for connecting the modular plug assembly to other electrical components of the overhead system. The connector means includes a connector plug assembly extending through an end aperture of the structural channel rail. This connector plug assembly is electrically coupled to one of the modular plugs which also extends through the end aperture. The end aperture extends through the first side panel and/or the second side panel of the main structural channel rail, and is of a length greater than the lengths of the spaced apart side plug assembly apertures.

Still further, the power distribution means can be connected to a source of electrical power for distributing electrical power along a main structural channel assembly. The power distribution means includes means for accessing the electrical power at selected and spaced apart locations along the structural channel assembly. Correspondingly, communications distribution means are provided for distributing communication signals along the channel assembly. The communications distribution means also includes means for accessing the communication signals at selected and spaced apart locations along the structural channel assembly. The system further includes means connectable to a first subset of the application devices and to the communications distribution means for receiving communication signals from the first subset of application devices. Means are connectable to a second subset of the application devices and to the power distribution means for selectively applying electrical power to the second subset of the application devices. Further, the system includes control means responsive to a subset of the communication signals for selectively controlling application of electrical power to the application devices.

In accordance with another aspect of the invention, the overhead system is an open architectural system, in that the series of main rails, the power distribution means and the communications distribution means can be expanded as to size, either singularly or in combination, without requiring substitution or other replacement of components of a first, original structural of the main rail assembly, the power distribution means or the communications distribution means. Further, the elongated main rail assembly, the power distribution means and the communications distribution means are all reconfigurable, independent of assembly, disassembly or modifications to the building infrastructure. Still further, the power distribution means can include a series of connector modules electrically connected to the source of electrical power, and physically located at spaced apart positions along the main structural channel assembly. The connector modules can include processor means responsive to the communication signals transmitted on the communications distribution means for controlling energization of application devices connected to the connector modules. Also, the processor means effect logical control relationships among application devices connected to the overhead system. The application devices include controlled and controlling devices, and the overhead system includes control and correlation means for selectively energizing certain of the application devices from the power distribution means. Also, the controlled and correlation means effect logical control relationships among the controlled and controlling devices, in the absence of any centralized processing means or centralized control means.

In accordance with another aspect of the invention, the power distribution means and the communications distribution means comprise distribution components contained within the modular plug assemblies. The system can include a series of individual lengths of the modular plug assemblies. These lengths of modular plug assemblies can be selectively located at desired positions along the structural channel assembly, without requiring the modular plug assemblies to be coupled to the structural channel assembly along an entirety of a length of the structural channel assembly. The power distribution means can include at least one modular plug assembly, with the plug assembly having distributed electrical power extending therethrough. The plug assembly also includes means for accessing the electrical power at spaced apart locations extending through apertures of the structural channel assembly. The modular plug assembly is nonintegral with the structural channel assembly.

The power distribution means can include a series of modular sections connectable to each other, to the main structural channel rail and to the source of electrical power, for providing access to the electrical power by the application devices along the structural channel rail. The modular section are selectively connectable as desired to individual lengths of the main structural channel rail. Control means are provided which are responsive to a subset of the communication signals for selectively controlling application of electrical power to the application devices. The main structural channel rail can include a series of spaced apart apertures extending therethrough. These apertures can be located on lateral sides of the structural channel rail. The system is configured so as to provide for releasable interconnection of the connector modules at spaced apart locations along the structural channel rail.

In accordance with further aspects of the invention, the power distribution means can include DC means connected to at least one source of DC power for distributing the DC power to the connector modules. Still further, a subset of the connector modules can include means for transmitting and receiving communication signals to and from the communications distribution means and at least a subset of the application devices. A subset of the connector modules can be electrically coupled to the power distribution means in a manner so that the connector modules fit within the structural channel. Still further, each of at least a subset of the plurality of connector modules can include DC power means for generating DC power. Still further, the mechanical structure can include a series of structural channel rails forming a mechanical grid. The grid, power distribution means and communications distribution means are all reconfigurable, independent of assembly, disassembly or modifications to the infrastructure.

Each of the main structural channel rails is capable of supporting components of the power distribution means and the communications distribution means. The system can include means for distributing electrical power and for providing a distributed, intelligence system for transmitting and receiving certain of the communication signals from the application devices physically located throughout an entirety of the mechanical structure.

The system can also include device connection means physically connectable to the mechanical structure, for mechanically connecting the application devices to the mechanical structure. The device connection means can be manually releasable and movable so as to be connected at a desired one of a series of different locations throughout the structure, and so as to provide for releasable interconnection and movement of the application devices throughout the structure. Still further, the system can include means for positioning sets of electrical conductors in vertically disposed configurations.

In accordance with further aspects of the invention, the system can include one or more wireways for distributing and carrying sets of electrical cables throughout the mechanical structure. The wireways can include means for electrically isolating and shielding the electrical cables from other electrical and communication signal conductors associated with the overhead system. Further, the system can include means for vertically stacking a series of the wireways, one above the other.

Still further, the system can include height adjustment means coupled to the support means, so as to vary the height of a general horizontal plane of the mechanical structure. The height adjustment means can also selectively vary the vertical locations of selected ones of the application devices, relative to a general horizontal plane of the mechanical structure.

In accordance with a further aspect of the invention, a first set of structural components includes a series of main structural rails, with the first set of structural components carrying components of the power distribution means and components of the communications distribution means. The system also includes a second set of structural components and suspension bracket means coupled to the support means and to the mechanical structure for translating gravitational loads from the second set of structural components directly to the support means. In this manner, substantially none of the gravitational loads from the second set of structural components are carried by the first set of structural components. The suspension bracket means also include means for translating gravitational loads of the first set of structural components directly to the support means. Still further, the suspension bracket means include individual means for connecting to a single one of the first set of structural components, and to a pair of the second set of structural components. Gravitational loads exerted on the suspension bracket means from the pair of second set of structural components act so as to increase coupling forces between certain components of the suspension bracket means.

Still further, the support means includes a series of support rods, and each of the suspension bracket means comprises means for connecting to a single one of the series of support rods. At least one wireway is provided for distributing and carrying sets of electrical cables throughout the overhead system. The wireway is carried on the overhead system so that the gravitational loads are carried by the support means, and are not carried by either the first set of structural components or the second set of structural components. The suspension bracket means can include a series of suspension brackets, with each bracket being stackable on individual ones of support rods, and with the brackets being independent of any connection to the first set of structural components or the second set of structural components. Further, the suspension bracket means can include means for vertically stacking the second set of structural components. The suspension brackets can each be connectable to any single one of the series of support rods.

With respect to the suspension brackets, each can include first section means coupled to a first one of the second set of structural components. Second section means can be connected to a second one of the second set of structural components. Central support section means are connected to a first one of the first set of structural components, the first section means, the second section means and the support means. The central support section means is connected to the support means so that gravitational loads from the first section means and the second section means are translated directly to the support means, and gravitational loads are not carried by the first one of the first set of structural components. The first section means can include a central portion having a leg formed on one side thereof, so as to configure a capturing slot. An arcuate arm can be formed on an opposing side of the central portion. The second section means can be substantially identical to the first section means. When assembled, the arcuate arm of the first section means is captured within the capturing slot of the second section means, and the arcuate arm of the second section means is captured within the capturing slot of the first section means.

The first section means can include a first suspension bracket half. The second section means can include a second suspension bracket half, with the second suspension bracket section half being substantially identical to the first suspension bracket section half. When one of the suspension brackets is assembled with the suspension bracket section halves being coupled together, outwardly directed forces exerted on the suspension bracket section halves of the one suspension bracket will act so as to increase coupling forces between the suspension bracket section halves.

The suspension bracket means can include a series of suspension brackets having a universal suspension plate assembly connected to the support means. The universal suspension plate assembly can be adapted to be used independently of other components of the suspension bracket, for purposes of directly securing structural elements to the support means. Still further, each of the suspension brackets can include means for mounting at least one cableway. Gravitational loads of the cableway are carried by the support means, and are not carried by the first set of structural components. The suspension brackets can include means for being coupled to at least one of the support rods, so that individual ones of the suspension brackets are vertically stackable, one above the other on a single support rod. The suspension brackets can include means for connecting to the second set of structural components, so that elements of the second set of structural components are capable of being vertically stacked in correspondence with vertical stacking of the suspension brackets. The suspension brackets can include means for the vertical stacking of the second set of structural components, independent of any interconnection to the first set of structural components.

In accordance with a still further aspect of the invention, the system can include a series of structural cross channels connected between pairs of the main structural channel rails. The main rails, suspension brackets, structural cross channels and elongated supporting elements form a structural grid comprising a common base for implementing various configurations of the overhead system. Further, the overhead system of an initial structural configuration can be expanded in size so as to form a second overhead system, without modification of the initial structural configuration. The system can also include a series of suspension points or nodes, with each suspension node formed in a location along one of the main structural channel rails, and where ends of a pair of structural cross channels, one of the suspension brackets and one of the elongated supporting elements are coupled together. The coupling is provided by the suspension bracket supporting, at least in part, the pair of structural cross channels, and the elongated supporting element supporting the suspension bracket, main structural channel rail in part, and the pair of structural cross channels.

The system can include main structural channel rails which comprise a series of spaced apart apertures, with the spaced apart apertures adapted to permit passage of electrical cables therethrough. The channel rails are supported by the support means, and load ratings of any given one of the structural channel rails may be varied by varying the intervals at which the structural channel rails are supported by the support means. The series of cross channels can each be coupled to and supported by the support means. Also, the cross channels have opposing ends positioned adjacent to the structural channel rails, with each of the cross channels being supported by the support means. In addition, a series of cross rails can be coupled to and supported by one or more of the main structural channel rails. Further, the system can include connection means for connecting one or more of the cross rails to one or more of the cross channels. Still further, the system can also include connection means for connecting one or more of the cross rails to one or more of the main structural channel rails, at an acute angle relative to an elongated length of an interconnected one of the main structural channel rails.

More specifically, the connection means can include a cross rail connector assembly, with the cross rail connector assembly including a universal structural channel attachment assembly. The attachment assembly includes a pair of opposing left side and right side brackets, with the brackets adapted to be coupled to one of the main structural channel rails. A suspension rod is coupled to the pair of opposing brackets and to the cross rail.

The series of main structural channel rails can be interconnected so as to form a structural grid, with the structural grid forming at least one substantially horizontal plane relative to the building infrastructure. Connection means are connectable to components of the structural grid and to a subset of the application devices, so as to support the subset of the application devices above the substantially horizontal plane of the structural grid.

In accordance with a further aspect of the invention, the power distribution means can include a series of connector modules electrically connected to the source of electrical power through the power distribution means, and located so as to be selectively connectable with the application devices to be energized. Plug assembly means are electrically connected to the power source, for carrying electrical power throughout the mechanical structure. Plug assembly connection means are provided for selectively and mechanically connecting the plug assembly means to components of the mechanical structure. The plug assembly means include a series of tap means located at spaced apart positions along the plug assembly means, and electrically connectable to the connector modules for supplying electrical power from the power supply means to the connector modules. The plug assembly means can include a series of modular plug assembly sections, with each section having an elongated configuration connectable to components of the mechanical structure. Modular plug assembly connector means are provided for electrically connecting together individual ones of the modular plug assembly sections. Each of the modular plug assembly sections includes a set of electrical power conductors, electrically connected to the power supply. Tap means are provided which comprise a series of modular plugs, with each of the plugs having terminals electrically tapped into the electrical power connectors, and with the plugs being located at spaced apart positions along the modular plug assembly sections. The modular plug terminals are connectable to the connector modules.

Still further, the modular plug assembly sections are adapted to be used independent of any mechanical connections to components of the structural grid. The modular plug assembly sections can also carry at least one set of communication conductors, carrying the communication signals. The modular plug assembly sections include means for mechanically and electrically isolating the electrical power conductors from the communication conductors. Still further, the tap means include means for tapping into the communication conductors, and supplying communication signals carried by the communication conductors to the conductor modules. The communication conductors can include at least one conductor carrying DC power. In accordance with a further aspect of the invention, means can also be provided for simultaneously tapping into the electrical power conductors, and supplying electrical signals carried by the electrical power conductors to the conductor modules.

The modular plug assembly connector means can include a right hand jumper assembly having right hand terminal means electrically and mechanically connectable to a connector plug of a modular power assembly section. A left hand jumper assembly is provided having left hand terminal means electrically and mechanically connectable to a connector plug of a second one of the modular plug assembly sections. Electrical conduit means are mechanically connected to the right hand jumper assembly and the left hand jumper assembly, and carry electrical power conductors electrically connected to the right hand terminal means and to the left hand terminal means. In accordance with a still further aspect of the invention, the left hand jumper assembly and the right hand jumper assembly can be configured so that the modular plug assembly connector means are unidirectional, in that the modular plug assembly connector means are capable of being electrically and physically connected to adjoining ones of the modular plug assembly sections only in one direction. Further, the modular plug assembly connector means include means for electrically connecting together communication signal conductors from the modular plug assembly sections.

Wireway means are provided for carrying high voltage and other conductors carrying electrical power and/or communication signals separate and independent of other conductors of the power distribution means and/or the communications distribution means which are carrying electrical power and/or communication signals, respectively. Wireway access means are provided for tapping into the high voltage and other conductors at selective locations throughout the mechanical structure, for purposes of supplying electrical power and/or communication signals to one or more of the connector modules, and/or one or more of the application devices.

The overhead system can further include a series of universal suspension plate assemblies connectable to the main structural channel rails and to the support means in a first configuration for supporting the main structural channel rails from the building infrastructure. Each of the plate assemblies is further adapted to be connectable to the main structural channel rails in a second configuration so as to support various elements from the rails, with the elements being positioned below the main structural channel rails. Still further, the suspension plate assemblies are adapted to be configured in a third configuration, where a single one of the plate assemblies in the third configuration is connected to the support means and is also mechanically interconnected to adjacent ends of a pair of the main structural channel rails.

The series of cross channels is adapted to be mechanically interconnected between two or more of the main structural channel rails, so that the rails in the cross channels form the mechanical structure. Bracket configuration means are mechanically supported on one or more of the cross channels, for purposes of supporting functional devices above a general plane of the mechanical structure. The bracket configuration means can include a series of braces and a series of T-brackets and 90° brackets for purposes of interconnecting together two or more braces of the bracket assembly means, and for connecting the braces to the cross channels.

With respect to the cableway, the cableway can include individual cableway sections for carrying conductors, with the conductors carrying power and/or communication signals. Each of the cableway sections can include a living hinge for access to interiors of the cableway sections. In accordance with a further aspect of the invention, the main structural channel rails can include apertures therein, with space provided for structural and electrical components of the system to be extended above a general plane of the structural channel rails through center portions of the rails. The rails and the support rods are positionable so that the support rods can be directly extended through the center portions of the rails, and connected to other devices associated with the overhead system, without supporting or otherwise being connected to the channel rails.

Referring to another aspect of the invention, the power distribution means can include power entry means directly connected to the power supply source for applying electrical power from the power supply source to other components of the system. The power entry means can include means responsive to the power supply source for generating DC power. The power entry means can also include a series of power entry boxes directly connected to the power supply source, and adapted to be secured to and supported by components of the mechanical structure. A series of power box connectors are also provided, with each connector associated with a corresponding one of the power entry boxes, and having means for electrically connecting the power entry boxes to other components of the power distribution means. At least a subset of the power entry boxes can include means for receiving power of multiple voltages from the power supply source. The power entry means also includes network circuit means for providing certain circuit paths for the communication signals.

In accordance with a further aspect of the invention, the connector modules each include input power connection means for releasably interconnecting the connector modules to the power distribution means, and for receiving the electrical power. Output power connection means are coupled to the input power connection means, and releasably connectable to one or more of the application devices, for energizing the application devices. Communication input connection means are provided for releasably interconnecting the subset of connector modules to the communications distribution means, and for receiving a first set of communication signals. Processor means are responsive to the first set of communication signals, for generating a first set of power control signals. The output power connection means are responsive to the first set of power control signals, so as to selectively apply electrical power as output signals from the output power connection means. The processor means are further responsive to the first set of communication signals, for reading data embodied within the first set of communication signals. The processor means are also responsive to the data embodied within the first set of communication signals so as to apply the signals or a second set of communication signals to the communications distribution means through the communication input connection means. Further, each of the connector modules can include means for receiving DC power from the communications distribution means, and using the DC power for operating components of the connector module. Alternatively, each of the connector modules can include means for generating DC power.

The connector modules can each include spatial signal receiving means for receiving spatial control signals from external sources. Means are provided for applying the received spatial control signals to the processor means. Still further, the processor means can be responsive to the received spatial control signals so as to generate communication signals, and apply the communication signals to the communications distribution means.

Still further, each of the modular plug assembly sections can be mechanically connected to the main structural channel rail. Each of the subset of connector modules can include a latch assembly manually operable so as to releasably secure the connector module to one of the modular plug assembly sections. Still further, each connector module can include at least one connector port for transmitting and for receiving communication signals directly from application devices. Still further, the connector port can include means for transmitting DC power to a subset of the application devices. The output power connection means can include at least one outlet receptacle adapted to releasably receive a conventional AC plug from an application device. The output power connection means can also include at least one universal connector adapted to receive a multi-terminal mating power connector associated with one of the application devices. The output power connection means can also include one multiple voltage relay adapted to be releasably connected to a multi-voltage switch of one of the application devices. Still further, the connector modules can include visual means for visually indicating to a user a status of a connector module and/or a status of modular control relationships associated with the connector module and one or more of the application devices. The system can also include spatial signal receiver means for receiving spatial control signals from a user, with the receiver means being remote from a subset of the connector modules. Still further, a subset of the communication signals can be utilized to control and reconfigure control among various ones of the application devices. Still further, the system provides for reconfiguration and real time control relationships between and among at least a subset of the application devices.

The connector means can include processor means and associated circuitry responsive to a subset of the communication signals, so as to selectively control the interconnected application devices in response to certain of the communication signals being received from others of the application devices.

The application devices can include at least one controlling device, with the device having signal generating means for generating a first of communication signals. The application devices can also include at least one controlled device, with the controlled device being associated with one of the series of connector modules, and having at least first and second states. The first set of communication signals is utilized to effect a logical control relationship between the controlling device and the controlled device, so that the controlling device controls whether the controlled device is in the first state or the second state. The logical control relationship between the controlling device and the controlled device is capable of reconfiguration, at least in part, with a second set of communication signals, in the absence of any physical relocation or physical rewiring associated with the controlling device and the controlled device. The controlling device can be communicatively coupled to a first one of the connector modules, and the first set of communication signals applied to the communications distribution means through the first connector module. The controlled device can be electrically coupled to a second one of the connector modules, with the second one of the connector modules being responsive to the first set of communication signals to selectively apply electrical power to the controlled device, so as to cause the controlled device to function in either the first state or the second state.

The controlling device can include processor means responsive to external control signals for generating communication signals so as to effect the logical control relationship between the controlling device and the controlled device. The controlling device can be electrically coupled to a first connector module through one or more connector ports and at least one patch cord. The patch cord and the connector ports can be adapted to apply DC power from the first connector module to the controlling device.

In accordance with the further aspect of the invention, the communication signals carried on the communications distribution means can be in a differential signal format. Also, a subset of connector modules can comprise processor means programmable by a user so as to initiate or otherwise modify the logical control relationship among controlling and controlled devices. The system can include remote programming means for transmitting spatial signals to one or more of the connector modules. The remote programming means can include means for transmitting spatial signals to the controlling device, thereby causing the controlling device to be assigned as a control for the first connector module. The spatial signals can be transmitted to the first connector module so as to announce to the communications distribution means that the first connector module is available for purposes of control. The first set of the communication signals generated by the controlling device can be applied to the communications distribution means as wireless signals.

In accordance with still further aspects of the invention, the system can include a first manually operable programming means for transmitting programming signals to the controlling device and to the connector module associated with the controlled device, the programming signals acting so as to effect the logical control relationship. The programming means can comprise a hand-held device. The controlling device can also include a series of switches, including a first switch. The controlled devices can include a series of lighting fixtures and other powered devices. The mechanical structure can include at least two rail sections having a longitudinally aligned configuration. The power distribution means can include a series of power entry boxes, with at least a subset of the rail sections having a power entry box connected to each of the subset of main rail sections. The power entry box can include electrical power cables and outgoing communication cables, with the power cables and communication cables being connected to plug assembly sections of the modular plug assembly. The power entry boxes can include network circuits forming circuit paths for the communication signals. The system can also include means for daisy chaining together individual ones of the power entry boxes, so as to link the network circuits together to form the communications distribution means.

The system can also include flexible connectors for interconnecting appropriate ones of the plug assembly sections. The first switch can be communicably coupled to the communications distribution means through a first connector module located on a first one of the channel rail sections. The light fixtures can be interconnected to one or more of the connector modules, located on either the same or different ones of the channel rail sections, relative to the channel rail sections to which the first connector module coupled to the first switch is located.

The communications distribution means can be programmed so that the first switch controls the light fixtures as to individual states of the light fixtures. Programming of correlation between the light fixtures and the switch results in enablement of the first switch causing communication signals to be applied through the first connector module coupled to the first switch and to the connector modules coupled to the light fixtures. Further, the connector modules coupled to the controlled device can be programmable so as to have a unique address identifiable through the communications distribution means.

In accordance with further aspects of the invention, the wireway can include a series of elongated wireway sections, with each section having means for electrically and physically isolating electrical cables from other electrical components associated with the system. The wireway can include joiner sections for mechanically interconnecting ends of pairs of adjacent wireway sections, so as to maintain electrical isolation of the electrical cables, as the cables pass from one of the wireway sections to an adjacent one of the wireway sections. Each of the wireway sections can include a hinged cover for providing access to the electrical cables, while also selectively maintaining an isolating covering for each of the wireway sections.

### BRIEF DESCRIPTION OF THE SEVERAL VIEWS OF THE DRAWING

The invention will now be described with reference to the drawings, in which:

FIG. 1 is a perspective view, showing an exemplary embodiment of a structural channel system in accordance with the invention, with FIG. 1 illustrating support of the system from a building structure;

FIG. 2 is a cross-sectional view of the structural channel system shown in FIG. 1, taken along section lines 2-2 of FIG. 1 and expressly illustrating the connection of the system to a threaded support rod;

FIG. 3 is an orthogonal, exploded view in two dimensions of certain of the elements of the structural channel system in accordance with the invention, with the principal elements also shown in FIG. 1;

FIG. 4 is a plan, diagrammatic view of certain mechanical principal elements of the structural channel system, including a main perforated structural channel, a plurality of cross-channels, a plurality of cross-rails and a bracket configuration extending between a pair of adjacent cross-channels;

FIG. 5 is a plan view of one section of a main perforated structural channel rail in accordance with the invention;

FIG. 6 is a side elevation view of the main perforated structural channel rail illustrated in FIG. 5;

FIG. 7 is an underside view of the main structural channel rail illustrated in FIGS. 5 and 6;

FIG. 8 is an enlarged, plan view of a portion of one end of the main structural channel rail illustrated in FIG. 5;

FIG. 9 is an enlarged, side elevation view of a portion of one end of the main structural channel rail illustrated in FIG. 5;

FIG. 10 is a perspective view of the main structural channel rail illustrated in FIG. 5;

FIG. 11 is an enlarged, perspective view of one end of the main structural channel rail illustrated in FIG. 10;

FIG. 12 is an enlarged, sectional end view of the main structural channel rail illustrated in FIG. 10, taken along section lines 12-12 of FIG. 10;

FIG. 13 is a perspective and stand-alone view of a suspension bracket in accordance with the invention, in a fully assembled state;

FIG. 14 is a perspective and partially exploded view of the suspension bracket illustrated in FIG. 13;

FIG. 15 is a plan view of a section half of the suspension bracket illustrated in FIG. 13;

FIG. 16 is a plan view of the entirety of the suspension bracket illustrated in FIG. 13;

FIG. 17 is a perspective view of a portion of a main structural channel rail, with the suspension bracket attached thereto and further attached to a support rod;

FIG. 18 is a perspective view of one end of a main structural channel rail showing various uses of a universal suspension plate assembly at upper and lower portions of the main structural channel rail, and at an end of the main structural channel rail;

FIG. 19 is a perspective view of one end of a main structural channel rail, showing the use of a suspension bracket for purposes of perpendicularly securing a pair of opposing perforated structural cross-channels;

FIG. 19A is an end view of a series of suspension brackets, cableways and wireways secured to a support rod in a stacked configuration;

FIG. 20 is a side elevation view of an example embodiment of one of the perforated structural cross-channels illustrated in FIG. 19;

FIG. 21 is a plan view of the perforated structural cross channel illustrated in FIG. 19;

FIG. 22 is a side elevation view of a perforated structural cross channel as connected between parallel and adjacent main structural channel rails, with the structural channel rails showing the interconnection of wireways and cableways to the rails;

FIG. 23 is a perspective view of one end of a main structural channel rail, one end of a cross rail, and a channel connector assembly interconnecting the cross rail beneath the main structural channel rail;

FIG. 24 is a perspective and partially exploded view of the channel connector assembly shown in FIG. 23, and specifically showing the support bracket assembly and the threaded support rod;

FIG. 25 is an end view of the support bracket assembly shown in FIG. 24;

FIG. 26 is an end view of the channel connector assembly connecting together one cross rail (with an end of the cross rail being partially shown) to a main structural channel rail, having a suspension bracket thereabove, and further showing an end view of a cableway and a wireway;

FIG. 27 is a perspective view of a bracket configuration as coupled to a pair of cross-channels, so as to support various elements, and specifically showing the support of a heating duct;

FIG. 28 is a perspective view of a 90° bracket which may be utilized in accordance with the invention;

FIG. 29 is a perspective view of a T bracket which may be utilized in accordance with the invention;

FIG. 30 is a perspective view of a clip and threaded rod hanger which may be utilized in accordance with the invention;

FIG. 31 is a perspective and stand-alone view of a cableway in accordance with the invention, which may be utilized, for example, for carrying communications cables or wires with low voltage DC power, and where the cables or wires do not need to be fully isolated or shielded, and further with the cableway being illustrated with a living hinge;

FIG. 32 is a perspective view of a wireway which may be utilized in accordance with the invention, for purposes of carrying power such as 277 volt AC, and illustrating the wireway in a partially cutaway format for purposes of clarity of parts, and further illustrating the wireway cover in a closed position in solid line format, and in an open position in phantom line format;

FIG. 33 is an exploded view of a joiner which may be utilized with the wireway illustrated in FIG. 32, with the joiner being adapted to interconnect adjacent lengths of wireways in a manner so that the interiors of the wireways are substantially isolated and covered, even at the ends of the lengths of wireways;

FIG. 34 is a perspective view of the joiner illustrated in FIG. 33, showing a pair of wireway lengths connected at a location of a suspension bracket through a joiner;

FIG. 35 is a perspective and stand-alone view of a modular plug assembly (showing one length thereof) which is adapted to be interconnected to main structural channel rails;

FIG. 36 is an enlarged view of one end of the modular plug assembly illustrated in FIG. 35;

FIG. 37 is a side elevation view of one side of the modular plug assembly illustrated in FIG. 35;

FIG. 38 is a plan view of the modular plug assembly illustrated in FIG. 35;

FIG. 39 is a side elevation view, showing the side opposing the side shown in FIG. 37, of the modular plug assembly illustrated in FIG. 35;

FIG. 40 is a side elevation and enlarged view of one end of the modular plug assembly shown in FIG. 35, with FIG. 40 illustrating the same side as shown in FIG. 39;

FIG. 41 is an end view of the modular plug assembly shown in FIG. 40, taken along lines 41-41 of FIG. 40;

FIG. 42 is a sectional, end view of the modular plug assembly shown in FIG. 40, taken along section lines 42-42 of FIG. 40;

FIG. 42A is a perspective and exploded view of one of the modular plugs of the modular plug assembly shown in FIG. 35;

FIG. 42B is a perspective and exploded view of one of the distribution plugs of the modular plug assembly shown in FIG. 35, with one of the distribution plugs being associated with each section of the modular plug assembly;

FIG. 43 is a perspective and partially exploded view of a portion of a main structural channel rail, a portion of a modular plug assembly, and a connector module, showing the relative locations of the various components when the modular plug assembly is secured to the main structural channel rail;

FIG. 44 is a perspective view of the main structural channel rail, modular plug assembly and connector module shown in FIG. 43, shown in a fully assembled state;

FIG. 45 is a perspective view of one embodiment of a power entry box coupled to a main structural channel rail through one embodiment of a power box connector;

FIG. 46 is a perspective view of the power entry box shown in FIG. 45, in substantially enlarged and stand-alone state, and further showing power being received from above the box;

FIG. 47 is a perspective and partially exploded view showing an end of the power entry box illustrated in FIG. 46, and further showing details relating to a power entry box clamp for securing the box to one of the threaded support rods;

FIG. 48 is a rear elevation view of the power entry box shown in FIG. 46, illustrating available wire knockouts;

FIG. 49 is a perspective view of one embodiment of a power box connector which may be utilized in accordance with the invention;

FIG. 50 is a perspective and stand-alone view of a flexible connector assembly which may be utilized in accordance with the invention, for purposes of electrically interconnecting together a pair of sections of the modular plug assembly;

FIG. 50A is an exploded view of the flexible connector assembly shown in FIG. 50;

FIG. 50B is a side elevation view of the flexible connector assembly shown in FIG. 50;

FIG. 50C illustrates the positioning of the flexible connector assembly as it is being used to connect adjacent sections of the modular plug assembly, and further showing the concept that such connection of the flexible connector assembly is unidirectional;

FIG. 51 is a perspective and stand-alone view of a receptacle connector module in accordance with the invention;

FIG. 51A illustrates a side elevation and stand-alone view of the receptacle connector module shown in FIG. 51;

FIG. 51B is an end view of the receptacle connector module shown in FIG. 51;

FIG. 51C is a further end view of the receptacle connector module shown in FIG. 51, and expressly showing the end opposing the end shown in FIG. 51B;

FIG. 51D is a plan view of the receptacle connector module shown in FIG. 51;

FIG. 52 is an exploded view of a portion of the receptacle connector module identified within circle 52 of FIG. 51A, and expressly showing a ferrule coupler;

FIG. 53 is a sectional end view of the receptacle connector module shown in FIG. 51, and illustrating details of the ferrule coupler, as taken along section lines 53-53 of FIG. 52;

FIG. 54 is a side elevation view of the receptacle connector module shown in FIG. 51, and expressly showing an initial positioning of the receptacle connector module as it is being mechanically and electrically coupled to a section of the module plug assembly;

FIG. 55 is a view similar to FIG. 54, but showing the receptacle connector module in its uppermost position as it is being coupled to the length of the modular plug assembly;

FIG. 56 is a view similar to FIGS. 54 and 55, and showing a user exerting forces on the end of the receptacle connector module, so as to mechanically and electrically secure the receptacle connector module in its final position as coupled to the modular plug assembly;

FIG. 57 is an enlarged view of a portion of the receptacle connector module as shown in FIG. 56, as expressly identified by circle 57 in FIG. 56, and showing details relating to use and operation of a connector latch assembly utilized for purposes of more rigidly coupling the receptacle connector module to the modular plug assembly;

FIG. 58 is a perspective view of the receptacle connector module illustrated in FIG. 51, and showing the connector module coupled to a modular plug assembly and main structural channel rail, and energizing an application device comprising a fan;

FIG. 58A is a partially schematic and partially diagrammatic block diagram of various circuit elements of the receptacle connector module shown in FIG. 51;

FIG. 59 is a perspective and exploded view of a dimmer connector module in accordance with the invention, and illustrating the internal configuration of the same;

FIG. 59A is a perspective view of the dimmer connector module shown in FIG. 59, and illustrating the pivotable coupling of a dimmer light track to the dimmer connector module;

FIG. 60 is a perspective view showing a partial length of a main structural channel rail, dimmer connector module and dimmer light track in a fully assembled state;

FIG. 60A is a partially schematic and partially diagrammatic block diagram showing, in simplified format, the internal circuitry associated with the dimmer connector module;

FIG. 61 is perspective and stand-alone view of a power drop connector module in accordance with the invention;

FIG. 62 is a perspective and exploded view of the power drop connector module shown in FIG. 61;

FIG. 62A is a partially schematic and partially diagrammatic block diagram showing, in simplified format, the internal circuitry associated with the power drop connector module;

FIG. 63 is a perspective view of the power drop connector module shown in FIG. 61, and further showing the power drop connector module connected to a section of the modular plug assembly within a main structural channel rail, and with the power drop connector module energizing an electrically interconnected exemplary embodiment of a power pole;

FIG. 64 is a perspective view of a power pole which may be utilized in accordance with the invention;

FIG. 65 is a sectional, plan view of a portion of the power pole shown in FIG. 64, taken along section lines 65-65 of FIG. 64;

FIG. 66 is another sectional, plan view of a part of the power pole shown in FIG. 64, taken along section lines 66-66 of FIG. 64;

FIG. 67 is a side, elevation view of an alternative embodiment of a receptacle connector module which may be utilized in accordance with the invention, and where the connector module provides for a lateral electrical interconnection to a modular plug of the module plug assembly, with the electrical connection occurring through selectively movable contacts;

FIG. 68 is a partial, side elevation view of an alternative embodiment of a modular plug compatible with use with the receptacle connector module shown in FIG. 67, and where the modular plug includes a configuration permitting lateral access to a series of buses or other components carrying electrical power and communications;

FIG. 69 is a sectional, end view showing the configuration for electrical interconnection of the movable contacts on the connector module shown in FIG. 67, with the buses or similar components of the module plug shown in FIG. 68;

FIG. 70 is a plan and diagrammatic view of a power and communications signal distribution system, illustrating how AC power and communication signals may be distributed among lengths of the main structural channel rails and modular plug assembly of the structural channel system;

FIG. 71 is a plan and diagrammatic view of an embodiment of the structural channel system, absent illustrations of incoming building power, but showing coupling of a power and communication signals among lengths of the main structural channel rails, modular plug assembly and application devices located at various positions within the layout of the structural channel system, and with the application devices and connector modules essentially forming individual subnetworks of their own as a distributed intelligence system;

FIG. 72 is a perspective view of a receptacle connector module illustrating its position within a main structural channel rail and interconnected to a modular plug assembly, and its interconnection to a wall switch;

FIG. 72A is a front elevation view of a pressure switch which may be utilized in accordance with the invention;

FIG. 72B is a front elevation view of a pull chain switch which may be utilized in accordance with the invention;

FIG. 72C is a front elevation view of a motion sensing switch which may be utilized in accordance with the invention;

FIG. 72D is a front elevation view of a dimmer switch assembly which may be utilized in accordance with the invention;

FIG. 72E is a perspective and exploded view of the dimmer switch assembly shown in FIG. 72D;

FIG. 72F is a perspective view of the dimmer switch assembly shown in FIG. 72D, in a fully assembled state;

FIG. 73 is a perspective view of a control wand which may be utilized with the structural channel system in accordance with the invention;

FIG. 74 is a plan view of the wand shown in FIG. 73;

FIG. 75 is a front, elevation view of the wand shown in FIG. 73;

FIG. 76 is a perspective view of one configuration of a structural channel system in accordance with the invention, and illustrating a user pointing the wand to an IR receiver on a receptacle connector module, to which a light fixture is electrically engaged;

FIG. 77 illustrates the user shown in FIG. 76, pointing the wand to the switch to be associated with the light, for purposes of programming the control relationship between the switch and the light;

FIG. 78 illustrates the use of a junction box assembly with the structural channel system;

FIG. 79 is a partially schematic and partially diagrammatic block diagram, in simplified format, showing internal circuitry of the junction box assembly, and further showing interconnection through a knock-out with high voltage cables carried in the wireway;

FIG. 80 is a perspective and exploded view of the junction box assembly shown in FIG. 79;

FIG. 81 is a perspective view of the junction box assembly shown in FIG. 79, in a fully assembled state;

FIG. 82 is a perspective and exploded view of alternative and possibly preferred embodiments for the power entry box and power box connector;

FIG. 83 is a perspective view of the alternative embodiments shown in FIG. 82, showing the power entry box and power box connector in a fully assembled state;

FIG. 84 is a perspective and exploded view of the alternative embodiment of the power box connector shown in FIG. 82;

FIG. 85 is a partially perspective and partially diagrammatic view illustrating the use of the power entry boxes in a daisy chain configuration for the communications network;

FIG. 86 is a partially schematic and partially diagrammatic block diagram of various circuit components of the receptacle connector module shown in FIG. 51, in a manner similar to FIG. 58A, but further showing the use of a remote IR receiver and light which can be directly connected to a connector module through a connector port, so that signals can be received in the manner that communications signals can be transmitted and received directly from and to the processor of the connector module;

FIG. 87 is a perspective view showing a structural channel rail 102 and a full and partially exploded view of the universal structural channel attachment assembly 350, previously illustrated in FIG. 24;

FIG. 88 illustrates an exploded view of the universal support bracket assembly 543 for connection to a cross rail 106;

FIG. 89 illustrates various components, including the universal structural channel attachment assembly 350, universal support bracket assembly 543 and a universal support bracket for cross channels 104, and further shows components comprising a suspension arrangement 545 for suspending lighting fixtures from the structural channel system 100;

FIG. 90 illustrates, in exploded view format, the connection of the universal support bracket assembly 543 to a cross rail 106;

FIG. 91 illustrates various components associated with the structural channel system 100, including the suspension bracket assembly, suspension plate assembly and universal support bracket; and

FIG. 92 illustrates, in another view, the universal support bracket for the structural channel rail 102, universal support bracket for the cross rail 106 and a clamp plate for use with the cross channels.

### DETAILED DESCRIPTION OF THE INVENTION

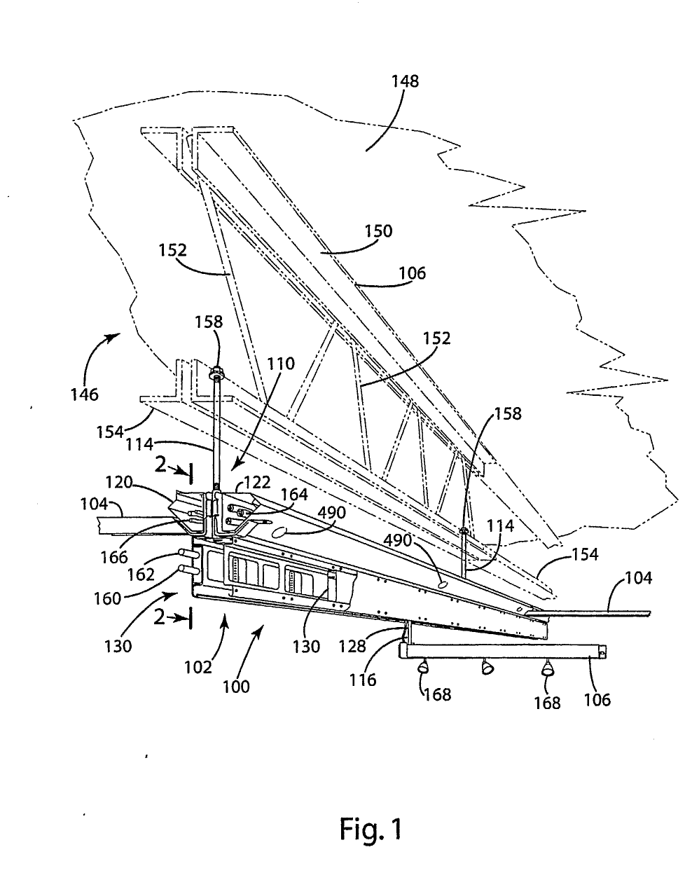

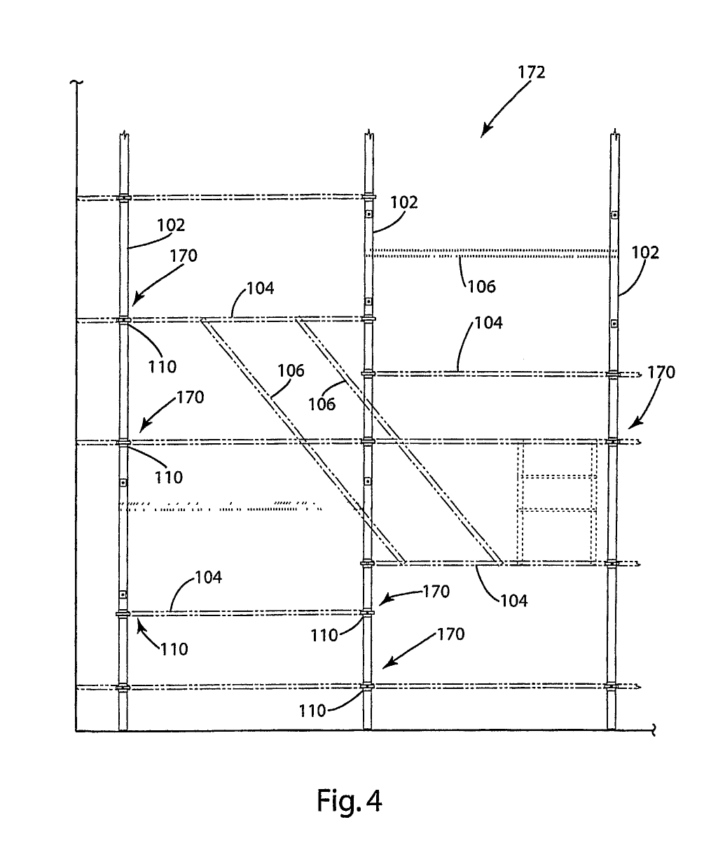

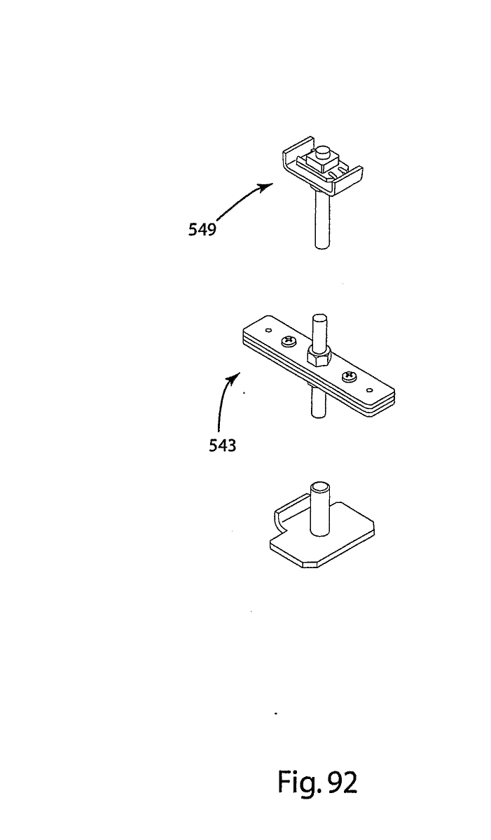

The principles of the invention are disclosed, by way of example, within a structural channel system 100 illustrated in FIGS. 1-92. A perspective view of major components of the structural channel system 100, as installed within a building structure which may comprise a reconfigurable commercial interior, is illustrated in FIG. 1. A structural layout of the structural channel system 100 employing certain of its components is illustrated in FIG. 4. The structural channel system 100 comprises an overhead structure providing significant advantages in environmental workspaces. As examples, the structural channel system 100 in accordance with the invention facilitates access to locations where a commercial interior designer may wish to locate various functional elements, including lighting, sound equipment, projection equipment (both screens and projectors), power poles, other means for energizing and providing data to and from electrical and communication devices, and other utilitarian elements.

As will be described in greater detail in subsequent paragraphs herein, the structural channel system 100 in accordance with the invention includes what may be characterized as a “grid” which essentially forms a base structure for various implementations of the structural channel system. The utilitarian elements referred to herein, for purposes of definition, are characterized as “devices.” Such devices, which may be programmed to establish control relationships (such as a series of switches and a series of light fixtures), are referenced herein as “applications.” In addition, the structural channel system 100 facilitates flexibility and reconfiguration in the location of various devices, which may be supported and mounted in a releasable and reconfigurable manner within the structural channel system 100. Still further, the structural channel system 100 in accordance with the invention may carry not only AC electrical power (of varying voltages), but also may carry DC power and communication signals.

In accordance with further aspects of the invention, the structural channel system 100 may include a communication structure which permits “programming” of control relationships among various commercial devices. For example, “control relationships” may be “programmed” among devices, such as switches, lights, and the like. More specifically, with the structural channel system 100 in accordance with the invention, reconfiguration is facilitated with respect to expense, time and functionality. Essentially, the commercial interior can be reconfigured in “real time.” In this regard, not only is it important that various functional devices can be quickly relocated from a “physical” sense, but logical relationships among the functional devices can also be altered. In part, it is the “totality” of the differing aspects of a commercial interior which are readily reconfigurable, and which provide some of the inventive concepts of the structural channel system 100.

Still further, the structural channel system 100 in accordance with the invention overcomes certain other issues, particularly related to governmental and institutional codes, regulations and standards associated with electrical power, mechanical support of overhead structures and the like. For example, it is advantageous to have power availability throughout a number of locations within a commercial interior. The structural channel system 100 in accordance with the invention provides the advantages of an overhead structure for distributing power and communication signals. However, structural elements carrying electrical signals (either in the form of power or communications) are regulated as to mechanical load-bearing thresholds. As described in subsequent paragraphs herein, the structural channel system 100 in accordance with the invention employs suspension brackets 110 for supporting elements such as cross-channels 104 and the like throughout the overhead structure. With the use of suspension brackets 110 in accordance with the invention, the load resulting from these cross-channels 104 is directly supported through elements coupled to the building structure of the commercial interior. Accordingly, rail elements carrying power and communication signals do not support the mechanical loads resulting from use of the cross-channels 104.

As will be further described in subsequent paragraphs herein, the structural channel system 100 in accordance with the invention provides other advantages. For example, the structural channel system 100 permits carrying of relatively high voltage cables, such as 277 volt AC power cables. With the use of wireways 122 as described subsequently herein, such cabling can be appropriately isolated and shielded, and meet requisite codes and regulations. Still further, the structural channel system 100 in accordance with certain other aspects of the invention can carry DC “network” power, along with DC communications. The DC power advantageously may be generated from building power, through AC/DC converters associated with power entry boxes. Alternatively, DC power may be generated by power supplies within connector modules throughout the network. With the DC network power essentially separate from other DC building power, overload potential is reduced.

Still other advantages exist in accordance with certain aspects of the invention, relating to the carrying of both AC and DC power. Again, governmental and institutional codes and regulations include some relatively severe restrictions on mechanical structures incorporating buses, cables or other conductive elements carrying both AC and DC power. These restrictions, for example, include regulations limiting the use of AC and DC cables on a single mechanical structure. The structural channel system 100 comprises a mechanical and electrical structure which provides for distribution of AC and DC power (in addition to distribution of communication signals through an electrical network) through corresponding cables that utilize a mechanical structure which should meet most codes and regulations.

Still further, the structural channel system 100 in accordance with the invention includes the concept of providing for both wireways and cableways for carrying AC and DC power cables. In the particular embodiment of the structural channel system 100 in accordance with the invention as described herein, the cableways (subsequently identified as cableways 120) are utilized for carrying components and signals such as low voltage DC power or other signals which do not necessarily require any substantial isolation or shielding. In contrast, the wireways (identified as wireways 122 subsequently herein) include an isolation and shielding structure which is suitable for carrying signals and power such as 277 volt AC power. Further, the structural channel system 100 includes not only the capability of providing for a single set of such cableways and wireways, but also provides for the “stacking” of the same. Still further, other governmental and intuitional codes and regulations include restrictions relating to objects which extend below a certain minimum distance above ground level, with respect to support of such objects. The structural channel system 100 in accordance with the invention provides for breakaway hanger assemblies, again meeting these restrictive codes and regulations. Still further, with a distributed power system as provided by the structural channel system 100, it is necessary to transmit power between various types of structural elements, such as adjacent lengths of main channels. With the particular mechanical and electrical structure of the structural channel system 100, flexible connector assemblies (such as the flexible connector assemblies 138 subsequently described herein) can be utilized to transmit power from one main channel length to another. Additionally, the structural channel system 100 may include various lengths of main channels which are coupled to components providing building power individually for each of the main channel lengths. However, in such event, it is still necessary to electrically couple together these main channel lengths in a manner so that communications signals can readily be transmitted and received among the various lengths. Accordingly, and in accordance with the invention, the structural channel system 100 includes means for “daisy chaining” components of the system together in a manner so that the distributed network is maintained with respect to communication signals.

Still further, the structural channel system 100 can be characterized as not only a distributed power network, but also a distributed “intelligence” network. That is, when various types of application devices are connected into the network of the structural channel system 100, “smart” connectors may be utilized. It is this intelligence associated with the application devices and their connectivity to the network which permits a user to “configure” the structural channel system 100 and associated devices as desired. This is achieved without requiring physical rewiring, or any type of centralized computer or control systems.

The structural channel system 100 in accordance with another aspect of the invention may also be characterized as an “open” system. In this regard, infrastructure elements (such as main channels and the like) and application devices can be readily added onto the system 100, without any severe restrictions. Other advantageous concepts include, for example, the use of mechanical elements for supporting the structural channel system 100 from the building structure itself, so as to permit the “height” of the structural channel system 100 from the floor to be varied.

As earlier stated, it is advantageous to provide for a mechanical structure meeting governmental and institutional codes and regulations, while still providing the capability of carrying communication signals, low voltage DC power and AC power. Such a configuration employing buses is disclosed in the copending U.S. Provisional Patent Application entitled “POWER AND COMMUNICATIONS DISTRIBUTION STRUCTURE USING SPLIT BUS RAIL SYSTEM,” filed Jul. 29, 2004. The disclosure of the aforementioned patent application is hereby incorporated by reference herein. As an alternative to using a bus structure, it is advantageous to provide for a power and communications distribution structure which utilizes cables or wires in place of buses. Still further, it is advantageous to provide such power and communications distribution within a relatively simplified structural network or “grid.” In this regard, it is also advantageous if the number of different types of components utilized for both mechanical and electrical structure can be relatively small in number, while still providing for a variety of various types of applications and features. Still further, it is advantageous if the mechanical structure can be relatively lightweight. In addition, advantages exist when connections can be made between source power and a power and communications distribution network at numerous locations within the network, without being particularly limited to only a relatively few network positions for interconnections. In addition, it is advantageous if assembly, disassembly and reconfiguration of electrical and mechanical components of the power and communications distribution structure and network structure can occur without substantial difficulty.

With reference first to FIG. 1, the structural channel system 100 may be employed within a commercial interior 146. The commercial interior 146 may be in the form of any type of commercial, industrial or office interior, including facilities such as religious, health care and similar types of structures. For purposes of description, FIG. 1 illustrates only certain overhead elements of commercial interior 146. These elements of the commercial interior 146 are illustrated in FIG. 1 in “phantom line” format, since they do not form any novel components of the structural channel system 100 in accordance with the invention. As shown in FIG. 1, the commercial interior structure 146 may include a ceiling 148, with sets of upper L-beams 150 welded or otherwise secured to the ceiling 148 by any appropriate and well-known means. Angled supports 152 extend downwardly from the upper L-beams 150, and attach to sets of lower L-beams 154. Secured to the lower L-beams 154 are sets of threaded support rods 114. The threaded support rods 114 extend downwardly from the lower L-beams 154 and may be secured to the lower L-beams 154 by any appropriate means. As an example, and as shown somewhat in diagrammatic format in FIG. 1, the threaded support rods 114 may have nut/washer combinations 158 at their upper ends for securing the support rods 114 to the L-beams 154.

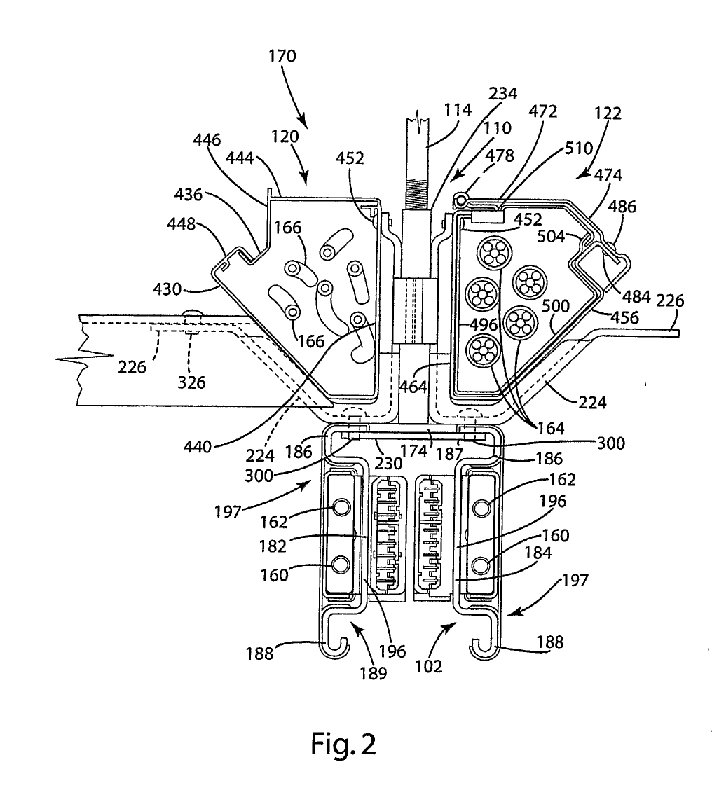

The structural channel system 100 includes a number of other principal components, many of which are shown at least in partial format in FIG. 1. More specifically, FIG. 1 illustrates a length of a main perforated structural channel rail 102 (sometimes referred to herein as the “main structural channel 102”) having an elongated configuration as shown in FIG. 1. As will be described in detail in subsequent paragraphs herein, the main perforated structural channel rail 102 may carry, on opposing sides of the structural channel 102, modular plug assemblies 130. As described in subsequent paragraphs herein, each of the modular plug assemblies 130 may carry, within its interior, an AC power cable assembly 160 and a DC power/communications cable assembly 162. As also described in subsequent paragraphs herein, the AC power cable assembly 160 may carry, for example, 120 volt AC power, other voltages, or electrical power other than AC. Correspondingly, the DC power/communications cable assembly 162 may carry communication signals and other low voltage DC power. Above the main structural channel 102 are a cableway 120 and a wireway 122. The cableway 120 and wireway 122 may be utilized for various functions associated with the structural channel system 100. For example, the wireway 122 may be utilized to carry 277 volt AC power cables 164, as illustrated in FIGS. 1 and 2. Correspondingly, the cableway 120 may be utilized to carry elements such as low voltage DC power cables 166, as also illustrated in FIGS. 1 and 2.

Also associated with the structural channel system 100, and comprising a principal aspect of the invention, are suspension brackets 110. One of these suspension brackets 110 is illustrated in part in FIG. 1, and will be illustrated and described in greater detail in subsequent drawings and paragraphs herein. The suspension brackets 110 are utilized in part to support the main structural channel rails 102 from the ceiling 148 through the threaded support rods 114. Also, and of primary importance, the suspension brackets 110 include elements which permit cross-channels, such as the cross-channels 104 illustrated in FIG. 1, to be mechanically supported directly through the threaded support rods 114 from the ceiling 148. Accordingly, and in accordance with the invention, the cross-channels 104 do not exert any significant mechanical load on the main structural channels 102, which carry the modular plug assemblies 130 having AC power cable assemblies 160 and DC cable assemblies 162. If mechanical loads were exerted on the main structural channels 102 by elements such as the cross-channels 104, governmental and institutional regulations would not permit the main structural channels 102 to carry the modular plug assemblies 130.

Also in accordance with the invention, the structural channel system 100 as illustrated in FIG. 1 may comprise cross-rails 106. Each of the cross-rails 106 utilized with the structural channel system 100, as described in subsequent paragraphs herein, is releasably interconnected to one of the main structural channel rails 102. Further, cross-rails 106 may extend in perpendicular configurations relative to the main structural channel rails 102, as illustrated in FIG. 1. However, as also described in subsequent paragraphs herein, a cross rail 106 may be interconnected to an adjacent main structural channel 102 at an angular configuration, relative to the longitudinal configuration of the main structural channel 102. Each cross rail 106 may be releasably coupled to an associated main structural channel 102 through a universal suspension plate assembly 116. The cross-rails 106 may be utilized for purposes of distributing electrical power and communication signals from an interconnected main structural channel rail 102 having a modular plug assembly 130. This power and communications signal distribution may be utilized with various devices, such as the three lights 168 illustrated in FIG. 1.

One advantage associated with the structural channel system 100 (and other structural channel systems in accordance with the invention) may not be immediately apparent. As described in previous paragraphs herein, the structural channel system 100 includes the threaded support rods 114, suspension brackets 110, and cross-channels 104. As will be explained in greater detail in subsequent paragraphs herein, the cross-channels 104 are supported through the suspension brackets 110 solely by threaded support rods 114. With reference to FIGS. 1 and 4, the threaded support rods 114 can each be characterized as forming a suspension point 170. That is, where each of the threaded support rods 114 is secured to a lower L-beam 154 or similar building structure position, the combination of the building structure position and the threaded support rod 114 may be characterized as a suspension point 170. Accordingly, the main structural channel rails 102, suspension points 170, suspension brackets 110 and cross-channels 104 may be characterized as forming a structural or mechanical network or “grid” 172. For purposes of designing the entirety of a structural channel system in accordance with the invention for any particular structure and set of applications, the structural grid 172 formed by the suspension points 170, suspension brackets 110, cross-channels 104 and main structural channels 102 may be characterized as a common “base” for building a particular implementation of a structural channel system in accordance with the invention. That is, a common configuration of the structural grid 172 can be designed and would not significantly change across various implementations of structural channel systems in accordance with the invention, except with respect to size. This concept of a common structural grid which may be utilized with a structural channel system having the capability of various configurations for power and communications distribution, for configuring and reconfiguring structural positioning of application devices (such as lights, fans and the like), and for configuration and reconfiguration of functional control relationships among devices (through programmability) provides a significant advantage to architects and designers. This principle should be kept in mind in reading the subsequent paragraphs herein describing the various components of the structural channel system 100.

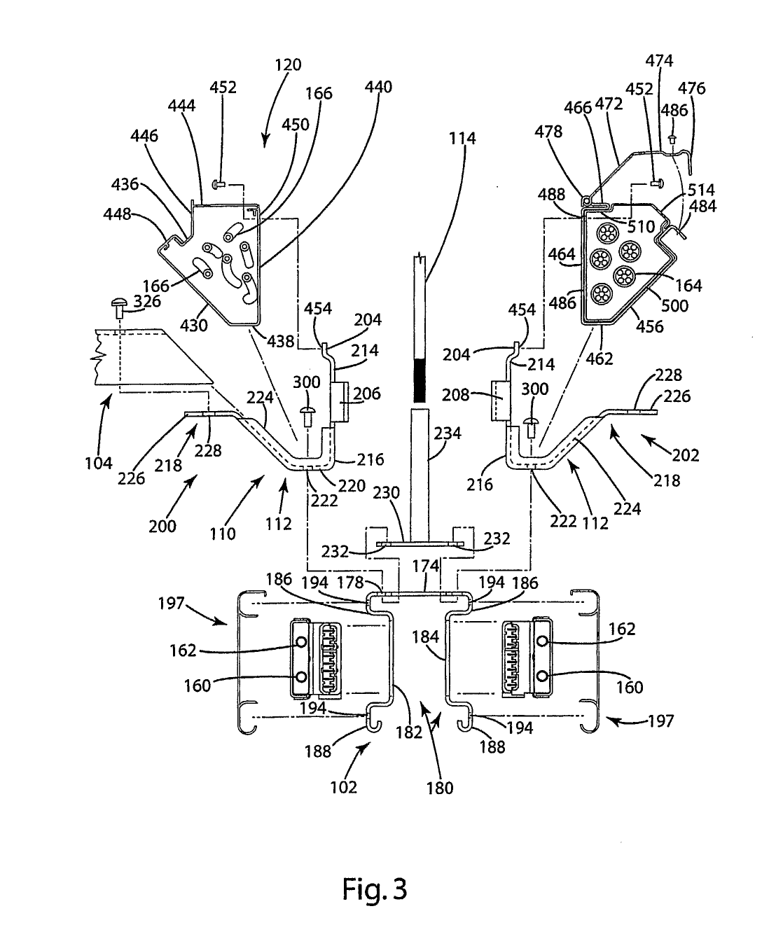

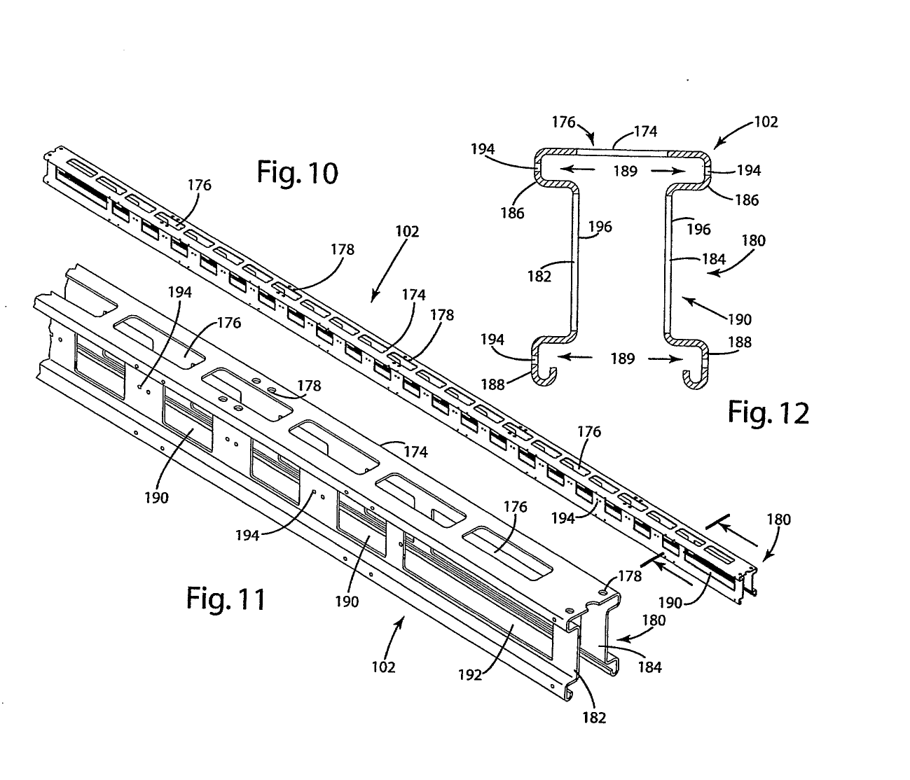

Turning more specifically to the details of the system 100, a main perforated structural channel rail 102 in accordance with the invention will now be described with respect to FIGS. 1, 2 and 5-12. Turning specifically to FIG. 2, which illustrates an assembled one of the main structural channel rails 102, each of the main structural channel rails 102 may be supported by associated threaded support rods 114. The support occurs at various suspension points 170, through associated suspension brackets 110. Each of the threaded support rods 114 may be in the form of a co-threaded rod. Only a lower end of the rod 114 is illustrated in FIGS. 2 and 3. As previously shown and described with respect to FIG. 1, each of the threaded support rods 114 may be secured at one end to one of the lower L-beams 154, through an aperture (not shown) extending through a flange of the L-beam 154. The co-threaded support rod 114 is threaded adjacent its upper end and is secured at a desired vertical disposition through its threading at both lower and upper ends. The co-threaded support rod 114 is threadably secured to one of the suspension brackets 110 at the lower end thereof. With the interconnections described herein, a main structural channel 102 may be secured to the lower L-beams 154 of the commercial interior 146 in a manner which provides for rigidity, yet also provides for adjustability with respect to vertical positioning relative to the L-beam 154. Also, in addition to the particular example of an overhead supporting arrangement as described herein, it is possible to interconnect the main structural channels 102 of the structural channel system 100 to other structure of the commercial interior 146, such as concrete structures above the channel system 100, and with connections other than support rods. For example, in place of the co-threaded support rod 114 and L-beam 154 configuration, the support rod 114 could be used with a threaded hanger or similar means, with the hanger threadably received at an upper end of the threaded rod 114. The hanger may then be hung on or otherwise releasably interconnected to other overhead supporting elements. In any event, it is advantageous to utilize a supporting arrangement which facilitates vertical adjustability of the interconnected main structural channel 102. As described in subsequent paragraphs herein, the lower end of the threaded support rod 114 illustrated in FIGS. 2 and 3 is threaded into and extends downwardly through a tube of the suspension bracket 110, also as shown in FIGS. 2 and 3.

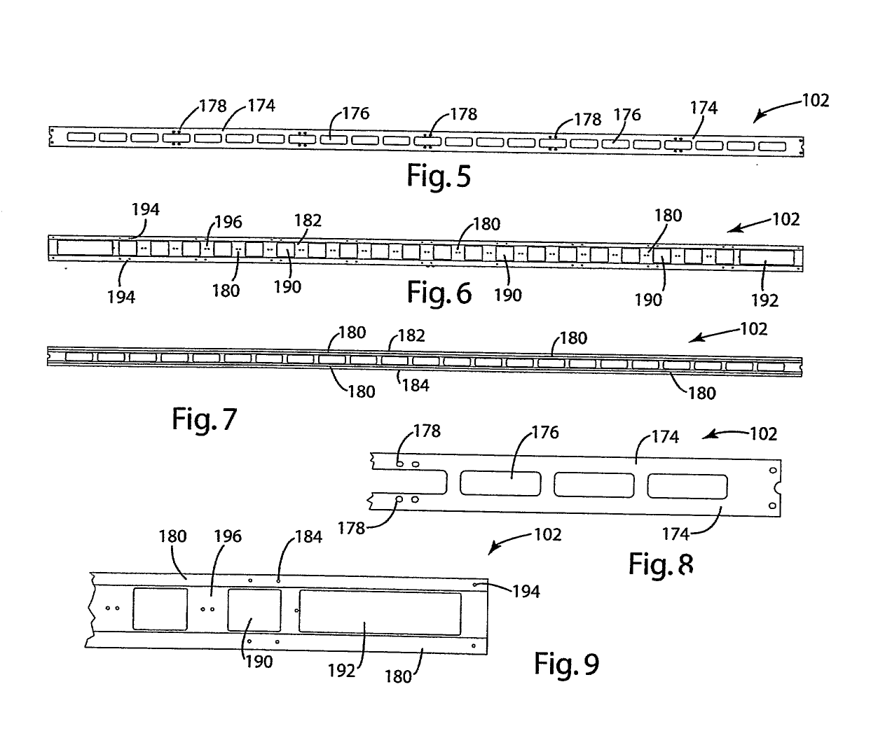

Each of the main structural channel rails 102 is of a unitary design. Turning primarily to FIGS. 5-12, the length of main perforated structural channel rail 102 shown therein includes a longitudinally extending upper portion 174 formed in a single plane, which would commonly be positioned in a horizontal configuration. Extending through the upper portion 174 are a series of spaced apart upper rectangular apertures 176. The apertures 176 can be characterized as surface perforations which are utilized to permit passage of cables above and below the ceiling plane formed by the structural channel rail 102. Also extending through the upper portion 174 at spaced apart positions are a series of predrilled mounting holes 178. As described in subsequent paragraphs herein, these predrilled mounting holes 178 will be utilized for purposes of providing interconnection to suspension brackets 110 at various locations along the length of the structural channel rail 102. For example, such mounting holes 178 (as shown in pairs in the drawings) could be spaced at 20-inch intervals.

Integral with the upper portion 174 and extending downwardly from opposing lateral sides thereof are a pair of side panels 180. As shown in the drawings, the side panels 180 comprise a left side panel 182 and a right side panel 184, with the left and right designations being arbitrary. As shown primarily, for example, in FIG. 12, each of the side panels 180 forms, at the upper portion thereof, an upper U-shaped section 186, with the base of each U-shaped section 186 being positioned outwardly. Extended downwardly from and integral with each of the upper U-shaped sections 186 is a recessed side portion 196. The recessed side portions 196 will have a vertical orientation when the main structural channel rail 102 is positioned within the structural channel system 100. At the lower ends of each of the recessed side portions 196, and preferably integral therewith, are lower hook-shaped sections 188. The hook-shaped sections 188 have a configuration as primarily shown in the sectional end view of FIG. 12. The hook-shaped sections 188 are utilized for various functions, including positioning of joiners for alignment of adjacent structural channel rails 102.

Extending through each of the recessed side portions 196, and positioned at spaced apart intervals therein, are perforations in the form of side plug assembly apertures 190. As will be described in subsequent paragraphs herein, the side plug assembly apertures 190 will be utilized to couple together the main structural channel rails 102 with the modular plug assemblies 130. As further shown in FIGS. 5-12, a series of predrilled through holes 194 extend through the side panels 180.

In addition to the foregoing elements, the main perforated structural channel rails 102 can also include covers, such as the covers 197 illustrated primarily in FIGS. 2 and 3. The covers 197 are utilized in pairs, so as to provide for aesthetics and general closure of the sides of the structural channel rails 102, when the sections 500 of the modular plug assembly 130 are secured within the structural channel rails 102. Each of the structural channel rails 102 includes an upper channel 199. Each of the upper channels 199 is shaped and has sufficient resiliency so as to be “snap fitted” around a corresponding one of the upper U-shaped sections 186 above the side panels 180. Correspondingly, the covers 197 also include lower channels 201, having the cross sectional configuration shown in FIG. 3. Like the upper channels 199, the lower channels 201 are shaped and have a resiliency so as to be “snap fitted” around corresponding lower hook-shaped sections 188 below the side panels 180. Alternatively, if desired, the covers 197 can be more rigidly secured to the upper U-shaped sections 186 and lower hook-shaped sections 188 through the use of connecting screws or the like received through the covers 197 and the main bodies of the structural channel rails 102. Again, the covers 197 are primarily designed for appearance. The upper channels 199 and channels 201 are integral with cover side panels 203 having a vertical disposition when secured to the structural channel rails 102.

One other concept should also be mentioned. Specifically, when connecting the individual sections of the covers 197 to the individual lengths of the main rails 102, the ends of the individual sections of the covers 197 may be “staggered” relative to the location of the ends of the individual lengths of the main rails 102. The staggering may assist in minimizing misalignments. In this regard, if such staggering results in sections of the main rails 102 which are partially uncovered, the covers 197 can be constructed of materials which would allow the individual sections of the covers 197 to be cut at the assembly site, so that partial cover lengths can be provided.

In brief summary, the main perforated structural channel rails 102 form primary components of the structural channel system 100. The structural channel rails 102 may be constructed and used in various lengths. For example, structural channel rails 102 may be formed in lengths of 60 inches or 120 inches. For purposes of providing appropriate support, suspension brackets 110 should be utilized to support the main structural channel rails 102 at designated intervals. The smaller the supporting intervals, the greater will be the load rating for the structural channel rails 102. For example, a specific load rating may be obtained with the main structural channel rails 102 supported by suspension brackets 110 at 60-inch intervals. Further, the main structural channel rails 102 may be constructed of various types of materials. For example, rails 102 may be formed as steel with a thickness of 0.105 inches, and may have a galvanized finish.

As earlier described, the structural channel system 100 also includes a series of suspension brackets 110. The suspension brackets 110 are a primary and important aspect of concepts associated with the invention. Specifically, each of the suspension brackets 110 is adapted to perform two functions. First, the suspension bracket 110 comprises means for providing mechanical support for the main perforated structural channel rails 102, through the threaded support rods 114. Also, each suspension bracket 110 is adapted to interconnect to one or a pair of cross-channels 104. The cross-channels 104 are relatively well known construction elements, commercially available in the industry. Of primary importance, however, is the means for supporting the cross-channels 104 through the suspension brackets 110. More specifically, the suspension brackets 110 comprise means for coupling the cross-channels 104 and supporting the same in a manner such that the weight of the coupled cross-channels 104 is carried only by the associated threaded support rod 114 and not by the main structural channel rail 102. This aspect of the structural channel system 100 in accordance with the invention is of importance with respect to governmental and institutional regulations regarding load-bearing structures carrying electrical and communications signals and equipment. As will be described in subsequent paragraphs herein, the main structural channel rails 102 carry modular plug assemblies 130 which, in turn, carry AC power, low voltage DC power (possibly) and communication signals. Because of the power carried by the main structural channel rails 102 through the modular plug assemblies 130, regulatory limitations exist with respect to mechanical loads supported by the main structural channel rails 102. With the configuration of each suspension bracket 110 as described in subsequent paragraphs herein, and although the cross-channels 104 act as crossing rails for the entirety of the structural channel system 100, and are “coupled” to the main structural channel rails 102, the weight of the cross-channels 104 (and any application devices supported therefrom) is carried solely by the threaded support rods 114 through the suspension brackets 110, rather than by the main structural channel rails 102 themselves.

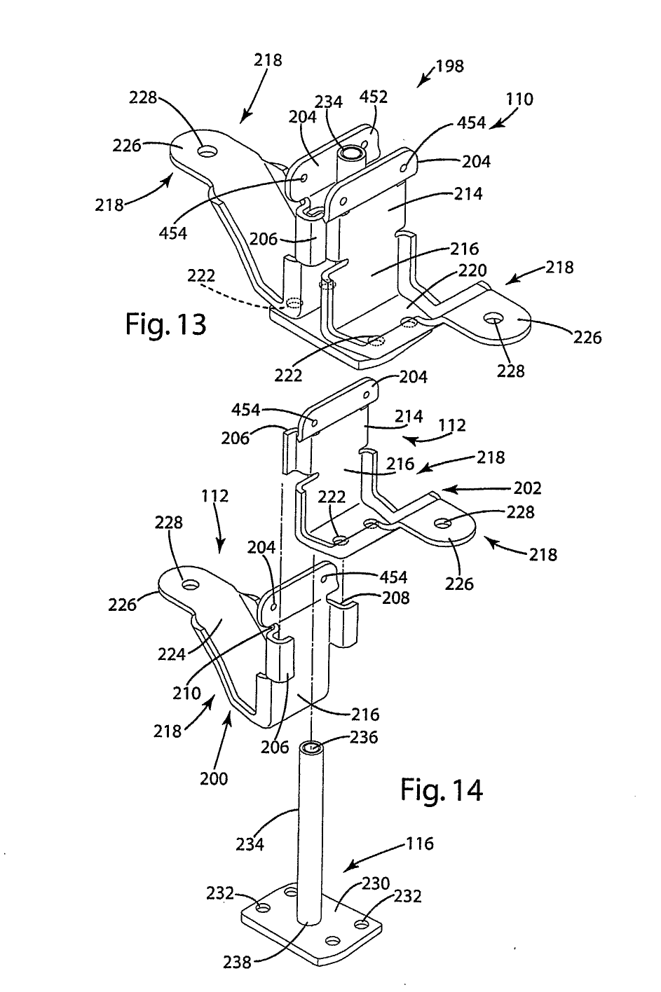

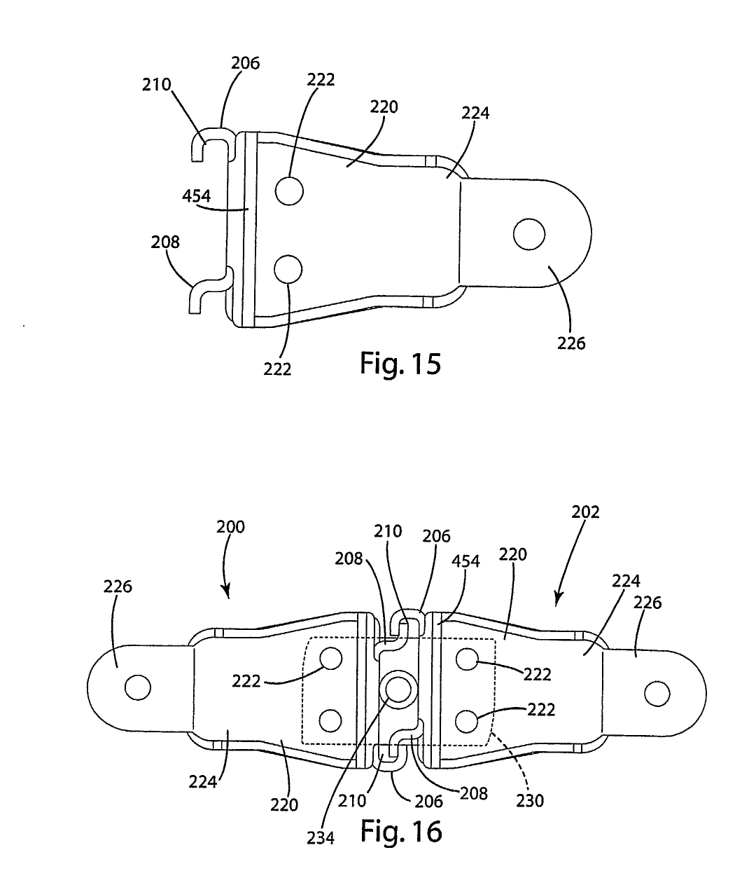

A suspension bracket 110 will now be described with respect to FIGS. 13-17. Turning first to FIGS. 13-16, the suspension bracket 110 includes a main rail hanger 198. The main rail hanger 198 comprises a pair of suspension bracket section halves 112. The section halves 112 include a first suspension bracket section half 200 and a second suspension bracket section half 202. Although numbered differently, it will be apparent from the description herein that the first section bracket section half 200 may be constructed identical to the second suspension bracket section half 202. With reference to each of the section bracket section halves 112, each half includes an upper flange 204 extending across the width of the section half 112. A pair of spaced apart, and preferably threaded, holes 454 extend through each of the upper flanges 204. The holes 454 will be utilized for purposes of mounting cableways 120 or wireways 122 as described in subsequent paragraphs herein.

Integral with each upper flange 204 is a central portion 214. On one side of each central portion 214, and preferably integrally formed therewith, is a U-shaped leg 206. The leg 206 has a configuration as primarily shown in FIGS. 14, 15 and 16. The U-shaped leg 206 forms an inwardly projecting “capturing” slot 210. Correspondingly, and extending outwardly from an opposing side of the central portion 214 (and preferably integral therewith) is an arcuate arm 208. The vertical cross section of the arm 208, as with the U-shaped leg 206, is primarily shown in FIGS. 14, 15 and 16. Extending downwardly from the central portion 214 and integral therewith for each section half 112, is a vertically disposed lower section 216. Extending outwardly from the lower edge (and preferably integral therewith) of the lower section 216 for each section half 112 is a cross channel bracket 218. The cross channel bracket 218 includes a horizontally disposed base 220 which is preferably integral with the lower edge of the lower section 216 of the section half 112. A pair of screw holes 222 are spaced apart and extend through the horizontally disposed base 220 of each section half 112. The screw holes 222 will be utilized to receive screws for purposes of securing that particular section half 112 to the corresponding main structural channel rail 102. Extending laterally outwardly and angled upwardly from the horizontally disposed base 220 is a lateral angled portion 224. The angled portion 224 is upwardly angled and preferably integral with the horizontally disposed base 220. Integral with the terminal end of each lateral angled portion 224 is a horizontally disposed foot 226. The foot 226 has the size and configuration as primarily shown in FIGS. 13 and 14. A through hole 228 extends downwardly through each foot 226. As described in subsequent paragraphs herein, each foot 226 will be utilized to interconnect the suspension bracket 110 to a cross channel 104.

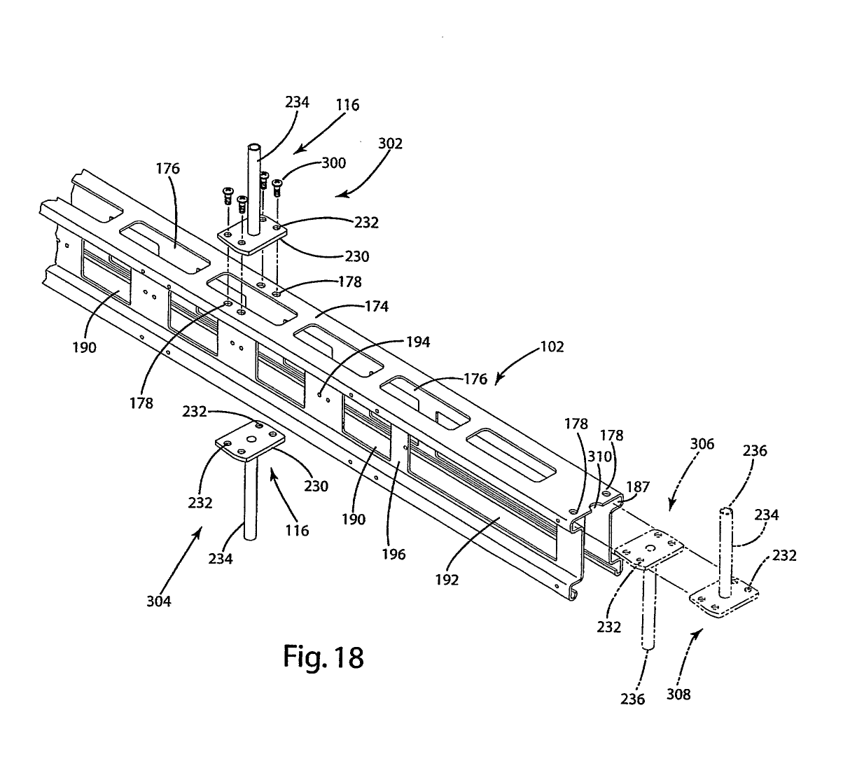

The suspension bracket 110 further includes a universal suspension plate assembly 116, as primarily illustrated in FIG. 14. The universal suspension plate assembly 116 can also be used separate and apart from the suspension bracket 110, as will be described in subsequent paragraphs herein with respect to FIG. 18. More specifically, the universal suspension plate assembly 116 includes a suspension plate 230 having a substantially rectangular configuration as shown in FIGS. 14 and 16. When used with the entirety of the suspension bracket 110, the suspension plate 230 will be in a horizontally disposed configuration. Extending downwardly through the suspension plate 230 are a set of four spaced apart threaded holes 232. The threaded holes 232 will be utilized to receive screws which will also pass through the through holes 222, for purposes of securing the suspension bracket 110 to the main structural channel rail 102. The universal suspension plate assembly 116 further includes a vertically disposed and upwardly extending tube 234. The tube 234 preferably includes a series of internal threads extending downwardly for at least a partial length of the tube 234 from the upper end 236 of the tube 234. The threaded tube 234 also includes a lower end 238, which is preferably welded or otherwise secured to an upper surface of the suspension plate 230.

The assembly of the suspension bracket 110 will now be described, both with respect to the assembly of its individual components and with respect to assembly to a main structural channel rail 102. The first suspension bracket section half 200 and the second suspension bracket section half 202 of the suspension bracket section halves 112 can first be brought together in a manner as shown in FIGS. 13 and 16. With reference specifically to FIG. 16, it is noted that the U-shaped leg 206 of the first suspension bracket section half 200 captures the arcuate arm 208 of the second suspension bracket section half 202 within the capturing slot 210 of the U-shaped leg 206. Correspondingly, the U-shaped leg 206 of the second suspension bracket section half 202 captures the arcuate arm 208 of the first suspension bracket section half 200 within the capturing slot 210 of the leg 206 of the second suspension bracket section half 202. In this manner, the section halves 200, 202 are essentially “locked” together, with respect to any laterally directed forces attempting to separate the section halves. The universal suspension plate assembly 116 is then brought into proximity with the main rail hanger 198, such that the threaded tube 234 extends upwardly between the opposing section halves 200, 202. This configuration is primarily shown in FIGS. 13 and 16. With this configuration, the suspension plate 230 will then be positioned immediately beneath the horizontally disposed bases 220 of each of the section halves 200, 202. As previously mentioned, screws (not shown in FIGS. 13 or 16, but illustrated as screws 300 in FIG. 2) can be inserted through the two pairs of screw holes 222 in the horizontally disposed bases 220, and further through the threaded holes 232 of the suspension plate 230. This configuration, with the screws 300 extending through the bases 220 and the suspension plate 230, is shown in FIG. 2. Also, it should be understood that the threaded tube 234 is utilized, when the universal suspension plate assembly 116 is used with the suspension bracket 110, to threadably receive one of the threaded support rods 114, for purposes of securing the suspension bracket 110 to the building structure.

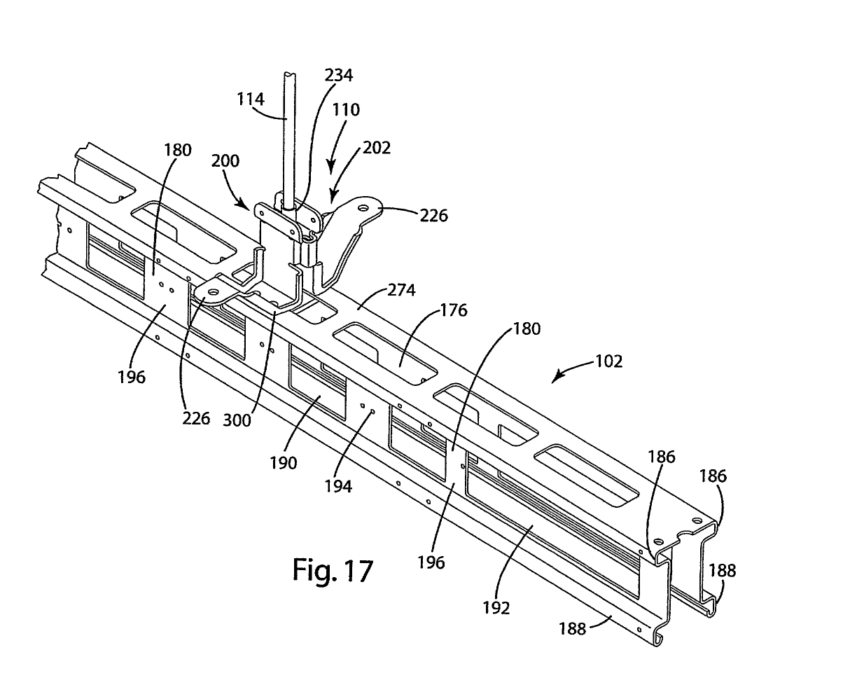

For purposes of fully assembling the suspension bracket 110 to a main structural channel rail 102, and with reference to FIGS. 2, 3, 12, 14 and 17, the universal suspension plate assembly 116, with the threaded tube 234 connected thereto, can be inserted within one of the upper rectangular apertures 176, so as to be configured as shown in FIG. 17. Connecting screws 300 (shown in FIG. 2) can then be inserted through the pairs of screw holes 222 located in the horizontally disposed bases 220 of each of the section halves 200, 202. The screws 300 can be inserted through the screw holes 222, through the predrilled mounting holes 178 within the upper portion 174 of the structural channel rail 102, and further through the threaded holes 232 within the suspension plate 230. With this configuration, the universal suspension plate assembly 116 and suspension bracket section halves 200, 202 can be secured to a length of the main structural channel rails 102. As further shown in FIG. 17, one of the threaded support rods 114 (shown in partial length in FIG. 17) can be threadably received, at its lower end, within the upper end 236 of the threaded tube 234. As previously described, the threaded support rod 114 will be connected at its upper end to part of the building structure, such as the lower L-beam 154 as illustrated in FIG. 1.

As described in foregoing paragraphs, the suspension bracket 110 in accordance with the invention utilizes a universal suspension plate assembly 116. As also previously described herein, the universal suspension plate assembly 116 includes a suspension plate 230, threaded holes 232 and threaded tube 234. The threaded tube 234 includes a threaded upper end 236 and a lower end 238, with the lower end 238 being welded or otherwise secured to a surface of the suspension plate 230. In accordance with the invention, the universal suspension plate assembly 116 is adapted not only to be utilized with the suspension bracket section halves 200, 202, but also in other configurations for supporting the main structural channel rail 102 and for supporting various other components of the structural channel system 100 and application devices which may be interconnected thereto.

With respect to describing concepts associated with the suspension bracket 110 and its capability of interconnection to the structural channel rails 102 and cross channels 104, the rails 102 can be described as comprising first structural components. Correspondingly, for purposes of describing the invention associated with the suspension bracket 110, the cross channels 104 can be characterized as a second set of structural components.

Certain of the various connection configurations between the universal suspension plate assembly 116 and a length of the main structural channel rail 102 are illustrated in FIG. 18. As shown therein, the universal suspension plate assembly 116 can be used in various configurations, in interconnections to main structural channel rail 102. FIG. 18 illustrates four example configurations, identified as a first configuration 302, second configuration 304, third configuration 306 and fourth configuration 308. With reference to the first configuration 302, configuration 302 illustrates a universal suspension plate assembly 116 positioned so that the suspension plate 230 is mounted to an upper surface of the upper portion 174 of the structural channel rail 102. In this configuration, threaded screws 300 extend downwardly through the threaded holes 232 of the suspension plate 230 and the predrilled mounting holes 178 and the upper portion 174. The threaded tube 234 extends upwardly above the structural channel rail 102. In the second configuration 304, the suspension plate 230 is received within the upper grid 187 of the structural channel rail 102, formed below the upper portion 174. In this configuration, connecting screws would first be received through the predrilled mounting holes 178 and then, therebelow, the threaded holes 232 and the suspension plate 230.

In a third configuration 306, the suspension plate 230 is again positioned within the upper grid 187, but at the end of a length of structural channel rail 102. Two of the threaded holes 232 and the suspension plate 230 are aligned with the two predrilled mounting holes 178 at the end of the rail 102. Although not expressly shown in FIG. 18, the other two threaded holes 232 of the suspension plate 230 can be coupled through connecting screws received through predrilled mounting holes (not shown) within another length of the structural channel rail 102 (not shown). Also in this configuration, the threaded tube 234 is extended downwardly, so that the upper end 236 is actually positioned at the lower-most position of the suspension plate assembly 116. A still further fourth configuration 308 can be utilized at an end of the structural channel rail 102. In this configuration, the suspension plate assembly 116 for the fourth configuration 308 is positioned in a directionally opposing configuration relative to the third configuration 306. Again, the suspension plate 230 is received within the upper grid 187. However, the threaded tube 234 is extended upwardly, so that the upper end 236 is at the uppermost plane of the suspension plate assembly 116. Also with the fourth configuration 308, two of the threaded holes 232 are aligned with the two holes 178 at the end of the structural channel length 102, for purposes of securing the suspension plate 230 to the one length of the structural channel rail 102. Connecting screws (not shown) are received within the other pair of threaded holes 232 of the suspension plate 230, with the holes 232 being aligned with predrilled mounting holes (not shown) in an adjacent length of the main structural channel rail 102. For purposes of securing the structural channel rail 102 lengths to be coupled together so that their ends are in close proximity, a slot 310 is formed at the end of the length of main structural channel rail 102 shown in FIG. 18. A corresponding slot (not shown) would exist within the end of an adjacent length of the main structural channel rail 102 (not shown). In this manner, the universal suspension plate assembly 116 for the fourth configuration 308, like the third configuration 306, would be secured to adjacent lengths of the main structural channel rail 102.

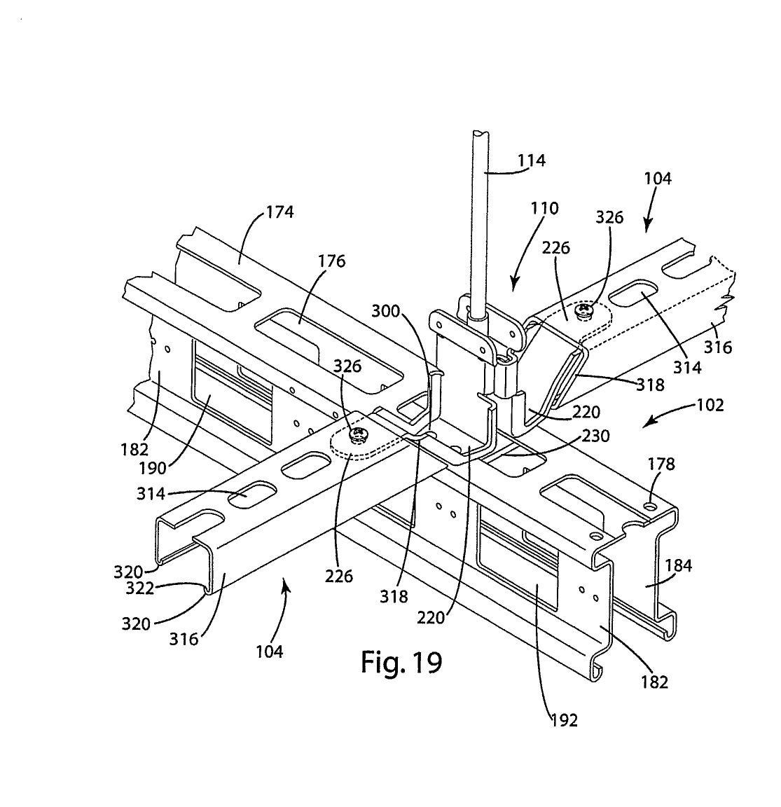

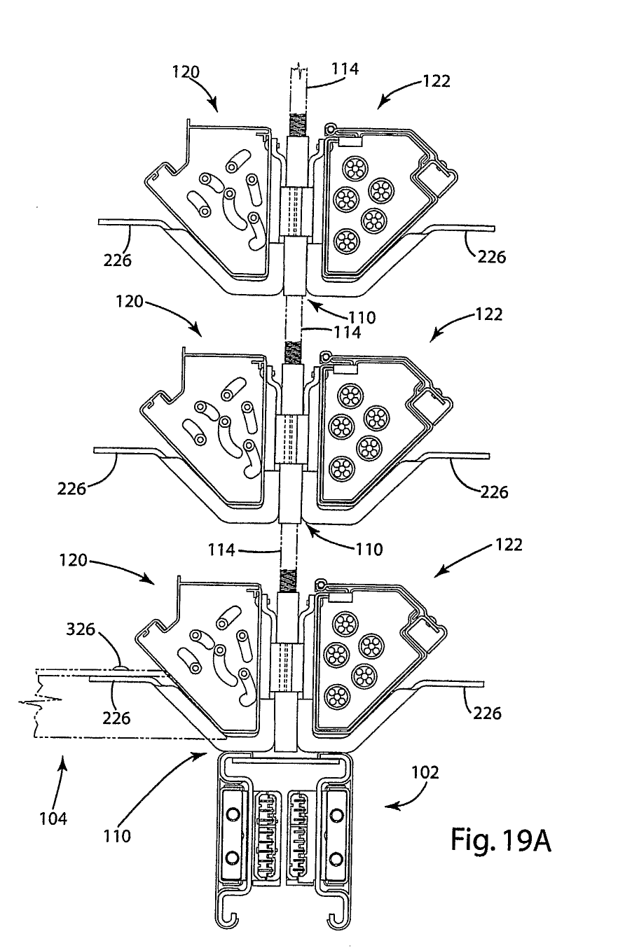

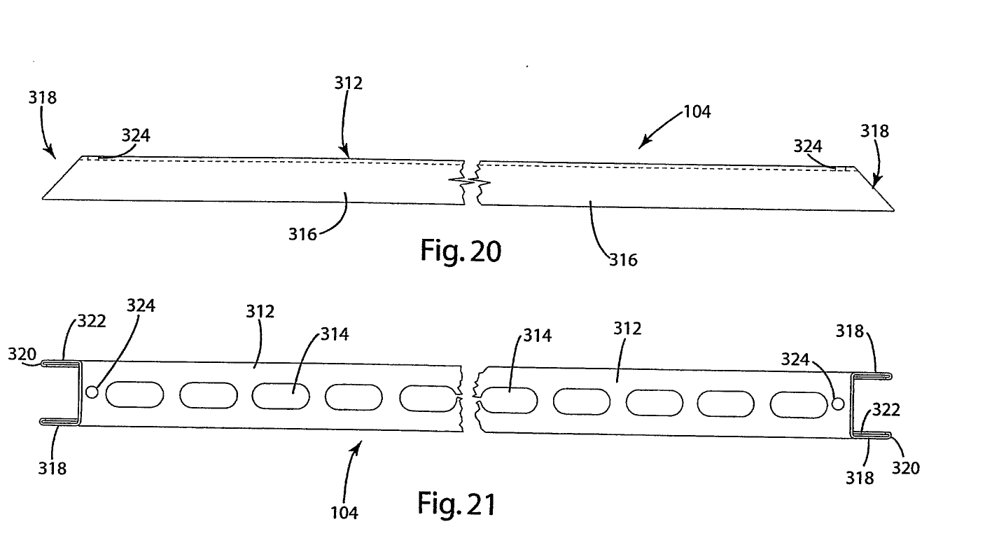

As earlier described herein, the structural channel system 100 in accordance with the invention includes a series of cross-channels 104, which form in part the structural network grid 172. The cross-channels 104, including their interconnection to the commercial interior and building structure through the suspension brackets 110, will now be described with respect to FIGS. 19, 20, 21 and 22. The cross-channels 104 (originally shown in FIG. 1) provide cross bracing for the mechanical structure of the structural channel system 100 and form part of the structural grid 172. FIG. 19 illustrates a pair of the cross-channels 104, with the channels 104 being in a coaxial alignment and both coupled to a common suspension bracket 110. FIGS. 20 and 21 illustrate side elevation and plan views, respectively, of one of the cross-channels 104. Turning specifically to FIG. 19, the drawing illustrates one of the suspension brackets 110 previously described herein, coupled to one of the threaded support rods 114. Horizontally disposed bases 220 of the suspension bracket 110 are connected through screws 300 or similarly connecting means to a suspension plate 230 and to the main structural channel rail 102 as previously described herein. FIG. 19 further illustrates one cross channel 104 connected to the suspension bracket 110 and extending perpendicular to the main structural channel 102. A second cross channel 104 is also illustrated in FIG. 19, extending perpendicular to the main structural channel 102 in an opposing direction to the first cross channel 104. Referring now primarily to FIGS. 20 and 21, each cross channel 104 includes an upper flange 312. A series of oval or elliptical apertures 314 extend through the surface of the upper flange 312. Integral with the upper flange 312 are a pair of opposing sides 316. At the end of each of the cross-channels 104, the sides 316 terminate in tapered or angled ends 318, as primarily shown in FIG. 20. At the lower portion of each tapered end 318, the sides 316 turn upwardly in curls 320. The curled portions of the sides 316 thereby form small troughs 322. Each of the cross-channels 104 may also include threaded or unthreaded holes 324 extending through the upper flange 312 adjacent the opposing tapered ends 318. Referring back to FIG. 19, and for purposes of connection of the cross-channels 104 to the suspension bracket 110, screws 362 may be threadably received within the threaded holes 324 of the cross-channels 104, and then also through apertures or through holes 228 of the horizontally disposed feet 226 of the suspension bracket 110. In this manner, each of the cross-channels 104 as illustrated in FIG. 19 is rigidly secured to the suspension bracket 110.

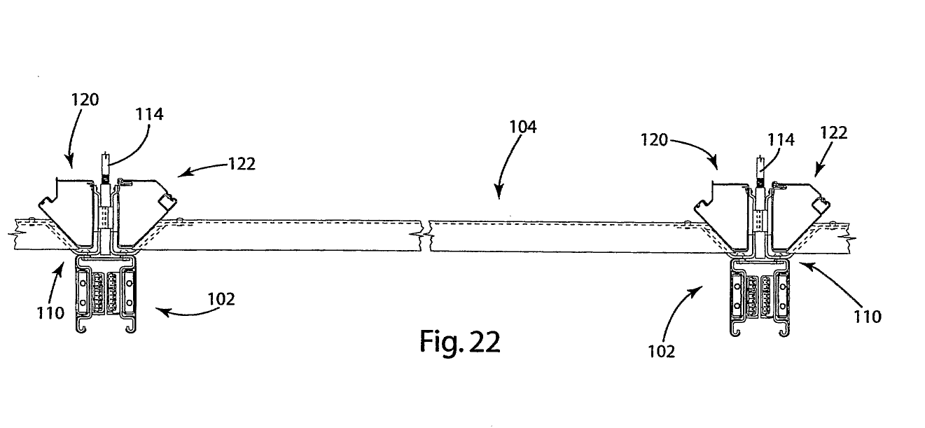

One concept which is patentably important in the aforedescribed connections of the cross-channels 104 to the suspension bracket 110 should again be noted. Specifically, with the cross-channels 104 secured to the horizontally disposed feet 226, the entirety of the mechanical load of the cross-channels 104 is carried by the associated threaded support rod 114 through the suspension bracket 110. Accordingly, the support of the cross-channels 104 as shown in FIG. 19 does not subject the associated main structural channel rail 102 to any additional mechanical load. This is of particularly importance in that, as described in subsequent paragraphs herein, the main structural channel rail 102 will be carrying AC power, communication signals and possibly DC power. Governmental and institutional regulations may not permit electrical load-carrying elements, such as the structural channel rail 102, to correspondingly support any substantial weight-bearing elements. It is the configuration of the suspension bracket 110, and the cooperative interconnection of the bracket 110 with the cross-channels 104 which provide this feature of permitting cross bracing (with the cross-channels 104), without subjecting the main structural rails 102 to significant mechanical loads. As earlier stated, the cross-channels 104 can be connected so as to extend perpendicularly from a length of the main structural channel rail 102. In this regard, any given cross channel 104 may be interconnected to suspension brackets 110 associated with a pair of adjacent main structural rails 102. Such a configuration is illustrated in FIG. 22. The coupling of the cross channel 104 illustrated in FIG. 22 between the spaced apart main structural channel rails 102 is accomplished by direct coupling of the cross channel 104 to suspension brackets 110 associated with each of the spaced apart main structural channel rails 102. That is, the interconnections will be in the same manner as illustrated in FIG. 19 and previously described herein. Again, it should be emphasized that advantageously, and in accordance with the invention, the cross channel 104 intermediate the two main structural channel rails 102 illustrated in FIG. 22 does not subject either of the main structural channel rails 102 to mechanical loads. Instead, the weight of the cross channel 104 is supported by the threaded support rods 114 partially shown in FIG. 22, through the suspension brackets 110.

Another primary aspect of the structural interconnections among the main structural channel rails 102, cross-channels 104 and suspension brackets 110 should also be emphasized. As previously described herein, and as particularly illustrated in FIG. 16, the first suspension bracket section half 200 is coupled to the second suspension bracket section half 202 through the releasable interconnection of the U-shaped legs 206 and arcuate arms 208 associated with each of the section halves 200, 202. With this type of coupling configuration, any mechanical loads which would be placed downwardly on the horizontally disposed feet 226, or otherwise be exerted on the suspension bracket section halves 200, 202 in a downward or laterally outward direction, will actually cause the section halves 200, 202 to exert opposing forces on each other, at least partially through the coupling of the U-shaped legs 206 and arcuate arms 208. That is, for example, reference can be made to the view of the suspension bracket section halves 200, 202 in FIG. 16. If downwardly or outwardly directed forces are exerted on the horizontally disposed foot 226 of the first suspension bracket section half 200, the section half 200 will exert, through the coupling of its arcuate arm 208 with the U-shaped leg 206 of the section half 202, and the coupling of the U-shaped leg 206 of the section half 200 with the arcuate arm 208 of the section half 202, forces which will be “pulling” the section half 202 to the left as viewed in FIG. 16. Correspondingly, if downwardly or outwardly directed forces are exerted on the horizontally disposed foot 226 of the suspension bracket section half 202, forces would be exerted on the suspension bracket section half 200, again through the U-shaped legs 206 and arcuate arms 208 of the section halves 200, 202, which would correspond to “pulling” forces on the section half 200 to the right as viewed in FIG. 16. Accordingly, and advantageously in accordance with the invention, loads exerted on the section halves 200, 202 of the suspension bracket 110, either directly or through loads associated with cross-channels 104 and application devices supported therefrom, will act so as to “increase” the “coupling forces” between the two section halves 200, 202. This is particularly advantageous if substantial loads are exerted on the feet 226 of the suspension bracket 110.

The cross-channels 104 can take the form of any of a number of well known and commercially available structural building and framing components. For example, one product which may be utilized for the cross-channels 104 is marketed under the trademark UNISTRUT®, and is manufactured by Unistrut Corporation of Wayne, Mich. Whatever components are utilized for the cross-channels 104, they must meet certain governmental and institutional regulations regarding structural bracing parameters.

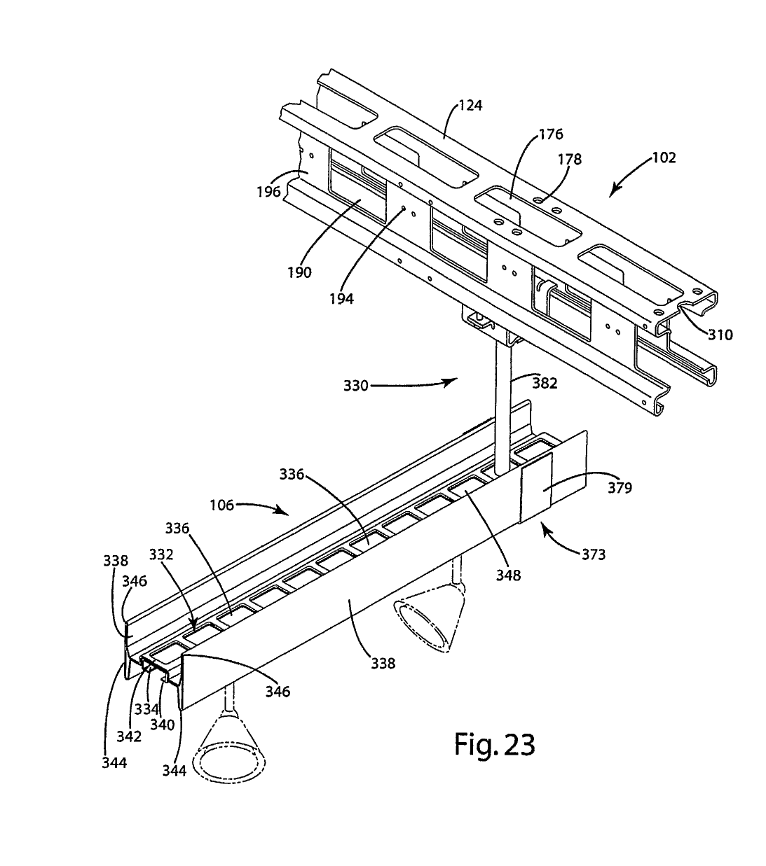

In addition to the main structural channel rails 102 and the cross-channels 104, the structural channel system 100 in accordance with the invention includes other structural members, for facilitating interconnection of devices or other types of “applications” to the structural channel system 100. These devices and applications include lights, projection screens, cameras, acoustical speakers and the like. These additional structural members include components which are referred to herein as cross-rails 106. A cross rail 106 is depicted in FIG. 1 and a more detailed illustration of the cross rail 106 is shown in FIG. 23. FIG. 23 illustrates part of a length of main structural channel rail 102, with a cross rail 106 connected below the rail 102 through a cross rail connector assembly 330. FIG. 23 further illustrates the cross rail 106 as supporting a track lighting assembly 328 coupled thereto. The cross rail 106 and associated track lighting assembly 328 are illustrated in FIG. 23 as being supported by a length of the main structural channel rail 102 through the cross rail connector assembly 330. The cross rail 106 can be any of a number of desired lengths. Preferably, the cross rail lengths should be such that they will uniformly attach to adjacent and spaced apart main structural channel rails 102. For example, lengths of 10 feet and 12 feet may be utilized for the cross-rails 106. The cross-rails 106 may be manufactured in the form of aluminum extrusions. However, other materials or methods may be utilized, such as steel roll-formed sections.

In the particular embodiment of a cross rail 106 in accordance with the invention as illustrated herein, the cross rail 106 includes an upper or top half 332. This upper or top half 332 includes a center ledge 334 extending longitudinally along the length of the top half 332. Apertures 336 are formed at spaced apart intervals along the length of the center ledge 334, and have a substantially a rectangular configuration as illustrated in FIG. 23. The top half 332 also includes a pair of opposing and upstanding sides 338, integral with the center ledge 334. Still further, the cross rail 106 includes a lower half 340. As with the top half 332, the lower half 340 also includes a center ledge 342, which is in registry with the center ledge 334 when the top half 332 and lower half 340 are coupled together. Extending upwardly and downwardly from the center ledge 342, and integral therewith, are a pair of opposing and curled sides 344. These curled sides 344 first extend downwardly and then curl back and extend upwardly so as to form the outermost exterior sides of the cross-rails 106. At the top of the curled sides 344, lips 346 are formed, which extend along the longitudinal length of the cross-rails 106. Also, as with the top half 332, the lower half 340 also includes a series of apertures 348 formed at spaced apart intervals. The apertures 348 of the lower half 340 are formed so as to be concentric with the apertures 336 of the top half 332. The top half 332 can be connected to the lower half 340 through weldments of adjacent sides 338 and 344, or otherwise through screws or other connecting means extending through the sides 338, 344. Further, a conventional rail (not shown) of the associated track lighting assembly 238 can be secured to the cross rail 106.

The cross-rails 106 can be interconnected and supported by other elements of the structural channel system 100, and by various means. The particular means which a user may choose for supporting the cross rail 106 may depend upon governmental and institutional regulations affecting that particular installation of the structural channel system 100, or otherwise a particular structural design desired by the user, or still further based on the weight and configuration of device or application loads to be attached to the cross-rails 106. In FIG. 23, the cross rail 106 is being supported directly by a length of a main structural channel rail 102, through a cross rail connector assembly 330. Accordingly, the length of main structural channel rail 102 is subjected to the mechanical load of the cross rail 106, and devices or applications connected thereto.

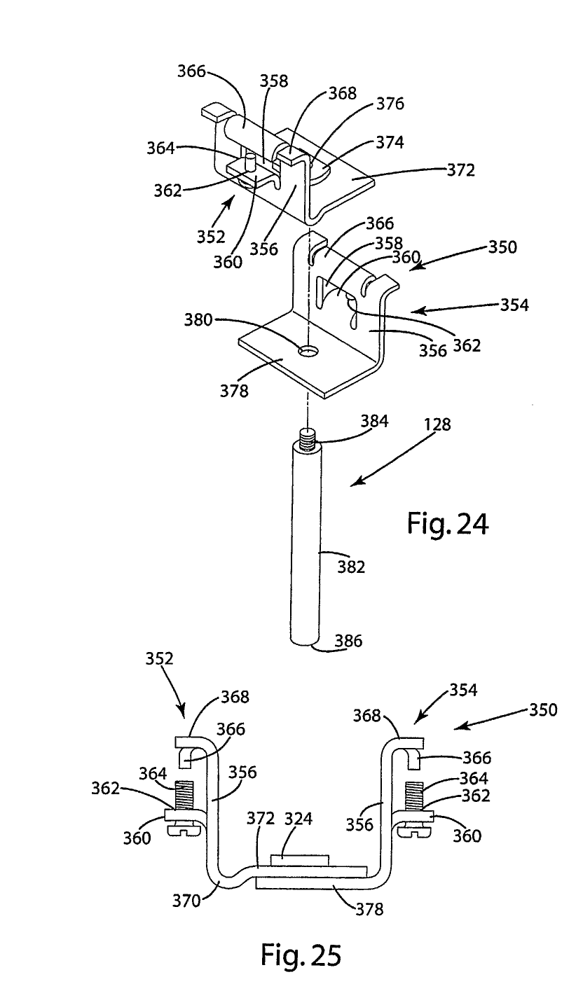

Turning primarily to FIGS. 24, 25 and 26, the cross rail connector assembly 330 consists of two major components. The first component is primarily shown in FIGS. 24 and 25, and can be characterized as a universal structural channel attachment assembly 350. The universal attachment assembly 350 includes what is characterized herein as a left side bracket 352 and a right side bracket 354. It should be noted that references to left side and right side are completely arbitrary, and are used for descriptive purposes only. Referring to the left side bracket 352, the bracket includes an upwardly extending side portion 356, as primarily shown in FIGS. 24 and 25. Located in the central area of the upwardly extending side portions 356 is a cutout portion 358. The cutout portion 358 can have a square or rectangular configuration. Integral with the side portion 356 and extending outwardly from the lower edge of the cutout portion 358 is an outwardly extending lip 360. The lip 360 has a configuration again as primarily shown in FIGS. 24 and 25. The lip 360 curves outwardly so as to be substantially horizontal, and a threaded hole 362 extends through the horizontal portion of the lip 360. A threaded screw 364 is adapted to be received within the threaded hole 362 of the lip 360.

At the top, central portion of the upwardly extending side portion 356 is an upper curled section 366. The curled section 366 extends upwardly and then curls back on itself, as primarily shown in FIG. 25. At the upper and opposing sides of the upwardly extending side portion 356 are a pair of outer arcuate fingers 368. The upper curled section 366 and outer arcuate fingers 368 are utilized to assist in securing the universal structural channel attachment assembly 350 to a length of main structural channel 102 as described in subsequent paragraphs herein.

As shown in both FIGS. 24 and 25, a curve exists at the lower edge of the upwardly extending side portion 356 of the left side bracket 352. This curve integrally couples together the upwardly extending side portion 356 with a horizontally disposed bracket 372. Positioned on the upper surface of the bracket 372 is a lug 374. A threaded aperture 376 extends through the lug 374 and the horizontal bracket 372.

Turning to the right side bracket 354, a number of the elements of the right side bracket 354 correspond in structure, function and configuration to elements of the left side bracket 352. Accordingly, such elements are like numbered. More specifically, the right side bracket 354, as with the left side bracket 352, includes an upwardly extending side portion 356. A cutout portion 358 is located in the central area of the upwardly extending side portion 356. An outwardly extending lip 360 extends outwardly from the lower edge of the cutout portion 358. A horizontal area of the outwardly extending lip 360 includes a threaded hole 362. A screw 364 is adapted to be received within the hole 262. Still further, and as with the left side bracket 352, the right side bracket 354 includes an upper curled section 366, which curls outwardly relative to the side portion 356. A pair of outer arcuate fingers 368 extend outwardly from the upper area of the upwardly extending side portion 356. However, unlike the left side bracket 352, the right side bracket 354 does not include any curved lower edge at the lower portion of the upwardly extending side portion 356. Instead, an integrally formed horizontal bracket 378 extends directly horizontally from the upwardly extending side portion 356 of the right side bracket 354. A through hole 380 extends through the horizontal bracket 378. For purposes of assembly, the left side bracket 352 is positioned relative to the right side bracket 354, so that the horizontal bracket 372 of the left side bracket 352 is directly above the horizontal bracket 378 of the right side bracket 354. The brackets 352, 354 are further aligned so that the through hole 380 is in a coaxial configuration relative to the threaded aperture 376 extending through the horizontal bracket 372 and lug 374.

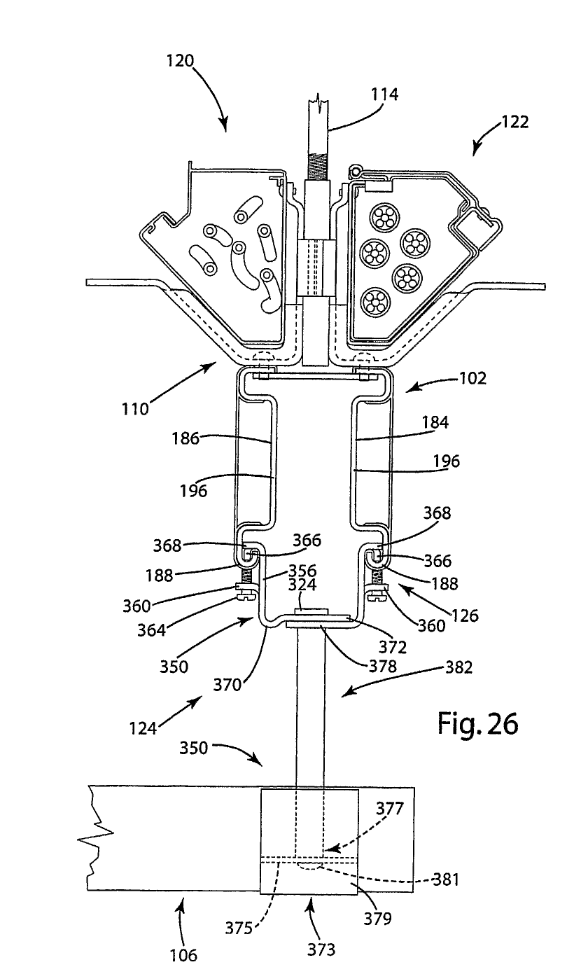

For purposes of interconnection of the universal structural channel attachment assembly 350 to other components of the structural channel system 100, the attachment assembly 350 further includes a suspension rod 382 as illustrated in FIGS. 24 and 26. The suspension rod 382 is not shown in FIG. 25. The suspension rod 382 has an elongated configuration, with a threaded upper end 384 as illustrated in FIG. 24. The lower end 386 of the suspension rod 382 may be threaded or unthreaded, depending upon the particular usage for the attachment assembly 350. The threaded upper end 384 of the suspension rod 382 may be received through the through hole 380 of the horizontal bracket 378, and then threadably received through the threaded aperture 376 extending through the horizontal bracket 372 and lug 374.

The interconnection of the universal structural channel attachment assembly 350 to a length of the main structural channel rail 102 is illustrated in FIG. 26. As shown therein, the screws 364 located within the threaded holes 362 would be “loosened,” and the outer arcuate fingers 368 would be positioned within the lower groove 189 formed by the lower hook-shaped sections 188 of the main structural channel rail 102. The left side bracket 352 would be positioned so that its upper curled section 366 would be located within the lower hook-shaped section 188 of one of the recessed side portions 196. Correspondingly, the upper curled section 366 of the right side bracket 354 would be positioned in the opposing lower hook-shaped section 188 of the right side panel 184. The screws 364 can then be tightened so as to abut against the outer surface of the lower hook-shaped sections 188, or the lower hook-shaped sections of the side covers for the main structural channel rails 102 (as described in subsequent paragraphs herein). The suspension rod 382 can then be received through the through hole 380 and threadably received through the threaded apertures in the horizontal bracket 372 and lug 374. In this manner, the universal structural channel attachment assembly 350 can be secured to a length of the main structural channel 102.

For purposes of connecting the universal structural channel attachment assembly 350 to the cross rail 106, a further element, identified as a cross rail tray 373, is utilized. Perspective and end views of a cross rail tray 373 are illustrated in FIGS. 23 and 26, respectively. With reference thereto, the cross rail tray 373 includes a base portion 375. A through hole 377 extends through the center area of the base portion 375. Integral with the base portion 375 are a pair of opposing sides 379. The sides 379 extend upwardly on the outside of the cross rail 106, so as to form two exterior sides relative to the cross rail 106. Threaded holes (not shown) may be formed in the sides 379 of the tray 377. To support the cross rail 106 with the attachment assembly 350, cross rail tray 373 can be positioned in a desired location on the cross rail 106. Such a configuration is primarily illustrated in FIGS. 23 and 26. In this configuration, the sides 379 of the tray 373 are positioned outside of the sides of the cross rail 106. The tray 373 is further positioned so that the base portion 375 is located underneath one of the apertures 348 of the cross rail 106. If desired, the cross rail 106 can be angled relative to the main structural channel rail 102. That is, the cross rail 106 is not required to be positioned so that its longitudinal length is perpendicular to the longitudinal length of the interconnected rail 102. When the cross rail 106 is positioned as desired, the bottom portion of the suspension rod 382 can be extended through the through hole 377 in the base 375. The suspension rod 382 can then be secured to the tray 373 by threadably inserting an end cap 381 into the hole 377 and the lower end 386 of the suspension rod 382 from below the base 375. In this manner, the tray 373 is interconnected to the cross rail 106, and the attachment assembly 350 is rotatably coupled to the tray 373. If desired, screws or similar connecting means can be inserted through through holes (not shown) and into the sides 338 of the cross rail 106. It should also be noted that the tray 373 may be positioned substantially anywhere along the cross rail 106. For example, threaded rods may be utilized to support a tray 373 by anchoring the threaded rods at their upper ends to part of the building structure.

As illustrated in FIG. 23, the cross rail 106 can support a track lighting assembly 383. Although the cross rail 106 does not have any power or communication cables, or otherwise carries electrical power signals, cables or conduit carrying electrical power can be run from the structural channel rail 102 to devices or other applications coupled to the cross rail 106. In the situation shown in FIG. 23, a conventional track lighting assembly 383 can be coupled below a cross rail 106. Cables or conduits for the track lighting assembly 383 can be run along the bottom portion of the cross rail 106. Further, various other application devices may be interconnected to the cross rail 106, and receive power from structures associated with the main structural channel rail 102.

The hanger assemblies previously described herein can be characterized primarily as “non-breakaway” hanger assemblies. That is, if any substantial weight is applied to a connected cross rail 106 (such as by a person at ground level attempting to “hang” from a cross rail 106), the hanger assemblies are configured so as to vigorously resist the cross rail 106 from breaking away from the connection to the main rail 102. In certain instances, however, it is preferable for elements hung from the structural channel system 100 to be supported in a manner so as to readily “break away” from their supporting structures, when forces at or above a designated minimum threshold are exerted on the supported elements. This may be required under certain governmental and institutional electrical and mechanical codes and regulations. Accordingly, the structural channel system may include supporting elements having a “breakaway” feature.

Such a breakaway feature and breakaway hanger assembly which may be utilized with a structural channel system 100 in accordance with the invention is disclosed in the U.S. Provisional Patent Application entitled “POWER AND COMMUNICATIONS DISTRIBUTION SYSTEM USING SPLIT BUS RAIL STRUCTURE” filed Jul. 30, 2004, and incorporated by reference herein. Such a breakaway hanger assembly can be utilized to support relatively light weight elements, such as banners, signs or the like. The concept of utilizing a breakaway hanger assembly is to ensure that if substantial forces are exerted on the hanging sign or banner, for example, the breakaway feature of the hanger assembly will ensure that the main structural channel rails 102 to which the hanger assembly may be coupled will not be subjected to any substantial damage, or otherwise cause any substantial danger, given that the main rails 102 carry electrical power.

Although not shown in the drawings, such a breakaway hanger assembly could include a lower support rod adapted to interconnect (through brackets or otherwise) to elements to be supported by the hanger assembly, such as signs, banners or the like. At the upper end, the support rod could be secured at its upper end to a breakaway bracket which couples to the main structural channel rail 102 between the side panels 180. The bracket and bracket size could be sized and configured so that when they were inserted into the center portion of a length of a main structural channel rail 102 from the bottom thereof, the breakaway bracket sides could be adjacent vertically disposed walls of the main rail 102, such as the side panels 180. Brackets could be positioned so as to rest within grooves or slots formed within the interior of the lengths of the main structural channel rail 102. The breakaway bracket sides could have flexibility and resiliency, so that when the bracket is inserted into the main rail 102 from the bottom portion thereof, the bracket sides are “squeezed” inwardly as the sides move upwardly within the main rail 102. This inward flexion could continue to occur until bosses on the bracket sides are within the upper groove 187 formed within the structural channel rail 102. At that point, the sides of the bracket would flex outwardly so that the bosses are received within the groove 187. With this configuration, the hanger assembly could readily support relatively light weight elements connected to a support rod, absent the application of any substantial forces on the supported elements. However, with the configuration of the breakaway bracket, and the flexion capability of the breakaway bracket sides, external forces of a sufficient quantity exerted in a downward direction on supported elements will overcome the flexion forces of the breakaway bracket, which cause the bracket to remain positioned within the groove 187. The sides of the bracket would therefore flex inwardly, in response to the forces which would correspondingly be exerted on the bracket. The bracket would then be caused to fall from the main rail 102. Although the foregoing describes one embodiment of a breakaway hanger assembly, it is apparent that other configurations could be utilized for providing breakaway features in the event of forces exerted on supported elements.

The foregoing description of various elements of the structural channel system 100 in accordance with the invention have included a number of supporting elements. Among these elements have been the main structural channel rails 102, cross-channels 104, cross-channels 106 and suspension brackets 110. However, in certain instances, it may be desirable to provide support of various devices and applications above a general ceiling or horizontal plane of the main structural channel rails 102 forming the structural channel system 100. For example, various types of HVAC equipment may be preferably located above the general plane of the structural channel system 100. For this reason, the structural channel system 100 in accordance with the invention may include other types of supporting elements which interface with the basic components of the channel system 100.

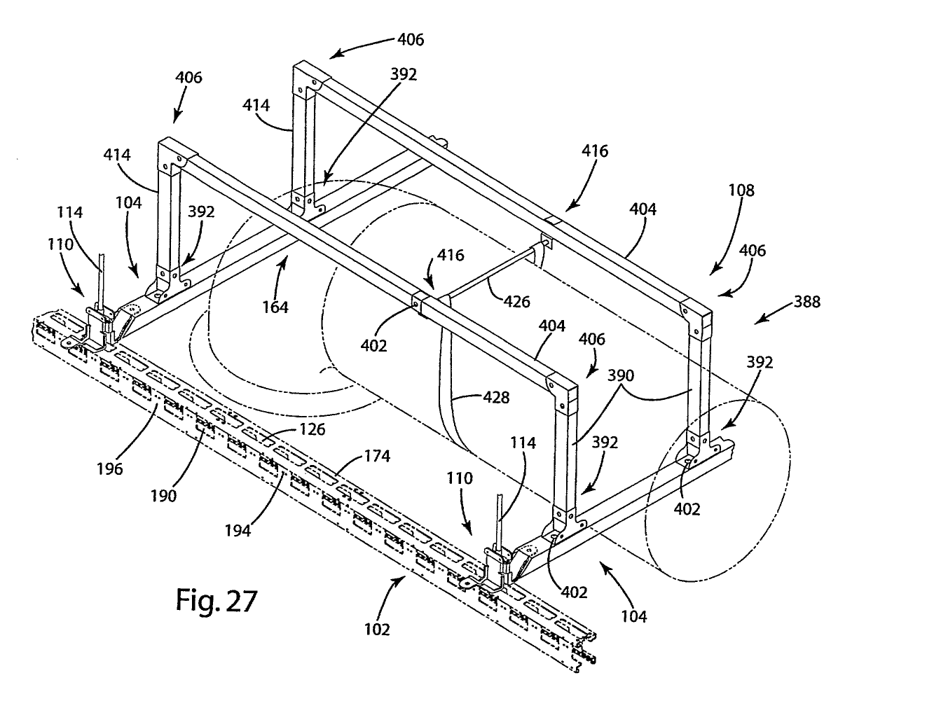

An example of the foregoing is illustrated in FIGS. 27-30. In FIG. 27, a bracket configuration 108 is illustrated, for purposes of supporting a terminal end of a duct 388 on a pair of cross-channels 104. As further shown in FIG. 27, the position of the heating duct 188 would be generally above an interconnected main structural channel rail 102. FIG. 27 further shows the pair of cross-channels 104 each being connected to a different suspension bracket 100 which, in turn, are coupled to the main structural channel rail 102. From prior description herein, it is apparent that other ends (not shown) of the cross-channels 104 would also be connected to a main structural channel rail 102 through the suspension brackets 110.

With reference again to FIG. 27, the heating duct 388 is supported through the use of a first pair of vertically disposed braces 390. The first pair of vertically disposed braces 390 are rigidly secured to a first one of the cross-channels 104 through a pair of T-brackets 392. A detailed illustration of a bracket which may be utilized as T-bracket 392 is shown in FIG. 29. With reference thereto, the T-bracket 392 includes a brace 394 having a horizontally disposed orientation, and will mount to the top surface of the cross channel 104. Extending upwardly from the base 394 are a pair of opposing sides 396. Integral with and extending upwardly from the top of the sides 396 is a rectangular channel 398 which is sized and configured so as to fit around one of the braces 390. Through holes 400 are located at various positions on the T-bracket 392. As shown in FIG. 27, the T-brackets 392 are secured to the top of the cross channel 104 by means of screws 402 or similar connecting means extending through the through holes 400. Correspondingly, one of the first pair of vertically disposed braces 390 is received within the channel 398 of the T-bracket 392, and also secured thereto by screws 402 or similar connecting means.

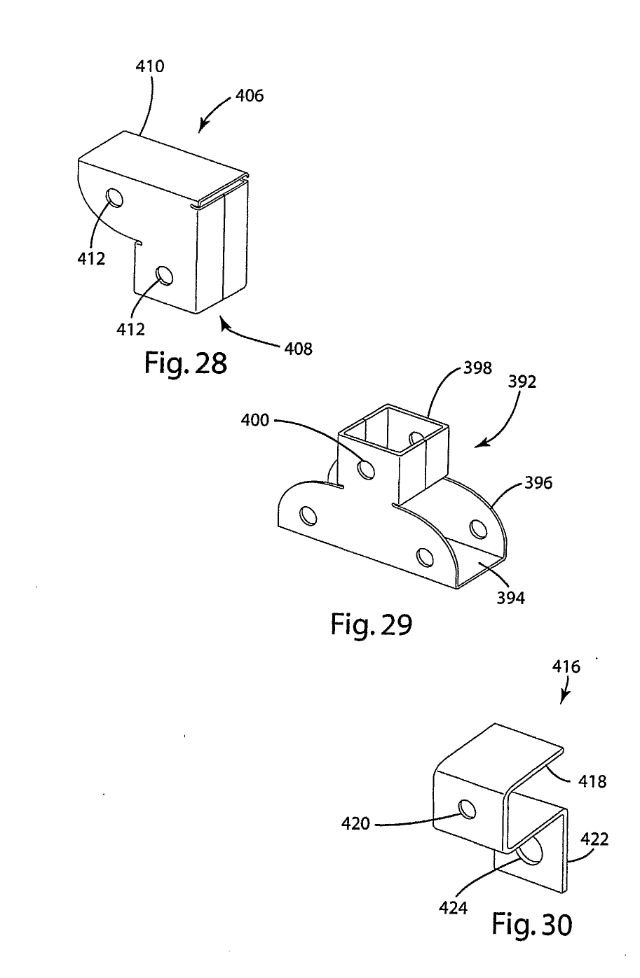

Again referring to FIG. 27, the upper end of each of the first pair of vertically disposed braces 390 is coupled to one of a pair of horizontally disposed supports 404. The coupling of each of the horizontal supports 404 to one of the first pair of vertically disposed braces 390 is achieved through the use of a 90° bracket 406. An exemplary configuration for the 90° bracket 406 is illustrated in FIG. 28. As shown therein, the 90° bracket 406 includes a vertical channel 408, which is sized so as to fit around the upper end of one of the braces 390. The vertical channel 408 is integral with a horizontally disposed member 410 which extends perpendicularly to the vertical channel 408. The horizontal member 410 is sized and configured so as to fit around one of the horizontal supports 404. Through holes 412 are located in both the vertical channel 408 and horizontal member 410. As illustrated in FIG. 27, one end of one of the horizontal supports 404 is received within the horizontal member 410, while an upper end of one of the vertically disposed braces 390 is received within the vertical channel 408. Screws 402 or similar connection means are received within through holes 412 so as to secure the 90° bracket 406 to the corresponding brace 390 and horizontal support 404.

Again referring to FIG. 27, the horizontal supports 404 extend from the one cross channel 104 to an adjacent and spaced apart second cross channel 104. Extending upwardly from the second cross channel 104 are a pair of vertically disposed braces 414, corresponding in size and structure to the first pair of braces 390. Correspondingly, the braces 414 are secured to the second cross channel 104 through T-brackets 392. The upper ends of each of the braces 414 are secured to terminating ends of the horizontal supports 404 through a pair of 90° brackets 406.

For purposes of support, the heating duct 388 can be made to rest on one of the cross-channels 104, as shown in FIG. 27. However, for purposes of providing further support, the bracket system 108 includes a pair of clip and threaded rod hangers 416, mounted to individual ones of the horizontal supports 404 as illustrated in FIG. 27. FIG. 30 illustrates one of the clip and threaded rod hangers 416 in detail. Referring thereto, the hanger 416 includes an upper U-shaped bracket 418, with a through hole 420 extending through the base thereof. Integral with the front edge of one of the legs of the upper U-shaped bracket 418, and extending downwardly therefrom, is a lower flange 422. The flange 422 includes a threaded rod hole 424 extending therethrough. In use, and referring back to FIG. 27, each of the clip and threaded rod hangers 416 is attached to a different one of the pair of horizontal supports 404. Specifically, the body of the horizontal support 404 is captured within the upper U-shaped bracket 418. Screws 402 or similar connecting means can be used to secure the hangers 416 to the horizontal supports 404. As further shown in FIG. 27, a threaded rod 426 extends between the opposing rod hangers 416. The threaded rod 426 is threaded at opposing ends and sized so as to be threadably received within the threaded rod holes 424 of each of the rod hangers 426. If desired, nuts (not shown) or similar means may be utilized with the threaded rod 426, so as to secure the rod 426 to the hangers 416. For purposes of providing full support to the heating duct 388, a flexible support strap 428 (as shown in FIG. 27) may be secured in any suitable manner to the threaded rod 426 and wrapped around the heating duct 388.

The foregoing has described one type of bracket assembly 108 which may be utilized to support equipment (such as a heating duct 388) generally above a horizontal plane formed by the main structural channel rails 102 of the structural channel system 100. It is apparent that other types of bracket and hanger structures could be utilized with the main structural channel rails 102 and cross-channels 104, without departing from the principal novel concepts of the invention.

As earlier described, other infrastructure components may be employed with the structural channel system 100 in accordance with the invention. As an example, and with reference primarily to FIGS. 1, 2, 3 and 31, the structural channel system 100 may include lengths of a cableway 120. The cableway 120 maybe utilized to carry, for example, DC or other low voltage power within the structural channel system 100 through lines such as cables 166 illustrated in FIG. 2. The cableway 120 may have a number of components constructed by means of plastic extrusion or similar processes. These components of the cableway 120 may be constructed of various plastics, including ABS (acrylonitrile, polymer with one, three-butadiene and styrene). The cableway 120 can include an exterior or outwardly extending portion 430. As illustrated in the drawings, the exterior portion 430 is angled. The angled exterior portion 430 is integral with or otherwise connected at its upper end to an upper right angled section 432. The upper right angled section 432 includes a section which forms a ledge 434. On the side of the ledge 434 opposing the integral connection to the exterior portion 430 is a lip 436.

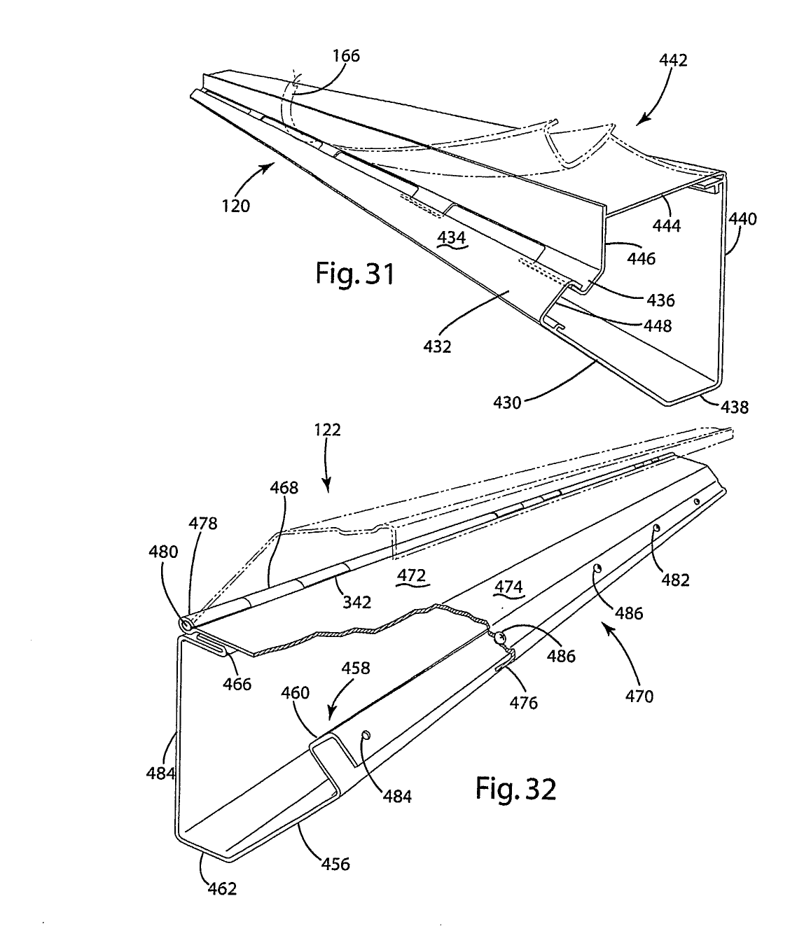

Still with reference to FIGS. 1, 2, 3 and 31, the lower end of the angled exterior portion 430 is integral with or otherwise connected to a flat section 438, which extends inwardly to other components of the structural channel system 100. Correspondingly, integral with or otherwise connected to an edge of the flat section 438 opposing the edge which is integral with the angled section 430 is a vertically disposed inner panel 440. The inner panel 440 extends upwardly from the flat section 438. At the top of the vertical inner panel 440 is a living hinge 442. With reference to FIG. 31, the living hinge 442 is shown in a “partially opened” position in phantom line format, and is also shown in a conventional, closed position in solid line format.

The living hinge 442 includes a flat section 444 which is integral with or otherwise connected to the top of the vertical inner panel 440. The flat section 444 extends outwardly, and is integral with or otherwise connected to an exterior side 446, which has a vertical disposition when the living hinge 442 is in a closed position. At the lower edge of the exterior side 446, the exterior side 446 is integral with or otherwise connected to an angled end portion 448. The angled end portion 448 is sized and configured so that it fits within the upper right-angled section 432, when the living hinge 442, is in a closed position.

One advantage of the cableways 120 in accordance with the invention relates to their positioning within the structural channel system 100. The cableways 120 are appropriately sized and shaped so as to conveniently rest on the suspension brackets 100, as primarily illustrated in FIGS. 1, 2 and 3. Specifically, through holes 450 may be preformed or otherwise drilled into the vertical inner panel 440 at appropriately spaced positions. Self tapping or other types of screws 452 (also shown in FIG. 3) may be received within the through holes 450 and threadably received within the through holes 454 (illustrated in FIGS. 13 and 14) in the upper flanges 204 of the suspension brackets 110. In this manner, the sections of the cableways 120 can be appropriately secured to and supported by the suspension brackets 110. In addition to the previously described advantages of the cableways 120 in accordance with the invention, other advantages also exist. For example, it is possible to “stack” the suspension brackets 110 on the associated threaded support rods 114. With this stackable capability, it is therefore also possible to stack cableways 120 in a vertically disposed manner. Such a configuration is illustrated in FIG. 19A.

In addition to the structural channel system 100 having the capability of employing cableways 120, the structural channel system 100 in accordance with the invention may also employ other structures having similar functions, but where metallic enclosure or isolation of conductive cables or wires may be required. For this function, the structural channel system 100 can include one or more wireways 122, one of which is illustrated in FIGS. 1, 2, 3 and 32. As earlier mentioned, and as shown in FIGS. 1, 2 and 3, the wireway 122 illustrated therein may be utilized to carry high voltage high voltage AC power cables or conduit 164. For example, this conduit or cabling 164 may carry 277 volt AC power. Of course, other voltages and other cabling or wiring may be utilized with the wireways 122.

Turning to the specific configuration of the wireway 122 illustrated in FIGS. 1, 2, 3 and 32, the wireway 122 includes an exterior or outwardly extending portion 456. As illustrated in the drawings, the exterior portion 456 is angled. The angled exterior portion 456 is integral with or otherwise connected at its upper end to an upper right-angled section 458. The upper right-angled section 458 includes a section which forms a ledge 460.

Still with reference to FIGS. 1, 2, 3 and 32, the lower end of the angled exterior portion 456 is integral with or otherwise connected to a flat section 462. The flat section 462 extends inwardly toward other components of the structural channel system 100. Correspondingly, integral with or otherwise connected to an edge of the flat section 462 opposing the edge which is integral with the angled section 456 is a vertically disposed inner panel 464. The inner panel 464 extends upwardly from the flat section 462. At the top of the inner panel 464, the panel 464 turns outwardly (or laterally away from the structural channel system 100) so as to form a tongue 466. The tongue 466 curls back on itself and terminates in a series of spaced apart and integrally connected hinge bails 468. As described in subsequent paragraphs herein, the hinge bails 468 form, with other components of the wireway 122, a hinge for appropriately connecting a pivotal cover to the wireway 122.

More specifically, the wireway 122 includes a wireway cover 470, as illustrated in FIGS. 1, 2, 3 and 32. The wireway cover 470 pivotally fits upon the top of the wireway 122, and provides a metallic covering for the AC power cables 164 extending along the interior of the wireway 122. The wireway cover 470 includes an angled portion 472. Connected to or otherwise integral with one edge of the angled portion 472 is a top portion 474. The top portion 474 terminates in an integral outer flange 476. At the outer edge of the angled portion 472, the angled portion 472 terminates in a series of spaced apart hinge sleeves 478. When the wireway cover 470 is appropriately interconnected to the wireway 122, the hinge sleeves 478 are received in spaces between the hinge bails 468.

To appropriately secure the wireway cover 470 to the wireway 122, a hinge rod 480 is received within an elongated aperture formed by the hinge bails 468 and the interspaced hinge sleeves 478. With the hinge rod 480 appropriately coupled and received within the hinge bails 468 and hinge sleeves 478, the wireway cover 470 is pivotal relative to the wireway 122. In FIG. 3, the wireway cover 470 is illustrated in an open position. The wireway cover 470 can be pivoted relative to the wireway 122, and moved to a closed position, as illustrated in FIGS. 1, 2 and 32 (with the wireway cover 470 illustrated in a closed position in FIG. 32 in solid line format). For purposes of securing the wireway cover 470 in a closed position, through holes 482 may be formed in the top portion 474 of the wireway cover 470 and spaced apart along the elongated wireway cover 470. Corresponding through holes or threaded holes 484 can be formed in one side of a ledge 460 of the wireway 122, with the holes 484 spaced apart and in alignment with the through holes 482. When the cover 470 is moved to a closed position, screws, such as self tapping screws 486, may be received within the through holes 482 and threaded holes 484. More specifically, the screws 486 should be received within the holes 482 and 484, without projecting into the cavity of the wireway 122, where cabling is contained.

As with the cableways 120, one advantage of the wireways 122 in accordance with the invention relates to their positioning within the structural channel system 100. The wireways 122 are appropriately sized and shaped so as to conveniently rest on the suspension brackets 110, as primarily shown in FIGS. 1, 2 and 3. To secure the wireways 122 to the structural channel system 100, through holes 488 may be preformed or otherwise drilled into the vertical inner panel 464 of the wireway 122, at appropriately spaced positions. Self tapping or other types of screws 452 (also shown in FIG. 3) may be received within the through holes 488 and threadably received within the through holes 454 (illustrated in FIGS. 13 and 14) in the upper flanges 204 of the suspension brackets 110. In this manner, the wireways 122 can be appropriately secured to and supported by the suspension brackets 110.

The wireways 122 can be constructed of various materials, such as galvanized steel or similar metallic elements and compounds. Further, the wireways 122 can be constructed of longitudinal and identical sections adapted to be interconnected end-to-end. The individual sections of the wireways 122 can be of any desired length. However, governmental and institutional regulations may limit the particular length of the wireways 122 which may be utilized in a physically realizable and “legal” environment. Further, in addition to the previously described advantages of the wireways 122 in accordance with the invention, other advantages exist. For example, it is possible to “stack” the suspension brackets 110 on the associated threaded support rods 114. With this stackable capability it is therefore also possible, as with the cableways 120, to stack the wireways 122 in a vertically disposed manner. An illustration of a series of suspension brackets 110 positioned in a stacked relationship, with corresponding cableways 120 and wireways 122, is shown in FIG. 19A. It should also be noted that positioned on the face or angular exterior portion 456 of the wireways 122 are a series of knock-outs 490. In one exemplary embodiment, the knock-outs 490 can be of a diameter of 0.875 inches. Further, the knock-outs 490 can be positioned, for example, at increments of 12 inches. The knock-outs 490 provide access to cabling 164 inside of the wireways 122. In this manner, the cabling 164 inside the wireways 122 can be utilized to provide power to lights or other electrical devices positioned along the exterior of the wireways 122.

In addition to the previously described components associated with the wireways 122, other structures could also be utilized with the wireways 122. For example, end caps (not shown) can be used at terminating ends of lengths of the wireways 122. Also, if it is desired to allow passage of cables 164 through the ends of different sections of the wireways 122, components which may be utilized as wireway “end feeds” (not shown) may be utilized, whereby the end feeds essentially cover the ends of the wireways 122, but include cutouts or the like which allow for passage for the cables 164.

The foregoing has been a description of the configuration of the wireways 122. It will be appreciated that the length of any individual wireway 122 will be finite. Accordingly, for purpose of providing a desired and substantially “closed” wireway system, a series of individual lengths of wireways 122 may be required. In such event, it is preferable for adjacent ones of the wireways 122 to be mechanically coupled to each other, and to be coupled at their ends to one of the suspension brackets 110. This mechanical coupling provides shielding of the AC power cables 164 at the ends of the individual lengths of the wireways 122, and also may be required in accordance with governmental or other institutional standards.

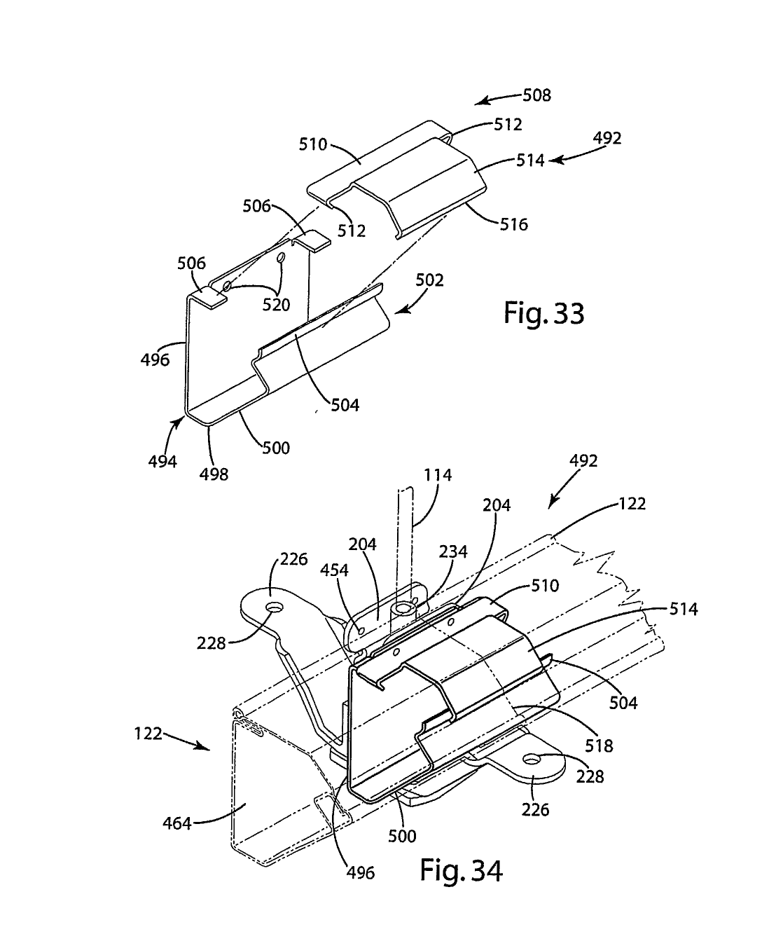

For purposes of providing this mechanical coupling, joiners may be utilized. An exemplary embodiment of a joiner which may be utilized in accordance with the invention is illustrated as joiner 492, primarily shown in FIGS. 33 and 34. Also, an end view of the joiner 492 as positioned within an end of a wireway 122 is illustrated in FIGS. 2 and 3. With reference initially to FIGS. 33 and 34, the joiner 492 includes an inset portion 494. The inset portion 494 is shown in perspective view in FIG. 33. Referring thereto, the inset portion 494 includes an inner panel 496 having a flat and vertically disposed surface. Integral with the inner panel 496 and positioned at the lower end of the inner panel 496 is a flat portion 498. The flat portion 498 is horizontally disposed when the joiner 492 is positioned and coupled to adjacent lengths of the wireways 122. The flat portion 498 is, at one edge, integral with an angled portion 500 which angles upwardly from the flat portion 498. At the upper edge of the angled portion 500 is a curved bracket 502 having somewhat of an L-shaped configuration, with an arcuate-shaped edge flange 504. At the top of the inner panel 496 are a pair of outwardly extending and spaced apart brackets 506.

The joiner 492 also includes a joiner cover 508, as shown separated from the joiner inset 494 in perspective view in FIG. 33. With reference thereto, the joiner cover 508 includes an elongated and inner flange 510, extending across the length of the cover 508. At opposing lateral ends of the inner flange 510 are a pair of downwardly extending lips 512 angled inwardly from the ends of the inner flange 510. Extending outwardly from the inner flange 510 is an outer flange 514, having somewhat of a curved structure as illustrated in FIGS. 33 and 34. The outer flange 514 is integral with the inner flange 510, and terminates in a downwardly extending and elongated lip 516.

The joiner cover 508 may be assembled with the inset 494 so as to form the entirety of the joiner 492 as illustrated in FIG. 34. More specifically, for purposes of assembly, the lips 512 of the inner flange 510 of the joiner cover 508 can be “slid” onto the brackets 506 positioned at the top of the inner panel 496 of the inset 494. The joiner cover 508 is sized and configured so that when the lips 512 are slid onto the brackets 506, the joiner cover 508 cannot be removed from the inset 494 solely by an “upper” movement of the joiner cover 508. With the lips 512 slid onto the brackets 506, the elongated lip 516 of the joiner cover 508 can then be positioned around the edge flange 504 of the inset 494. In this manner, the lip 516 can essentially “capture” the edge flange 504. This configuration is illustrated in FIGS. 2, 3 and 34. It should be noted that to provide this assembly, the angled portion 500 and the curved bracket 502 are constructed so as to have a sufficient resilience or flexibility which allows the flange 504 to be moved toward the inner panel 496, in a manner so as to permit the lip 516 to be extended to the outside of the edge flange 504, thereby capturing the same. Preferably, the joiner cover 508 is positioned in a closed configuration, after the interior cabling is laid in place within the wireway 122. In this manner, installers can lay the cabling in place within the interior of the wireway 122, prior to closing of the joiner cover 508 so as to minimize any necessity of “pull-through” of the cabling from an end of a length of the wireway 122.

For purposes of coupling the joiner 492 to adjacent lengths of the wireway 122, the joiner 492 will be coupled in a “straddle” configuration between the adjacent wireways 122, as primarily shown in FIG. 34. With reference thereto, the joiner 492 is illustrated as straddling adjacent ends of two lengths of the wireways 122, with the wireways 122 being shown in phantom line format. The adjacent end edges of the two wireways 122 are illustrated by phantom line 518. The joiner 492 is positioned in the straddle configuration between the adjacent wireways 122 in a manner so that the inner panel 496 of the inset 494 is adjacent the inner panels 464 of the wireways 122. As previously described herein, the inner panels 464 may include through holes 488 either predrilled or self tapped. When the joiner 492 is properly aligned with the adjacent wireways 122, a through hole 488 of each wireway 122 is aligned with one of the through holes 520 which are either predrilled or self tapped through the inner panel 496. Self tapping screws 452 (FIG. 3) are received within the through hole 520 and through holes 488. This will provide mechanical coupling of the adjacent wireways 122 through the joiner 492. Correspondingly, to secure the ends of the wireways 122 to a suspension bracket 110, a suspension bracket 110 as shown in FIG. 34 can be coupled to the wireways 122 and the joiner 492 by aligning the through holes 488, 520 with the through holes 454 extending through an upper flange 204 of one of the suspension brackets 110. Self tapping or other types of screws 452 (also shown in FIG. 3) may then be received within the through holes 488, 520 and 454. In this manner, the wireways 122 are secured, at their ends, to suspension brackets 110 through the joiners 492.

Another aspect of the structural channel system 100 should be described. With the structure of the main structural channel rails 102 and other components described herein, space is provided for structural and electrical components to be extended from above the main rails 102 through the center portions thereof. As an example, if desired, rods supporting fire sprinklers could be extended through the main rails 102. Also, the threaded support rods 114 could be extended, so as to support other elements, since such support does not put any load on the main rails 102.

The foregoing describes a substantial number of the primarily mechanical components associated with the structural channel system 100. In accordance with the invention, the structural channel system 100 includes means for distributing power (both AC and DC) and communication signals throughout a network which is enmeshed with the mechanical components, or structural grid 172, of the structural channel system 100. For purposes of describing the embodiment herein comprising a structural channel system 100 in accordance with the invention, another term will be utilized. Specifically, reference will be made to the “electrical network 530” or “network 530.” The network 530 can be characterized as all of the electrical components of the structural channel system 100 as described in subsequent paragraphs herein. As will be apparent from subsequent description herein, the electrical network 530, like the structural grid 172, can be characterized as an “open” network, in that additional components (including modular plug assemblies, power entry boxes, connector modules, application devices, and other components as subsequently described herein) can be added to the entirety of the electrical network 530.

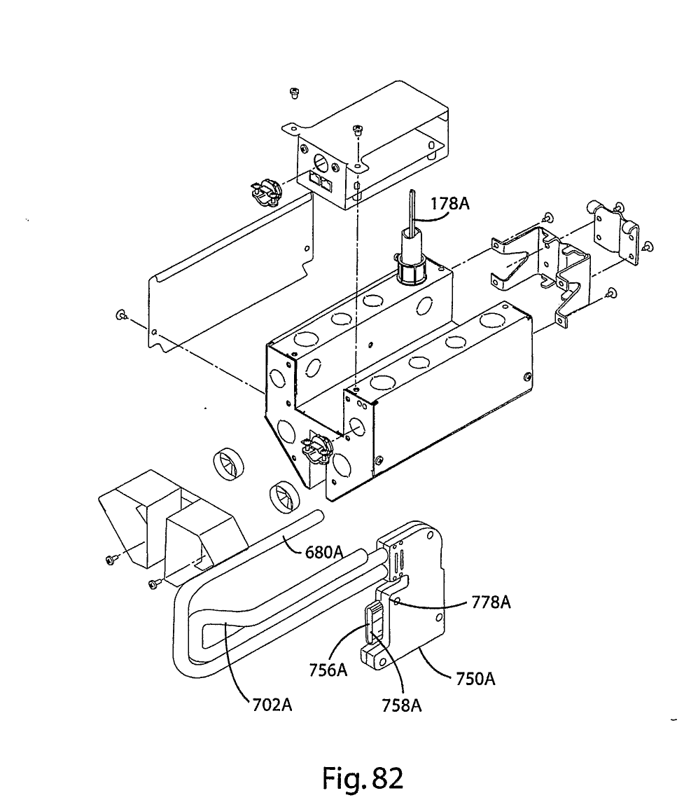

To provide the electrical network 530 in accordance with the invention, the structure channel system 100 includes means for receiving incoming building power and distributing the power across the structural grid 172. Also, so as to provide for programmability and reconfiguration of control/controlling relationships among application devices, the structural channel system 100 also includes means for generating and receiving communication signals throughout the grid 172. To provide these features, the structural channel system 100, as will be described in subsequent paragraphs herein, comprises power entry boxes 134, power box connectors 136, modular plug assemblies 130 having modular plugs 576, receptacle connector modules 144, dimmer connector modules 142, power drop connector modules 140, flexible connector assemblies 138 and various patch cords and other cabling. These components are in addition to the cableways 120 and wireways 122, previously described herein, which carry power cables 166 and 164, respectively. In addition to the foregoing, a somewhat preferred embodiment of a power entry box and power box connector will also be subsequently described herein, and identified as power entry box 134A and power box connector 136A, as illustrated in FIGS. 82-85.

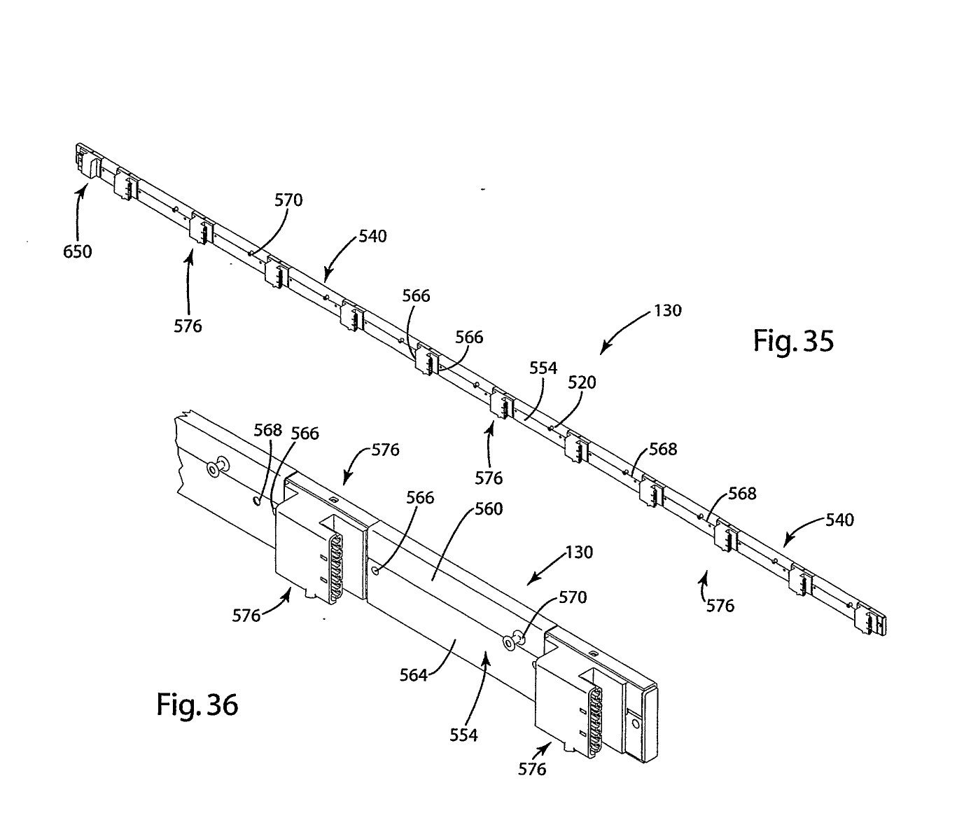

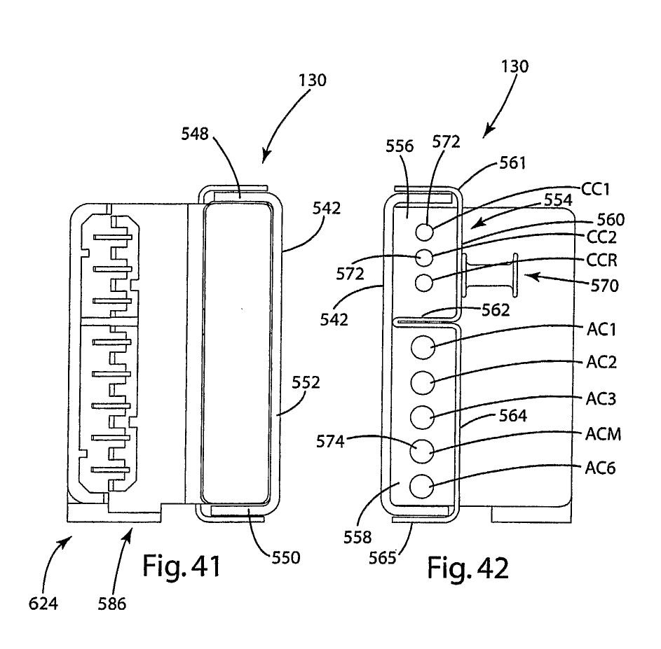

Turning more specifically to the components of the electrical network 530, these components include one or more modular plug assemblies 130, a length of which is illustrated and described herein with respect to FIGS. 35-44. Each length of the modular plug assembly 130 will be mechanically interconnected to a main structural channel rail 102, so as to be mechanically distributed throughout the structural grid 172. The modular plug assembly 130 provides means for distributing power and communication signals throughout the electrical network 530, and for providing network distribution for communication signals in the form of programming and data signals applied among connector modules associated with application devices. With reference first primarily to FIGS. 37 and 41, the modular plug assembly 130 includes elongated modular plug assembly sections 540, one of which is illustrated in FIG. 37. As described in subsequent paragraphs herein, individual plug assembly sections 540 may be mechanically connected to lengths of the main structural channel rails 102, and electrically interconnected together through the use of flexible connector assemblies. With reference primarily to FIGS. 37 and 41, the elongated power assembly section 540 includes an elongated power assembly cover 542. The cover 542 has a cross sectional configuration as primarily shown in FIG. 41. The cover 542 includes a cover side panel 552 which will be vertically disposed when the modular plug assembly section 540 is secured within the structural channel system 100. Integral with the cover side panel 552 and curved inwardly therefrom is an upper section 548, having a horizontally disposed configuration relative to the side panel 552. Extending inwardly from the lower portion of the side panel 552 and integral therewith is a lower section 550, again as shown in FIG. 41. As shown primarily in FIG. 37, a first set of through holes 544 are spaced apart and extend through the cover side panel 552. Correspondingly, a second set of through holes 546 are also spaced apart and extend through the cover side panel 552. The power assembly cover 542 is utilized to provide an outer cover for individual lengths of the elongated modular power assembly sections 540, when the modular power assembly 130 is coupled to the main structural channel rails 102.

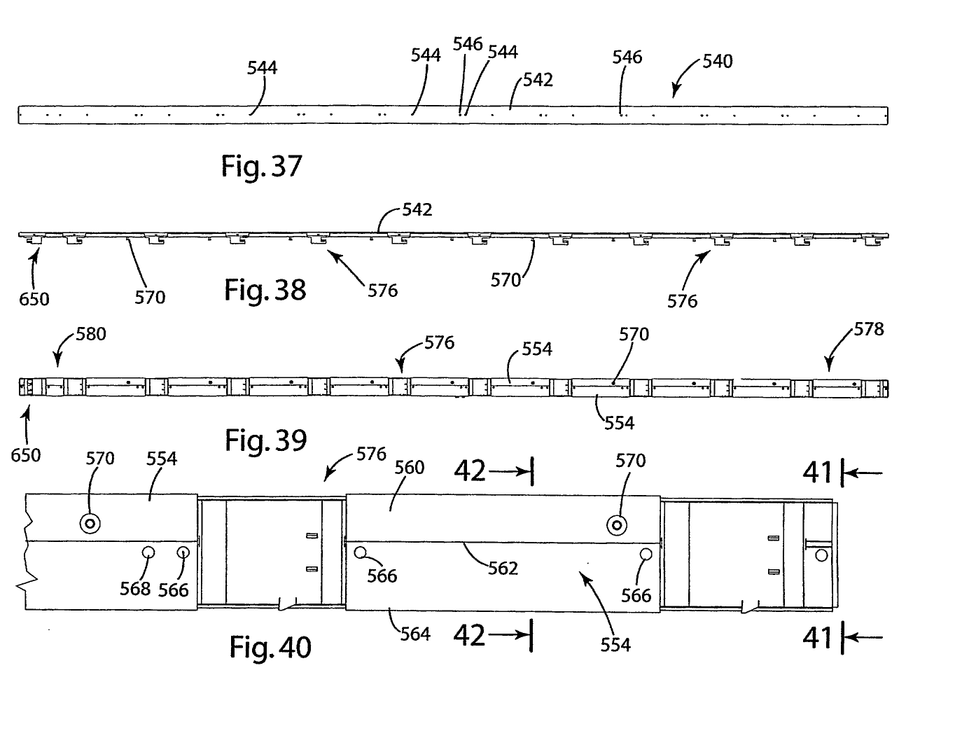

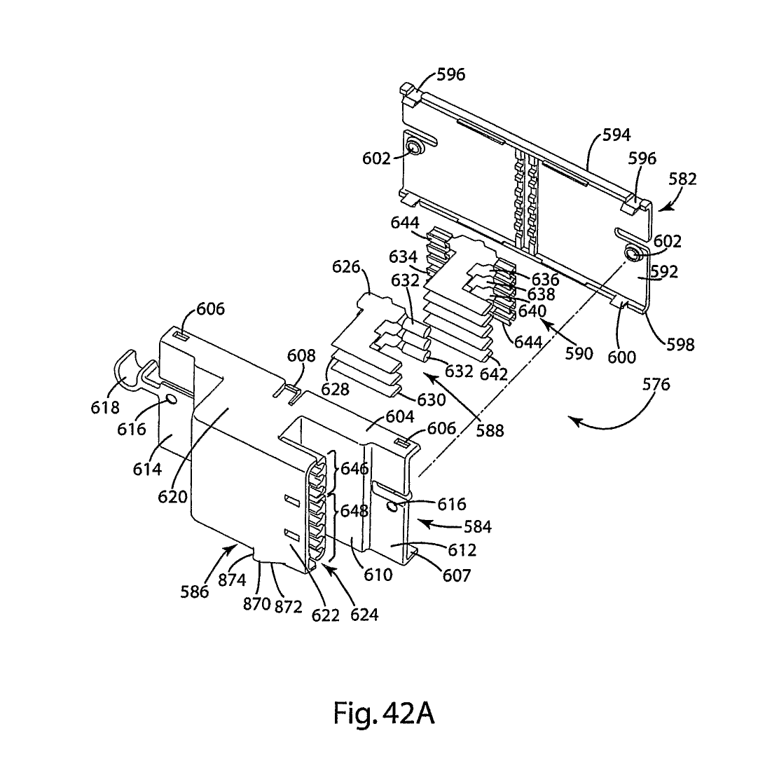

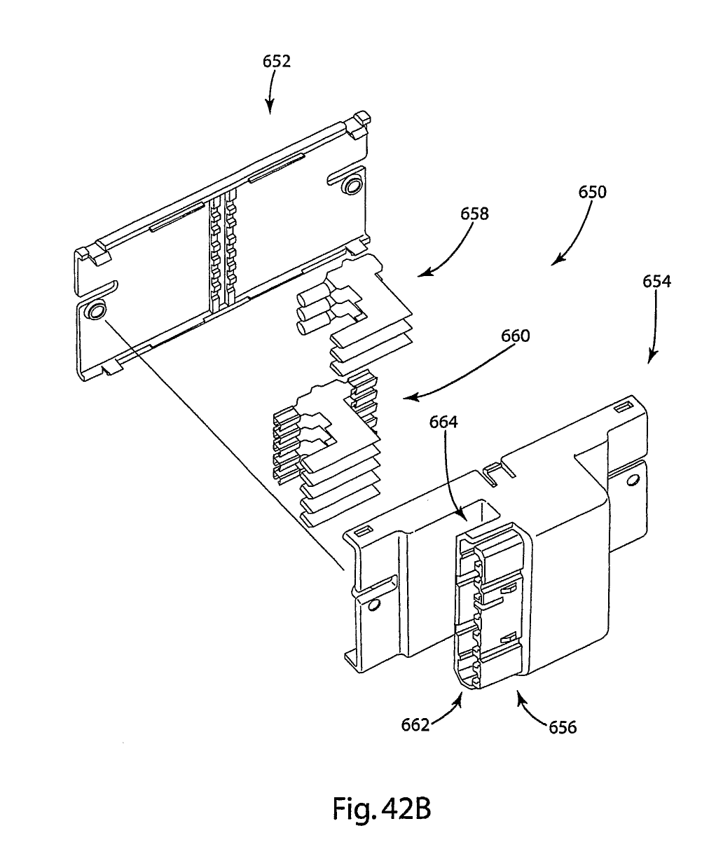

The sections 540 of the modular plug assembly 130 also include what are characterized as principal electrical dividers 554. FIG. 42 illustrates a cross sectional view of the divider 554. With reference primarily to FIGS. 36, 40 and 42, the principal electrical dividers 554 are utilized to provide an inner side of the modular plug assembly sections 540, and to also form channels for carrying communication cables and AC power cables, with electrical isolation therebetween. With reference to the drawings, each principal electrical divider 554 includes an upper communications channel 556. The purpose of the channel 556 is to carry communications cables 572, described in subsequent paragraphs herein. The upper communications channel 556 is formed by an upper inner side panel 560 integral with an upper section 561 which is horizontally disposed and curves outwardly from the side panel 560. Also integral with and extending perpendicularly and outwardly from the upper inner side panel 560 at the lower portion thereof (see FIG. 42) is an inwardly directed divider tongue 562. The inwardly directed divider tongue 562 separates the upper communications channel 556 and the lower AC power channel 558. The divider tongue 562 curves outwardly on itself. Integral with and extending downwardly from the divider tongue 562 is a lower inner side panel 564. The lower inner side panel 564 terminates at its lower portion with an integrally formed and perpendicularly curved lower section 565. For purposes of connection of the principal electrical divider 554 with the power assembly cover 542, screw holes 568 extend through the lower inner side panel 564. These holes align with a second set of through holes 546 in the plug assembly cover 542. Pan head or similar screws (with locking nuts) may be utilized for interconnection. Also extending through the lower inner side panel 564 are a set of through holes 55. These holes 556 are aligned with the first set of through holes 544 in the plug assembly cover 542. Rivets or similar connecting means may be utilized with these holes, for purposes of interconnecting the electrical dividers 554, plug assembly cover 542 and modular plugs 576 as described in subsequent paragraphs herein.

In addition to the foregoing components of the principal electrical dividers 554, the dividers 554 also include a series of spaced apart ferrules 570. The ferrules 570 are best viewed in FIGS. 36 and 42. As described in subsequent paragraphs herein, the ferrules 570, which may be secured to the upper inner side panels 560 of the electrical dividers 554 in any suitable manner, function so as to provide for coupling of connector modules (described in subsequent paragraphs herein) to the modular plug assembly sections 540. The ferrules 570 have a stool or mushroom-shaped configuration, as principally shown in FIG. 42.

The electrical dividers 554 have been referred to herein as the “principal” electrical dividers. The reason for this designation is that electrical dividers having a substantially similar configuration as the electrical dividers 554, but differing in length, are utilized at opposing ends of the modular plug assembly sections 540. As illustrated in FIG. 39, the modular plug assembly section 540 includes what can be characterized as a right-hand electrical divider 578. The right-hand electrical divider 578 has somewhat of a shorter length than each of the principal electrical dividers 554. In this regard, the principal electrical dividers 554 are preferably each of equal length. The modular plug assembly section 540 also includes what can be characterized as a left-hand electrical divider 580. This divider is of a still shorter length, relative to the right-hand electrical divider 578 and the principal electrical dividers 554. Each of the electrical dividers 578, 580 has a structural configuration substantially similar to the principal electrical dividers 554.

As earlier stated, the modular plug assembly sections 540 will carry a set of communications cables 572, and a set of AC power cables 574, as shown in cross section in FIG. 42. The structural channel system 100, in its entirety, is adapted to distribute at least AC power and communication signals throughout the electrical network 530, which is enmeshed with the mechanical components of the structural channel system 100. As will be described in subsequent paragraphs herein, the electrical network 530 includes means for receiving building power, distributing power and communication signals throughout the structural grid 172 and the electrical network 530, and providing power, reconfiguration and programmability to application devices interconnected into the electrical network 530. To provide for the distribution of power and communication signals, and as also earlier mentioned herein, the modular power assembly 130 includes a series of communication cables 572 which are carried in the upper communications channel 556 along the length of each of the elongated modular plug assembly sections 540. These communication cables 572 are utilized to carry digital communication signals throughout the electrical network 530, for purposes of providing programmability of connector modules associated with application devices, and reconfiguration of control and controlling relationships among the application devices.

Also, in a somewhat modified embodiment of the structural channel system 100, the communication cables 572 can be utilized to carry not only communication signals, but also low voltage DC power. This concept of utilizing the communication cables 572 for DC power as well as communication signals, will be described subsequently herein. It may be mentioned at this time that the signals carried on the communication cables 572 will operate so as to provide for a distributed, programmable network, where modifications to the control relationships among various application devices can be reconfigured and reprogrammed at the physical locations of the application devices themselves, as attached to the network 530. In this regard, and as also subsequently described herein, the network 530 includes not only the communication cables 572, but also connector module means having processor circuitry responsive to the communication signals, so as to control application devices coupled to the connector module means. Also, means will be described herein with respect to connecting communication cables 572 associated with one section 540 of the modular plug assembly 130, to an adjoining or otherwise adjacent section 540 of the plug assembly 130.

At this point in the description, it is worthwhile to more specifically describe one configuration which may be utilized with the communication cables 572, along with nomenclature for the same. It should be emphasized that this particular cable configuration and nomenclature is only one embodiment which may be utilized with the structural channel system 100 in accordance with the invention. Other communications cable configurations may be utilized. Also, described subsequently herein, the communications cables 572 and network 530 may be modified so as to carry not only communication signals, but also DC power.

Specifically, reference is made to FIG. 42, which illustrates three communication cables 572. For purposes of identification and description, the communications cables 572 as illustrated in FIG. 42 are referenced in FIG. 42 (and elsewhere in the specification) as communication cables CC1, CC2 and CCR. In the particular embodiment described herein, the communication cables CC1 and CC2 may be utilized to carry communications signals in what is commonly referred to as a “differential configuration.” Such a signal carrying arrangement may be contrasted with what is often characterized as “single ended configuration.” With differential configurations for electrical signals, wire or cable pairs are utilized for each electrical signal. In this case, the cable pair CC1 and CC2 will be utilized for the communications signals applied through the network 530. The concept of differential configurations is relatively well known in the electrical arts. The use of cable pairs for carrying communication signals, as opposed to single-ended configurations, provides for relatively high immunity to noise and cross-talk. With this configuration, the “value” of the signal at any given time is the instantaneous algebraic difference between the two signals. In this regard, the communication signals carried on CC1 and CC2 may be distinguishable from the single-ended configuration, where the signals are represented by one active conductor and signal ground. The communications cable 572 which is identified as cable CCR is characterized as the “return” cable. The return cable CCR essentially provides for a return line for communications associated with the network 530. This return line cable CCR provides for appropriate grounding of the entirety of the DC portion of the network 530. It should be stated that if a configuration is utilized which employed the communication cables 572 not only to carry communication signals, but also to carry DC power, one of the three communication cables 572 would be made to carry the communication signals for the network 530. Correspondingly, another one of the cables 572 would be made to carry DC power for various network components associated with the distributed network 103. Such DC power transmitted along one of the communication cables could be used, for example, to power microprocessor elements and the like within various connector modules as described subsequently herein. Further, even if DC power is carried by the communication cables 572, one of the communication cables 572 would still preferably be utilized as a “return” cable. This cable would be utilized to provide a return line not only for the communication signals associated with the network 530, but also for the DC power carried along the communication cables 572.

As will be made apparent herein, the communication cables CC1 and CC2 are of primary importance with respect to the distributed network 530. The communication cables CC1 and CC2 will carry data, protocol information and communication signals (collectively referred to herein as “communications signals”) throughout the network 530 of the structural channel system 100, including transmission to and from connector modules. For example, and as described subsequently herein, the communication cables CC1 and CC2 may carry data or other information signals to electronic components within a connector module, so as to control the application within the connector module of AC power to an electrical receptacle. Again, it should be noted that signals on communication cables CC1 and CC2 may be in the form of data, protocol, control or other types of digital signals.

In addition to the communication cables 572, the sections 540 of the modular plug assembly 130 carry the AC power cables 574 within the lower AC power channel 558 of each section 540 of the plug assembly 130. For purposes of description, it is worthwhile to more specifically describe one configuration which may be utilized for the AC power cables 574, along with nomenclature for the same. It should be emphasized that this particular AC power cable configuration and nomenclature is only one embodiment which may be utilized with the structural channel system 100 in accordance with the invention. Other AC cable configurations may be utilized. More specifically, reference is made to FIG. 42, which illustrates the AC power cables 574. In the example embodiment shown in FIG. 42, the AC power cables 574 are five in number, and are identified as AC cables AC1, AC2, AC3, ACN and ACG. With a five cable (or as commonly referred to, “five wire”) configuration for AC power, it is known that such a configuration can provide three separate circuits, with the circuits utilizing a common neutral and common ground. In this particular AC power cable configuration utilized with the structural channel system 100, AC1, AC2 and AC3 are designated as the “hot” cables. ACN is neutral cable, and ACG is a common ground cable. In accordance with the foregoing, if a user wished to “tap off” the AC power cables 574, so as to provide a single AC circuit with three wires, the user would connect to ACN and ACG, and then also connect to one of the hot cables AC1, AC2 or AC3. By advantageously providing the capability of selecting one of three AC circuits, the distributed network 530 associated with the structural channel system 100 can be effectively “balanced.”

In addition to the foregoing elements, the modular plug assembly 130 includes a series of modular plugs 576 coupled to each plug assembly section 540 and spaced apart on the same side of each section 540 as the side of the electrical dividers 554. The modular plugs 576 are actually spaced intermediate adjacent lengths of the electrical dividers 554. The modular plugs 576 function so as to electrically interconnect the communication cables 572 to connector modules (to be described herein). In this manner, communication signals can be transmitted and received between the connector modules and the communication cables 572. In addition, the modular plugs 576 also function to couple AC power from the AC power cables 574 to those connector modules which have the capability of applying power to various application devices.

One embodiment of a modular plug 576 in accordance with the invention is primarily illustrated in FIGS. 36, 40, 41 and 42A. With reference thereto, the modular plug includes a lid 582, inner panel 584, plug connector 586, communications male blade set assembly 588 and AC power male blade set 590. With reference first to the modular plug lid 582, and primarily referring to FIG. 42A, the plug lid 582 includes an outer and vertically disposed panel 592. The panel 592 includes a top edge 594, with a pair of upper tabs 596 located at opposing ends of the edge 594. A lower edge 598 extends along the bottom of the outer panel 592. A pair of downwardly projecting lower tabs 600 are located at opposing ends of the lower edge 598. A pair of rivet holes 602 are located at opposing sides of the outer panel 592. With reference to the inner panel 584, and again with reference to FIG. 42A, the inner panel 584 includes a side panel 610, with a top edge 604 running therealong. On opposing sides of the top edge 604 are a pair of slots 606. When assembled, the upwardly projecting tabs 596 of the lid 582 will snap into place within the slots 606. Although not shown in the drawings, slots similar to slots 606 are located at opposing sides of a lower edge 607 projecting inwardly from the bottom of the side panel 610. A tab 608 is located near the center portion of the top edge 604. When assembled, the upwardly projecting tab 608 will be captured under the top edge 594 of the outer panel 592 of lid 582.

Extending laterally outward from opposing sides of the side panel 610 are a pair of recessed panels, identified as right hand recessed panel 612 and left hand recessed panel 614. The references to “right hand” and “left hand” are arbitrary. Extending through both the right hand recessed panel 612 and left hand recessed panel 614 are a pair of rivet holes 616. Extending outwardly from the left hand recessed panel 614 is a screw bail 618.

Referring now to the plug connector 586, and again primarily with reference to FIG. 42A, the plug connector 586 includes a lateral portion 620 in the form of a housing extending outwardly from the side panel 610. Integral with and extending perpendicularly to the lateral portion 620 is a right angled section 622. Correspondingly, extending outwardly from a terminating end of the right angled section 622 is a modular plug male terminal set housing 624. The housing 624 has a cross sectional configuration as shown primarily in FIGS. 41 and 42A. As further shown in these drawings, the housing 624 includes a first side wall 625 and an opposing second side wall 627. The first side wall 625 has an elongated C-shaped configuration, with a height X as shown in FIG. 41. Correspondingly, the second side wall 627 has a “reversed C-shaped” (as viewed in FIG. 41) configuration, with a height Y, which is less than height X. The side walls 635, 627 are sized and configured so that the housing of a connector with a “reversed” configuration of the side walls 625, 627 would “mate” with the housing 624 shown in FIG. 41.

In addition to the lid 582, inner panel 584 and plug connector 586, the modular plug 576 further includes a series of three male communication blade terminals, identified as blade terminals 626, 628 and 630. Attached to each of the three blade terminals 626, 628 and 630 is a crimp connector 632. Each crimp connector 632 is coupled to a different one of the communications cables 572 (not shown in FIG. 42A). With this coupling connection, the crimp connectors 632 will cause the communication cables 572 to each be conductively connected to one of the communications blade terminals 626, 628 or 630. For example, the communications blade terminal 626 may be conductively connected to the communications cable 572 previously designated as CC1. Correspondingly, male blade terminal 628 may be conductively connected to cable CC2. Male blade terminal 630 may be connected to cable CCR. The communications male blade set 588 may then be appropriately positioned within the modular plug 576 so that the terminating ends of the communications blades 626, 628 and 630 extend outwardly and into the modular plug male terminal set housing 624. With this assembly, the portion of the housing 624 which is identified as communications terminal set 646 will have the blades extending therefrom, and connected to differing ones of the communications cables 572.

In addition to the communications cable male blade set 588, the modular plug 576 also includes the AC power male blade set 590. As shown primarily in FIG. 42A, the AC power male blade set 590 has a configuration substantially similar to that of the communications male blade set 588. The male blade set 590 includes a series of terminal blades, identified as blades 634, 636, 638, 640 and 642. Extending laterally outward from opposing sides of the base of each blade is a pair of crimp connectors 644. The crimp connectors 644 will be utilized to electrically and conductively interconnect each of the individual blades of the male blade set 590 to different ones of the AC power cables 574. For purposes of clarity, neither the communication cables 572 nor the AC power cables 574 are illustrated in FIG. 42A. More specifically, the male blade terminal 634 will be conductively connected through its pair of crimp connectors 644 to AC power cable AC1. Correspondingly, blade 636 will be conductively connected to AC power cable AC2. Blade 638 will be conductively connected to AC power cable AC3. Blade 640 will be connected to AC power cable ACN, while blade 642 will be connected to AC power cable ACG.

For assembly of the modular plug 576, the communications male blade set 588 can be inserted and secured by any suitable means to the inner panel 584. This assembly occurs so that the individual blades 626, 628 and 630 of the communication male blade set 588 extend into the right-angled section 622 of the plug connector 586. These blades extend into the upper three terminal openings of the plug connector 586, identified in FIG. 42A as the communications terminal set 646. Correspondingly, the AC power male blade set 590 is assembled with the inner panel 584 so that the individual blades of the set 590 extend outwardly into the lower five terminal openings of the modular plug male terminal set housing 624, identified as AC power terminal set 648, again illustrated in FIG. 42A. As shown primarily in FIG. 41, the male terminal set housing 624 can include a terminal set divider 649 extending therethrough, for purposes of isolation of the communication male blade set 588 from the AC power male blade set 590 when assembled into the housing 624. The lid 582 can then be coupled to the inner panel 584, with the blade sets 588 and 590 secured to the inside of the lid 582 by any suitable means. To secure the lid 582 to the inner panel 584, the upper tabs 596 of the lid 582 are secured within the slots 606 of the inner panel 584. Correspondingly, the tabs 608 at the upper portion of the inner panel 584 are secured under the top edge 594 of the lid 582. Lower tabs 600 of the lid 582 are secured within slots (not shown) on the lower edge 607 of the inner panel 584.

As illustrated primarily in FIGS. 35, 36, 40 and 42, the right hand recessed panel 612 of the inner panel 584 and the left hand recessed panel 614 of the panel 584 are positioned so that they are received “behind” adjacent ones of the principal electrical dividers 554. With this positioning, rivets can be secured through the through holes 566 (of the electrical divider 554), 616 (of the inner panel 584), 602 (of the lid 582), and holes 544 in the power assembly cover 542. As also earlier stated, during assembly, the AC power cables 574 will be extended through crimp connectors 644 of the AC power male blade set 590. Correspondingly, communication cables 572 will be extended through the crimp connectors 632 of the communications male blade set 588. In accordance with the foregoing, the individual modular plugs 576 can be assembled into the modular plug assembly 130.

In addition to the modular plugs 576 which are spaced apart and used along the sections 540 of the modular plug assembly 130, a somewhat modified plug is utilized at one end of each elongated modular plug assembly section 540. This plug is identified as a distribution plug 650, and is illustrated in an exploded view in FIG. 42B. The distribution plug 650 is also illustrated in an assembled format within a section 540 of the modular plug assembly 130 in FIGS. 35, 38 and 39. As described subsequently herein, the distribution plug 650 will be utilized, in combination with the flexible connector assembly 138, to electrically couple together adjacent sections 540 of the modular plug assembly 130. As earlier stated, the distribution plug 650 is substantially similar to the previously described modular plug 576. Accordingly, the distribution plug 650 will not be described in substantial detail. Instead, with reference to FIG. 42B, only the main components of the plug 650 will be described. Assembly of these components occurs in the same manner as assembly of similar components for the modular plugs 576.

The distribution plug 650 includes a lid 652 (substantially corresponding to the lid 582 of the plug 576). For purposes of interconnection of terminal components to communications cables 572 and AC power cables 574, the distribution plug 650 also includes a communications male blade set 658, and an AC power male blade set 660. Connected to or otherwise integral with the inner panel 654 is a plug connector 656, substantially corresponding to the plug connector 586 of the modular plug 576. An angled section 662 extends in a substantially parallel alignment with the inner panel 654. Correspondingly, extending outwardly from a terminating end of the angled section 662 is a distribution plug male terminal set housing 664.

For assembly of the distribution plug 650, the communications male blade set 658 can be inserted and secured by any suitable means to an inner panel 654 (corresponding to the inner panel 584 of modular plug 576). This assembly occurs so that the individual blades of the communication male blade set 658 extend into the angled section 662 of the plug connector 656. These blades extend into the upper three terminal openings of the plug connector 656, identified in FIG. 42B as the communications terminal set 663. Correspondingly, the AC power male blade set 660 which again comprises five blades, each connected to a different one of the AC power cables 574, is assembled within the inner panel 654 so that the individual blades of the set 660 extend outwardly into the lower five terminal openings of the distribution plug male terminal set housing 664. These lower five terminal openings are identified in FIG. 42B as the AC power terminal set 665. The lid 652 can then be coupled to the inner panel 654, with the blade sets 658 and 660 secured to the inside of the lid 652 by any suitable means. The lid 652 can then be secured to the inner panel 654, in a manner similar to the connection of the lid 582 to the inner panel 584 of the modular plug 576. The distribution plug 650 can then be secured to the end of a section 540 of the modular plug assembly 130, adjacent and attached to the left hand electrical divider 580 associated with the particular section 540.

As described in subsequent paragraphs herein, the distribution plug 650 will be utilized to secure the corresponding section 540 of the modular plug assembly 130 to one end of a flexible connector assembly 138. For this purpose, the distribution plug male terminal housing 664 has the configuration shown primarily in FIG. 42B. More specifically, the distribution housing 664 includes, like the modular plug housing 624, a first side wall 667, and an opposing second side wall 669. The first side wall 667 has an elongated C-shaped configuration, with a height X as shown in FIG. 42B. It should be noted that this configuration and height corresponds to the first side wall 625 of the plug connector 586 of the modular plug 576 as shown in FIGS. 41 and 42A. Correspondingly, the second side wall 669 has a “reversed C-shaped” (as viewed in FIG. 42B) configuration, with a height Y, which is less than height X. It should be noted that the second side wall 669 corresponds in structure and size to the second side wall 627 of the modular plug 576. With the entirety of the aforedescribed sizing and configuration of the side walls 667, 669 of the housing 664, if the modular plug housing 624 of the modular plug 576 (as shown in FIG. 42A) is brought into engagement with the distribution plug housing 664 of the distribution plug 650 (as viewed in FIG. 42B), the housings will, in fact, “mate.” Of course, both plugs 576 and 650 are carrying male terminals. In effect, the distribution plug housing 664 is essentially identical to a “reversal” of the modular plug housing 624. This concept becomes relevant in the use of the flexible connector assembly 138 in connecting together adjacent sections 540 of the modular plug assembly 130, in a manner such that the flexible connector assembly 138 is “unidirectional” and cannot be electrically engaged with the sections 540 in an incorrect manner. This concept is advantageous in providing for safety, proper assembly and conformance with governmental and institutional codes and regulations.

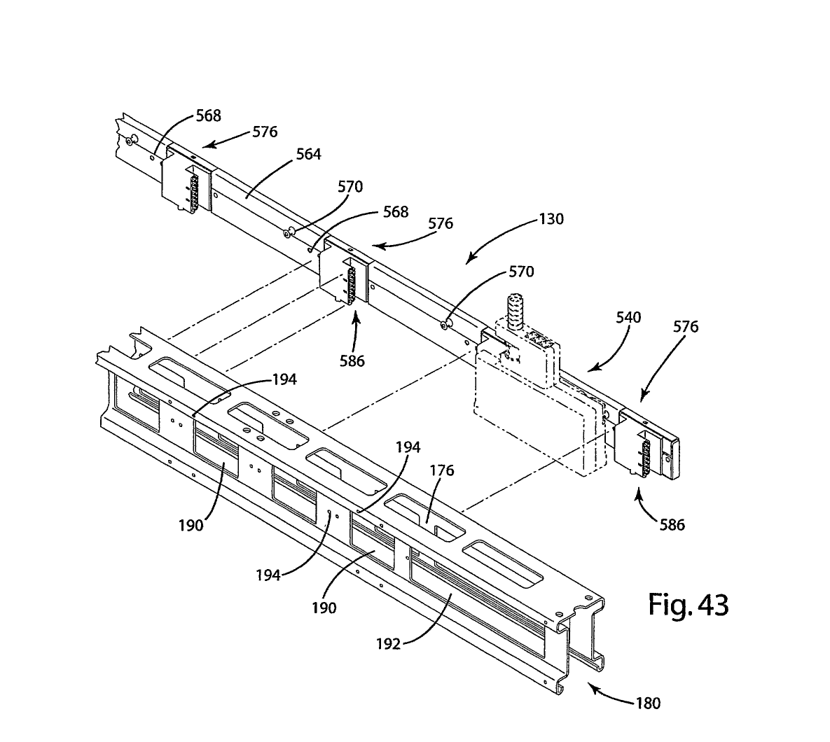

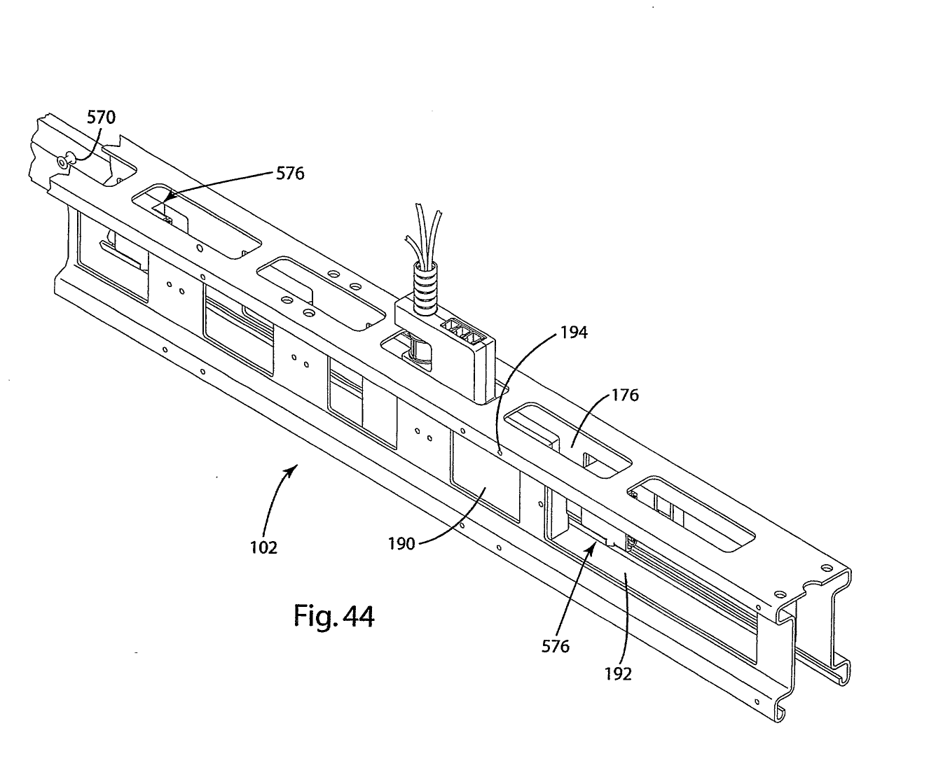

In accordance with the invention, the modular plug assembly 130, comprising the individual sections 540, is secured to the main perforated structural channel rails 102, as primarily illustrated in FIGS. 43 and 44. With reference to these drawings, and also with reference to FIGS. 2 and 3, a section 540 of the modular plug assembly 130 is moved toward the side of a main perforated structural channel rail 102. The section 540 is assembled by positioning the plug assembly section 540 into the recessed areas of one of the side panels 180 of the structural channel rail 102. The modular plugs 576 are appropriately spaced apart so that they are aligned with the side plug assembly apertures 190 in the structural channel rail 102. With this alignment, the plug connectors 586 will be assembled through the side plug assembly apertures 190, so that they are secured within the spatial area formed between opposing side panels 180 (i.e. the left side panel 182 and the right side panel 184 as shown in FIGS. 2 and 3). The first modular plug 576 along a section 540 of the modular plug assembly 130 will be fitted into one of the elongated side-end apertures 192 of the rail 102. This elongated configuration of the aperture 192 permits sufficient room for coupling of this end modular plug 576 to a power box connector 136 as described in subsequent paragraphs herein. With this positioning of the section 540 of the modular plug assembly 130 relative to the corresponding section of the main structural channel rail 102, the two components can be secured together through self tapping screws (not shown) or similar means extending through holes 568 of the plug assembly 130 and holes 194 within the structural channel rail 102. It will be apparent that other types of connecting means may also be utilized for coupling the section 540 of the modular plug assembly 130 to the structural channel rail 102.

With the foregoing configuration, the modular plugs 586 are positioned so that the plug connectors 586 of the modular plugs 576 are positioned within the inner spatial area of the structural channel rail 102. Also, it is apparent that sections 540 of the modular plug assembly 130 can be positioned with in the inner spatial area of the structural channel rail 102 through both side panels 180 of the structural channel rail 102. In this manner, a pair of sections 540 of the modular plug assembly 130 can be within the spatial interior of the structural channel rail 102. Also, although not shown in FIGS. 43 or 44, a distribution plug 650 (previously described with respect to FIG. 42B) will be positioned at the opposing end (not shown) of the end of the section 540 of the plug assembly 130 shown in FIG. 43. In accordance with the foregoing, this assembly now provides for a length of the structural channel rail 102 to have electrical terminals accessible at various positions along the structural channel rail 102, with these terminals electrically interconnected to the communication cables 572 and the AC power cables 574. Communication signals and AC power can therefore be distributed throughout the entirety of the electrical network 530, and the associated structural grid 172. With respect to both the modular plugs 576 and the distribution plugs 650, it may be appropriate to include “end caps” (not shown) so as to cover the housing ends of these plugs when not in use. Also, for purposes of aesthetics and safety, it may be worthwhile to include end caps at the ends of the sections 540 of the modular plug assembly 130.

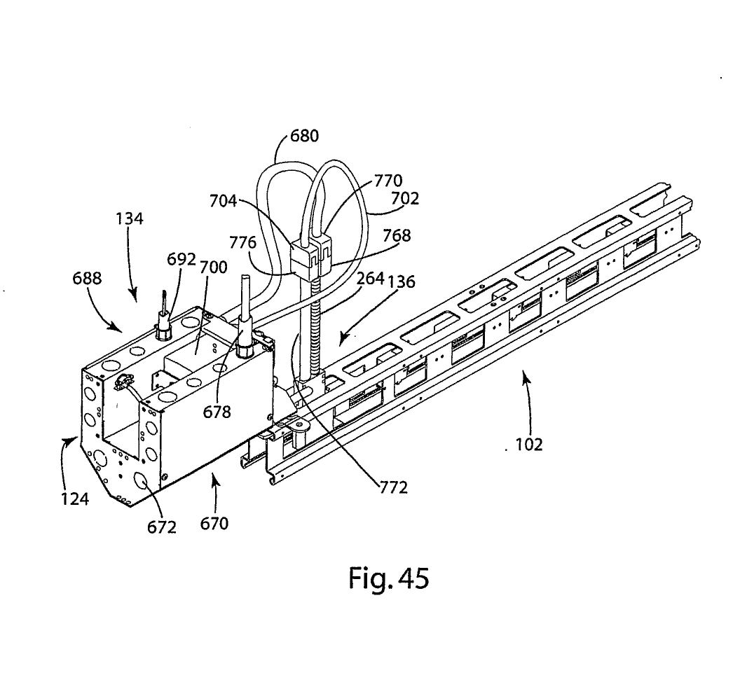

To this point in the description, various mechanical and electrical aspects of the structural channel system 100 have been described, including the modular plug assembly 130, carrying communication cables 572 and AC power cables 574. References were previously made to the AC power cables 574 and having the capability of carrying three separate AC circuits. References have also been made to components such as wireways 122, through which other AC power cables (such as 277 volt AC cables) may be carried. Cableways 120 have also been described, with the capability of carrying other types of electrical cables, such as low voltage DC power cables. In addition, reference has been made to the concept that the communications cables 572 may also have the capability of carrying low voltage DC power. Although the previously described components of the structural channel system 100 function to carry and transfer AC and DC power, and communications, throughout the entirety of the channel system 100, means have not yet been described as to how power is initially applied to the AC power cables 574, and may be applied to the communications cables 572. For this purpose, the components of the structural channel system 100 include means for receiving building electrical power from the building structure and, potentially, generating DC power from building power. This means for receiving, generating and distributing power may include a power entry box, such as the power entry box 134 primarily illustrated in FIGS. 45-48.

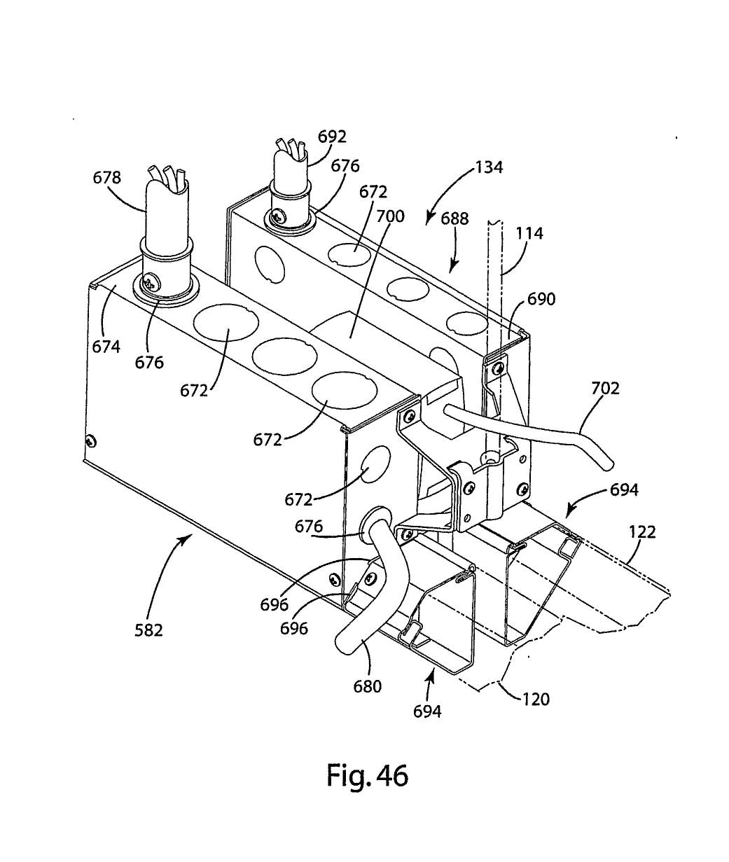

Prior to describing the power entry box 134, it should be noted that the inventors have determined that a potentially preferable structure of a power entry box may be utilized in accordance with the invention. For this reason, a second power entry box 134A (and associated power box connector 136A) is described in subsequent paragraphs herein with respect to FIGS. 82-85. However, it should be emphasized that either of the power entry boxes 134 or 134A, or other means for receiving, generating and distributing power throughout the network 530, may be utilized without departing from the principal concepts of the invention. Referring first to the power entry box 134, and with reference to FIG. 46, the power entry box 134 is adapted to receive AC power from sources external to the structural channel system 100. These sources may be in the form of conventional building power or, alternatively, any other type of power source sufficient to meet the power requirements of the structural channel system 100 and application devices interconnected thereto. Further, power sources of various amplitudes and wattage may be utilized. As an example, the power entry box 134 is illustrated as receiving both 120 volt AC power and 277 volt AC power from the building.

More specifically, the power entry box 134 shown in FIG. 46 comprises a 120 volt AC side block 670 having a substantially rectangular cross section. Knockouts 672 are provided in an upper surface 674. In the particular embodiment shown in FIG. 46, a cable nut 676 is secured to one of the knockouts 672 and to an incoming 120 volt AC cable 678. The cable nut 676 or other components associated therewith may provide strain relief for the incoming cable 678 and other power cables associated with the power entry box 134. Although not specifically shown in any of the drawings, the wires of the incoming 120 volt AC cable 678 may be directly or indirectly connected and received through an outgoing AC cable 680. Connected at the terminal end of the AC cable 680 is a standard 120 volt AC universal connector 682. The AC connector 682 is adapted to transmit power to a power box connector, such as the power box connector 136 illustrated in FIG. 45. Power box connector 136 will be described in subsequent paragraphs herein. In the configuration shown in FIG. 45, the power entry box 134 is mounted above the main structural channel rail 102, as also described in subsequent paragraphs herein. The 120 volt AC connector 682 is coupled to a corresponding AC connector 684. Connector 684 is connected to the terminating end of the AC power entry conduit 686 which, in turn, is coupled to the power box connector 136.

Referring back to FIG. 46, the power entry box 134 may also include a 277 volt AC side block 688, having a substantially rectangular cross sectional configuration. An upper surface 690 of the side block 688 includes a series of knockouts 672. Connected to one of the knockouts 672 is a cable nut 676. Also coupled to the cable nut 676 and extending into the side block 688 is a 277 volt AC cable 692. As previously described herein, the structural channel system 100 includes wireways 122. As also previously described, AC power conduits or cables 164 can run through the wireways 122. These conduit or cables 164 may carry relatively high voltage, such as 277 volt power, and thus may be connected, directly or indirectly, to the wires within the 277 volt AC cables 692. As previously described herein with respect to the wireways 122, various codes and regulations may require that cables 164 extending through the wireways 122 must be isolated or otherwise shielded at all times. For this reason, individual lengths of wireways 122 are preferably coupled together through the use of joiners 492, previously described with respect to FIGS. 33 and 34.

For purposes of maintaining such shielding adjacent the power entry box 134, the power entry box 134 can include a pair of interconnected wireway segments 694. The wireway segments 694 can be formed with the same peripheral or cross sectional configuration as the wireways 122 previously described herein. In fact, each of the wireway segments 694 can be characterized as an extremely short length of a wireway 122. Accordingly, the individual parts of the wireway segments 694 will not be described herein, since they substantially conform to individual parts of wireways 122 previously described herein. However, for purposes of connecting the wireway segments 694 to the front portion of the power entry box 134, brackets 696 (partially shown in FIGS. 46 and 47) can be integrally formed at one end of each of the wireway segments 694. Screws or other similar connecting means (not shown) may then be utilized to connect the brackets 696 to the front cover of the power entry module 134, for purposes of securing the wireway segments 694 to the power entry box 134. To then connect one of the wireway segments 694 to a wireway 122 (depending upon the particular direction the power entry box 134 is facing along the main structural channel rail 102), a joiner 492 as previously described herein can be utilized. Further, it should be noted that the power entry box 134 includes a substantial number of knockouts 672. These knockouts 672 can be utilized not only for conduit or cables connected to incoming power through cables 678 and 692, but they can also be utilized to permit cables (such as cables 164) to extend completely through the power entry box 134. For example, cables associated with the cableways 120 may not be interconnected to any wiring or cabling associated with the power entry box 134, and may merely need to extend through the lower portion of the power entry box 134.

In addition to the foregoing, the power entry box 134 may also include a network circuit 700, situated between the 120 volt AC power side block 582 and the 277 volt AC power side block 688. The network circuit 700 may be utilized to provide various functions associated with operation of the communications portion of the electrical network 530. The network circuit 700 may include a number of components associated with the electrical network 530 and features associated with generation and transmission of communication signals. For example, each network circuit 700 may include transformer components, for purposes of utilizing AC power to generate relatively low voltage DC power. Also, the network circuit 700 can include repeater components for purposes of performing signal enhancement and other related functions. Corresponding transformer and repeater functions will be describe din greater detail herein, with respect to the board assemblies 826 associated with the connector modules 140, 142 and 144. Extending out of the housing which encloses the network circuit 700 is a pair of connector ports 909. The connector ports 909 may be in the form of conventional RJ11 ports. As will be explained subsequently herein with respect to the alternative power entry box 134A (and FIG. 85), the connector ports 909, in combination with patch cords (not shown), may be utilized to provide for daisy chaining of the electrical communications network 530 through the power entry boxes. Also, and again as subsequently described herein with respect to the alternative power entry box 134A, patch cords in the form of “bus end” patch cords may be used with the connector ports 909 of first and last power entry boxes within a chain.

As earlier mentioned, the communications portion of the network 530 utilizes communication signals on cables CC1, CC2 and CCR. Further, in one embodiment, the communication signals can be carried on cables CC1 and CC2 in a “differential” configuration, while cable CCR carries a return signal. With the use of differential signal configurations, and as subsequently described herein, individual low voltage DC power supplies or transformers will be associated with connector modules and other elements associated with the network 530, where DC power is required.

However, as an alternative to having these individual DC power supplies associated with the connector modules, the network circuit 700 could include conventional AC/DC converter circuitry. Such converter circuitry could be adapted to receive AC power tapped off the 120 volt AC cables 678. The AC power could then be converted to low voltage DC power and applied as an output of the converter to a conventional DC cable 702. The DC cable 702 could be conventionally designed and terminate in a conventional DC connector 704. Such an alternative is still within the principal concepts of the invention as embodied within the structural channel system 100. A configuration utilizing AC/DC converters within power entry boxes is disclosed in United States Provisional Patent Application entitled “POWER AND COMMUNICATIONS DISTRIBUTION SYSTEM USING SPLIT BUS RAIL STRUCTURE” filed Jul. 30, 2004, and incorporated by reference herein.

In the configuration of the power entry box 134 illustrated in FIGS. 45-48, the cable 702 is shown as extending out of the housing comprising the network circuit 700, and will be characterized herein as the power box communications cable 702. As shown in FIG. 45, the power box communications cables 702 terminates in a conventional DC or digital connector 704.

The conventional connector 704 is directly connected to a connector 776 and connector cable 772 associated with the power box connector 136. These components will be described in subsequent paragraphs herein. As earlier described, the power entry box 134 is adapted to be positioned above a length of the main structural channel rail 102, as primarily illustrated in FIG. 45. The power entry box 134 essentially “rests” on the upper portion of the main rail 102. To secure the power entry box 134 in an appropriate position, the box 134 is connected to the grid 172 through a connector 706, as primarily shown in FIGS. 46 and 47. In these illustrations, FIG. 47 is somewhat of an exploded view of the connector 706. With reference thereto, the connector 706 includes a support brace 708 having a size and configuration as illustrated in the drawings. The support brace 708 includes a pair of spaced apart upper legs 710 which angle upwardly and terminate in feet 712. The support brace 708 is connected at its upper end to the side blocks 670 and 688 through screws 714 extending through holes in the feet 712 and in the side blocks 670, 688. As also shown primarily in FIG. 47, the upper legs 710 include a pair of spaced apart slots 716. Integral with the upper legs 710 and extending downwardly therefrom is a central portion 718. Integral with the lower edge of the central portion 718 are a pair of spaced apart lower legs 720, only one of which is illustrated in FIG. 47. As with the upper legs 710, the lower legs 720 also include feet 712. Screws 714 extend through threaded holes (not shown) in the feet 712 of the lower legs 720, and connect to the front walls of the side blocks 670 and 688.

Returning to the central portion 718, a series of four threaded holes 722 extend therethrough in a spaced apart relationship. The central portion 718 also includes a vertically disposed groove 724 extending down the center of the central portion 718. The connector 706 also includes a bracket 726, primarily shown in FIG. 47. The bracket 726 has a series of four threaded holes 728. A pair of spaced apart upper lips 730, having a downwardly curved configuration, extend upwardly from the bracket 726. The bracket 726 also includes a vertically disposed groove 732 positioned in the center portion of the bracket 726.

To couple the power entry box 134 to the structural grid 172, the power entry box 134 can be positioned above a corresponding main structural channel rail 102 as primarily shown in FIG. 45. With reference to FIG. 47, the power entry box 134 can be positioned so that one of the threaded support rods 114 is partially “captured” within the groove 724 of the support brace 708. When the appropriate positioning is achieved, the bracket 726 can be moved into alignment with the central portion 718 of the support brace 708. In this aligned position, the threaded support rod 114 is also captured by the groove 732 and the bracket 726. Also with this position, the threaded holes 722 in the central portion 718 will be in alignment with the threaded holes 728 in the bracket 726. Also, to readily secure the bracket 726 to the support brace 708, the upper lips 730 of the bracket 726 are captured within the slots 716 of the brace 708. Correspondingly, screws 734 are threadably received within the through holes 728 and through holes 722 of the bracket 726 and support brace 708, respectively. In this manner, the threaded support rod 114 is securely captured within the grooves 724 and 732. The supported positioning of the power entry box 134 is illustrated in FIG. 45.

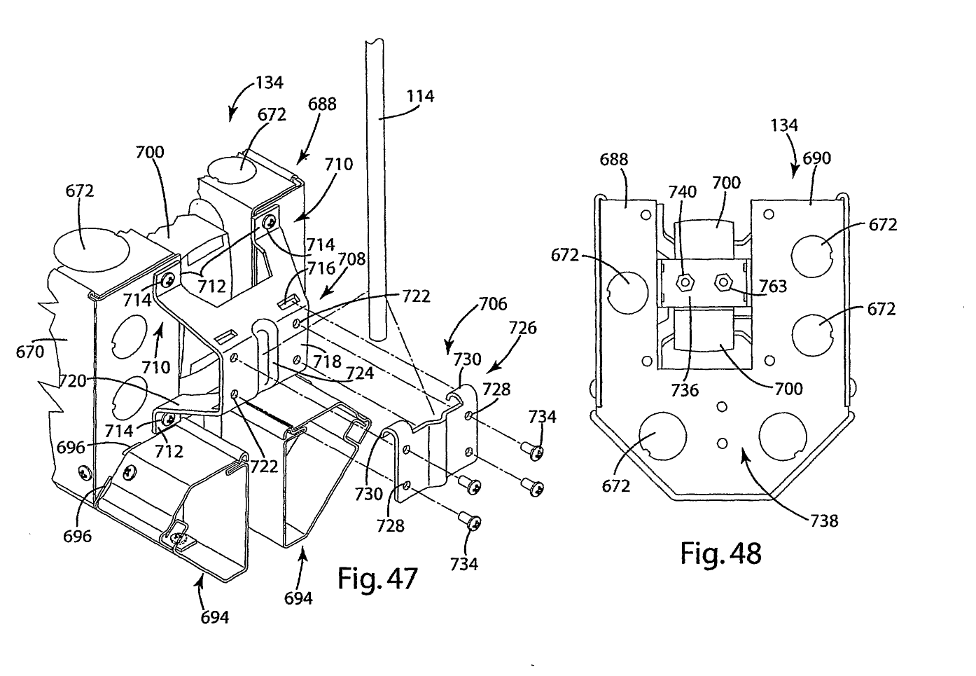

With respect to interconnections of other elements of the power entry box 134, attention is directed to FIG. 48, which illustrates a rear view of the power entry box 134. A rear wall 738 of the power entry box 134 may include knockouts 672, for purposes of extending cables and conduit therethrough. Also, for purposes of securing the network circuit 700, a rear mounted cross bracket 736 can be integral with or otherwise connected to sides of the side blocks 670 and 688. This cross bracket 736 can then be secured to the rear portion of the network circuit 700, through the use of bolt and hex nut combinations 740 or similar connecting means.

In accordance with the foregoing, a component of the structural channel system 100 has been described which serves to receive power from sources external to the structural channel system 100, and apply AC power to the AC power cables 574. Correspondingly, the power entry box 134 can include circuitry for communication signals applied through the electrical network 530 on communication cables CC1, CC2 and CCR. Also, as described subsequently herein with respect to an alternative embodiment of a power entry box 134A, the power entry boxes can be utilized for purposes of “daisy chaining” so as to provide for interconnection of communication signal paths throughout the network 530. In the particular embodiment of the structural channel system 100 described herein, the AC power and communication signals from the power entry box 134 are applied to the appropriate cabling through a power box connector 136, as subsequently described herein.

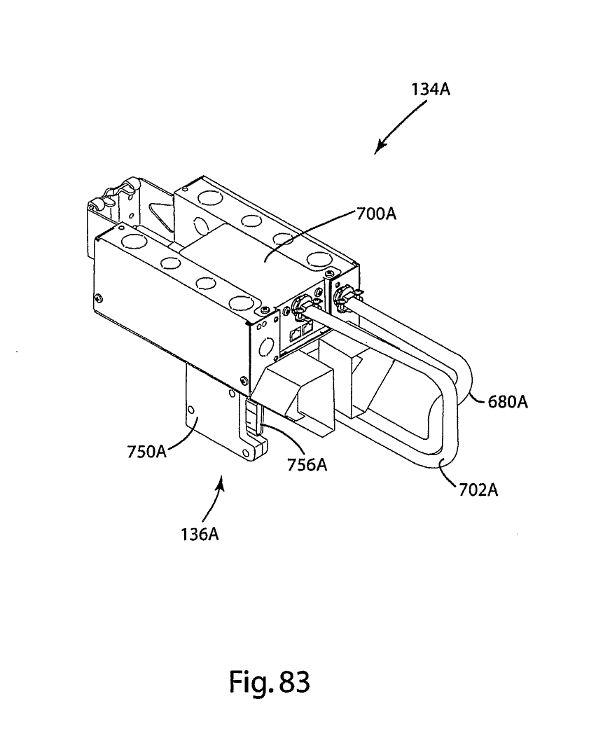

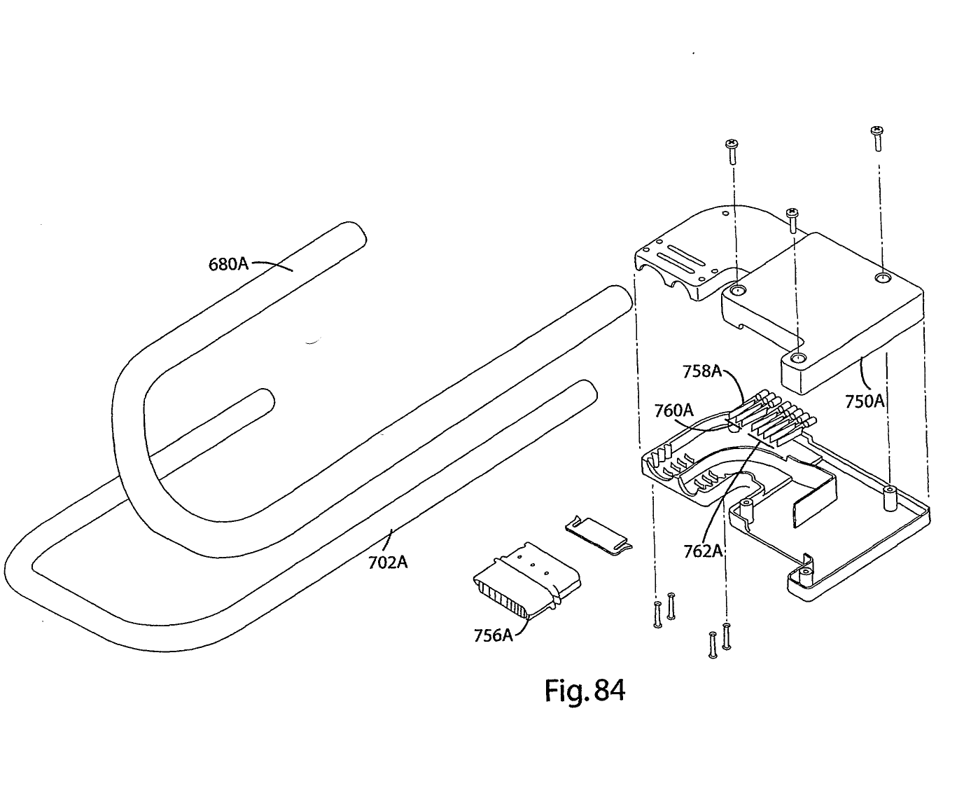

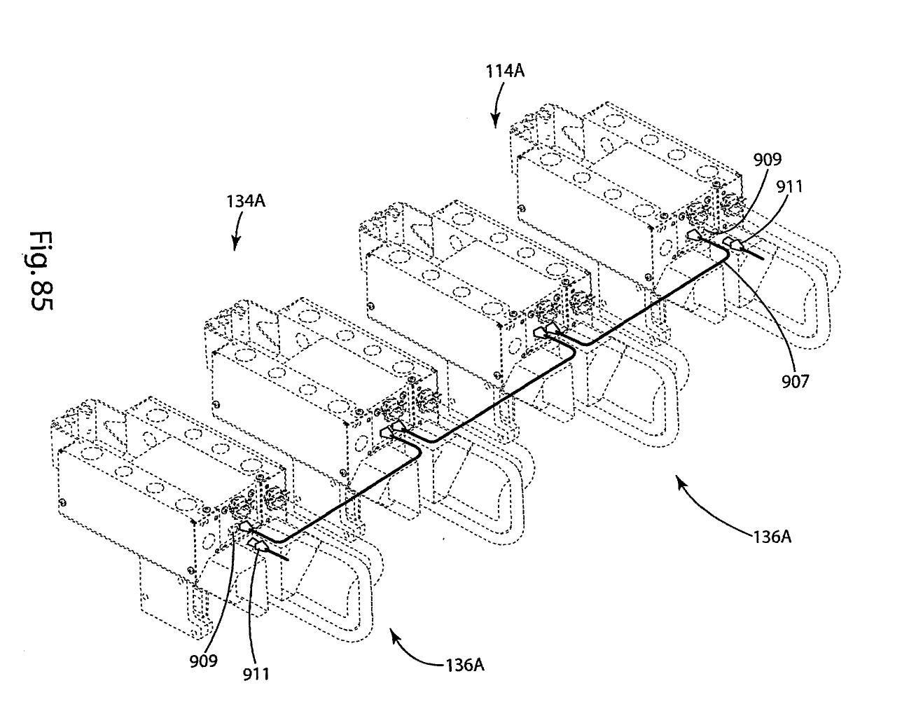

More specifically, the power entry box 134 is electrically coupled to the power box connector 136. The power box connector 136 provides a means for receiving AC power from the building through the power entry box 134, and applying the AC power to an elongated plug assembly section 540 of the modular power assembly 130. The power box connector 136 also provides means for connecting the network circuit 700 from the power entry box 134 to the communication cables CC1, CC2 and CCR associated with an elongated plug assembly section 540 of the modular power assembly 130. Although the power box connector 136 represents one embodiment of a means for providing the foregoing functions, it will be apparent that other types of power box connectors may be utilized, without departing from the principal novel concepts of the invention. In fact, an alternative and somewhat preferred embodiment of a power box connector which may be utilized in accordance with the invention is subsequently described herein and illustrated as power box connector 134A in FIGS. 83 and 84.

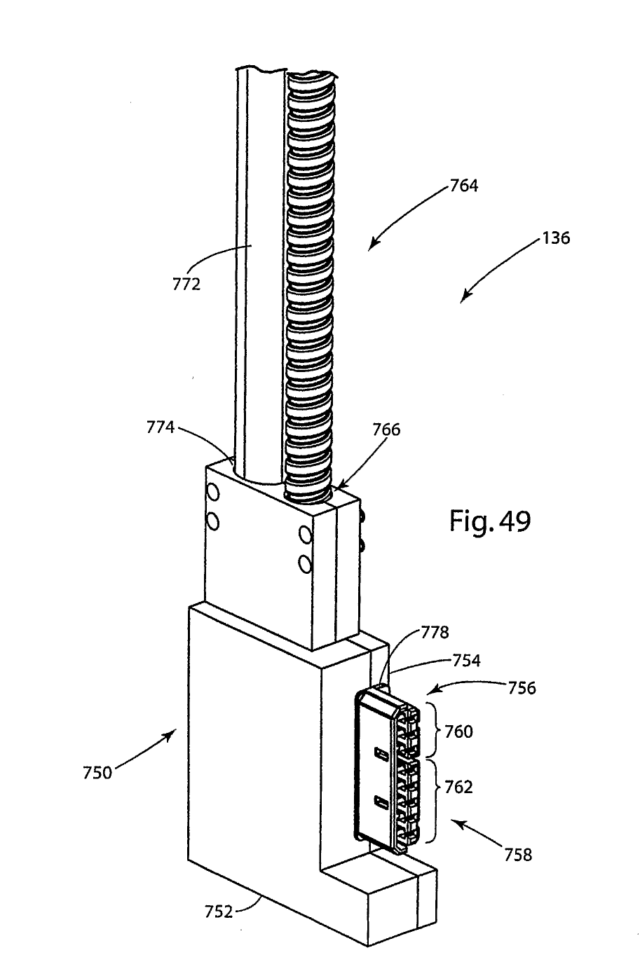

Turning primarily to FIGS. 45 and 49, and first with reference to FIG. 49, the power box connector 136 comprises a base housing 750, which will be located within a main structural rail 102 and adjacent a plug assembly section 540 when installed. The base housing 750 includes a relatively conventional main body 752, secured to an outer cover 754. Extending outwardly from a slot 778 formed within one end of the main body 752 is a connector housing 756, again as primarily shown in FIG. 49. The connector housing 756 is formed such that it includes a first side wall 757 and a second side wall 759. The first side wall 757, as viewed in FIG. 49, has an elongated C-shaped cross-sectional configuration, with a height X. The second side wall 759, also as viewed in FIG. 49, has a “reverse” elongated C-shaped configuration, with a shorter height Y. The heights X and Y of the first and second side walls 757, 759, respectively, correspond to the heights of the first side wall 625 and second side wall 627 previously described herein with respect to the modular plugs 576 of the sections 540 of the modular plug assembly 130. Accordingly, with these side walls 757, 759, the connector housing 756 is adapted to mate with a corresponding modular plug male terminal set housing 624 (FIG. 42A) of a modular plug 576. Extending into the connector housing 756 from the interior of the base housing 750 are a set of eight female terminals 758. The female terminals 758 include a set of three terminals, identified as a communications cable female terminal set 760. The remaining five of the female terminals 758 are identified as AC power female terminal set 762. When the power box connector 136 is connected to a modular plug 576, the individual female terminals 758 of the female terminal set 760 will be electrically connected to individual terminals of the communications cable terminal set 646 of a modular plug 576. Therefore, the individual terminals 758 of the terminal set 760 will be electrically connected to communication cables CC1, CC2 and CCR within the modular plug assembly 130. The terminals 758 of the female terminal set 760 are connected, by any simple means, to individual wires or cables (not shown) extending into the interior of the power box connector 136 from the communications conduit 772. The communications conduit 772 is coupled, at aperture 774, to the base housing 750 of the connector 136. The wires or cables extending through communications conduit 772, as shown in FIG. 45, extend upwardly through a conventional communications connector 776. The connector 776 is connected, in turn, to the mating communications connector 704. The communications connector 704 is connected to the power box communications cable 702 which, in turn, is connected to the network circuit 700. In this manner, signals from the network circuit 700 may be transferred to and received from the communications cables CC1, CC2 and CCR.

With respect to AC power, the AC power female terminal set 762 will, when the power box connector 136 is coupled to a modular plug 576, provide for electrical connection from the power box connector 136 to the individual AC power cables AC1, AC2, AC3, and ACG. This AC power female terminal set 762 is connected, within the interior of the base housing 750, to electrical wires or cables extending out of the base housing 750 through the AC power entry conduit 686. The AC power entry conduit 686 is coupled to the base housing 750 through the aperture 766. As shown in FIG. 45, the AC power entry conduit 686 is connected, at a terminating end, to a conventional AC connector 684. The AC connector 684 mates with the corresponding AC power entry box connector 682. The AC power entry box connector 682 is coupled to a terminating end of the outgoing AC cable 680 from the power entry box 134. As earlier described, the AC cable 680 carries, in this particular embodiment, three AC circuits from the building power. With the AC power female terminal set 762 appropriately connected to a corresponding AC power male terminal set 648 associated with a modular plug 576 of the modular plug assembly 130, the three-circuit AC building power is then applied to AC power cables AC1, AC2, AC3, ACN and ACG through the power entry box 134 and power box connector 136.

With respect to connection to a specific end of a section of the main structural channel rail 102 where the power entry box 134 will be connected to the modular plug assembly 130 through the power box connector 136, the interconnections should be such that the power box connector 136 is inserted upwardly from the bottom of a section of the structural channel rail 102 at the end where the elongated side-end apertures 192 exist within the side panels 180 of the rail 102 (see FIG. 43 for the relative location of the apertures 192 in the structural channel rail 102). Also, with respect to the assembly of a section 540 of the modular plug assembly 130 to the structural channel rail 102, this will be the end of the section 540 where the particular plug connector 586 at the end of the section 540 is in the same directional alignment as the plug connectors 586 of the other modular plugs 576 of section 540. That is, the interconnection would typically not be at the end of a section 540 of the modular plug assembly 130 having the distribution plug 650 (as shown, for example, in FIGS. 38 and 39).

The foregoing has explained functions and components associated with the structural channel system 100 which provide for transmitting building power to AC power cables 574 associated with the modular plug assemblies 130, and for providing means to couple communications signals through power entry boxes 134, power box connectors 136, modular plugs 576 and communication cables 572. Still further, as an alternative, the foregoing components could utilize an AC/DC converter with the power entry box 134, for purposes of applying DC power through certain of the communication cables 572.

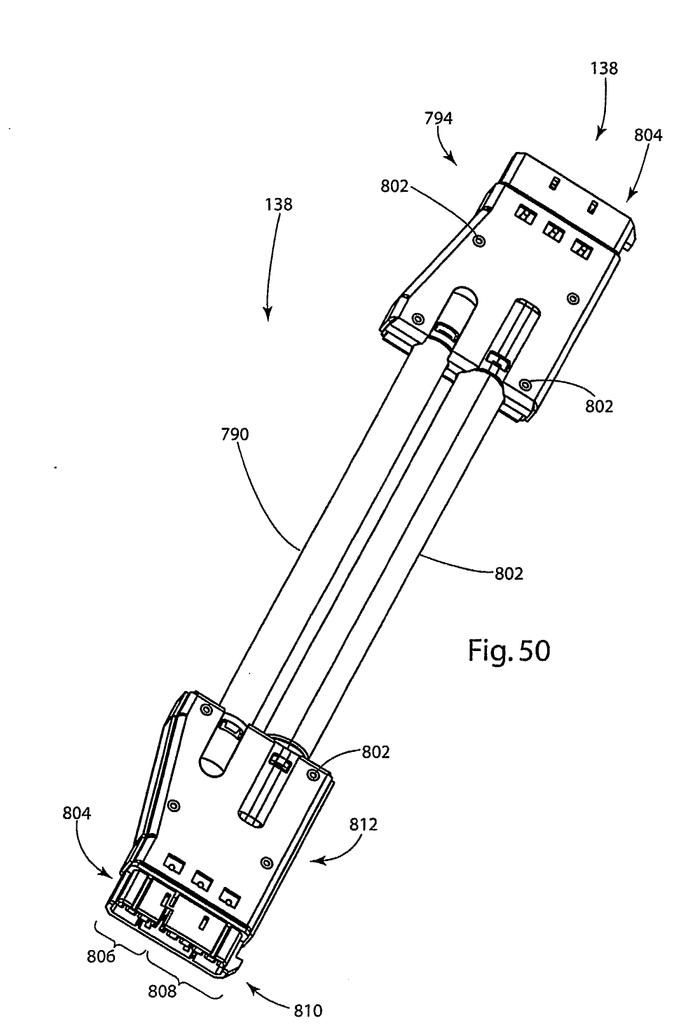

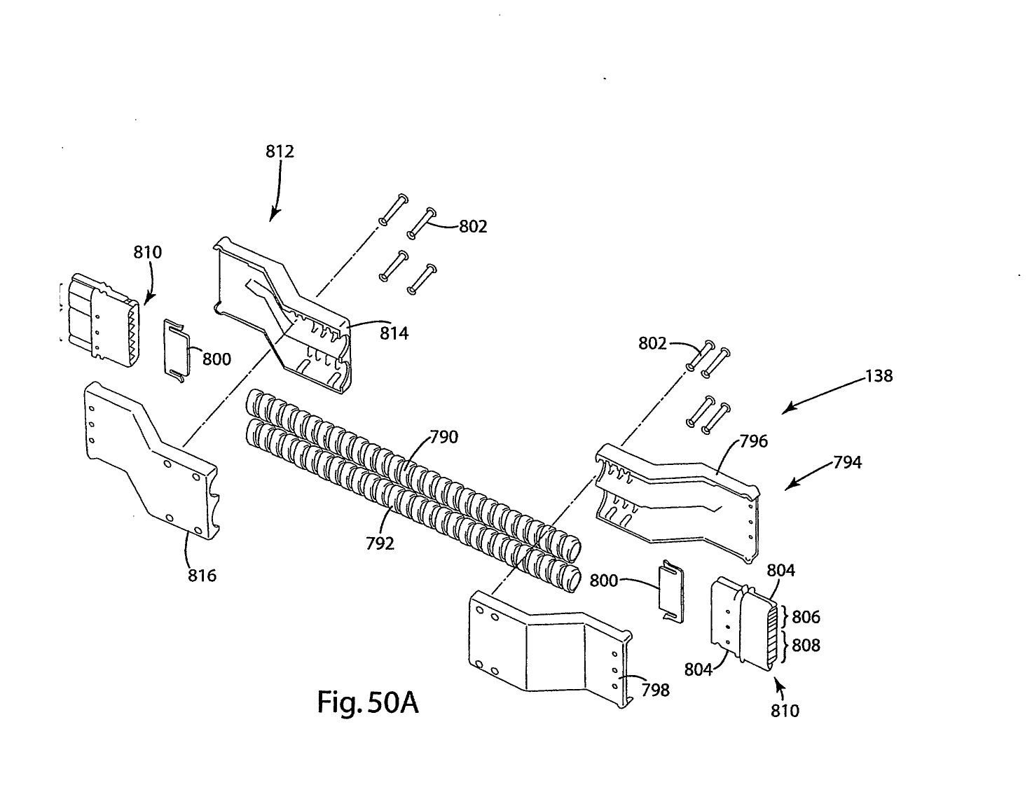

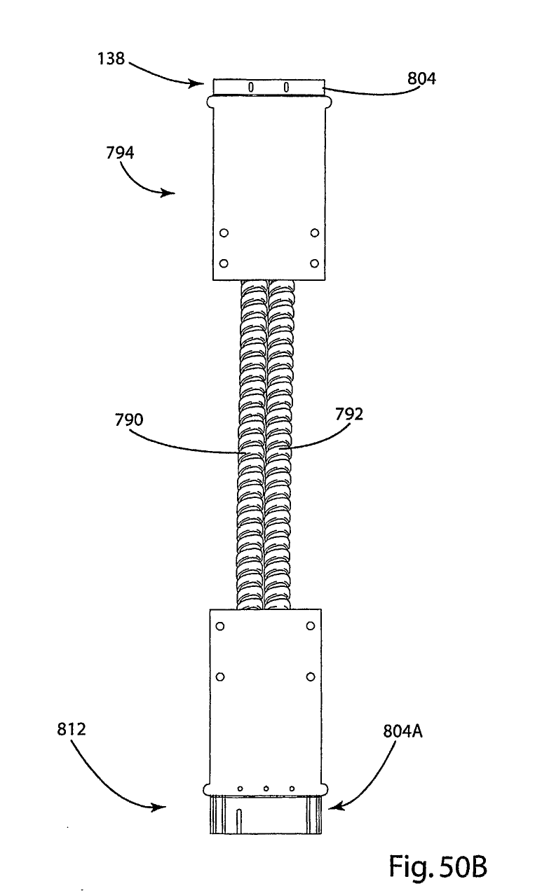

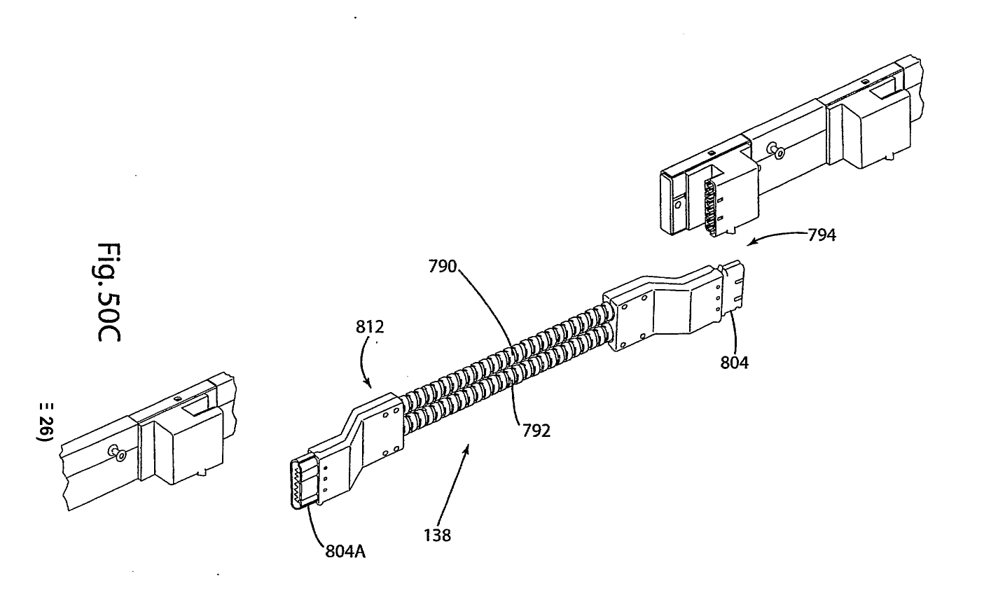

In accordance with the foregoing, the components described herein function so as to provide power and communication signals to and through one section 540 of the modular plug assembly 130. In addition, through the use of daisy chaining of the power entry boxes (which will be described in further detail herein with respect to power entry boxes 134A), communication signals can be transmitted from one section 540 of the modular plug assembly 130 to another section 540. Further, however, and in accordance with the invention, the structural channel system 100 includes means for electrically coupling AC power cables 574 from one section 540 to a relatively adjacent section 540 of the modular plug assembly 130. Still further, this means for electrically coupling of the AC power cables 574 also includes means for electrically coupling the communication cables 572 of adjacent sections 540. For this purpose, the structural channel system in accordance with the invention includes flexible connector assemblies 138, one of which is illustrated in FIGS. 50, 50A, 50B and 50C. Turning to these drawings, the flexible connector assembly 138 includes an elongated AC power flexible conduit 790. The flexible conduit 790 is conventional in structure and is utilized to carry AC power cables (not shown) between the two ends of the connector 138. Also provided is an elongated communications flexible conduit 792. The communications flexible conduit 792 may, for example, have an oval configuration. Each of the conduits is relatively well known in the industry.

One end of the AC power flexible conduit 790 and one end of the communications flexible conduit 792 are connected to what is characterized as a right-hand jumper housing 794 of the flexible connector assembly 138. References herein to right hand and left hand are arbitrary. The right hand jumper housing 794 includes a right hand jumper offset 796, having the offset construction as illustrated primarily in FIG. 50A. A right hand jumper cover 798 is also included, with the offset 796 and cover 798 forming the housing 794. The conduits 790 and 792 extend into one end of the housing 794, and are secured therein by any suitable means. Rivets 802 may be utilized to secure together the offset 796 and cover 798.

As further shown in FIG. 50A, the right hand jumper housing 794 encloses a spacer clip 800 utilized for maintaining spacing and positioning of components of the flexible connector assembly 138 within the interior of the housing 794. Coupled to one end of the housing 794 is a female terminal housing 804. The female terminal housing 804 houses a set of eight female terminals 810. The female terminals 810 comprise a communications female terminal set 806, having three of the female terminals 810. The remaining five female terminals 810 comprise the AC power female terminal set 808. The female terminals 810 extend toward the outer end of the terminal housing 804. As with other connector housings previously described herein, the terminal housing 804 also comprises a pair of side walls. Specifically, the terminal housing 804 associated with the housing 794 includes a first side wall 780 and a second side wall 782, shown in FIGS. 50A and 50C. The first side wall 780 is in the form of an elongated C-shaped cross-sectional configuration, having a height X (FIG. 50A). Correspondingly, the second side wall 782, opposing the first side wall 780, as a “reverse” C-shaped cross-sectional configuration. The second side wall 782 has a relatively shorter height identified as height Y. These references to heights X and Y correspond to the same heights identified as heights X and Y in the prior description associated with the modular plugs 576 and the distribution plugs 650. As will be described in subsequent paragraphs herein, the sizing and configuration of the various connector housings ensures that the interconnection of a flexible connector assembly 138 between two sections 540 of the modular plug assembly 130 is “unidirectional.”

On the opposing end of the flexible connector 138, the AC power flexible conduit 790 and communications flexible conduit 792 are secured to a left hand jumper housing 812. As further shown in FIG. 50A, the left hand jumper housing 812 is similar in configuration to the right hand jumper housing 794, but with a “reverse” offset. The left hand jumper housing 812 comprises a left hand jumper offset 814 and a left hand jumper cover 816. The offset 814 and cover 816 are secured together by means of rivets 802. Secured within the left hand jumper housing 812 is an additional spacer clip 800, utilized for maintaining spacing and positioning of components of the flexible connector assembly 138 within the interior of the housing 812. Coupled to a terminating end of the left hand jumper housing 812 is a second female terminal housing 804, having the same structure and configuration as the female terminal housing 804 previously described with respect to use within the right hand jumper housing 794. The conduits 790 and 792 extend into an opposing end of the jumper housing 812, and are secured therein by any suitable means. As with the female terminal housing 804 associated with the right hand jumper housing 794, the female terminal housing 804 associated with the left hand jumper housing 812 also houses a set of eight female terminals 810, comprising a communications female terminal set 806 and an AC power female terminal set 808. The communications female terminal set 806 includes three female terminals 810, while the AC power female terminal set 808 comprises five female terminals 810. The female terminals 810 extend toward the outer end of this terminal housing 804. As shown primarily in FIG. 50A, the spatial positioning of the female terminal housing 804 associated with the left hand jumper housing 812 corresponds to the spatial positioning of the female terminal housing 804 associated with the right hand jumper housing 794, but rotated 180°. To make clear this configuration, when the flexible connector assembly 138 is viewed in the side elevation view of FIG. 50B, the first side wall 780 associated with the housing 804 for the right hand jumper housing 794 is visible. On the opposing end of the flexible connector assembly 138 as viewed in FIG. 50B, the second side wall 782 of the housing 804 associated with the left hand jumper housing 812 is visible. Accordingly, the 180° rotation of one of the female terminal housings 804 relative to the other occurs within a horizontal plane, so that the vertical orientations of the female terminals 810 are identical for each of the female housings 804. This positional orientation of the female housings 804 and the use of the jumper offsets will be made apparent in subsequent discussions relating to the interconnection of the flexible connector assembly 138 to adjacent sections 540 of the modular plug assembly 130.

Although not specifically shown in the drawings, cables or wires are attached to the female terminals 810 associated with each terminal housing 804 (by any suitable means), and extended through the AC power flexible power conduit 790 and communications flexible conduit 792. Three of these wires or cables are connected to the communications female terminal sets 806, and extend through the communications flexible conduit 792. These cables or wires will be utilized to couple together the communications cables CC1, CC2 and CCR associated with adjacent sections 540 of the modular plug assembly 130. Correspondingly, a set of five wires or cables are extended through the AC power flexible conduit 790 and conductively interconnected to the female terminals 810 associated with each terminal housing 804 which form the AC power female terminal sets 808. These wires or cables and the AC power female terminal sets 808 are utilized to couple together the AC cables AC1, AC2, AC3, ACN, and ACG associated with adjoining sections 540 of the modular plug assembly 130.

More specifically, the female terminals 810 of one of the terminal housings 804 will be electrically coupled to the male blade sets 658, 660 associated with a distribution plug 650 (see FIG. 42B) at one end of one section 540 of the modular plug assembly 130. The other terminal housing 804 of the flexible connector assembly 138 will be electrically coupled to the male blade sets 588, 590 associated with a modular plug 576 (see FIG. 42A) at one end of another, or a second, section 540 of the modular plug assembly 130, thereby electrically coupling the second section 540 to the first section 540. Typically, for purposes of interconnection, these first and second adjacent sections 540 of the modular plug assembly 130 will be positioned so that the end of the second section 540 which is nearest to the distribution plug 650 of the first section 540 will be the end of the second section 540 which does not have a distribution plug 650. That is, in a typical configuration, the female terminals 810 of one of the terminal housings 804 will be electrically connected to the distribution plug 650 of one section 540, and to an endmost modular plug 576 associated with the adjacent, or second, section 540.

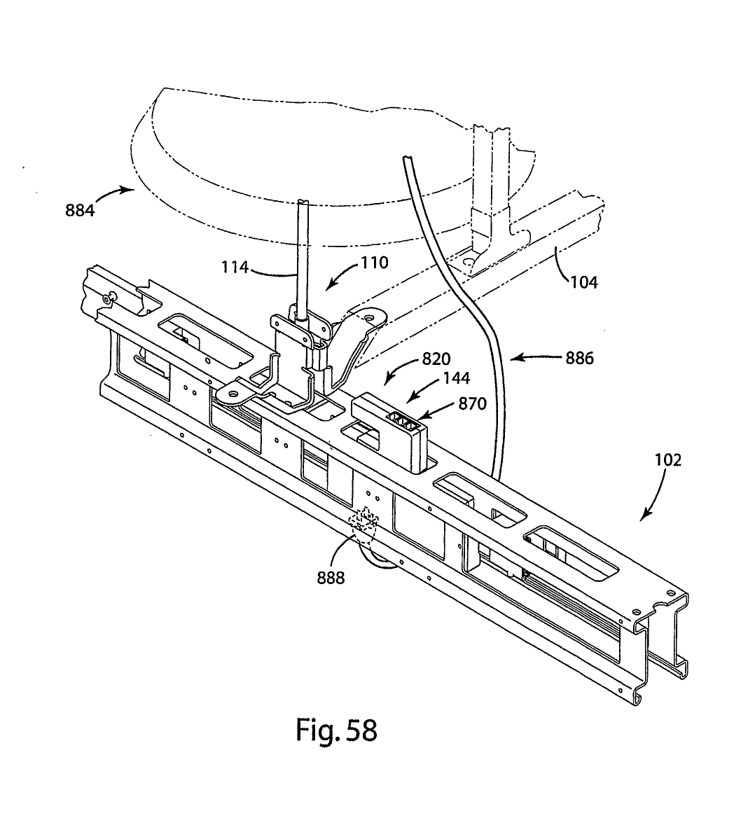

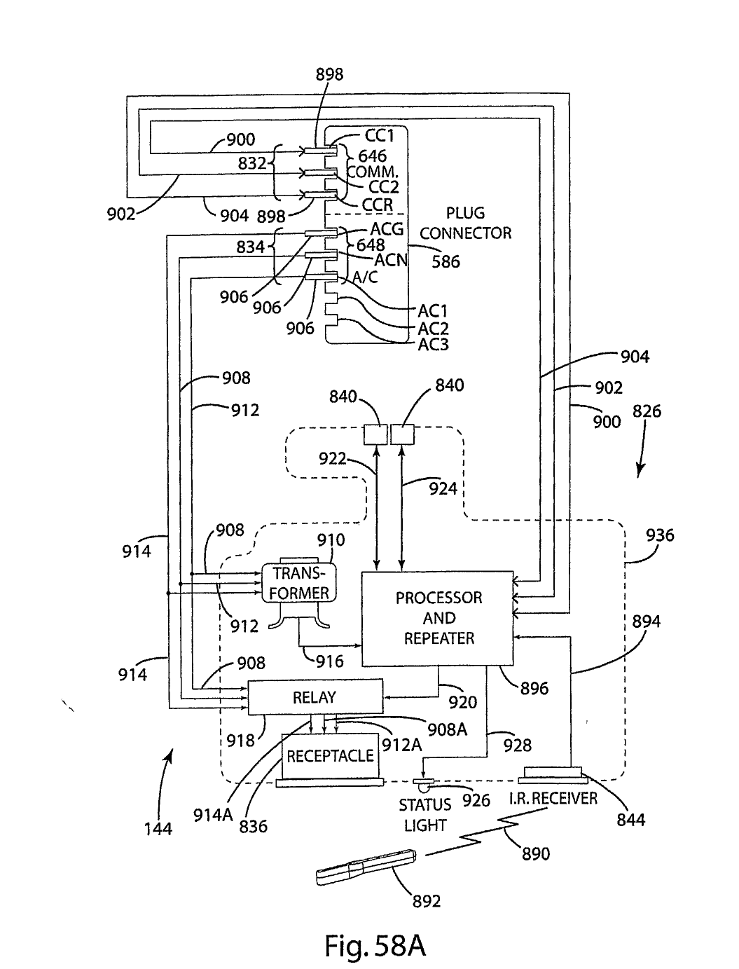

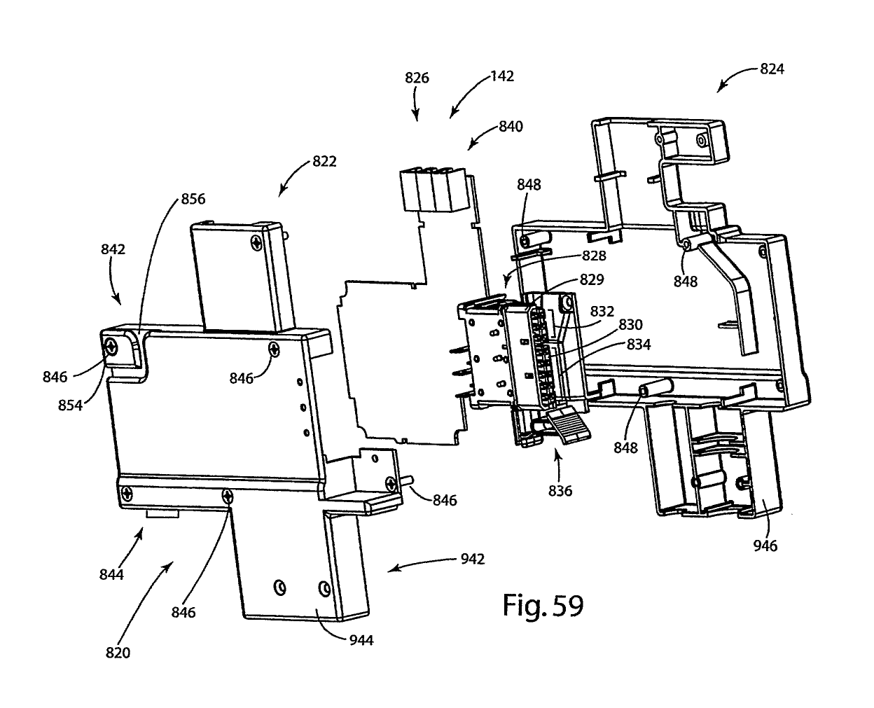

As earlier referenced, one particular advantage of the flexible connector assembly 138 in accordance with the invention comprises its capability of being “plugged into” adjoining sections 540 of the modular plug assembly 130 only in one direction. With this feature, the flexible conduit assembly 138 is referred to herein as being “unidirectional.” This unidirectional property is a significant safety feature. More specifically, and as earlier referenced, each of the terminal housings 804 of the flexible connector assembly includes a first side wall 780 and a second side wall 782. These sidewalls correspond in size and configuration to the first and second side walls 625, 627 of the modular plugs 576 and first and second side walls 667, 669 of the distribution plug 650. As also earlier referenced, the positioning of one of the terminal housings 804 in the flexible connector assembly 138 corresponds to a two-dimensional, 180° rotation in a horizontal plane of the other terminal housing 804 of the assembly 138. Accordingly, as shown in FIG. 58, one of the terminal housings 804 includes its first side wall 780 on one side of the connector assembly 138, while the other terminal housing 804 is positioned so that its first side wall 780 is on the opposing side. Interconnection of one of the flexible connector assemblies 138 to adjacent sections 540 of the modular plug assembly 130 is shown in FIG. 50C. For purposes of description and understanding, the sections 540 are shown independent of any interconnections to main rails 102 or similar components. Also, and again for purposes of description, the two terminal housings 804 associated with the flexible connector assembly 138 in FIG. 50C are identified as terminal housing 804A and terminal housing 804B. With the connector assembly 138 positioned as shown in FIG. 50C relative to the section 540, the terminal housing 804A has its first side wall 780 facing the sections 540. The second side wall 782 of the terminal housing 804A faces in an opposing direction. In contrast, with reference to terminal housing 804B, its first side wall 780 faces outwardly from the sections 540, while its second side wall 782 faces toward the sections 540.

In assembling the flexible connector assembly 138 to the two sections 540 shown in FIG. 50C, the terminal housing 804A will be coupled to the modular plug male terminal set housing 624 of a modular plug 576 located at the end of one of the sections 540. For purposes of description, this modular plug 576 is expressly identified by reference numeral 576A. As further shown in FIG. 50C, the first side wall 625 of the modular plug 576A is to the outside of the housing 654, while the second side wall 627 is toward the inside of the housing 624. With this configuration, relative to the configuration of the side walls 780, 782 of housing 804A, the housing 804A can readily “mate” with the housing 624 of modular plug 576A. It should be noted that if the side walls 780, 782 of housing 804A or the side walls 625, 627 of modular plug 576A were “reversed,” it would not be possible to interconnect housing 804A with housing 624 of plug 576A.

Correspondingly, the terminal housing 804B is adapted to mate with a distribution plug 650, identified specifically as distribution plug 650A in FIG. 50C. As further shown in FIG. 50C, the first side wall 667 of the distribution plug male terminal housing 664 is located toward the inside of the housing 664. Correspondingly, the second sidewall 669 of distribution plug 650A is located outwardly of the plug 650A. With this configuration, and with the positional configuration of terminal housing 804B as shown in FIG. 50C, the terminal housing 804B can readily “mate” with the housing 664 of the distribution plug 650A. As previously noted with respect to housing 804A and housing 674 of plug 576A, if either of the side walls 780, 782 of housing 804B or the side walls 667, 669 of distribution plug 650A were reversed, mating of the housing 804B, in the position shown in FIG. 50C, would not be possible. With the foregoing configurations of the terminal housings associated with the module plugs 576, distribution plug 650 and flexible connector assembly 138, in combination with the offsets provided by the structural configuration of the right hand jumper housing 794 and left hand jumper housing 812, a proper mating configuration of the flexible connector assembly 138 with the adjacent sections 540 can only occur in one direction. That is, the flexible housing assembly 138 will be capable of being “plugged into” adjoining sections 540 of the modular plug assembly 130 only in a “unidirectional” manner. As previously stated, it is believed that this provide a significant safety feature. Also, with this feature and the general structural configuration of the interconnection of the connector assembly to the adjoining sections 540, it is believed that the use of the flexible connector assembly 138 will meet most governmental and institutional codes and regulations relating to electrical apparatus.

One other concept associated with the flexible connector assembly 138 should be mentioned. FIG. 50C illustrates the use of the flexible connector assembly 138 to electrically couple together a pair of sections 540 of the modular plug assembly 138 which are essentially in an alignment which could be characterized as a “straight line” configuration. However, if for some reason it would be desirable to electrically couple together a pair of sections 540 which are, for example, angled relative to each other, the connector assembly 138, having flexibility with respect to its conduits 790, 792, can be utilized for such electrical interconnection. Still further, the flexible connector assembly 138 is not necessarily limited to any particular length, with the exception that electrical and code requirements may limit the connector assembly length. Except for these possible limitations, the flexible connector assembly 138 can be of any desired lengths, and a user may incorporate a number of connector assemblies 138 having varying lengths within a structural channel system 100.

In accordance with the foregoing, the flexible connector assembly 138 provide a means for essentially electrically coupling together sections 540 of the modular plug assembly 130. Power from the building therefore does not have to be directly applied through a power entry box 134 for each section 540 of the modular plug assembly 130. It will be apparent, however, that the number of sections 540 of the modular plug assembly 130 which may be coupled together through the use of the flexible connector assemblies 138 may be limited in a physically realizable implementation, by electrical load and “density” requirements, and code restrictions.

In accordance with all of the foregoing, the structural channel system 100 in accordance with the invention may be employed to provide high voltage electrical power (or other power voltages) through AC power cables 164 extending through sections of the wireways 122. Correspondingly, DC or other low voltage power may be provided throughout the network grid 172 through cables 166 extending through the cableways 120. Power from the cables 164 or cables 166 can be “tapped off” anywhere along the grid 172 as desired, for purposes of energizing various types of application devices. Still further, and also in accordance with the invention, the structural channel system 100 includes components such as the power entry boxes 134, power box connectors 136, modular plug assembly 130 and flexible connector assemblies 138 for purposes of distributing both AC power (with multi-circuit capability) and communication signals throughout the grid 172 and electrical network 530. Also, if desired, the communication cables 572 can be utilized for purposes of distributing low voltage DC power throughout the electrical network 530, as well as communication signals.

With the components of the electrical network 530 as previously described herein, not only electrical power can be provided to conventional, electrically energized devices, such as lights and the like, but communication signals may also be provided on the electrical network 530 and utilized to control and reconfigure control among various application devices. As an example, and as described in the commonly assigned International Patent Application No. PCT/US03/12210, entitled “SWITCHING/LIGHTING CORRELATION SYSTEM,” filed Apr. 18, 2003, control relationships between switches and lights may be reconfigured in a “real time” fashion. In this regard, and as described in subsequent paragraphs herein, connector modules can be associated with application devices, such as lighting fixtures and the like. These connector modules can include DC power, processor means and associated circuitry, responsive to communication signals carried on the communication cables 572, so as to appropriately control the lighting fixtures, in response to communication signals received from other application devices, such as switches. The structural channel system 100 in accordance with the invention provides means for distributing requisite power and for providing a distributed intelligence system for transmitting and receiving these communication signals from application devices which may be physically located throughout the entirety of the structural grid 172.

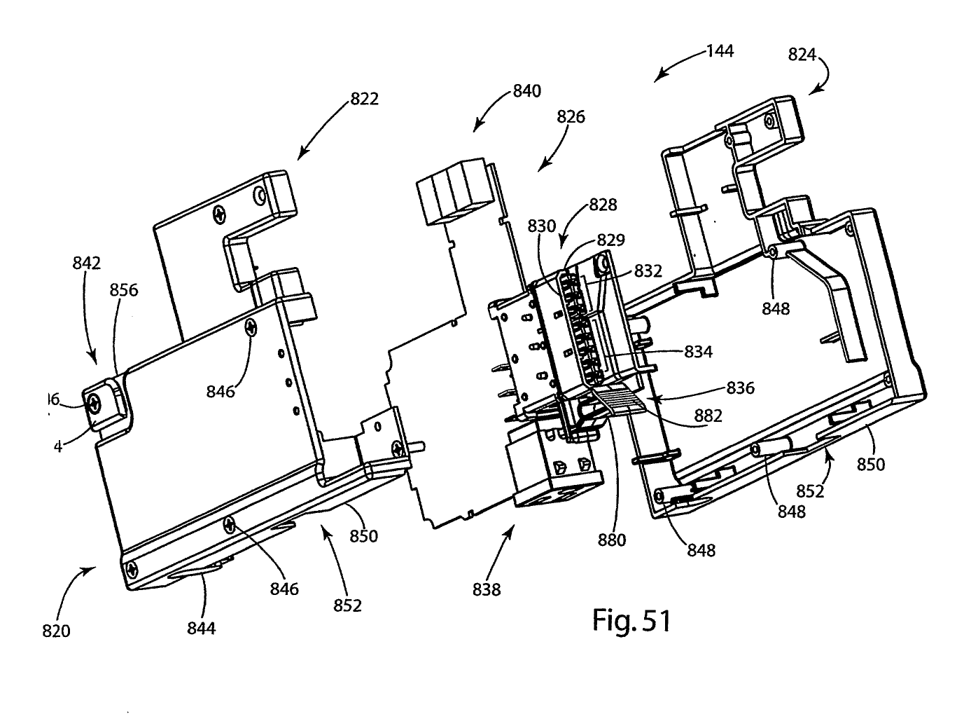

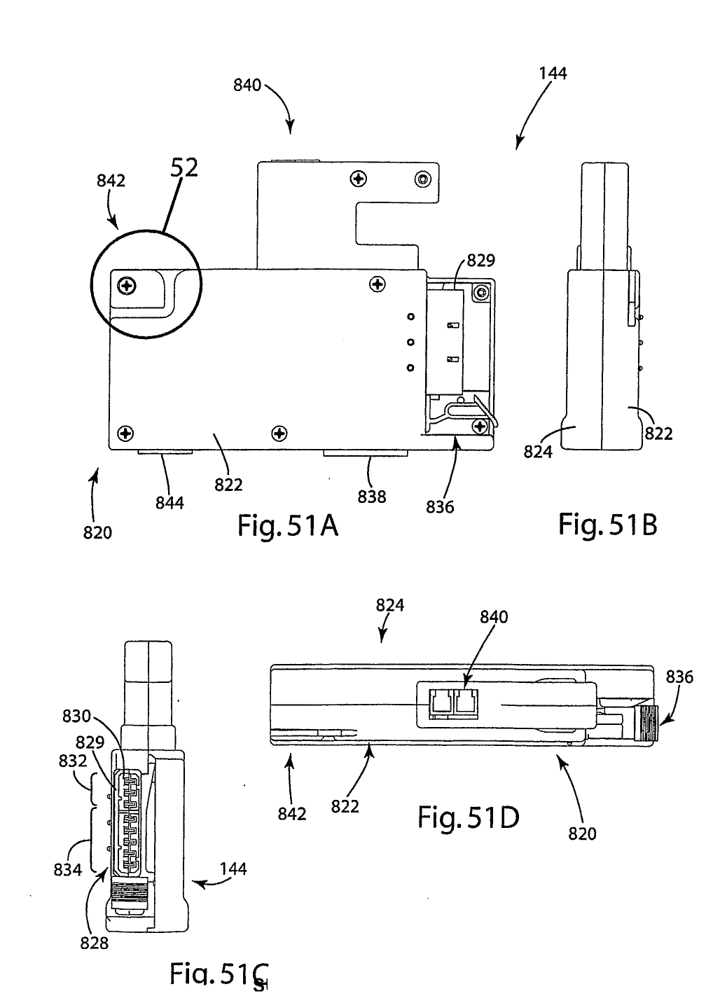

Once such connector module which may be utilized in accordance with the invention in the structural channel system 100 is referred to herein as a receptacle connector module 144. The receptacle connector module 144 is illustrated in FIGS. 51-58A. With the exception of FIG. 58, the receptacle connector module 144 is illustrated in a stand-alone configuration in FIGS. 51-58A. In FIG. 58, the receptacle connector module 144 is illustrated as electrically and mechanically interconnected to a section 540 of the modular plug assembly 130, and energizing an electrical device. For purposes evident from subsequent description herein, the receptacle connector module 144 can be referred to as a “smart” connector module, in that it includes certain logic which permits the connector module 144 to be programmed by a user (through remote means) so as to initiate or otherwise modify a control/controlling relationship between devices energized through the receptacle connector module 144 and controlling devices, such as switches or the like.

With reference initially to FIGS. 51-51D, the receptacle connector module 144 includes a connector housing 820. The connector housing 820 includes a front housing cover 822 and a rear housing cover 824. Fasteners 846 can be extended through apertures in the front housing cover 822 and secured within threaded couplers 848 in the rear housing cover 824, for purposes of securing the covers 822 and 824 together. Secured within the connector housing 820 is a board assembly 826, as primarily shown in FIG. 51. The board assembly 826 includes various circuit components for purposes of functional operation of the receptacle connector module 144. The principal components are illustrated in FIG. 58A and will be described in subsequent paragraphs herein. The board assembly 826 includes a connector plug 828. The connector plug 828 comprises a connector plug housing 829. The connector plug housing 829, as will be apparent from subsequent description herein, is adapted to mate with the male terminal set housing 624 of each of the modular plugs 576 associated with sections 540 of the modular plug assembly 130. A set of eight female terminals 830 extend toward the end of the connector plug 828 to the opening of the connector plug housing 829. The female terminals 830 include a set of three female terminals forming a communications female terminal set 832. When the receptacle connector module 144 is electrically and mechanically coupled to a section 540 of the modular plug assembly 130, the communications female terminal set 832 will be electrically connected to the communications male terminal set 646 previously described with respect to FIG. 42A. Correspondingly, five of the female terminals 830 will form an AC power female terminal set 834. When coupled to a modular plug 576 of a section 540 of the modular plug assembly 130, the AC power female terminal set 834 will be electrically engaged with the AC power male terminal set 648 of the modular plug 576, as also shown in FIG. 42A.

For purposes of securing the connector plug 828 of the connector module 144 to a modular plug 576, a connector latch assembly 836 is provided below the connector plug housing 829. Operation of the connector latch assembly 836 will be described in subsequent paragraphs herein. In addition to the foregoing, the receptacle connector module 144 includes a lower surface 850 formed by the lower portions of the front housing cover 822 and rear housing cover 824. Extending through a slot 852 also formed by the covers 822, 824, is an electrical receptacle 838, operation of which will be described in subsequent paragraphs herein. The connector module 144 includes a set of two connector ports 840. Each of the connector ports 840 may be a standard RJ45 port. Such ports are conventionally used as telephone plugs and also as programmable connections. The connector ports 840, as described in greater detail subsequently herein, provide a means for transferring and receiving communication signals to and from various application devices (including switches and the like), in addition to providing a means for transmitting DC power to certain application devices for functional operation. The communication signals may then be carried to and from the communication cables 572 associated with the modular plug assembly 130.

The receptacle connector module 144 also includes an IR (infrared) conventional receiver 844 which is located as shown in FIG. 51 on the lower surface 850 of the connector housing 820. As also described in subsequent paragraphs herein, the IR receiver 844 provides a means for receiving spatial signals from a user for purposes of “programming” the functional operation of the receptacle connector module 844 in response to communication signals received through the connector ports 840 and through the communications female terminal set 832.

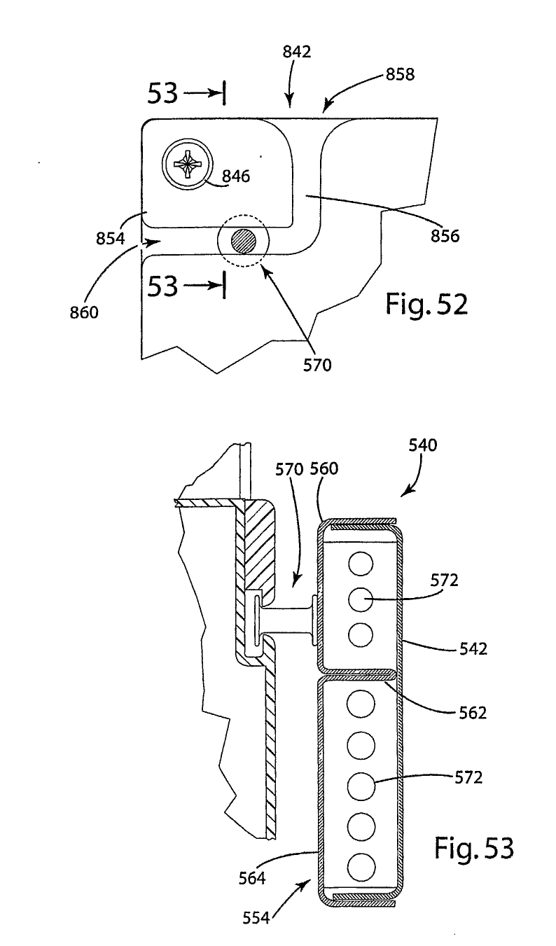

As earlier described, the receptacle connector module 144 is electrically coupled to communication cables 572 and AC power cables 574 of the modular plug assembly 130, through a mating connection of the female terminals 830 within the connector plug 828 to the male blade sets 588, 590 of one of the modular plugs 576 associated with the modular plug assembly 130. Further, the receptacle connection module 144 (and other connector modules as described in subsequent paragraphs herein) preferably includes additional means for mechanically securing the connector module 144 to a section 540 of the modular plug assembly 130. For this purpose, a subdevice referred to herein as a ferrule coupler 842 is utilized, in combination with one of the spaced apart ferrules 570 which is secured to one of the electrical dividers 554 of a section 540 of the modular plug assembly 130. Reference will be made primarily to FIGS. 51, 51A, 52 and 53, in describing the ferrule coupler 842. As shown first primarily in FIGS. 51 and 52, the front housing cover 822 includes a pin insert 854 which is coupled to the housing cover 822 at its upper left hand corner (as viewed in FIG. 51A). The pin insert 854 is secured to the front housing cover 822 by one of the fasteners 846. As shown in an enlarged view in FIG. 52, the positioning of the pin insert 854 and the structural configuration thereof forms a slot 856. The slot 856 includes a vertical slot section 858 which opens outwardly at the upper portion of the connector housing 820. The slot 856 then continues downward and turns at substantially a right angle so as to form a horizontal slot section 860. The horizontal slot section 860 opens outwardly at one end of the connector housing 820.

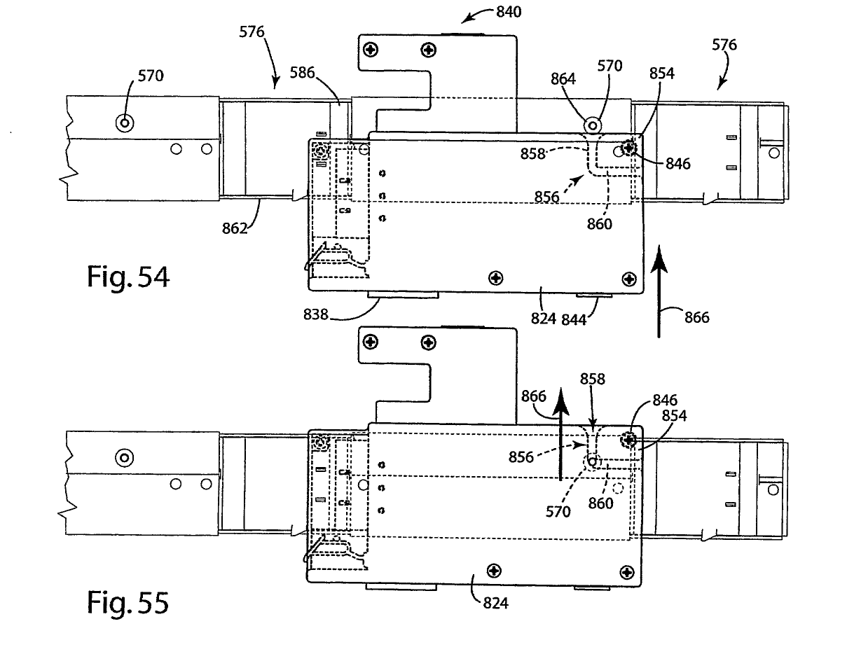

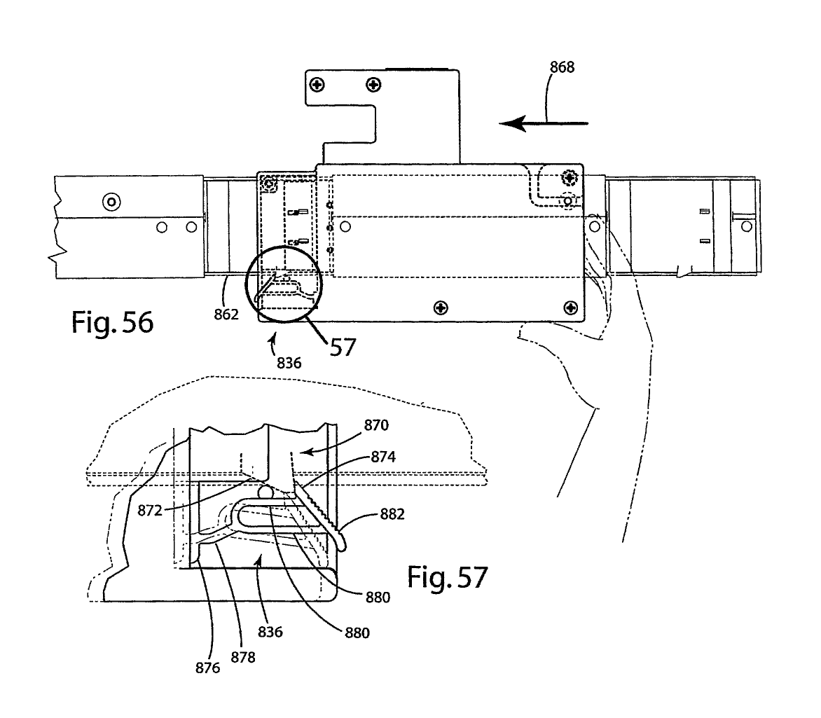

With reference primarily to FIGS. 52, 53, 54 and 55, the connector module 144 is positioned relative to one of the modular plugs 576 to which it is to be connected by moving the connector module 144 upward through the central spatial area of a structural channel rail 102 until the connector module 144 is essentially in a position as shown in FIG. 54. In this position, the particular modular plug 576 to which the connector module 144 will be electrically connected is identified as modular plug 862. The connector module 144 is positioned so that its upper surface is immediately below a ferrule 570, with the ferrule 570 in alignment with the vertical slot section 858. This position is also shown in FIG. 54. The particular ferrule 570 of interest is identified as ferrule 864. The connector module 144 is then raised upwardly in the direction shown by arrows 866 in FIGS. 54 and 55. As the connector module 144 is moved upwardly, the ferrule 864 moves downwardly into the slot 856 through the vertical slot section 858. This upward movement continues until the ferrule 864 rests against the bottom of the vertical slot section 858 of the slot 856. This position is illustrated in FIG. 55. To then engage the connector plug 828 of the connector module 144 with the plug connector 586 of the modular plug 862, the connector module 144 is moved toward the modular plug 862. This movement would correspond to movement of the connector module 144 to the left as viewed in FIG. 55. The sizing and relative structure of the section 540 of the modular plug assembly 130 and the various components of the connector module 144 should be such that when the connector plug 828 is fully engaged with the plug connector 586, the ferrule 864 will be located within the horizontal slot section 860 of the slot 856. This relative positioning and configuration is illustrated in FIG. 56. In this manner, the ferrule coupler 842 assists in preventing vertical movement of the connector module 144 relative to the section 540 of the modular plug assembly 130.

In accordance with the foregoing, any substantially vertical movement of the connector module 144 relative to the section 540 of the modular plug assembly 130 is prevented through the ferrule coupler 842. However, the ferrule coupler 842, when the connector module 144 is fully electrically coupled to the plug connector 586, will not prevent initial movement of the connector module 144 to the right (i.e. opposite the direction of the arrow 868) relative to the section 540, as viewed in FIG. 56. Any such unintentional movement (through earthquake movements, “bumping” against the connector module 144, etc.) could present a substantially unsafe situation, in that the connector plug 828 could become partially dislodged from the plug connector 586. To prevent such unintentional movement, the connector module 144 further includes a connector latch assembly 836.

Functional operation of the connector latch assembly 836 will now be described primarily with respect to FIGS. 42A, 56 and 57. With reference first to FIGS. 42A and 57, the plug connector 586 includes, at the lower portion thereof, a mating ramp 870. The mating ramp 870, as shown in FIG. 57, has an inclined ramp surface 872. The lower end of the inclined ramp surface 872 terminates in a ramp edge 874. The connector latch assembly 836 also comprises a brace 876 which is integral with or otherwise coupled to a lower portion of the connector plug 828 of the connector module 144. Projecting outwardly from the brace 176 is a resilient arm 878, as also shown in FIG. 57. The distal end of the resilient arm 878 terminates in a pair of fingers 880. The fingers 880 are integral with or otherwise connected to an inclined latch shoe 882. The connector latch assembly 836 is sized and configured so that it has a “normal” position as illustrated in solid line format in FIG. 57. However, the resilient arm 878 and fingers 880 are sufficiently flexible so that the latch shoe 882 can be flexed downwardly, as illustrated in phantom line format in FIG. 57. When the receptacle connector module 144 is first positioned relative to the section 540 of the modular plug assembly 130 as illustrated in FIG. 54, the latch shoe 832 is in the position shown in FIG. 54. As the connector module 144 is raised upwardly to the position shown in FIG. 55, the latch shoe 882 is located to the “right” of the mating ramp 870 of the modular plug 862, as viewed in FIG. 55. As the connector module 144 is moved to the left as viewed in FIG. 55 relative to the modular plug 862, for purposes of electrically connecting the module 144 to the modular plug 862, the latch shoe 882 will contact the ramp edge 874. This configuration is illustrated in phantom line format in FIG. 57. As the connector module 144 is moved to the left as viewed in FIG. 56 (corresponding to movement of the latch shoe 882 to the right as viewed in FIG. 57), the latch shoe 882 contacts the ramp surface 872 and is flexed downwardly, as shown by the phantom line format of FIG. 57.

When the connector module 144 is moved a sufficient distance, as shown in FIGS. 56 and 57, the latch shoe 882 passes the ramp edge 874 of the mating ramp 870. When the latch shoe 882 is completely past the ramp edge 874, the latch shoe 882 is free to flex upwardly to its normal position, as shown in solid line format in FIG. 57. This configuration is also illustrated in FIG. 56. With this positioning of the latch shoe 882 relative to the mating ramp 870, the connector module 144 is essentially “locked” into appropriate position, relative to the modular plug 862. To thereafter disengage the connector module 144 from the modular plug 862, a user must manually press downward on the latch shoe 882, until the upper end of latch shoe 882 is positioned below the ramp edge 874 of the mating ramp 870. With the latch shoe 882 below the ramp edge 874, the connector module 144 can be disconnected from the modular plug 862. That is, the connector module 144 can be moved to the right as viewed in FIG. 56, relative to the modular plug 862. This movement can continue until the ferrule 864 has moved to the end of the horizontal slot section 860. This would correspond to the position of the connector module 144 as shown in FIG. 55. The connector module 144 has been sized and configured so that it is then completely disconnected from the modular plug 862. The connector module 144 can be pulled downwardly, so that the ferrule 570 moves upward within the vertical slot section 858. This would correspond to movement of the connector module 144 from the position shown in FIG. 55 to the position shown in FIG. 54.

In accordance with all of the foregoing, the connector latch assembly 836, in combination with the mating ramp 870, and the ferrule coupler 842, in combination with a ferrule 570, serve to provide for mechanical interconnection of the connector module 144 to the section 540 of the modular plug assembly 130. With this interconnection, as shown in FIG. 56, external forces must be manually exerted on the latch shoe 882, for purposes of disconnecting the connector module 144 from the modular plug 862. These components provide means for preventing inadvertent vertical or horizontal movement of the connector module 144, relative to the section 540 of the modular plug assembly 130.

As earlier described, the receptacle connector module 144 includes an IR receiver 844 and an electrical receptacle 838 extending through a lower surface 850 of the module 144 (FIG. 51). In this particular instance, the receptacle 838 is illustrated in the drawings as a conventional three-prong receptacle, having a ground wire connection. For purposes of providing AC power to an electrical application device through the receptacle 838, the receptacle 838 will be coupled to AC power from the AC power cables 574, in a manner as subsequently described herein. As an example of use, and as shown in FIG. 58, the receptacle connector module 144 can be utilized to energize an electrical application device, such as an overhead fan 884 shown in phantom line format in FIG. 58. The overhead fan 884 may be energized through an electrical cord 886 having a plug 888. The plug 888 may be electrically connected to the receptacle 838 of the connector module 144.

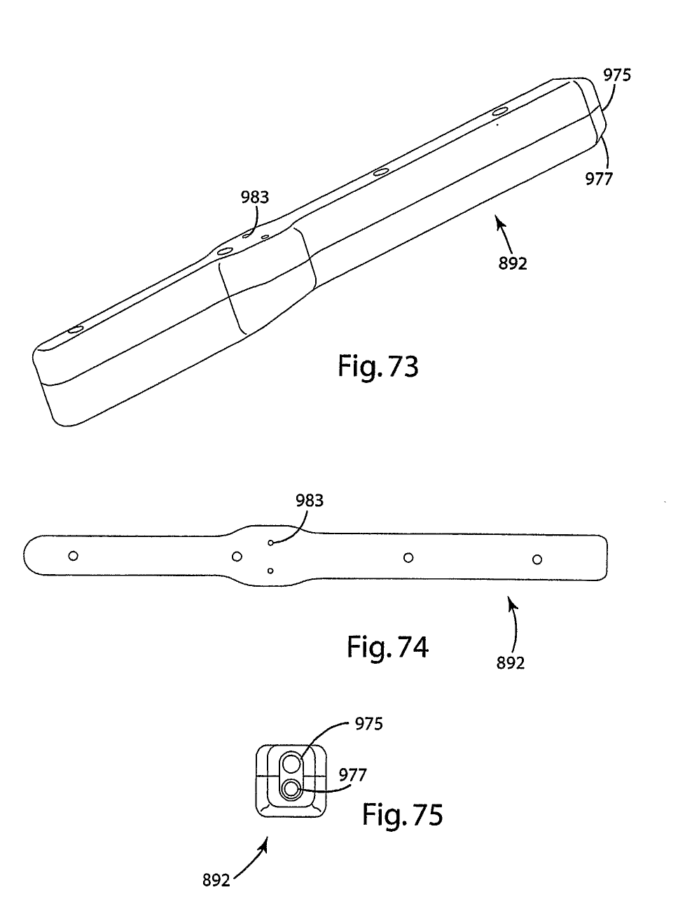

The internal circuitry of the receptacle connector module 144, represented by the board assembly 826 illustrated in FIG. 51, will now be described, primarily with respect to FIG. 58A. As shown therein, the receptacle connector module 144 includes the IR receiver 844. The receiver 844 is a conventional and commercially available IR receiver, which is adapted to receive spatial IR signals 890 from a manually operable and hand-held device, illustrated as a wand 892 in FIG. 58A. The wand 892 is operated by a user, and will be described in subsequent paragraphs herein with respect to FIGS. 73, 74 and 75. Incoming spatial IR signals 890 are received by the IR receiver 844, and converted to electrical signals which are applied as output signals on line 894. The output signals on line 894 (which is a “symbolic” line and may comprise a plurality of wires or cables) are applied as input signals to a processor and associated repeater circuitry 896.

In addition to the signals received by the processor and associated repeater circuitry 896 from the IR receiver 844 through line 894, the processor and associated repeater circuitry 896 also receives communication signals from communication cables CC1, CC2 and CCR running through sections 540 of the modular plug assembly 130. These signals are “tapped off” the plug connector 586 (symbolically shown in FIG. 58A) of one of the modular plugs 576 spaced along a section 540 of the modular plug assembly 130. More specifically, signals from the communication cables CC1, CC2 and CCR are received through the communications cable terminal set 646 (see FIG. 42A) of the plug connector 586. The three terminals of the communications cable terminal set 646 are electrically coupled to the communications female terminal set 832 of the connector module 144. This connection is illustrated in FIG. 58A through what is shown as “symbolic” contacts 898. Although shown as symbolic contacts 898, they represent an electrical interconnection of the modular plug 576 and associated plug connector 586, comprising communications cable terminal set 646, to a communications female terminal set 832 associated with the connector module 144. For purposes of simplifying description of the board assembly 826 and circuits of other connector modules as subsequently described herein, the elements shown as symbolic contacts 898 will be utilized to represent these electrical interconnections. Further, it should be noted that FIG. 58A represents the receptacle connector module 144 when the module 144 is completely mechanically and electrically engaged with a section 540 of the modular plug assembly 130, and an associated modular plug 576.

As further shown in FIG. 58A, reference is made to each of the symbolic contacts 898 as being representative of an electrical interconnection to one of the communication cables CC1, CC2 and CCR. Communication signals from the communication cables CC1 and CC2 are applied through the symbolic contacts 898 and lines 900 and 902 as input signals to the processor and associated repeater circuitry 896. Correspondingly, the return communication cable CCR is also connected through a symbolic contact 898 and its signal is applied to the processor and associate repeater circuitry 896 on line 904. Also, although communication signals from cables CC1 and CC2 can be received by the processor and associated repeater circuitry 896, the lines 900, 902 and 904 are bidirectional, and the processor and associated repeater circuitry 896 is also adapted to generate output signals and apply the same as communication signals to the communication cables CC1, CC2 and CCR through the symbolic contacts 898.

Turning to the AC power portion of the receptacle connector module 144, and the AC/DC conversion features so as to provide DC power for functional operation of the connector module 144, the modular plug 576, as previously described herein, includes an AC power terminal set 648 mounted on the plug connector 586 and connected to the AC power cables 574 (see, e.g., FIG. 42) which run through each section 540 of the modular plug assembly 130. The AC power terminal set 648 is electrically interconnected to the AC power female terminal set 834 associated with the connector module 144 (see prior description with respect to FIG. 51). This electrical interconnection is illustrated through the use of “symbolic” contacts 906 as shown in FIG. 58A. Symbolic contacts 906 correspond to symbolic electrical connections in the same manner as the previously described symbolic contacts 898.

In this particular embodiment of the receptacle connector module 144 and associated board assembly 826 as shown in FIG. 58A, the symbolic contacts 906 are illustrated so as to correspond to electrical interconnection to AC power cables AC1, ACN and ACG. AC1 corresponds to a “hot” cable. As previously described herein, the particular embodiment of the AC power cables 574 comprises three hot circuits, utilizing AC power cables AC1, AC2 and AC3. FIG. 58, and other diagrammatic circuit configurations of other connector modules as shown herein, illustrate the use only of the hot AC power cable AC1, and not the AC power cables AC2 or AC3. However, as previously described herein, for purposes of “balancing” and the like, AC power could be received by the connector module 144 utilizing AC power cable AC2 or AC3.

In FIG. 58A, for purposes of clarity and description, no connections are shown to the terminals of the AC terminal set 648 of plug connector 586 corresponding to AC power cables AC2 and AC3. However, in a physical realization of the receptacle connector module 144, the AC power female terminal set 834 of the connector module 144 may, in fact, include female terminals corresponding to the slots for power cables AC2 and AC3. Also, lines may exist from the proximity of all of these female terminals, which are connected to a transformer 910 and relay 918 as subsequently described herein. With such a “five wire” connection arrangement, various means could be utilized to insure that only one of the lines connected to the “hot” wires for power cables AC1, AC2 and AC3 is enabled at any given time. As somewhat of an alternative, the symbolic contacts 906 could be provided for each of the slots associated with the AC power cables AC1, AC2, AC3, ACN, and ACG. These contacts 906 could be in the form of spade terminals or the like. Correspondingly, the line shown as line 908, connected to the transformer 910, relay 918 and symbolic contact 906 associated with AC power cable AC1, may be used to selectively couple the transformer 910 and relay 918 to any one of the contacts 906 associated with the power cables AC1, AC2 or AC3. For example, line 908 may be in the form of a “pigtail,” having one end substantially permanently coupled to the transformer 910 and relay 918. The other end of the pigtail line 908 may be assembled so that it is capable of being selectively coupled to any one of the symbolic contacts 906 associated with “hot” cables AC1, AC2, or AC3. The selective coupling will be dependent upon which circuit is to be used. The selectively coupled end of the line 908 may be in the form of any suitable terminal which could be electrically coupled to the spade of the symbolic contact 906. Such a selective interconnection can be done on-site or, and likely preferably, at the manufacturing site when the connector module 144 is assembled. In any event, such a pigtail configuration may provide a convenient means for using connector modules 144 of substantially the same configurations with any of the three circuits AC1, AC2 or AC3. Of course, and as apparent from the description herein, the structural channel system 100 is not, in any manner, limited to the use of three AC circuits. Any number of AC power circuits may be employed. Also, it should be kept in mind that various configurations may be utilized for the electrical interconnections of the communication female terminal set 832 and AC power female terminal set 834 of the connector module 144 to the communications cable terminal set 646 and AC power terminal set 648 of the modular plug 576, without departing from the principal concepts of the invention.

As illustrated in FIG. 58A, the AC “hot” cable AC1 is electrically connected through one of the symbolic contacts 906 and applied through line 908 as an input to a conventional and commercially available transformer 910. Correspondingly, the neutral AC power cable ACN also is electrically connected through one of the symbolic contacts 906 and applied to the transformer 910 through line 912. Further, ground AC power cable ACG may be electrically connected to a further one of the symbolic contacts 906, through the plug connector 586 of the module plug 576, and applied to the transformer 910 and relay through line 914.

The transformer 910 can be any of a number of conventional and commercially available transformers, which provide for receiving AC input power on lines 908, 912 and 914, and converting the AC power to an appropriate DC power level for functional operation of components of the board assembly 826. For example, one type of transformer which may be utilized is manufactured and sold by Renco Electronics, Inc. of Rockledge, Fla. The transformer is identified under Renco's part number RL-2230. The transformer 910 may convert 120 volt AC power from the power cables AC1, ACN and ACG to an appropriate level of DC power for operation of components on the board assembly 826. The DC power generated by the transformer 910 is applied as output power signals on symbolic line 916 (which may consist of several wires or cables). The DC power on line 916 is applied as input power signals to the processor and repeater circuitry 896.

In addition to the connection to the transformer 910, the AC power signals on lines 908, 912 and 914 are also applied as input signals to a receptacle relay 918, as illustrated in FIG. 58A. The receptacle relay 918, like the transformer 910, can also be a relatively conventional and commercially available component. The receptacle relay 918 includes three output lines, namely lines 908A, 912A and 914A. The receptacle relay 918 can be characterized as having two states, namely an “on” state and an “off” state. When the receptacle relay 918 is in an on state, the electrical signals on lines 908, 912 and 914 are switched through to lines 908A, 912A and 914A, respectively. Accordingly, line 908A is a hot line (corresponding to AC power cable AC1) which is applied as an input line to the receptacle 838. Correspondingly, lines 912A and 914A are neutral and ground lines, respectively, which are also applied as input lines to the receptacle 838. Still further, control signals for controlling the particular state of the receptacle relay 918 are applied as input control signals from the processor and repeater circuitry 896 through control line 920.

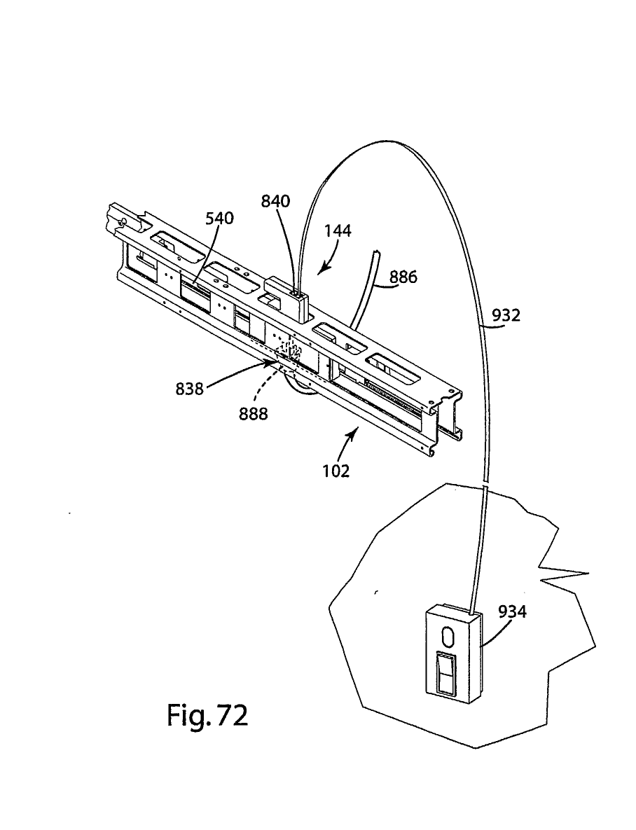

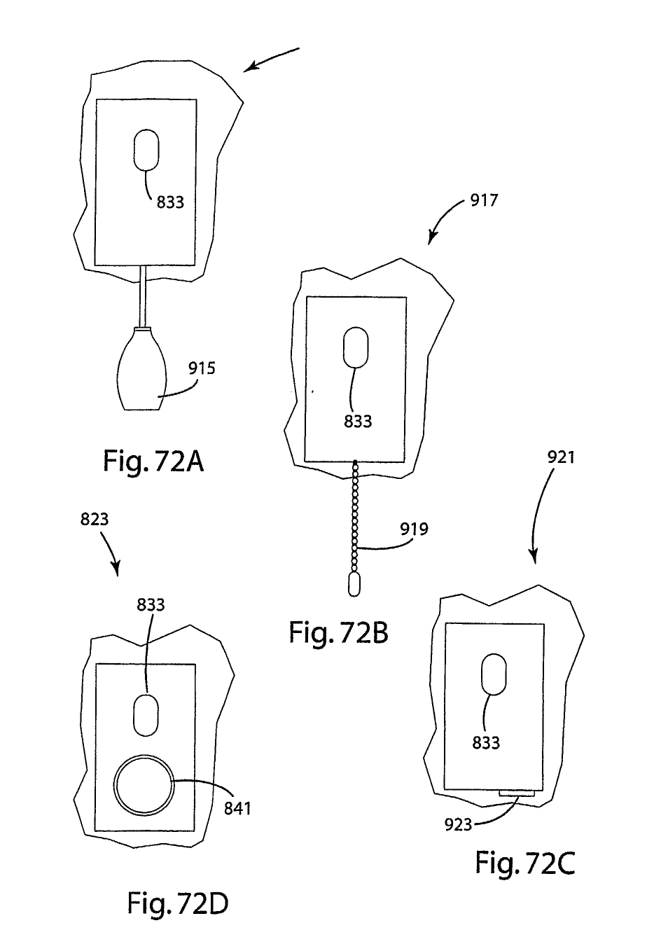

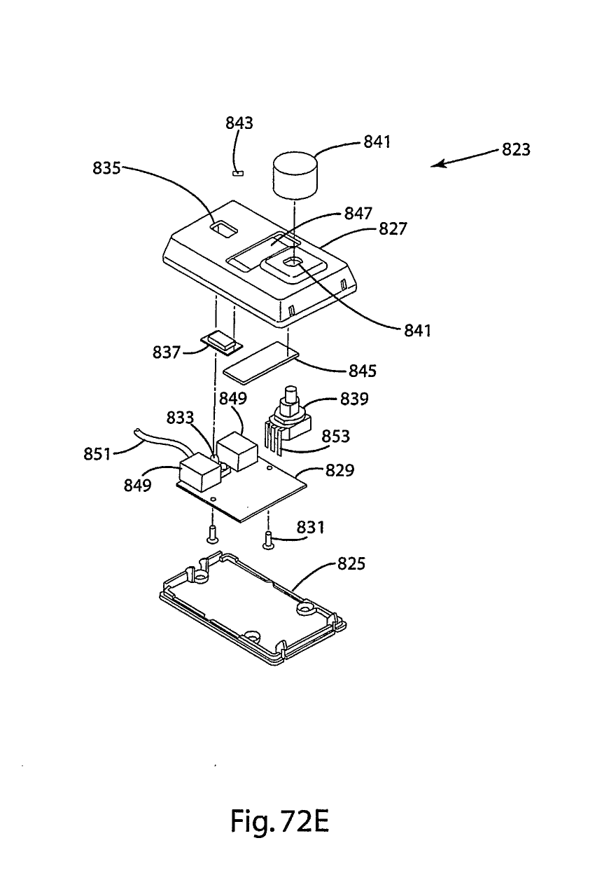

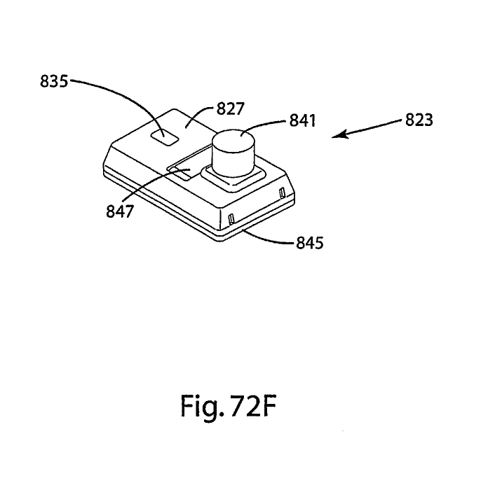

In operation, the receptacle connector module 144 may be “programmed” by a user through the use of the wand 892. The wand 892 may, for example, be utilized to transmit spatial signals 890 to the receptacle connector module 144, which essentially “announces” to the network 530 that the connector module 144 is available to be controlled. The wand 892 may then be utilized to transmit other spatial IR signals to an application device, such as a “switch,” which would then be “assigned” as a control for the connector module 144. The use of switches is subsequently described herein with respect to FIGS. 72A-72D. The switch will thereafter control application devices which may be “plugged into” the connector module 144 through the electrical receptacle 838. For example, it may be assumed that the receptacle 838 is electrically connected to the overhead fan 884 illustrated in FIG. 58. This connection can be made through the electrical cord 886 and plug 888 also illustrated in FIG. 58. The plug 888 is electrically engaged with the receptacle 838. With appropriate spatial signals 890 transmitted to the IR receiver 844 of the receptacle connector module 144, and to an IR receiver on the controlling application device (i.e., the switch) which is to control whether electrical power is applied through the receptacle 838, IR receiver circuitry will, in turn, transmit electrical signals on line 894 to the processor and repeater circuitry 896. The signals received by the processor and repeater circuitry 896 may, for example, be signals which would cause the processor and repeater circuitry 896 to program itself so as to essentially “look” for specific communication signal sequences from the communication cables CC1 and CC2. To undertake these functions, it is clear that the controlling application device (not shown in FIG. 58) also requires logic circuitry which may be “programmed.” Also, this logic circuitry must be capable of transmitting signals (either by wire or wireless) to the communications cables CC1 and CC2.

Assuming that programming has been completed, and assuming that the relay 918 is in an “off” state, meaning that electrical power is not being applied through receptacle 838, the user may activate the switch or other controlling device. Activation of this switch may then cause transmission of appropriate communication signal sequences on communication cables CC1 and CC2. The processor and repeater circuitry 896 will have been programmed to interrogate signal sequences received from the communication cables CC1 and CC2, and respond to particular sequences generated by the controlling switch, which indicate that power should be applied through the receptacle 838. In response to receipt of these signals on lines 900 and 902 from the communication cables CC1 and CC2, the processor and repeater circuitry 896 will cause appropriate control signals to be applied on line 920 as input signals to the receptacle relay 918. The receptacle relay 918 will be responsive to these signals so as to change states, meaning that the receptacle relay 918 will move from an off state to an on state. With this movement to an on state, power from the AC power cables AC1, ACN and ACG will be applied through the receptacle relay 918 to the receptacle 838. In this manner, the overhead fan 884 will be energized.

In addition to the foregoing components, the receptacle connector module 144 also includes other components and features in accordance with the inventions. For example, for purposes of providing a visual indication to a user of the current status of the receptacle connector module 144 (i.e., whether the receptacle connector module 144 is then currently powered and “hot”), the connector module 144 can include a status light 926. The status light can be secured to the structural components of the connector module 144 in any suitable manner, so as to be readily visible to the user. For this reason, it is preferable that the status light 926 extend outwardly from the lower surface 850 (see FIG. 51) of the outer structure of the connector module 144. The status light 926 can be controlled by status signals from the processor and repeater circuitry 896, as applied through line 928. In this regard, when the connector module 144 is “powered,” the processor and repeater circuitry 896 will be “aware” of the status, and can apply appropriate signals to the status light 926, indicating the same. The status light 926 can be any of a number of conventional lights, and may comprise an LED.

As subsequently described in greater detail, various types of connector modules can be utilized for various functions associated with the structural channel system 100. These functions are associated with AC power, DC power and network communications. As also previously described, network communications occur through communication signals on communication cables CC1 and CC2 of the communication cables 572 associated with the sections 540 of the modular plug assembly 130. Devices which are to act as controlling or control devices must therefore be coupled into the network 530. The prior description explained how an application device, such as the overhead fan 884 (FIG. 58), could be coupled into a programmable connector module comprising the receptacle connector module 144. As also described, controlling devices, such as switches and the like, may also be coupled into the network 530. These devices, which are also “smart” devices (in that they may include processors and associated electronic elements), have the capability of transmitting and receiving communication signals from connector modules through the communication cables 572, and are also powered. Accordingly, the structural channel system 100 in accordance with the invention provides means for supplying DC power to application devices, and for transmitting and receiving communication signals from and to these application devices and the communication cables 572.

This capability of providing communications to “smart” devices is provided in substantial part through the connector ports 840, which were previously described from a structural format with respect to FIG. 51. The ports 840 are symbolically shown as being part of the board assembly 826 in FIG. 58A. The connector ports 840 can be relatively conventional and commercially available communication ports, such as RJ45 ports, with a selected number of circuit wires being utilized with the ports. The connector ports 840 have bidirectional communications with the processor and repeater circuitry 896 through symbolic lines 922 and 924. The connector ports 840 provide a means for interconnecting switches and the like to the network 530. Specifically, through the processor and repeater circuitry 896, communication signals can be transmitted and received through the connector ports 840 to and from controlling devices with the use of patch cords (not shown in FIG. 58A) connecting the connector ports 840 to the controlling application devices. Still further, DC power can be applied from the processor and repeater circuit 896 through lines 922 and 924 and the connector ports 840 to interconnected controlling application devices, for purposes of powering circuit boards and other components within the switches or other application devices. In this regard, if necessary, the transformer 910 may generate a certain level of DC power on line 916, while the processor and repeater circuitry 896 may cause a different level of DC power to be generated on lines 922 and 924, and applied to various application devices through connector ports 840.

With the configuration shown for the connector ports 840 of the receptacle connector module 144, not only can communication signals and DC power be transmitted to interconnected application devices through lines 922 and 924, but such interconnected application devices can also transmit communication signals back to the processor and repeater circuitry 896 through the ports 840 and lines 922, 924. Such communication signals can then be processed by the processor and repeater circuitry 896, and/or the same or different communication signals (in response to the communication signals received on lines 922,924) can be transmitted to the communication cables CC1 and CC2 through lines 900 and 902. These lines 900 and 902 are then being utilized as lines for output signals from the processor and repeater circuitry 896, which are applied to the communication cables CC1 and CC2 through the symbolic contacts 898 and plug connector 586 of a modular plug 574. In this regard, FIG. 72 illustrates the coupling of connector ports 840 of a receptacle connector module 144 to a section 540 of the modular plug assembly 130. FIG. 72 further illustrates a patch cord 932 connected at one end to one of the connector ports 840, and connected at its other end to a connector port of a switch 934. It is in this manner that communication signals can be transmitted from the switch 934 to the connector module 144 and to communication cables CC1 and CC2 associated with the communication cables 572. These communication signals from the switch 934 may be utilized for various control purposes, including control of devices electrically interconnected to the receptacle 838 of the receptacle control module 144, such as through plug 888 and cord 886 shown, in part, in FIG. 72.

A further feature of the receptacle connector module 144, which is also associated with other connector modules subsequently described herein, relates to “repeater” functions. The connector module 144 includes repeater features associated with the processor and repeater circuitry 896. The repeater circuitry 896 is provided for purposes of maintaining signal and power strength. Such functions are relatively well known in the electronic arts. Repeater circuitry can take various forms, but may typically be characterized as circuitry which is used to extend the length, topology or interconnectivity of physical media beyond that imposed by individual segments. This is a relatively “complex” way to define the conventional activities of repeaters, which are to perform basic functions of restoring signal amplitudes, wave forms and timing to normal data and collision signals. Repeaters are also known to arbitrate access to a network from connected nodes, and optionally collect statistics regarding network operations.

In the receptacle connector module 144 as illustrated in FIG. 58A, the processor and repeater circuitry 896 utilizes DC power generated as output from the transformer 910 to operate its own internal circuitry, and to provide signal enhancement and apply output DC power illustrates the coupling of connector ports 840 of a receptacle connector module 144 to a section 540 of the modular plug assembly 130. FIG. 72 further illustrates a patch cord 932 connected at one end to one of the connector ports 840, and connected at its other end to a connector port of a switch 934. It is in this manner that communication signals can be transmitted from the switch 934 to the connector module 144 and to communication cables CC1 and CC2 associated with the communication cables 572. These communication signals from the switch 934 may be utilized for various control purposes, including control of devices electrically interconnected to the receptacle 838 of the receptacle control module 144, such as through plug 888 and cord 886 shown, in part, in FIG. 72.

A further feature of the receptacle connector module 144, which is also associated with other connector modules subsequently described herein, relates to “repeater” functions. The connector module 144 includes repeater features associated with the processor and repeater circuitry 896. The repeater circuitry 896 is provided for purposes of maintaining signal and power strength. Such functions are relatively well known in the electronic arts. Repeater circuitry can take various forms, but may typically be characterized as circuitry which is used to extend the length, topology or interconnectivity of physical media beyond that imposed by individual segments. This is a relatively “complex” way to define the conventional activities of repeaters, which are to perform basic functions of restoring signal amplitudes, wave forms and timing to normal data and collision signals. Repeaters are also known to arbitrate access to a network from connected nodes, and optionally collect statistics regarding network operations.

In the receptacle connector module 144 as illustrated in FIG. 58A, the processor and repeater circuitry 896 utilizes DC power generated as output from the transformer 910 to operate its own internal circuitry, and to provide signal enhancement and apply output DC power to each of the connector ports 840 through the lines 922, 924. Also, as earlier described, communication signals can be transmitted to and received from the communication cables 572 through the symbolic contacts 898 and lines 900 and 902. The processor and repeater circuitry 896 is adapted to enhance these communication signals. Such communication signals may be transmitted to and received from application devices connected to the connector ports 840.

In accordance with the foregoing, the connector module 144 includes not only features associated with control of power applied to the receptacle 838, but also provides for distributing power to interconnected application devices through the connector ports 840 connected to the processor and repeater circuitry 896, and for transmitting and receiving communication signals to and from interconnected application devices and the communication cables 572. Still further, the receptacle connector module 144 (and other connector modules as subsequently described herein) operate so as to provide repeater functions, which may be in the form of signal amplifications, wave shaping, collision priorities and the like. It should also be noted that in the example embodiment of the structural channel system 100 in accordance with the invention, functions such as signal amplification and the like can be performed solely with DC power provided through the transformer 910, and do not require any AC power directly provided from AC power cables 574. Further, these repeater functions also do not require any DC power received from outside of the corresponding connector module 144, such as from external transformers or the like.

As a primary feature of the receptacle module 144, the module 144 comprises means responsive to programming signals received from a user (utilizing the wand 892) to configure itself so as to be responsive to selectively control the application of AC power to the receptacle 838 from appropriate ones of the AC power cables 574. In this regard, and as earlier explained, although FIG. 58A illustrates AC power cable AC1 as being utilized, it is clear that cables AC2 or AC3 could also be utilized, with appropriate interconnections.

With respect to functions of the receptacle connector module 144, the combination of the IR receiver 844, processor and repeater circuitry 896, receptacle relay 918 and associated incoming and outgoing lines, may be characterized as an “actuator” 936. The actuator 936 is shown in FIG. 58A as consisting of the components captured within the phantom line boundary of the actuator 936. An actuator 936 may be found in all of the connector modules described herein, and each includes an IR receiver 844 and processor and associated repeater circuitry 896. Elements other than the receptacle relay 918 may be incorporated within the actuators 936 utilized with other connector modules. In this regard, an actuator 936 can be defined as a component of the electrical network 530 which controls the application of AC or DC power to devices such as light fixtures, projection screen motors, power poles and similar devices. Although this specification describes only a certain number of connector modules, for utilization with a certain number of application devices, it will be apparent that various other types of connector modules and application devices having functions differing from those described herein may be utilized with a structural channel system in accordance with the invention, without departing from the principal novel concepts of the invention.

With the use of the receptacle connector module 144, the module 144 and the application device to which the module is connected (in this instance, overhead fan 884) actually become part of the distributed electrical network 530. It should also be noted that this interconnection or addition of an application device (i.e., the overhead fan 884) to the structural channel system 100 has occurred, through use of the connector module 144, without requiring any physical rewiring or programming of any centralized computers or any other centralized control systems. The receptacle connector module 144 and other connector modules as subsequently described herein, in combination with the capability of being coupled to AC and DC power, and communication signals through communication cables 572, provide for a true distributed network. Also, it will be apparent to those of ordinary skill in the art that the processor and repeater circuitry 896 may include a number of elements, such as memory, microcode, instruction registers and the like for purposes of logically controlling the receptacle relay 918, in response to communication signals received by the processor and repeater circuitry 896. Concepts associated with “programming” a control switch electrically connected to the network 503, so that activation of the control switch will transmit communication signals which may be received by appropriate logic in the receptacle connector module 144, will be explained in somewhat greater detail in subsequent paragraphs relating to FIGS. 73-77. Other examples associated with the use of a manually operated and hand-held device for transmitting appropriate signals to program a “control/controlling” relationship between and among devices, including those associated directly with connector modules, are described in International Patent Application No. PCT/US03/12210, filed Apr. 18, 2003. The contents of the aforedescribed patent application are incorporated by reference herein.

Still further, it will also be apparent to those skilled in the art that the board assembly 826 of the receptacle connector module 144, and board assemblies of other connector modules subsequently described herein, may include a number of other electronic components. For example, the board assembly 826 may include line surge protection components, for purposes of component protection and safety. Also, the processor and repeater circuitry 896 may include various interface logic for purposes of communications with the status light 926 and IR receiver 844. In addition to the processor and repeater circuitry 896 including components such as those previously described herein, and components such as a microcontroller and oscillator, support components may be included. Such support components may include, for example, a micro debug interface circuit. Still further, for purposes of communications between the circuitry 896 and other components associated with the receptacle module 144 and the structural channel system 100, communications control logic may be included, and may also include logic associated with transceivers, signal arbitrations, “short to power” detection, and other functional components and features. Communications circuitry and software associated with communications from and to the processor and repeater circuitry 896 may also include various relays, relay control logic and other functional components and software such as zero crossing detectors.

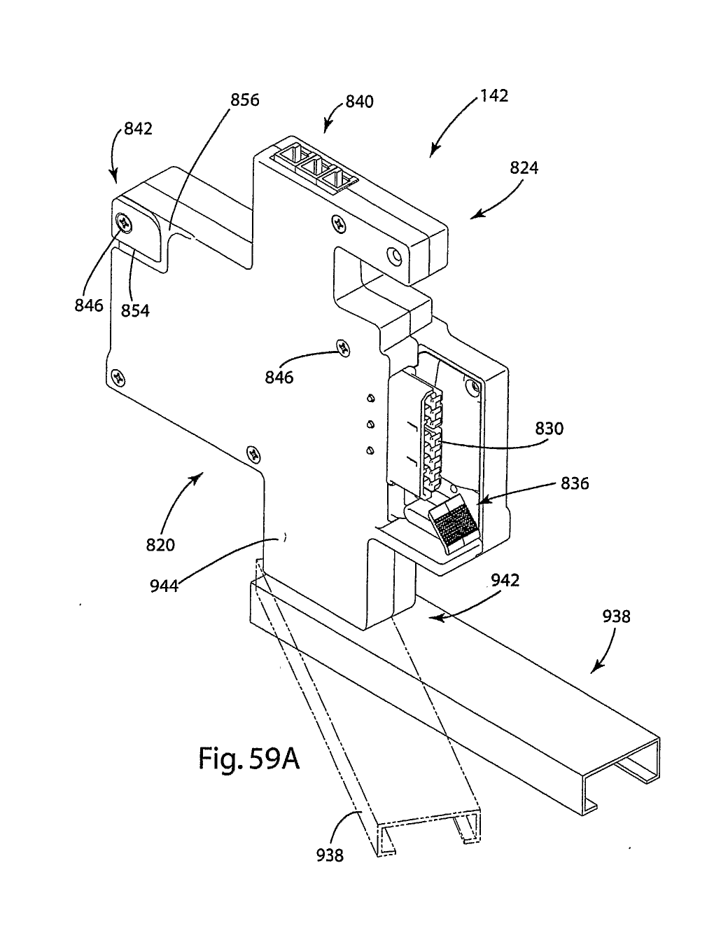

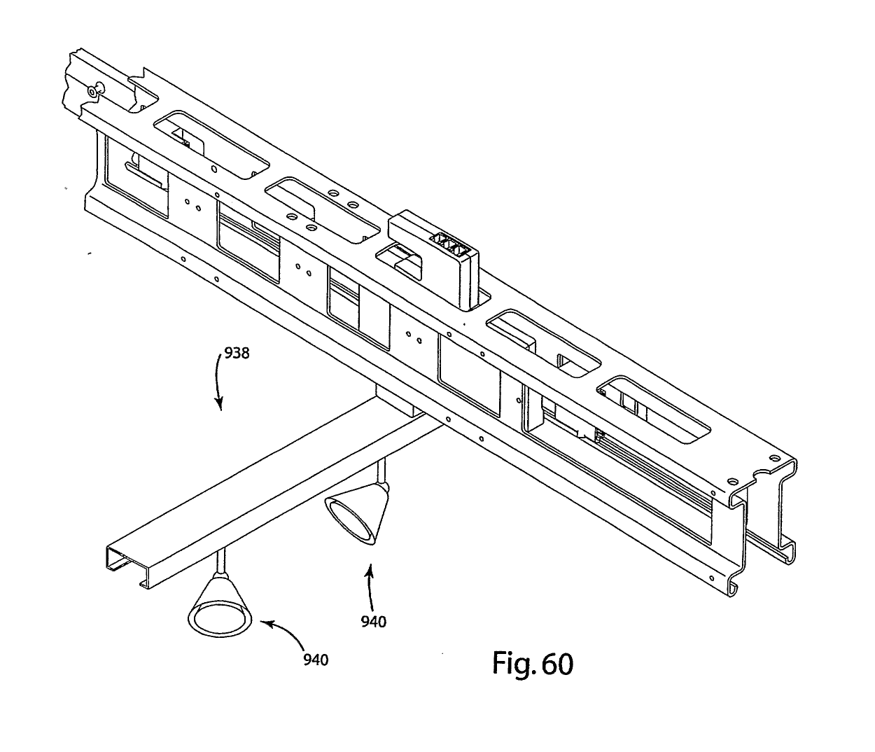

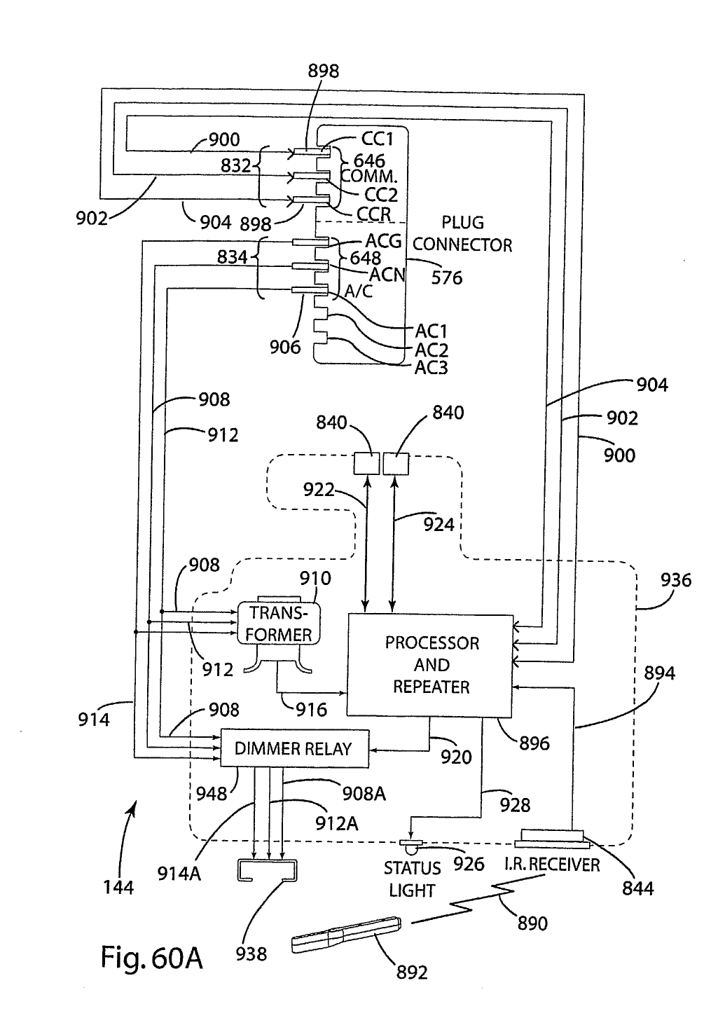

A number of differing connector modules may be utilized in accordance with the invention. As a further example, a connector module referred to as a dimmer connector module 142 is illustrated in FIGS. 59, 59A, 60 and 60A. The dimmer connector module 142 is similar in mechanical and electrical structure to the previously described receptacle module 144. However, the dimmer connector module 142 is adapted to interconnect to conventional dimmer lights, such as those that may be found on a track light rail 938 illustrated in FIGS. 59A and 60. Well known and commercially available lights, light rails and track lighting which may be utilized with the dimmer connector module 142 are adapted to receive electrical power input signals of varying voltages. The track light rail 938 is electrically and mechanically coupled to a series of lights 940, two of which are shown as an example embodiment in FIG. 60. The lights 940 are adapted to receive electrical power input signals of varying voltages, so as to vary the intensity of their. That is, when relatively lower voltages are applied as input power to the lights 940, the intensity of the emanating light is relatively low. Correspondingly, higher voltages will cause the lights 940 to emanate a higher intensity of light. In addition to using the concept of varying voltages for purposes of varying light intensity, other uses may also be employed in accordance with the invention. For example, the concept of utilizing connector modules for purposes of applying varying voltage signals may be utilized for sound intensity, acoustical management, fan speed and many other applications. In fact, the dimmer connector module 142 and similar connector modules which provide for varying output voltages may be utilized with any type of application device which will accept power signals of varying amplitudes.

Turning specifically to the dimmer connector module 142, and as earlier stated, the module 142 is somewhat similar to the receptacle connector module 144. Accordingly, like structure of the connector module 142 will be numbered with like reference numerals corresponding to the receptacle connector module 144. In FIG. 59, the dimmer connector module 142 is illustrated in a stand-alone configuration. As with the receptacle connector module 144, the dimmer connector module 142 can be referred to as a “smart” connector module, in that it includes certain logic which permits the connector module 142 to be programmed by a user (through a remote means) so as to initiate or otherwise modify a control/controlling relationship between devices energized through the dimmer connector module 142 and controlling devices, such as switches or the like. As with the receptacle connector module 144, the dimmer connector module 142 includes a connector housing 820. The connector housing 820 includes a front housing cover 822 and rear housing cover 824. Fasteners 846 extend through apertures in the front housing cover 822 and are secured with threaded couplers 848 within the rear housing cover 824 for purposes of securing the covers 822, 824 together. Secured within the connector housing 820 is a board assembly 826. The internal circuitry of the board assembly 826 will be described with respect to FIG. 60A. The board assembly 826 includes a connector plug 828, surrounded by a connector plug housing 829. A set of eight female terminals 830 extend toward the end of the connector plug 828 to the opening of the plug housing 829. The female terminals 830 include the communications female terminal set 832. The communications female terminal set 832 will be electrically connected to the communications male terminal set 646 previously described with respect to FIG. 42A. Correspondingly, an AC power female terminal set 834 is also provided as part of the connector plug 828. When coupled to a modular plug 576 of a section 540 of the modular plug assembly 130, the AC power female terminal set 834 will be engaged with the AC power male terminal set 648 of the modular plug 576, as also shown in FIG. 42A.

Also in a manner substantially corresponding to that of the receptacle connector module 144, the dimmer connector module 142 includes a connector latch assembly 836, for purposes of securing the connector plug 828 of the connector module 142 to a modular plug 576. The operation of the connector latch assembly 836 corresponds to the previously described operation of the connector latch assembly 836 associated with the receptacle connector module 144.

In addition to the foregoing, and like the receptacle connector module 144, the dimmer connector module 142 includes a set of two connector ports 840 at the top portion thereof. The connector ports 840 provide a means for transmitting communication signals to and from various application devices (including switches and the like). The communication signals may then be carried to and from the communication cables 572 associated with the modular plug assembly 130.

The dimmer connector module 142 also includes an IR receiver 844, located as shown in FIG. 59A at the lower portion of the connector housing 820. As with the receptacle connector module 144, the module 142 is electrically coupled to communication cables 572 and AC power cables 574 of the modular plug assembly 130 through a mating connection of the female terminals 830 within the connector plug 828 to the male blade sets or terminals 588, 590 of one of the modular plugs 576 associated with the plug assembly 130. Further, the dimmer connector module 142 also includes a ferrule coupler 842, used in combination with one of the spaced apart ferrules 570 which is secured to one of the electrical dividers 554 of a section 540 of the modular plug assembly 130. The structure and functional operation of the ferrule coupler 842 corresponds to that described with respect to the receptacle connector module 144 and illustrated in FIGS. 5 1A, 52 and 53. Accordingly, the functional operation of the ferrule coupler 842 for the dimmer connector module 142 will not be repeated herein.

To prevent any unintentional movement of the dimmer connector module 142, the connector module 142 further includes a connector latch assembly 836 corresponding in structure and function to the connector latch assembly 836 previously described with respect to the receptacle connector module 144. The structure and functional operation of the connector latch assembly 836 was previously described with respect to FIGS. 42A, 56 and 57. Accordingly, this description will not be repeated in detail herein for the dimmer connector module 142. As with the receptacle connector module 144, the connector latch assembly 836, in combination with a mating ramp 870 of a modular plug 576, and the ferrule coupler 842, in combination with a ferrule 570, serve to provide for mechanical interconnection of the dimmer connector module 142 to a section 540 of the modular plug assembly 130. With this interconnection, external forces must be manually exerted on a latch shoe 882 of the connector latch assembly 836, for purposes of disconnecting the dimmer connector module 142 from a modular plug 576. These components provide means for preventing inadvertent vertical or horizontal movement of the dimmer connector module 142, relative to the section 540 of the modular plug assembly 130.

In addition to the foregoing components, and unlike the receptacle connector module 144, the dimmer connector module 142 includes a lower dimmer housing 942 formed within the front dimmer housing 944 and rear dimmer housing 946 as shown in FIG. 59. The lower dimmer housing 942 will house electrical components interconnected to the board assembly 826 which are specifically adapted for interconnection to track lighting, conventional dimmer lights or other application devices which have are responsive to variations in voltage amplitudes applied to application device components. For purposes of providing AC power of varying voltages to an application device through dimmer circuitry within the lower dimmer housing 942, a dimmer relay 948 as subsequently described herein will be coupled to AC power form the AC power cables 574. As an example of use, and as shown in FIG. 60, the dimmer connector module 142 can be utilized to energize an electrical application device such as the track lighting 938. The track lighting 938 will be energized through appropriate electrical wires or cables (not shown) interconnected to dimmer circuitry within the dimmer connector module 142.

The internal circuitry on the board assembly 826 of the dimmer connector module 142 includes a number of components substantially corresponding to components of the receptacle connector module 144 previously described with respect to FIG. 58A. The internal circuitry of the dimmer connector module 142 is illustrated in FIG. 60A. Like numbers have been utilized as reference numerals for components corresponding to numbered components of the receptacle connector module 144. Accordingly, the dimmer connector module 142 includes the IR receiver 844, adapted to receive spatial IR signals 890 from the manually operable and hand-held wand 892. As earlier mentioned, the wand 892 is operated by a user, and will be described in greater detail with respect to FIGS. 73, 74 and 75. The IR receiver 844 converts incoming spatial IR signals 890 to electrical signals applied as output signals on line 894. These output signals are applied as input signals to the processor and associated repeater circuitry 896.

In addition to signals received by the processor and associated repeater circuitry 896 from the IR receiver 844 through line 894, the circuitry 896 also receives communication signals from cables CC1, CC2 and CCR of the modular plug assembly 130. The signals are tapped off the plug connector 586 of the modular plug 576. Signals from the communication cables CC1, CC2 and CCR are then received through the communications cable terminal set 646 (see FIG. 42A) of the plug connector 586. These terminals are coupled through the communications female terminal set 832 of the module 142. This connection is illustrated in FIG. 60A, through “symbolic” contacts 898. It should be noted that FIG. 60A represents the dimmer connector module 142 when the module 142 is mechanically and electrically engaged with a section 540 of the modular plug assembly 130, and an associated modular plug 576.

As further shown in FIG. 60A, communication signals are applied through the symbolic contacts 898 and lines 900 and 902 as input signals to the processor and associated repeater circuitry 896. Return communication cable CCR is also connected through a contact 898, with its signal applied to the circuitry 896 on line 904. The lines 900, 902 and 904 are bidirectional, and the circuitry 896 is adapted to generate output signals as communication signals to the cables CC1, CC2 and CCR through the contacts 898.

Turning to the AC power portion of the dimmer connector module 142, an AC power terminal set 648 is mounted on the plug connector 586 and connected to the AC power cables 574 (see FIG. 42) which run through the modular plug assembly 130. The terminal set 648 is interconnected to the AC power female terminal set 834 associated with the dimmer connector module 142 (see prior description with respect to FIG. 59). This interconnection is illustrated through the use of symbolic contacts 906.

In this particular embodiment of the dimmer connector module 142, the symbolic contacts 906 are illustrated as corresponding to electrical interconnection of AC power cables AC1, ACN and ACG. AC1 corresponds to the “hot” cable. However, as previously described herein, and for purposes of balancing and the like, AC power could be received by the connector module 142 utilizing AC power cables AC2 or AC3. Also as previously described, the line 908 and the symbolic contact 906 associated with AC power cable AC1 could actually be in the form of a pigtail secured to the transformer 910, and capable of being selectively interconnected to any of the terminals corresponding to the AC power cables AC1, AC2 or AC3. Of course, other types of configurations could be utilized for providing selective interconnection to one of the “hot” circuits made available for use with the dimmer connector module 142.

As with the receptacle connector module 144, the interconnections to the AC cables AC1, ACN and ACG can be applied as input through lines 908, 912 and 914, respectively, to the transformer 910. The transformer 910 for the dimmer connector module 142 may correspond in structure and function to the transformer 910 utilized with the receptacle connector module 144. The transformer 910 may convert AC power from the power cables AC1, ACN and ACG to DC power, applied as output power signals on symbolic line 916. The DC power on line 916 is applied as input power to the processor and repeater circuitry 896.

In addition to the connections to the transformer 910, the AC power signals on lines 908, 912 and 914 are also applied as input signals to what is illustrated in FIG. 60A as a dimmer relay 948. The dimmer relay 948 as illustrated in FIG. 60A includes output lines 908A, 912A and 914A. Control signals for the dimmer relay 948 are applied as output signals from the processor and associated repeater circuitry 896 on control line 920. With respect to operation of the dimmer relay 948, the AC power which is applied as input on lines 908, 912 and 914 will be relatively constant in amplitude. The control signals on line 920 applied to the dimmer relay 948 from the processor and associated repeater circuitry 896 will act so as to modify the AC output voltage amplitudes applied to the light track 938 through lines 908A, 912A and 914A. Various types of dimmer relays are well known and commercially available.

In operation, the dimmer connector module 142 may be “programmed” by a user through use of the wand 892. The wand 892 may, for example, be utilized to transmit spatial signals 890 to the dimmer connector module 142, which essentially “announces” to the network 530 that the connector module 142 is available to be controlled. The wand 892 may then be utilized to transmit other spatial IR signals to an application device, such as a dimmer switch, which would then be assigned as a control for the connector module 142. The use of switches is subsequently described herein with respect to FIGS. 72A-72F. The dimmer switch will thereafter control track lighting or other similar types of dimming devices which may be interconnected to the track light rail 938 or any other appropriate components for electrically coupling the dimming devices to the dimmer relay 948. For example, it may be assumed that the dimmer relay 948 is electrically connected through appropriate dimmer electronics to a track light rail 938, having the lights 940. With appropriate spatial signals 890 transmitted to the IR receiver 844 of the dimmer connector module 142, and to an IR receiver on the controlling application device (i.e. the dimmer switch) which is to control the amplitude of electrical power applied through the dimmer relay 948, IR receiver circuitry would, in turn, transmit electrical signals on line 894 to the processor and repeater circuitry 896. Signals received by the processor and repeater circuitry 896 may, for example, be signals which would cause the processor and repeater circuitry 896 to program itself so as to essentially “look” for specific communication signal sequences from the communication cables CC1 and CC2. To undertake these functions, it is clear that the controlling application device (not shown in FIG. 59) also requires logic circuitry which may be “programmed.” Such logic circuitry must be capable of transmitting signals (either by wire or wireless) to the communication cables CC1 and CC2.

Assuming that programming has been completed, and assuming that the dimmer relay 948 is essentially in a “zero” state, meaning that no electrical power is being applied through lines 908A, 912A and 914A, the user may activate the dimmer switch or other controlling device. Activation of this switch may then cause transmission of appropriate communication signal sequences on communication cables CC1 and CC2. The processor and repeater circuitry 896 would have been programmed to interrogate signal sequences received from the cables CC1 and CC2, and respond to particular sequences generated by the controlling dimmer switch, which indicate the level of power which should be applied through the dimmer relay 948. In response to receipt of these signals on lines 900 and 902 from the cables CC1 and CC2, respectively, the processor and repeater circuitry 896 will cause appropriate control signals to be applied on control line 920 as input signals to the dimmer relay 948. The dimmer relay 948 will be responsive to these signals so as to vary the amplitude of power or voltage which is permitted to “pass through” the dimmer relay 948 from the lines 908, 912 and 914. Accordingly, the output intensity of the lights 940 may be varied, in accordance with the level of power transmitted through the dimmer relay 948.

In addition to the foregoing components, the dimmer connector module 142 also includes other components and features in accordance with the invention. As with the receptacle connector module 144, the dimmer connector module 142 can include a status light 926. The light can be controlled by status signals from the processor and repeater circuitry 896, as applied through line 928. In addition, for purposes of coupling various application devices into the network 530, the dimmer connector module 142, like the connector module 144, includes a pair of connector ports 840. The connector ports 840 have bidirectional communications with the processor and repeater circuitry 896 through symbolic lines 922 and 924. Communication signals can be transmitted or received through the connector ports 840 to and from controlling devices with the use of patch cords (not shown in FIG. 60A) connecting the connector ports 840 to the controlling application devices. Also, with the configuration shown for the connector ports 840 of the dimmer connector module 142, not only can communication signals and DC power be transmitted to interconnected application devices through lines 922 and 924, and connector ports 840, but such interconnected application devices can also transmit communication signals back to the processor and repeater circuitry 896 through the ports 840 and lines 922, 924. Such communication signals can then be processed by the circuitry 896, and the same or different communication signals can be transmitted to the communication cables CC1 and CC2 through lines 900 and 902. In this manner, communication signals from the application devices can be applied to the network 530. Still further, and as with the receptacle connector module 144, the dimmer connector module 142 includes the IR receiver 844, processor and repeater circuitry 896 and associated incoming and outgoing lines. These components, along with the dimmer relay 948, may be characterized as an “actuator” 936, as shown in FIG. 60A. Further, with the use of the dimmer connector module 142, the module 142 and the application device to which the module is connected become part of the distributed electrical network 530. In accordance with all of the foregoing, the dimmer connector module 142 comprises a means responsive to programming signals received from a user to configure itself so as to be responsive to selectively control the amplitude of AC voltages applied to application devices connected to the dimmer relay 948.

It should be emphasized that variations in the dimmer connector module 142 and the interconnected track light rail 948 may be implemented, without departing from the spirit and scope of certain of the novel concepts of the invention. For example, the track light rail 948 may be mechanically coupled to the bottom of the dimmer connector module 142, in a manner so that the rail 948 may be rotated in a horizontal plane. Accordingly, the rail 948 may be “angled” relative to the elongated axis of a section 540 of the modular plug assembly 130. This concept is illustrated in FIG. 59A, with an angled configuration of the rail 948 being shown in phantom line format.

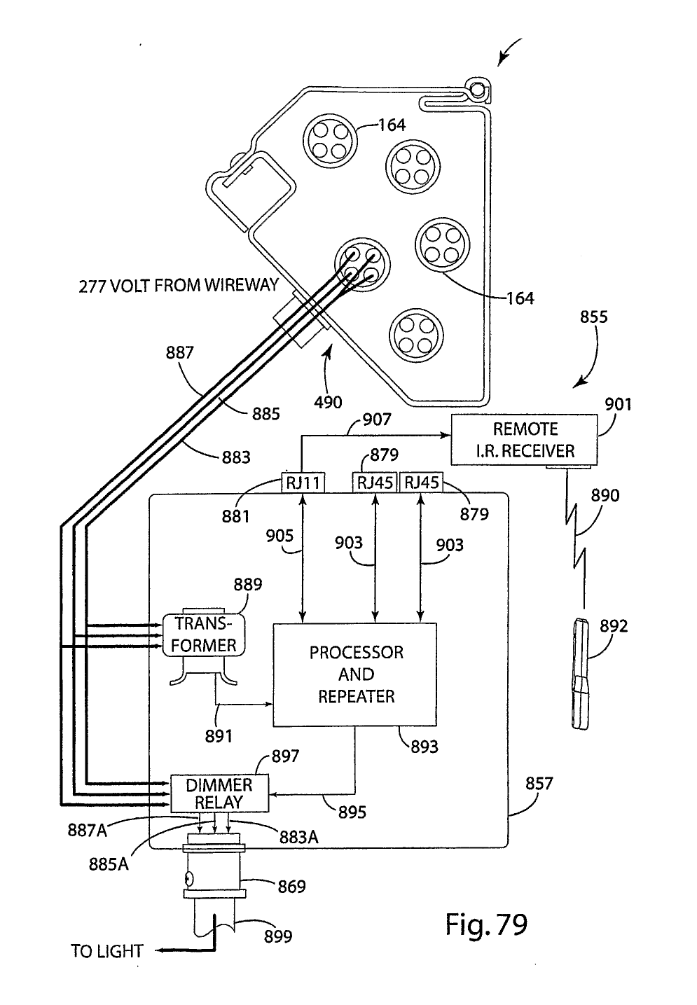

Another aspect of the dimmer connector module 142 and other connector modules which may be utilized in accordance with the invention should be mentioned. In the embodiment of the dimmer connector module illustrated herein, the IR receiver 844 for programmable control of the connector module 142 is located on the bottom of the connector module 142 itself. If desired, the dimmer connector module 142 could be wired so as to couple the logic and electronics within the connector module 142 to receivers located remotely from the connector module 142. In this manner, when a user wishes to remotely program the control/controlling relationships involving the lights 940, the user can transmit IR or other spatial signals to IR receivers adjacent the actual lights 940 which the user wishes to control. Otherwise, and particularly if the lights 940 may be located a substantial distance form the connector module 142, the user will essentially need to “back track” from the lights 940 so as to determine the location of the connector module 142 associated with the lights 940. This concept of utilizing a remotely positioned IR receiver 844 is described in subsequent paragraphs herein with respect to the dimmer junction box assembly 855 illustrated in FIGS. 79, 80 and 81.

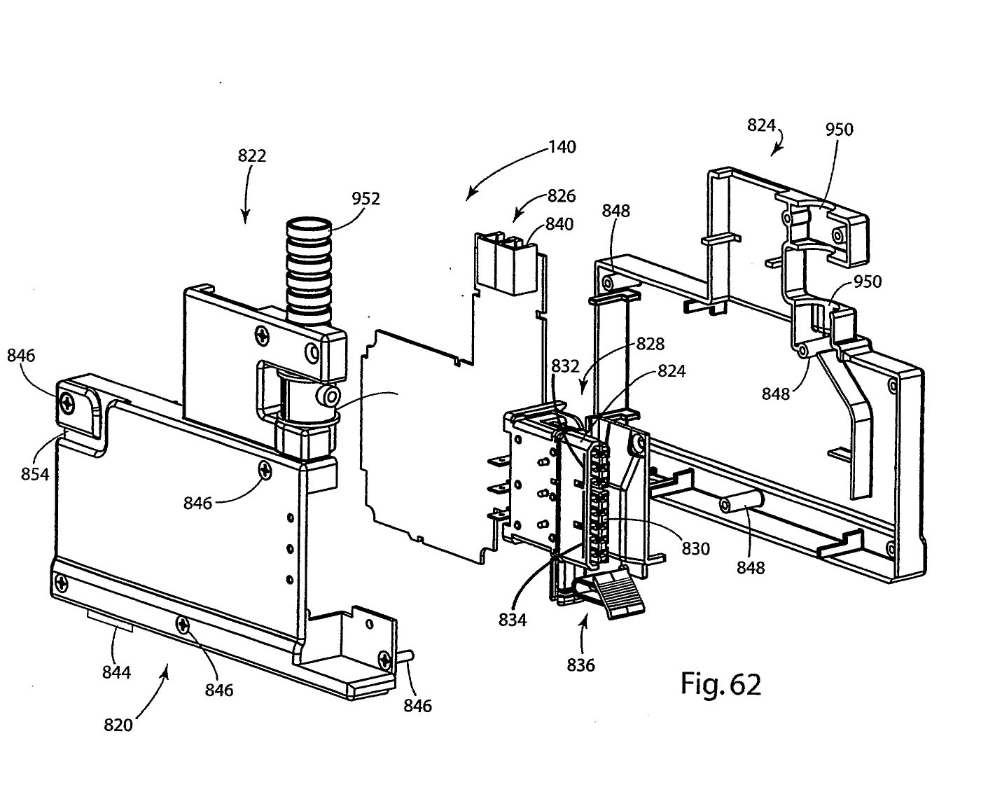

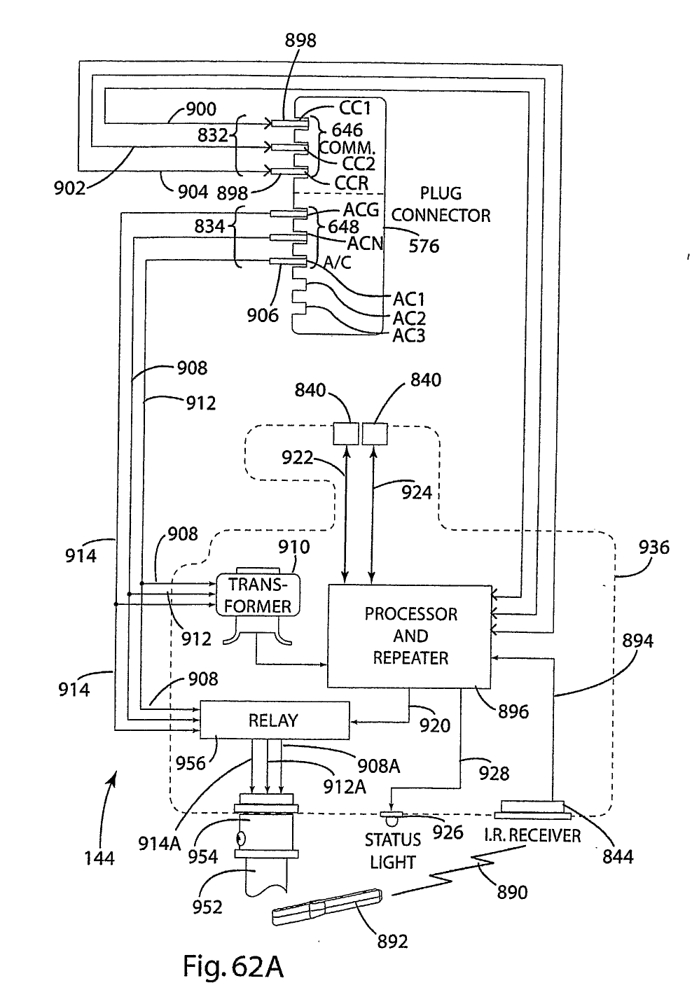

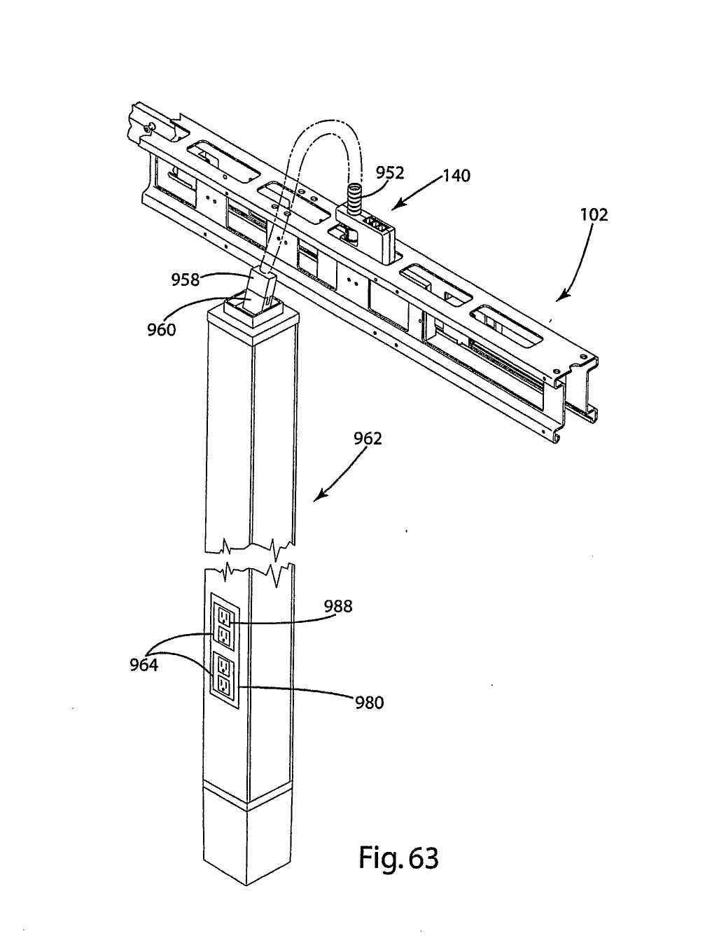

A still further example of a connector module which may be utilized in accordance with the invention is referred to herein as a power drop connector module 140, and is illustrated in FIGS. 62, 62A and 63. The power drop connector module 140 is substantially similar to the receptacle connector module 144. Accordingly, like structure of the connector module 140 will be numbered with like reference numerals corresponding to the receptacle connector module 144. The power drop connector module 140 is adapted to provide selectable AC power to application devices coupled to the connector module 140, such as the pole 962 described in subsequent paragraphs herein. Turning primarily to FIG. 62, the power drop connector module 140 is illustrated therein in a stand-alone configuration. As with the receptacle connector module 144, the power drop connector module 140 can be referred to as a “smart” connector module, in that it includes certain logic which permits the connector module 140 to be programmed by a user (through remote means) so as to initiate or otherwise modify a control/controlling relationship among devices energized through the power drop connector module 140, and also to control the devices, such as through switches or the like.

As with the receptacle connector module 144, the power drop connector module 140 includes a connector housing 820. The connector housing 820 includes a front housing cover 822 and rear housing cover 824. Fasteners 846 extend through apertures in the front housing cover 822 and are secured with threaded couplers 848 within the rear housing cover 824 for purposes of securing the covers 822, 824 together. Secured within the connector housing 820 is a board assembly 826. The internal circuitry of the board assembly 826 will be described with respect to FIG. 62A. The board assembly 826 includes a connector plug 828, surrounded by a connector plug housing 829. A set of eight female terminals 830 extend toward the end of the connector plug 828 to the opening of the plug housing 829. The female terminals 830 include the communications female terminal set 832. The communications female terminal set 832 will be electrically connected to the communications male terminal set 646 of a modular plug 576, previously described with respect to FIG. 42A. Correspondingly, an AC power female terminal set 834 is also provided as part of the connector plug 828. When coupled to a modular plug 576 of a section 540 of the modular plug assembly 130, the AC power female terminal set 834 will be engaged with the AC power male terminal set 648 of the modular plug 576, as also shown in FIG. 42A.

Also like the receptacle connector module 144, the power drop connector module 140 includes a set of two connector ports 840 at the top portion thereof. The connector ports 840 provide a means for transmitting communication signals to and from various application devices (including switches and the like), as well as a means for transmitting DC power to “smart” devices, such as switches. The communication signals may also be carried to and from the communication cables 572 associated with the modular plug assembly 130. The power drop connector module 140 also includes an IR receiver 844, located as shown in FIG. 62 at the lower portion of the connector housing 820. As with the receptacle connector module 144, the module 140 is electrically coupled to communication cables 572 and AC power cables 574 of the modular plug assembly 130 through a mating connection of the female terminals 830 within the connector plug 828 to the male blade sets or terminals 588, 590 of one of the modular plugs 576 associated with the plug assembly 130.

Further, the power drop connector module 140 also includes a ferrule coupler 842, used in combination with one of the spaced apart ferrules 570 which is secured to one of the electrical dividers 554 of a section 540 of the modular plug assembly 130. The structure and functional operation of the ferrule coupler 842 corresponds to that described with respect to the receptacle connector module 144 and illustrated in FIGS. 51A, 52 and 53. Accordingly, the functional operation of the ferrule coupler 842 for the power drop connector module 140 will not be repeated herein. The connector module 140 also includes a connector latch assembly 836 corresponding in structure and function to the connector latch assembly 836 previously described with respect to the receptacle connector module 144 and FIGS. 42A, 56 and 57. Accordingly, this description will not be repeated herein for the power drop connector module 140. As with the receptacle connector module 144, the connector latch assembly 836, in combination with a mating ramp 870 of a modular plug 576, and the ferrule coupler 842, in combination with a ferrule 570, provide mechanical interconnection of the power drop connector module 140 to a section 540 of the modular plug assembly 130. With this interconnection, external forces must be manually exerted on a latch shoe 882 of the connector latch assembly 836, for purposes of disconnecting the power drop connector module 140 from a modular plug 576. These components provide means for preventing inadvertent vertical or horizontal movement of the power drop connector module 140, relative to the section 540 of the modular plug assembly 130.

In addition to the foregoing components, and unlike the receptacle connector module 144, the power drop connector module 140 includes a pair of conduit slots 950 formed within the front housing cover 822 and rear housing cover 824, as illustrated in FIG. 62. A flexible conduit 952 extends upwardly from an upper portion of the front housing cover 822. The flexible conduit 952 is secured to the entirety of the housing cover 820 through a bushing 954, preferably having strain relief properties. As will be described with respect to FIG. 62A, AC power lines will extend through the flexible conduit 952, which are connected through a switching relay to the AC power cables 574 in the modular plug assembly 130. The flexible conduit 952 can include a universal connector at its terminating end, such as the connector 958 illustrated in FIG. 63. In this manner, AC power from the AC power cables 574 can be selectively applied to application devices connected to the flexible conduit 952. As an example, and as shown in FIG. 63, the power drop connector module 140 can be utilized to selectively energize an application device such as the power pole 962.

The internal circuitry on the board assembly 826 of the power drop connector module 140 includes a number of components substantially corresponding to components of the receptacle connector module 144 previously described with respect to FIG. 58A. This circuitry is illustrated in FIG. 62A. Like numbers have been utilized as reference numerals for components corresponding to numbered components of the receptacle connector module 144. Accordingly, the power drop connector module 142 includes the IR receiver 844, adapted to receive spatial IR signals 890 from the manually operable and hand-held wand 892. As earlier mentioned, the wand 892 is operated by a user, and will be described in greater detail with respect to FIGS. 73, 74 and 75. The IR receiver 844 converts incoming spatial IR signals 890 to electrical signals applied as output signals on line 894. These output signals are applied as input signals to the processor and associated repeater circuitry 896.

In addition to signals received by the processor and associated repeater circuitry 896 from the IR receiver 844 through line 894, the circuitry 896 also receives communication signals from cables CC1, CC2 and CCR of the modular plug assembly 130. These signals are received through the communications cable terminal set 646 (see FIG. 42A) of the plug connector 586. These terminals are coupled through the communications female terminal set 832 of the module 140. This connection is illustrated in FIG. 62A, through “symbolic” contacts 898. It should be noted that FIG. 62A represents the power drop connector module 140 when the module 140 is mechanically and electrically engaged with a section 540 of the modular plug assembly 130, and an associated modular plug 576.

As further shown in FIG. 62A, communication signals are applied through the symbolic contacts 898 and lines 900 and 902 as input signals to the processor and associated repeater circuitry 896. Return communications cable CCR is also connected through a contact 898, with its signal applied to the circuitry 896 on line 904. The lines 900, 902 and 904 are bidirectional, and the circuitry 896 is adapted to generate output signals as communication signals applied to the cables CC1, CC2 and CCR through the contacts 898.

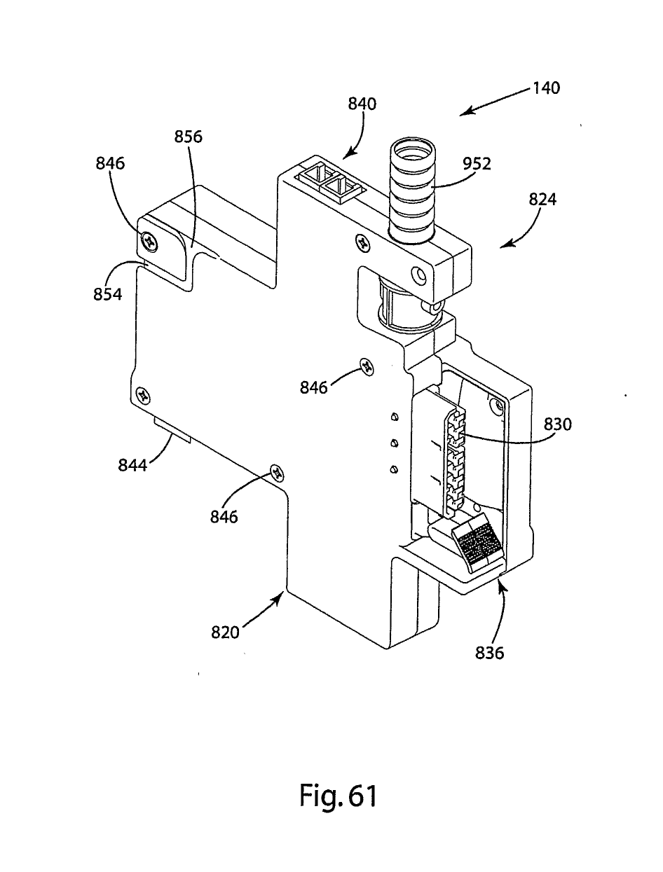

Turning to the AC power portion of the power drop connector module 140, an AC power terminal set 648 is mounted on the plug connector 586 and connected to the AC power cables 574 (see FIG. 42) which run through the modular plug assembly 130. The terminal set 648 is interconnected to the AC power female terminal set 834 associated with the power drop connector module 142 (see prior description with respect to FIGS. 61 and 62). This interconnection is illustrated through the use of symbolic contacts 906.

In this particular embodiment of the power drop connector module 140, the symbolic contacts 906 are illustrated as corresponding to electrical interconnection of AC power cables AC1, ACN and ACG. AC1 corresponds to the “hot” cable. However, as previously described herein, and for purposes of balancing and the like, AC power could be received by the connector module 142 utilizing AC power cables AC2 or AC3. Also, as previously described, the line 908 and the symbolic contact 906 associated with AC power cable AC1 could actually be in the form of a pigtail and selectively secured to the transformer 910, and capable of being interconnected to any of the terminals corresponding to the AC power cables AC1, AC2 or AC3. Also, of course, other types of configurations could be utilized for providing selective interconnection to one of the “hot” circuits made available for use with the power drop connector module 140.

As with the receptacle connector module 144, the power from the AC cables AC1, ACN and ACG can be applied as input through lines 914, 912 and 908, respectively, to the transformer 910. The transformer 910 for the power drop connector module 140 may correspond in structure and function to the transformer 910 utilized with the receptacle connector module 144. The transformer 910 may convert AC power from the power cables AC1, ACN and ACG to DC power, applied as output power signals on symbolic line 916. The DC power on line 916 is applied as input power to the processor and repeater circuitry 896.

In addition to the connections to the transformer 910, the AC power signals on lines 908, 912 and 914 are also applied as input signals to what is illustrated in FIG. 62A as a relay 956. The relay 956, like the transformer 910, can be a relatively conventional and commercially available device. The replay 956 includes three output lines, namely lines 908A, 912A and 914A. Further, the relay 956 can be characterized as having two states, namely an “on” state and an “off” state. When the relay 956 is in an on state, the electrical AC power signals on lines 908, 912 and 914 are switched through to lines 908A, 912A and 914A, respectively. Accordingly, line 908A is a hot line (corresponding to AC power cable AC1) which is applied as an input line to the flexible conduit 952. Correspondingly, lines 912A and 914A are neutral and ground lines, respectively, which are also applied as input lines to the conduit 952. Still further, control signals for controlling the particular state of the relay 956 are applied as input control signals from the processor and repeater circuitry through control line 920.

In operation, the power drop connector module 140 may be “programmed” by a user through the use of the wand 892. The wand 892 may, for example, be utilized to transmit spatial signals 890 to the power drop connector module 140, which essentially “announces” to the network 530 that the connector module 140 is available to be controlled. The wand 892 may then be utilized to transmit other spatial IR signals to an application device, such as a “switch,” which would then be “assigned” as a control for the connector module 140. The use of switches is subsequently described herein with respect to FIGS. 72A-72F. The switch will thereafter control application devices which may be connected to a terminating end of the flexible conduit 952. For example, it may be assumed that the flexible conduit 952, with its universal connector 958, is electrically connected to the power pole 962 illustrated in FIG. 63. With appropriate spatial signals 890 transmitted to the IR receiver 844 of the power drop connector module 140, and to an IR receiver on the controlling application device (i.e., the switch) which is to control whether electrical power is applied through the flexible conduit 952, IR receiver circuitry will, in turn, transmit electrical signals on line 894 to the processor and repeater circuitry 896. The signals received by the processor and repeater circuitry 896 may, for example, be signals which would cause the processor and repeater circuitry 896 to program itself so as to essentially “look” for specific communications signals sequences from the communication cables CC1 and CC2. To undertake these functions, it is clear that the controlling application device (not shown in FIG. 62A or FIG. 63) also requires logic circuitry which may be “programmed.” In addition, the logic circuitry should be capable of transmitting signals (either by wire or wireless) to the communication cables CC1 and CC2.

Assuming that programming has been completed, and assuming that the relay 956 is in an “off” state, meaning that electrical power is not being applied through the flexible conduit 952, the user may activate the switch or other controlling device. Activation of this switch may then cause transmission of appropriate communication sequences on communication cables CC1 and CC2. The processor and repeater circuitry 896 will have been programmed to interrogate signal sequences received from the cables CC1 and CC2, and respond to particular sequences generated by the controlling switch, which indicate that power should be applied to the flexible conduit 952 through the relay 956. In response to receipt of these signals on lines 900 and 902 from the communication cables CC1 and CC2, the processor and repeater circuitry 896 will cause appropriate control signals to be applied on line 920 as input signals to the relay 956. The relay 956 will be responsive to these signals so as to change states, meaning that the relay 956 will move from an off state to an on state. With this movement to an on state, power from the AC power cables AC1, ACN and ACG will be applied through the relay 956 to the flexible conduit 952. In this manner, the power pole 962 may be energized.

In addition to the foregoing components, the power drop connector module 140 also includes other components and features in accordance with the invention. As with the receptacle connector module 144, the power drop connector module 140 can include a status light 926. The light can be controlled by status signals from the processor and repeater circuitry 896, as applied through line 928. In addition, for purposes of coupling various application devices into the network 530, the power drop connector module 140, like the connector module 144, includes the connector ports 840. The connector ports 840 have bidirectional communications with the processor and repeater circuitry 896 through symbolic lines 922 and 924. Communication signals can be transmitted or received through the connector ports 840 to and from controlling devices with the use of patch cords (not shown in FIG. 62A) connecting the connector ports 840 to the controlling application devices. Also, with the configuration shown for the connector ports 840 of the power drop connector module 140, not only can communication signals and DC power be transmitted to interconnected application devices through lines 922 and 924, and connector ports 840, but such interconnected application devices can also transmit communication signals back to the processor and repeater circuitry 896 through the ports 840 and lines 922, 924. Such communication signals can then be processed by the circuitry 896, and the same or different communication signals can be transmitted to the communication cables CC1 and CC2 through lines 900 and 902. In this manner, communication signals from the application devices can be applied to the network 530. Still further, and as with the receptacle connector module 144, the power drop connector module 140 includes the IR receiver 844, processor and repeater circuitry 896 and associated incoming and outgoing lines. These components, along with the relay 956, may be characterized as an “actuator” 936, as shown in FIG. 62A. Further, with the use of the power drop connector module 140, the module 140 and the application device to which the module is connected become part of the distributed electrical network 530. In accordance with all of the foregoing, the power drop connector module 140 comprises a means responsive to programming signals received from a user to configure itself so as to be responsive to selectively control the application of AC power through the relay 956 to wires or cables within the flexible conduit 952, and therefore to interconnected application devices.

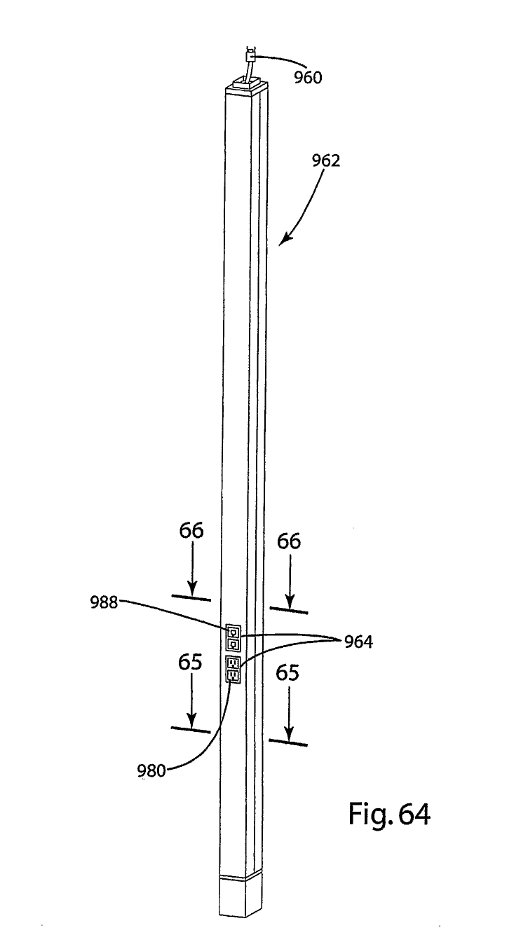

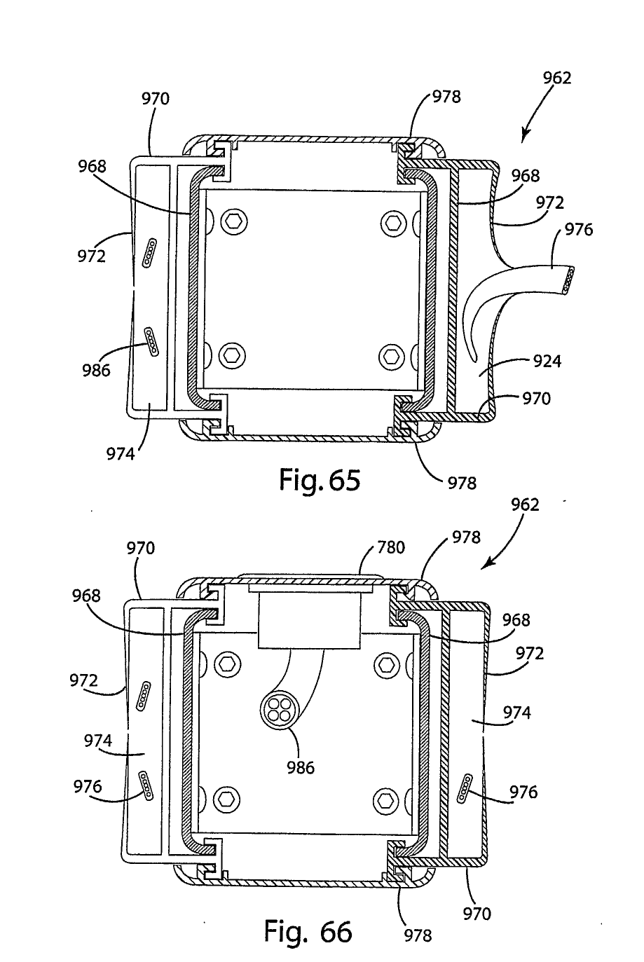

In accordance with the foregoing, the power drop connector module 140 is adapted to provide AC power from the AC power cables 574 associated with the modular plug assembly 130, to application devices such as the power pole 962 illustrated in FIGS. 63 and 64. The power pole 962 will now be described in greater detail, with respect to FIGS. 63-66. Referring thereto, the power pole 962 is adapted to be electrically coupled to AC power from the overhead structure of the structural channel system 100. Structurally, the power pole 962 is further adapted to be secured at its lower portion to a floor or other ground level structure. With reference primarily to FIGS. 64, 65 and 66, the power pole 962 includes a base 966, with a base cover surrounding the base 966. Extending upwardly from the base 966 are a pair of metallic and opposing side frames 968, in the form of metal extrusions. The side frames 968 are illustrated in FIGS. 65 and 66. Preferably, the side frames 968 are welded or otherwise connected to the base 966, and extend upwardly so as to form the basic frame of the power pole 962. For purposes of stability, the side frames 968 can be welded or otherwise connected through braces (not shown) at various intervals along the vertical length of the power pole 962.

The power pole 962 further includes a pair of opposing plastic pole extrusions 970. The pole extrusions 970 have the cross sectional configurations illustrated in FIGS. 65 and 66. These pole extrusions 970 include flexible covers 972, which form spaces 974 through which components, such as DC cables 976, may enter and extend. In addition to the opposing plastic pole extrusions 970, the power pole 962 further includes plastic extrusion side covers 978. The cross sectional configurations of the covers 978 are illustrated in FIGS. 65 and 66. These side covers 978, at least at their lower portions, are constructed of plastic materials which can be relatively easily cut, for purposes of providing openings through which electrical components may be coupled to the power pole 962. For example, FIG. 63 illustrates the use of a plastic outlet cover 980 secured to the power pole 962 for purposes of coupling two electrical receptacle pairs 964 to the power pole 962. In an alternative configuration, FIG. 64 illustrates the use of a plastic outlet cover 980 with one electrical receptacle pair 964 and a pair of DC jacks 988.

At the top of the power pole 962, a top cap 984 can be secured to the pole 962. The top cap 984 includes a central aperture through which an AC cable 986 may extend. The AC cable 986 is adapted to extend through the center of the power pole 962, and can be utilized to provide AC power to components such as the electrical outlet receptacle pair 964. At its terminating end at the top, the AC cable 986 is connected to a conventional AC connector 960. The AC connector 960 is adapted to connect, for example, to the AC connector 958 and the flexible conduit 952 of the power drop connector module 140, as illustrated in FIG. 63. In the particular embodiment of the power pole 962 in accordance with the invention as illustrated herein, DC power is not provided from any transformers associated with the connector modules. Instead, if DC power is required, the same could be provided through sources external to the structural channel system 100. On the other hand, however, there is nothing to prevent DC power or communication signals from being applied to the power pole 962 from the modular plug assembly 130. In general, the power pole 962 provides means for applying power (and communications and data, if desired) downwardly from the overhead structure of the structural channel system 100. The power pole 962 is adapted to permit selectivity in providing multiple outlets, data jacks or other electrical components to a user in a manner so as to facilitate accessibility.

In accordance with the foregoing description, the universal connector 958 can be characterized as being adapted to receive the power pole connector 960. The power pole connector 960 can be characterized as a multi-terminal mating power connector. Also, with respect to previous descriptions herein for dimmers adapted to be used with multiple voltages, such dimmer connectors can be characterized as “multiple voltage relays.” These multiple voltage relays are releasably connected to multiple voltage switches of the application devices.

The connector modules 140, 142 and 144 as described herein all utilize, in some manner, AC power from the AC power cables 574, through connections with modular plugs 576 of the modular plug assembly 130. Also with use of the modular plugs 576, the previously described connector modules directly receive communication signals from the communication cables 572 of the modular plug assembly 130. Power on the modular plug assembly 130 may typically be 120 volt AC power. However, as previously described, the wireways 122 are isolated and shielded, for purposes of carrying relatively high voltage power. For example, as previously described with respect to FIGS. 2 and 32, the wireways 122 may carry 277 volt AC power as the user may “tap off” the power cables 164 within the wireways 122 at varying locations along the lengths of the wireways 122, with electrical connections through knockouts 490. In certain instances, it is also advantageous if application of power from the power cables 164 of the wireways 122 to interconnected application devices is controlled. For example, certain dimmer lights are adapted for use with 277 volt maximum input. Accordingly, it would be worthwhile to have the capability of connecting such application devices to power cables 164 of wireways 122, if the power cables 164 are carrying 277 volt AC. Although such connections could be made directly, it would also be advantageous if control of the light intensity for such application devices could be maintained as part of the electrical network 530. For this reason, the structural channel system 100 may include means for providing a “smart” connection of the power cables 164 to interconnected application devices through the network 530.

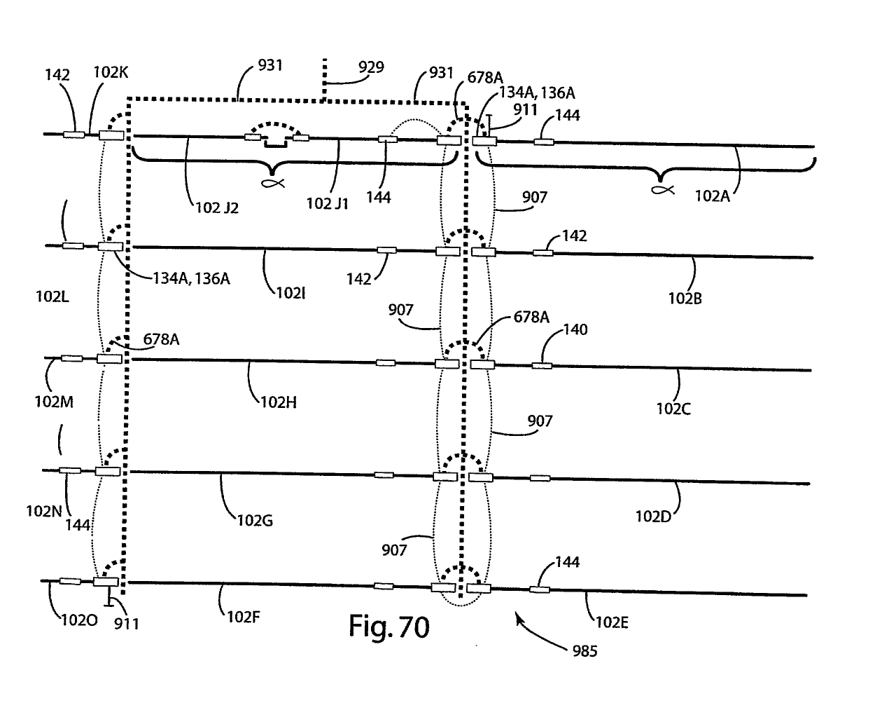

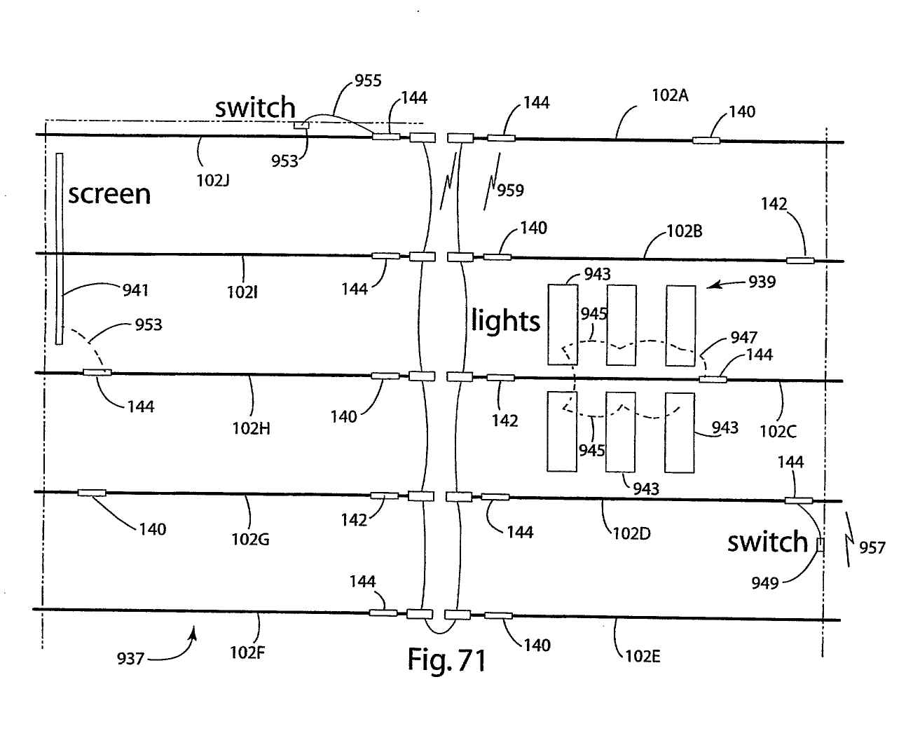

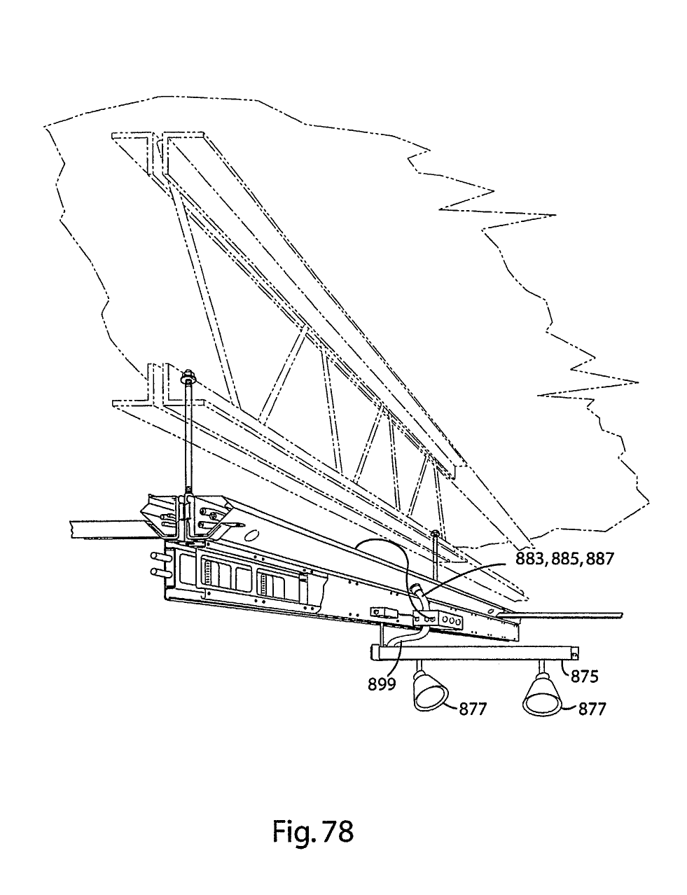

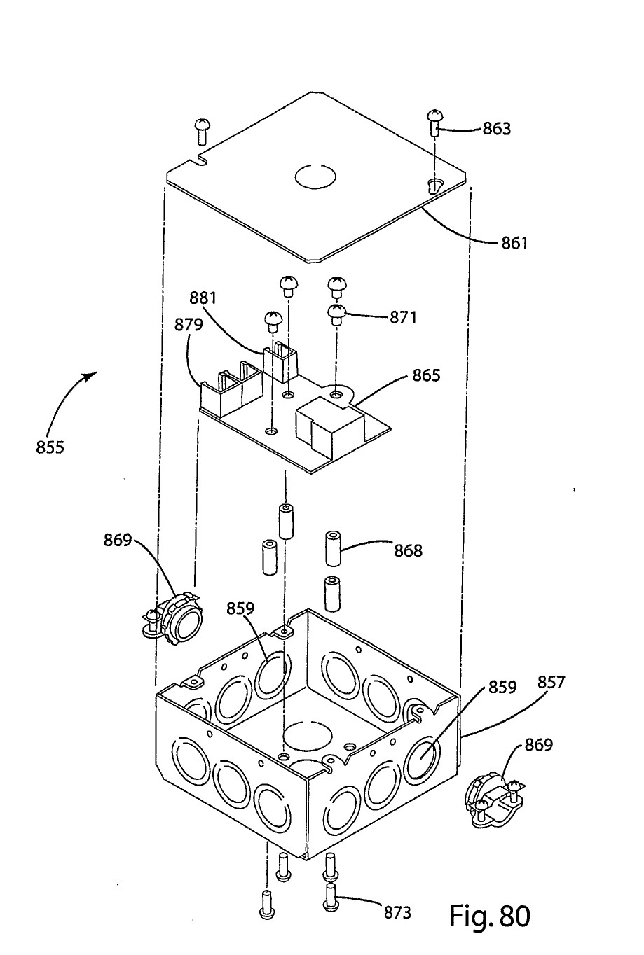

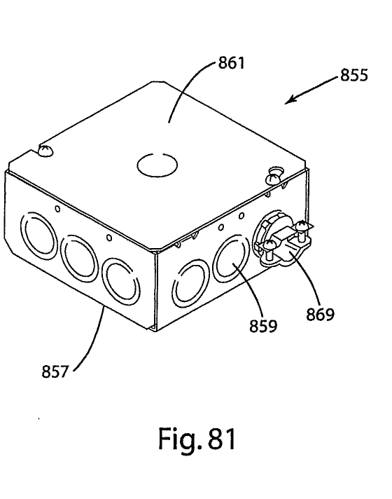

To this end, the structural channel system 100 includes a junction box assembly 855. The junction box assembly 855 is illustrated in FIGS. 78-81. With reference first to FIGS. 80 and 81, the junction box assembly 855 may be utilized with a light rail (such as light rail 875 illustrated in FIG. 78) having a series of dimmer lights 877 attached thereto. The light rail 875 and dimming lights 877 can be conventionally wired to the junction box assembly 855 and also mechanically secured to a length of the structural channel rail 102. This configuration is illustrated in FIG. 70A, which is substantially similar to the configuration illustrated in FIG. 1. The light rail 875 and dimming lights 877 may be in the form of a 277 volt light dimmer configuration. The junction box assembly 855 may be attached by any suitable means to the rail 102 or other components of the structural channel system 100, in a manner so that the 277 volt AC power cables 164 within the wireway 122 may be tapped into for 277 volt AC power. This configuration is illustrated in the diagrammatic view of FIG. 79. The junction box assembly 855 can be characterized as a smart junction box, and includes several of the components of the dimmer connector module 142. The junction box assembly 855 can be appropriately connected to the light rail 875 and programmed so as to control the amplitude of voltages applied to the dimming lights 877.

Turning specifically to FIGS. 80 and 81, the junction box assembly 855 includes an electrical box 857 having a conventional configuration, with a top cover 861 attached thereto through pan head screws 863. Knockouts 859 are provided at various locations around the perimeter of the electrical box 857. A board assembly 865 is included, having various electronic components and processor circuitry associated with the “smart” box assembly 855. Positioned below the board assembly 865 is a series of spacers 867. Pan head screws 873 are received from the bottom of the electrical box 857 for purposes of securing the positioning of the board assembly 865, and are received through the spacers 867. Pan head screws 871 are also provided for purposes of securing the board assembly 865 to the spacers 867. As further shown in FIG. 80, the board assembly 865 includes a pair of connector ports 879, and a remote IR receiver connector port 881. As subsequently described herein, the connector ports 879 may preferably be RJ45 ports, while the remote receiver connector port 881 may preferably be an RJ11 port. For purposes of safety and appropriately securing cabling with the junction box assembly 855, strain reliefs 869 can be provided as required.

Turning to the diagrammatic view of FIG. 79, a flexible conduit or other cabling may be coupled to one or more of the AC power cables 164 within the wireway 122. Such conduit may be connected through a knockout 490 within the wireway 122. This cabling or conduit may include three AC wires, comprising wires 883, 885 and 887. These wires may carry, for example, hot, neutral and ground for a specific circuit within the power cables 164. As with the incoming AC power associated with the previously described connector modules 140, 142 and 144, the AC power from wires 883, 885 and 887 are applied as input power to a transformer 889. The transformer 889 is adapted to receive the AC power and convert the same to an appropriate level of DC power, which is applied as input power on line 891 to the processor and associated repeater circuitry 893. The transformer 889 and processor and associated repeater circuitry 893 can operate in a manner substantially similar to that of the transformers 910 and processors 896 previously described with respect to the connector modules 140, 142 and 144. The processor and repeater circuitry 893 includes a control line 895 through which output signals can be applied for purposes of controlling a dimmer relay 897. The dimmer relay 897 also accepts, as input signals, the AC power from the wires 883, 885 and 887. The dimmer relay 897 will operate in response to control signals from control line 895 so as to vary the amplitude of voltages applied as output on lines 883A, 885A and 887A. This varying voltage amplitude is then applied through the strain relief 869 to flexible conduit or other cable 899, connected to the dimming lights 877.

Also similar to the previously described connector modules, the junction box assembly 855, as previously stated, includes a pair of RJ45 connector ports 879. The connector ports 879 are similar to the connector ports 840 previously described with respect to the connector modules 140, 142 and 144. Patch cords may be connected to the connector ports 879, and attached from these connector ports to application devices and to one of the connector modules currently on the network 530. It should be noted that for purposes of interconnecting the junction box assembly 855 to the network 530, one of the RJ45 connector ports 879 will need to be connected through a patch cord to a connector module or other device currently on the network 530. The RJ45 connector ports 879 are connected to the processor and associated repeater circuitry 893 through bidirectional lines 903.

In addition to the foregoing, the junction box assembly 855 also includes the RJ11 connector port 881, connected to the processor and associated repeater circuitry 893 through line 905. The remote IR receiver RJ11 connector port 881 is adapted to connected to a remote IR receiver 901 through patch cord or connector line 907. As previously described herein, it may be advantageous to provide the user with one or more remote IR receivers, such as receiver 901 which can be spaced apart and located in a more visually accessible location on the structural channel system 100. As with the IR receivers 844 previously described herein, the receiver 901 is adapted to receive spatial IR signals 890 from the wand 892.

In accordance with all of the foregoing, the junction box assembly 855 comprises a means for using high voltage power running through the wireways 122 for various application devices, and has also provided means for coupling such application devices to the network 530. In this regard, it should be noted that power is being applied to the dimmer lights 877, without requiring the use of AC power from the AC power cables 574. A configuration for the junction box assembly 855, as connected to dimmer lights 877 on the structural channel system 100, is illustrated in FIG. 78.

Previously, a specific means for receiving and distributing power throughout the network 530 was described with respect to the power entry box 134. The power entry box 134 was described in detail with respect to FIGS. 45-48. Also, a power box connector 136 for use with the power entry box 134 was described with respect to FIG. 49. Second embodiments of a power entry box and a power box connector are described in the following paragraphs, primarily with respect to FIGS. 82-84. The power entry box illustrated in FIGS. 82 and 83 will be referred to herein as the power entry box 134A, and the power box connector illustrated primarily in FIGS. 82, 83 and 84 will be referred to herein as the power box connector 136A. It is believed by the inventors that the power entry box 134A and the power box connector 136A may be somewhat of preferred embodiments relative to the previously described power entry box 134 and power box connector 136. However, it is also believed that the structure and functional operation of the power entry box 134 and power box connector 136 are fully acceptable for implementation of the structural channel system 100 in accordance with the invention.

As apparent from FIG. 82, the power entry box 134A is substantially similar to the power entry box 134. For purposes of description, like components of the power entry box 134A and the power box connector 136A to the power entry box 134 and power box connector 136 will be numbered substantially the same, with the letter A designating components for power entry box 134A and power box connector 136A. More specifically, and with reference to FIGS. 82 and 83, the power entry box 134A includes an AC side block 670A, knockouts 672A and upper surface 674A. A cable nut 676A is secured to one of the knockouts 672A and to an incoming 120 volt AC cable 678A. Although not specifically shown in the drawings, wires of the incoming 120 volt AC cable 678A may be directly or indirectly connected and received through the outgoing AC cables 680A. Unlike the flexible cable 680 associated with the power entry box 134, the cable 680A may be more rigid in structure. The AC cable 680A, as shown in FIG. 82, is coupled directly into the power box connector 136A.

The power entry box 134A may also include a 277 volt AC side block 688A. An upper surface 690A of the side block 688A includes a series of knockouts 672A. Connected to one of the knockouts 672A is a cable nut 676A. Also coupled to the cable nut 676A and extending into the side block 688A is a 277 volt AC cable 692A. Power from the cable 692A may be applied to power cables 674 within wireways 122. The power entry box 130A can include wireway segments 694A corresponding in structure and function to the previously describe wireway segments 694. For purposes of connecting the wireway segments 694A to the front portion of the power entry box 134A, brackets, as previously described herein with respect to FIGS. 46 and 47, may be integrally formed at one end of the wireway segments 694A. Also, joiners 492 as previously described herein can be utilized, for purposes of connecting one of the wireway segments 694A to a wireway 122. Further, the knockouts 672A can be utilized not only for conduits or cables connected to the incoming power through cables 678A and 692A, but can also be utilized to permit cables to extend completely through the power entry box 134. For example, cables associated with the cableways 120 may need to extend through the lower portion of the power entry box 134A.

In addition to the foregoing, the power entry box 134A also includes a network circuit 700A, situated between the side block 670A and the side block 688A. In addition, the power entry box 134A also includes a pair of connector ports 909A, preferably having an RJ11 port configuration. As will be described in subsequent paragraphs herein, the connector ports 909A can be utilized, with corresponding patch cords (not shown) to “daisy chain” multiple power entry boxes 134A and provide interconnection of communications and associated cabling throughout the electrical network 530.

One distinction may be mentioned at this time, relative to the structural configurations of the power entry box 134 and power entry box 134A. With the previously described power entry box 134, a connector 706 was provided as shown in FIGS. 46 and 47. The connector 706 is located on the same side of the power box communications cable 702 as the outgoing AC cable 680. In contrast, and the embodiment of the power entry box 134A, a connector 706A is provided at the rear portion of the power entry box connector 134A. However, like the connector 706, the connector 706A includes a support brace 708A with a pair of spaced apart upper legs 710A. The upper legs 710A angle upwardly and terminate in feet 712A. The support brace 708A is connected at its upper end to the side blocks 670A and 688A through screws 714A extending through holes in the feet 712A and in the side blocks 670A and 688A. As also shown primarily in FIG. 82, the upper legs 710A include a pair of spaced apart slots 716A. Integral with the upper legs 710A and extending downwardly therefrom is a central portion 718A. Integral with the lower edge of the central portion 718A are a pair of spaced apart lower legs 720A. As with the upper legs 710A, the lower legs 720A include feet 712A. Screws 714A extend through threaded holes in the feet 712A of the lower leg 720A, and connect to the rear walls of the side blocks 670A and 688A.

Returning to the central portion 718A, a series of four threaded holes 722A extend therethrough in a spaced apart relationship. The central portion 718A also includes a vertically disposed groove 724A extending down the center of the central portion 718A. The connector 706A also includes a bracket 726A, also shown in FIG. 82. The bracket 726A has a series of four threaded holes 728A. A pair of spaced apart upper lips 730A, having a downwardly curved configuration, extend upwardly from the bracket 726A. The bracket 726A also includes a vertically disposed groove 732A positioned in the center portion of this bracket 726A.

To couple the power entry box 134A to the structural grid 172, the power entry box 134A can be positioned above a corresponding main structural channel rail 102. The power entry box 134A can be positioned so that one of the threaded support rods 114 is partially “captured” within the groove 724A of the support brace 708A. When the appropriate positioning is achieved, the bracket 726 can be moved into alignment with the central portions 718A of the support brace 708A. In this aligned position, the threaded support rod 114 is also captured by the groove 732A and the bracket 726A. Also, to readily secure the bracket 726A to the support brace 708A, the upper lips 730A of the bracket 726A are captured within the slots 716A of the brace 708A. Correspondingly, screws 734A are threadably received within the through holes 728A and through holes 722A of the bracket 726A and support brace 708A, respectively. In this manner, the threaded support rod 114 is securely captured within the grooves 724A and 732A.

The power entry box 134A is mechanically and electrically coupled to the power box connector 136A, as primarily shown in FIGS. 82, 83 and 85. The power box connector 136A provides a means for receiving AC power from the building through the power entry box 134A, and applying the AC power to an elongated power assembly section 540 of the modular power assembly 130. The power box connector 136A also provides means for connecting the network circuit 700 from the power entry box 134A to the communication cables CC1, CC2 and CCR associated with an elongated power assembly section 540 of the modular power assembly 130. The power box connector 136A, in combination with the power entry box 134A, performs the same functions as the previously described power box connector 136 and power entry box 134.

Turning to the drawings, the power box connector 136A includes a base housing 750A, which will be located within a main structural rail 102 and adjacent a power assembly section 540 when installed. The base housing 750A includes a main body 752A and a cover 754A. The main body 752A and cover 754A are connected together by means of rivets 987 or similar connecting means. Internal to the base housing 750A formed by the main body 752A and cover 754A is a spacer clip 985. Extending outwardly from a slot 778A formed within the housing 750A is a connector housing 756A. The connector housing 756A is adapted to mate with a modular plug male terminal set housing 624 (FIG. 42A) of a modular plug 576. Extending into the connector housing 756A from the interior of the base housing 750A are a set of eight power entry female terminals 758A. The power entry female terminals 758A include a set of three terminals, identified as a communications cable female terminal set 760A. The remaining five of the female terminal set 758A are identified as AC power female terminal set 762A. When the elements 756A and 758A are appropriately located within the interior of the housing 750A, the main body 752A and cover 754A can be tightly secured together through the use of plastic screws 989. When the power box connector 136A is connected to a modular plug 576, the individual female terminals 758A of the female terminal set 760A will be electrically connected to individual terminals of the communications cables terminal set 646 of a modular plug 576. Correspondingly, the terminals 758A of the female terminal set 760A are connected to individual wires or cables (not shown) extending into the interior of the power box connector 136A from the communications conduit 702A. The wires or cables extending through the communications conduit 702A are connected to appropriate communication connections on the network circuit 700 in the power box connector 134A.

Correspondingly, when the power box connector 136A is connected to the modular plug 576, the individual female terminals 758A of the AC power female terminal set 762A will be electrically interconnected to individual terminals of the AC power terminal set 648 of the modular plug 576. Correspondingly, the terminals 758A of the AC power female terminal set 762A can be connected to individual wires or cables (not shown) extending into the interior of the power box connector 136A from the outgoing AC cable or conduit 680A. The wires or cables extending through the outgoing AC cable or conduit 680A are connected to incoming AC building power within the power box connector 134A, as previously described herein. A configuration of the power entry box 134A as electrically coupled to the power box connector 136A is illustrated in FIG. 83.

With respect to the use of the power entry boxes 134A and power box connectors 136A with the network 530, greater details of the network 530 will be described in subsequent paragraphs herein. However, at this time, reference can be made to the manner in which individual lengths of the main structural channel rails 102 and associated modular plug sections 540 can be coupled together so as to form the network 530. As earlier described, one component of the structural channel system 100 in accordance with the invention which can be utilized to electrically interconnect adjacent or adjoining sections 540 of the modular plug assembly 130 is the flexible connector assembly 138. With the flexible connector assembly 138, the adjacent or adjoining sections 540 of the modular plug assembly 130 are electrically coupled together both with respect to AC power on AC power cables 574 and communication signals on communication cables 572. In some instances, however, limitations with respect to power loads and government and institutional codes and regulations may result in the necessity of utilizing multiple power entry boxes 134A and associated power box connectors 136A. When this is required, it is inappropriate to “transfer” power signals from one section 540 to another section 540 of a modular plug assembly 130. On the other hand, however, in order to provide for a complete and distributed electrical network 530, it is desirable to have the capability of readily coupling together communication cables 572 from sections 540 of the modular plug assembly 130, regardless of the relative spatial positioning of the sections 540, and regardless of whether multiple power entry boxes 136A are being utilized.

In this regard, reference is made to FIG. 85, which illustrates in diagrammatic form a series of four power entry boxes 134A and associated power box connectors 136A. For purposes of description and simplicity, mechanical and structural elements other than the power entry boxes 134A and power box connectors 136A are not shown. It can be assumed that each of the power entry boxes 134A shown in FIG. 85 is supported on a separate one of lengths of main structural channel rails 102. Further, it can be assumed that each of the power box connectors 136A is plugged into separate modular plugs 576 of separate sections 540 of the modular plug assembly 130. FIG. 85 essentially shows the concept of daisy chaining the power entry boxes 134A. This is performed by the use of patch cords 907A which connect adjacent ones of the power entry boxes 134A through connector ports 909A within the power entry boxes 134A. The connector ports 909A are connected to the network circuitry 700 within each of the power entry boxes 134A. These connector ports 909A may be in the form of RJ11 ports for purposes of daisy chaining the network 530 through the power entry boxes 134A. The patch cords 907 may be in the form of CAT5 cable. In terms of operation, the network circuit 700 acts so as to essentially cause the communication signals associated with communication cables CC1, CC2 and CCR, and transmitted to the power entry boxes 134A through communications conduit 702A, to be “passed through” an interconnected patch cord 907 to the network circuit 700 associated with the particular power box connector 134A to which that particular patch cord 907 is interconnected. Transmission can be bidirectional and the network circuit 700 may have transformer, repeater or similar circuitry for purposes of enhancing received and transmitted communication signals. It is in this manner that communication signals can be transmitted to and from spaced apart sections 540 of the modular plug assembly 130. Also, as earlier described, this is a means for transmitting such communication signals among different sections 540, without using a flexible connector assembly 138. For purposes of appropriate interconnections and functional operation, patch cords which are typically characterized as bus end patch cords should be inserted into connector ports 909A of the first and last power entry boxes 134A within the chain. These bus and patch cords are illustrated as patch cords 911A in FIG. 85.

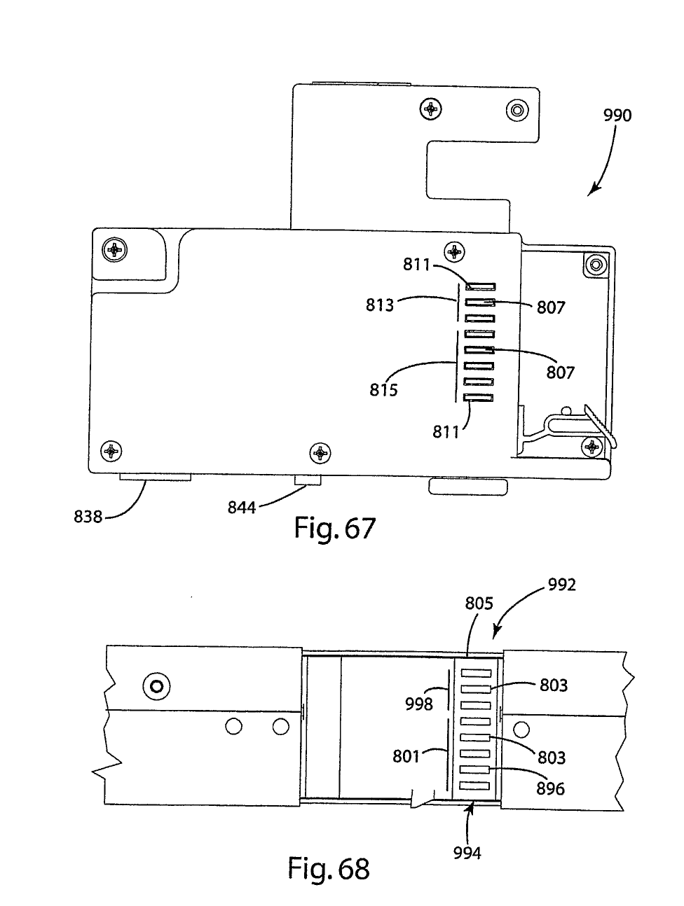

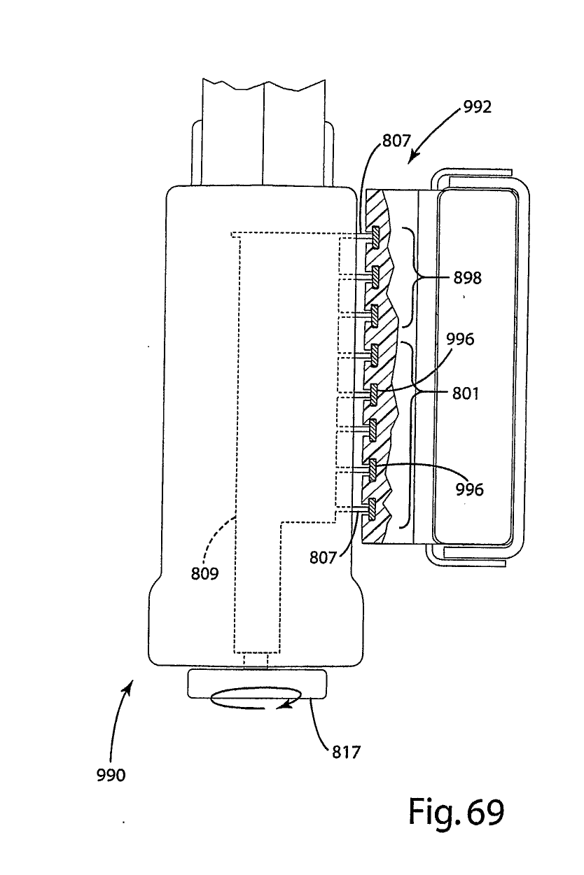

Turning to other aspects of structural channel systems in accordance with the invention, the prior description herein has been directed primarily to connector modules (such as the receptacle connector module 144) which are electrically interconnected to the modular plugs 576 on an “inline” basis. In some instances, it may be preferable to provide for a variation in the electrical connections between the connector modules and the modular plugs 576. An example embodiment of such a variation is illustrated with the modified receptacle connector module 990 shown in FIGS. 67, 68 and 69. This configuration also includes a modified modular plug 992, utilized in place of the modular plug 576 previously described herein. With this particular configuration, the modified modular plug 992 may include a modified plug connector 994 (replacing the plug connector 586 of the modular plug 576 shown in FIG. 42A) as primarily shown in FIGS. 68 and 69. The modified plug connector 994 can include a series of buses 996 comprising three communications buses 998 and five AC power buses 801. These buses can be connected to the communications cables 572 and AC power cables 574 within the modular plug assembly 130 in any suitable manner, so as to provide for complete conductivity between the same. Also, without departing from certain of the novel concepts of the invention, the communications cables 572 and AC power cables 574 could be replaced by a series of buses, carrying the same signals as the cables 572, 574. In any event, the buses 996 can be configured so as to project laterally outward from the plug connector 994 through a series of terminal openings 803 of a plug connector bus housing 805. The concept of the employment of buses within a power and communications distribution system is disclosed in copending U.S. Provisional Patent Application entitled POWER AND COMMUNICATIONS DISTRIBUTION SYSTEM USING SPLIT BUS RAIL STRUCTURE filed Jul. 30, 2004. The disclosure of the aforedescribed provisional patent application is incorporated by reference herein.

Turning to the modified receptacle connector module 990, it can be assumed that the principal structural and electrical components of the connector module 990 correspond to those previously described herein with respect to the receptacle connector module 144. However, as shown in FIGS. 67 and 69, the modified receptacle connector module 990 includes a series of movable electrical contacts 807. The movable electrical contacts 807 are adjustable through what is shown in diagrammatic form in FIG. 69 as an extender control module 809. The extender control module 809 may include relatively conventional components, which provide for the capability of the movable electrical contacts 807 to be moved from a retracted position within the housing of the receptacle connector module 990, to an extended position so that they are in conductive connectivity with the buses 996. This conductive configuration is illustrated in FIG. 69. Referring back to FIG. 67, the electrical contacts 807 may move between the extended and retracted positions within terminal slots 811 which extend laterally outwardly from one side of the receptacle connector module 990. The moveable electrical contacts 807 include a series of three communications contacts 813 and five AC power contacts 815.

Referring again to FIG. 69, the extender control module 809, which can be appropriately housed and secured within the receptacle connector module 990, can include a manually rotatable control knob 817. The control knob 817 can be structurally connected to the extender control module 809, so that rotation of the knob 817 will cause the moveable electrical contacts 807 to move between a retracted position and an extended position. Again, in the retracted position, the electrical contacts 807 would not be in contact with any of the buses 996. In the extended position shown in FIG. 69, the three communication contacts 813 would be electrically connected to the three communication buses 998, and the five AC power contacts 815 would be electrically connected to the AC power buses 801. With respect to further operation of the modified receptacle connector module 990, reference can be made to the prior description with respect to the receptacle connector module 144 and FIG. 58A. With reference to FIG. 58A, the moveable electrical contacts 807 can be characterized as substantially conforming to the symbolic contacts 898 previously described with respect to the receptacle connector module 144. The foregoing is a brief description of a modified receptacle connector module 990, which may utilize a different type of connection between a connector module and a modular plug. It is apparent that other modifications of these configurations may also be developed, without departing from the principal novel concepts of the invention.

Turning to other aspects of the structural channel system 100 in accordance with the invention, the system 100 has been described with respect to use of various types of applications and application devices. For example, the use of a receptacle connector module 144, with a switch 934 interconnected through a patch cord 932 was previously described with respect to FIG. 72. It should be emphasized that there is no necessity for the structural channel system 100 to be configured so that the switch 934 is directly controlling the receptacle control module 144. That is, the patch cord 932, in combination with its connection to a connector port 840 of the receptacle connector module 144, provides a means for supplying DC power to the switch 934, and also for coupling the switch 934 to the electrical network 530. In this regard, although the switch 934 is coupled into the network 530 through the connector module 144, the switch 934 may be operating so as to control either one or several other connector modules which are coupled into the network 530. In this regard, the connector ports 840 can be characterized as providing a network tap for the interconnection of switch 934 into network 530. Also, because it is unnecessary for the switch 934 to be directly coupled (through a patch cord) to a connector module for which the switch has been programmed to control, this feature again illustrates one of the advantageous of the structural channel system 100 in accordance with the invention, in that the switch 934 can be reprogrammed any number of times so as to control any of a various set of connector modules, without requiring any physical rewiring or any modifications to the patch cord connections. That is, it is only necessary for the switch 934 to be connected “somewhere” into the electrical network 530.

It should be noted that various types of switches may be utilized as part of the applications or application devices associated with the structural channel system 100 in accordance with the invention. One type of switch which may be utilized with the structural channel system 100 is characterized as a rotary dimmer switch 823, as illustrated in FIGS. 72E and 72F. With reference thereto, the rotary dimmer switch assembly 823 includes a back plate or rear housing 825, having a structural configuration as primarily shown in FIG. 72E. The rear housing 825 can be secured by connecting means or by a snapfit arrangement with a front dimmer switch housing 827. Secured within the interior formed by the front housing 827 and rear housing 825 is a sensor board 821. The sensor board 821 can, for example, be secured to the front housing 827 by means of pan head screws 831 or other similar connecting means. Secured to the sensor board 821 is an IR receiver 833. The IR receiver 833 functions in a manner similar to the IR receivers 844 previously described with respect to the connector modules, such as the receptacle connector module 144. The IR receiver 833 is adapted to receive spatial IR signals from a wand, such as the wand 892 previously described herein. The IR receiver 833 is made accessible to the wand 892 through a cover slot 835 within the front housing 827. A lens 837 is positioned within the slot 835, and covers the IR receiver 833. Structurally and electrically connected to the sensor board 821 is a dimmer switch 839. The dimmer switch 839 projects outwardly through a switch slot 841 positioned within the front housing 827 as shown in FIGS. 72E and 72F. For purposes of manual rotation of the dimmer switch 839, a switch knob 841 is secured to the end of the dimmer switch 839 by means such as a set screw 843 as illustrated in FIG. 72E. For purposes of identification of the particular switch assembly 823, a switch label 845 can be included, and secured within a label slot 847 of the front housing 827. The dimmer switch 839 also includes a set of pins 853 adapted to electrically interconnect to appropriate lines and circuitry of the sensor board 821. These pins 853 essentially provide a means of communicating, by electrical signals, the rotational position of the dimmer switch 839.

Secured to the sensor board 821 and accessible to a user are a pair of connector ports 849, as shown from the rear in FIG. 72E. The connector ports 849 are adapted to receive patch cords 851. The patch cords 851 may be utilized in two ways. First, the other end of a patch cord 851 connected to a connector port 849 may be directly connected to one of the connector ports 840 associated with any of the connector modules 140, 142 or 144. In this manner, the rotary dimmer switch assembly 823 may be electrically connected into the network 530. DC power may be received through a patch cord 851 from an interconnected connector module, for purposes of functional operation of circuitry of the sensor board 821. Also, the patch cord 851, once connected to one of the connector modules 140, 142 or 144, is utilized to transmit and receive communication signals to and from the electrical network 530 through the interconnected connector module. In this regard, it should be noted that the rotary dimmer switch assembly 823 can be characterized as a smart switch, in that it includes processor and associated control circuitry within the sensor board 821. In accordance with the invention, the electronics and processor elements of the sensor board 821 perform several features. First, the sensor board 821 includes components which will be responsive to spatial signals received from the IR receiver 833, for purposes of associating the rotary dimmer switch assembly 823 with control of dimming lights (such as the lights 940 previously described herein with respect to FIG. 60). Further, the electronics and processor elements of the sensor board 821 will be responsive to manual rotation of the switch knob 841 and the dimmer switch 839, so as to cause appropriate communication signals to be applied through a connector port 849 and interconnected patch cord 851. These communication signals from patch cord 851 will then be applied through the network 530 to one or more appropriate dimmer connector modules 142 and interconnected dimming light elements associated with the network 530. In addition, for purposes of programming the rotary dimmer switch assembly 823, signals will also be transmitted on patch cord 851 in response to certain spatial signals received by the IR receiver 833. The connector ports 849, like the connector ports 840, may be relatively standard RJ 45 ports. Patch cords, such as the patch cords 851, are adapted to be received within RJ 45 connector ports and are commercially available.

In addition to the feature of electrically interconnecting the rotary dimmer switch assembly 823 to the electrical network 530 through interconnection of the patch cord 851 directly to a connector module, switch assemblies such as the dimmer switch assembly 823 may also be daisy chained within the network 530. That is, one of the two connector ports 849 may include a patch cord 851 which, as previously described herein, is directly connected to one of the connector modules 140, 142 or 144. Further, however, a second patch cord 851 may be connected at one end to the other connector port 849 of the rotary dimmer switch assembly 823, with its terminating end coupled to a connector port 849 of another rotary dimmer switch assembly 823. In this manner, two or more rotary dimmer switch assemblies 823 may be daisy chained together for purposes of functional operation. Limitations on the daisy chaining of the switch assemblies 823 may exist based on voltage and power requirements. Also, it should be emphasized that the concept of daisy chaining switch assemblies is not limited to the rotary dimmer switch assembly 823, and will be applicable to other types of switches.

In accordance with the foregoing, the concept has been described of a manually manipulated and hand-held instrument, such as the wand 892 to essentially program a dimmer connector module 142 and associated lighting elements, in a configuration as shown in FIG. 60. The dimmer connector module 142 can be programmed, along with the rotary dimmer switch assembly 823, so that the dimmer switch assembly 823 controls a particular one (or more) of the dimmer connector modules 142. With this program designation, manual manipulation of the switch knob 841 by a user will cause communication signals to be generated by the sensor board 821, and applied as output signals to one of the patch cords 851 connected to one of the connector ports 849. These communication signals on the patch cord 851 will then be applied to the communications cables 572 of the modular plug assembly 130, through connection of the patch cord 851 to a connector port 840 associated with one of the connector modules 140, 142 or 144. With the assumption that the particular rotary dimmer switch assembly 823 is controlling the lights 940 illustrated in FIG. 60, the signals applied on the electrical network 530 through the interconnected patch cord 851 will be recognized as input signals of interest by the appropriate dimmer connector module 142. With reference to FIG. 68, the signals applied to the communication cables 572 may then be applied as input signals to the processor and repeater circuitry 896 associated with the particular dimmer connector module 142. The processor and associated repeater circuitry 896 will be responsive to these input signals to apply control signals on control line 920, so as to control the voltage amplitude through the dimmer relay 948, which is applied to lights 940. In this manner, the intensity of the lights 940 is controlled.

The concepts associated with the foregoing description of the rotary dimmer switch assembly 823, with its interconnection to the electrical network 530 through a connector module represents an important feature of a structural channel system 100 in accordance with the invention. In conventional rotary dimmer switches, 120 volt AC power is typically applied through the switch. Manual rotation of the switch knob and associated dimmer switch with the conventional configuration will cause dimmer control circuitry to vary the voltage output on AC power lines passing through the dimmer switch assembly. These power lines are typically directly connected to dimming lights on a light rail or the like. The variation in voltage amplitude of the AC power lines as they pass through the dimmer switch assembly will thereby cause the track lights to vary in intensity. In contrast, in the configuration previously described herein and in accordance with the invention, there is no AC power applied to or passing through the rotary dimmer switch assembly 823. Instead, manual rotation of the switch knob 841 and associated dimmer switch 839 will cause variations in DC voltages and communication signals, which are applied to processor components associated with the sensor board 821. The processor components will interpret the DC voltage variations in a manner so as to cause corresponding communications or control signals to be applied through the patch cord 851. These control signals will correspondingly be applied to other elements of the network 530 (i.e., eventually to a dimmer connector module 142 programmed to be responsive to signals from the particular rotary dimmer switch 823) so as to cause circuitry within the dimmer connector module 142 to vary the voltage amplitude applied to an interconnected set of lights 940. To provide this feature, the rotary dimmer switch assembly 823 has been “programmed,” along with one or more sets of lights 940 and interconnected dimmer connector modules 142. It should be emphasized that this programming of the control relationship occurs without any need whatsoever of any type of centralized computer control, or any physical change in circuits, wiring or the like.

FIGS. 72A-72C illustrate elevation views of other types of switches which may be utilized in accordance with the invention. Specifically, FIG. 72A illustrates a pressure switch 913. The pressure switch 913 includes, as does the rotary dimmer switch assembly 823, an IR receiver 833, for purposes of programming controlled relationships between the switch 913 and other devices associated with the structural channel system 100. The pressure switch 913 includes an air bulb 915. The pressure switch 913 includes circuitry (not shown) internal to the switch 913, in the form of a pressure transducer which can generate signals in response to forces exerted on the bulb 915 which “squeeze” air from the bulb. The output signals of the transducer can be utilized for purposes of generating appropriate control signals, in a manner having similarity to the control signal generation associated with the rotary dimmer switch assembly 823.

FIG. 72B illustrates an elevation view of a pull chain switch 917 which may be utilized with the structural channel system 100 in accordance with the invention. As with the other switches, the pull chain switch 917 includes an IR receiver 833. In addition, the switch 917 includes a conventional pull chain 919. Forces exerted on the pull chain 919 will cause switching circuitry (not shown) within the switch 917 to operate so as to generate appropriate control signals which can be applied to other devices associated with the network 530.

Still further, FIG. 72C is an elevation view of a motion sensing switch 921 which may be utilized with the structural channel system 100 in accordance with the invention. Again, the motion sensing switch 921 includes an IR receiver 833. The switch 921 would include circuitry which is relatively conventional and commercially available, so as to sense motion in a spatial area surrounding the switch through motion sensor 923. The motion sensing circuitry will sense motion through a lens 923 located in an appropriate position on the switch 921 for purposes of sensing motion within an appropriate spatial area. If motion is sensed, the switch 921 will be caused to generate signals on an interconnected communications line, which may be applied to an interconnected connector module associated with the structural channel system 100. As with the other switches described herein, the network 530 may be “programmed” so that certain devices (such as lights or the like) are responsive to the signals generated by the motion sensing switch 921.

Although the foregoing paragraphs have described four types of switches, numerous other types of switch configurations may be utilized for purposes of controlling various devices or applications associated with the network 530, without departing from the novel concepts of the invention. However, for appropriate operation, each of the aforedescribed switches will include circuitry and components similar to those of the dimmer switch assembly 823, including connector ports and processor circuitry associated with a sensor board. That is, each of the switches described with respect to FIGS. 72A-72B will also be a “smart” switch, and capable of being programmed by a user.

The structural channel system 100 provides a means for facilitating control and reconfiguration of control relationships among various devices associated with applications. An example of a controlling/controlled relationship among devices has been previously described herein for the rotary dimmer switch assembly 823 and dimming lights.

The prior description also focused on the structure of the rails 102, modular power assembly 130 and various types of connector modules. The network 530 of the structural channel system 100 has significant advantages. Namely, it does not require any type of centralized processor or controller elements. That is, the network 530 can be characterized as a distributed network, without requirement of centralized control. Further, it is a programmable network, where controlling/controlled relationships among devices associated with an application are not structurally or functionally “fixed.” In fact, various types of devices can be “reprogrammed” to be part of differing applications. For example, a dimmer light may be programmed to be controlled by a first rotary dimmer switch assembly, and then “reprogrammed” to be controlled by only a second rotary dimmer switch assembly, or both the first and second rotary dimmer switch assemblies. This can occur without any necessity whatsoever of physical rewiring, or programming of any type of centralized controller. Instead, the network 530 utilizes what is referred to as a “programming tool” for effecting the application environment. As an example embodiment of a programming tool which may be utilized with the structural channel system 100, subsequent paragraphs herein will describe the manually manipulable and hand-held “wand” 892.

With the network structure described herein, the network 530 can be characterized not only as a distributed network, but also as an “embedded” network. That is, it is embedded into physical devices (e.g. connector modules, etc.) and linked together through the mechanical structural grid 172 of the structural channel system 100. In this regard, with the connector modules interconnecting various devices (e.g. switches, lights, etc.) to the AC and communications cable structures, the connector modules can be characterized as “nodes” of the network 530.

With the network 530 characterized in this manner, it is worthwhile, for purposes of understanding the power and communications distribution, to illustrate an exemplary structural channel system 100 and network “backbone” associated therewith. In typical communications networks, the backbone is often characterized as a part of the network which handles “major” traffic. In this regard, the backbone typically employs the highest speed transmission paths in the network, and may also run the longest distance. Many communications systems utilize what is often characterized as a “collapsed” backbone. These types of collapsed backbones comprise a network configuration with the backbone in a centralized location, and with “subnetworks” attached thereto. In contrast, the network 530 which is associated with the structural channel system 100 is somewhat in opposition to the concept of a collapsed backbone. In fact, the backbone of the network 530 can better be described as a “distributed” backbone. Further, the network 530 can be characterized as being an “open” system, and even the backbone can be characterized as an “open” backbone. That is, the network 530 and the backbone are not limited in terms of expansion and growth.

For purposes of understanding this concept of the backbone, FIG. 70 illustrates an exemplary structure of the structural channel system 100. The illustration is essentially in a “diagrammatic” format. Specifically, FIG. 70 illustrates a structural channel system 100 configuration having sixteen main rails 102. The sixteen rails are identified as main rails 102A through 102O, with two rails 102J1 and 102J2. In the particular configuration shown, three or four main rails 102 are essentially in a coaxial configuration. For example, main rails 102A, 102J1, 102J2 and 102K form one coaxial configuration. Similarly, main rails 102D, 102G and 102N form another coaxial configuration. FIG. 70 also illustrates incoming 120 volt AC power on line 929. This power can be general building power. The incoming AC power on line 929 is applied to common power distribution cables 931. In the particular embodiment shown in FIG. 70, two power distribution cables 931 are utilized. The power distribution cables 931 are further shown in FIG. 70 as being coupled to either one or a pair of 120 volt AC power cables 678A. These AC power cables 678A were previously described with respect to FIG. 82 and the power entry box 134A. As further shown in FIG. 70, each of the main rails 102, with the exception of rail 102J2, has a power entry box 134A at one end of the associated main rail 102. For example, with respect to main rails 102B and 102I, each rail has a power entry box 134A associated therewith, which may be physically adjacent to each other, as shown in FIG. 70. As previously described herein, the power entry boxes 134A have outgoing AC power cables 680A and outgoing communication cables 702A extending outwardly from the power entry boxes 134A. Although not specifically shown in FIG. 70, the AC power cables 680A and communication cables 702A, as previously described herein, are connected to power box connectors 136A. In FIG. 70, the power entry boxes 134A and power box connectors 136A are shown as one element, for purposes of simplicity. Also in accordance with prior description herein, the power box connectors 136A are electrically connected (both with respect to AC power and communication signals) through modular plugs 576 to sections 540 of the modular plug assembly 130. With respect to the illustrations in FIGS. 70 and 71, and the description herein, it is being assumed that each of the structural channel rails 102 includes sections 540 of the modular plug assembly 130 running along the entirety of the length of each of the main rails 102. Accordingly, these combinations of the power entry boxes 134A and associated power box connectors 136A are utilized to apply the incoming AC building power to the sections 540 of the modular plug assembly 130 as previously described herein.

Further, as also previously described herein, communication signals are received and transmitted through network circuits 700 associated with each of the power entry boxes 134A. For purposes of description and simplicity, the previously described communication cables 702A are not illustrated in FIG. 70 or FIG. 71. However, what is shown in FIG. 70 are the interconnections using the patch cords 907, for purposes of daisy chaining together the separate power entry boxes 134A. In this manner, each of the main rails 102 and the associated modular power assembly sections 540 are linked together for purposes of forming the network 530, through these interconnections of the patch cords 907. As also earlier described, separate bus ending patch cords 911 are connected to connector ports 909A within the first power entry box 134A in the chain, and the last power entry box 134A in the chain.

As further shown in FIG. 70, each of the main rails 102 has a power entry box 134A associated therewith, with the exception of main rail 102J2. As shown therein, a flexible connector assembly 138 (previously described with respect to FIGS. 50A-50C) is shown connected to the main rail 102J1, at an end of the main rail 102J1 opposing the end associated with the power entry box 134A. The flexible connector 138 is utilized to “jump” power and communication signals from the main rail 102J1 to the main rail 102J2. In accordance with all of the foregoing, including the daisy chaining of the power entry boxes 134A, AC power and communication signals are applied to all of the main rails 102A-102O associated with the structural channel system 100. As further shown in FIG. 70, various ones of the connector modules 140, 142 and 144 can be connected at various positions along the main rails 102 and associated modular plug assembly 130. For purposes of clarity, these connector modules in FIG. 70 are not shown as being interconnected to any application devices.

With the particular configuration illustrated in FIG. 70, a “backbone” 935 of the network 530 associated with the structural channel system 100 can be defined. With the FIG. 70 configuration, the “initiation point” for the back bone 935 begins at the power entry box 134A associated with main rail 102A. The communications path of the backbone 904 then flows from main rail 102A through the patch cords 907 associated with the main rails 102A-102O in alphabetical sequence, with the path of power and communication signals being coupled from main rail 102J1 to main rail 102K, and main rail 102J1 being coupled to main rail 102J2. The “termination” of the particular backbone 935 shown in FIG. 70 occurs at the power entry box 134A associated with main rail 102O. With this backbone 935 in place, it can be seen that the main rails 102 actually function in what can be characterized as a series of “parallel” network branches off of the backbone 935. It can also be seen that the backbone 935 represents a completely open system, in that main rails 102 (and associated power entry boxes and power box connectors) can be readily added to the backbone 935 and network 530.

FIG. 71 is similar to FIG. 70, in that it illustrates an embodiment of the structural channel system 100 in a “diagrammatic” format. More specifically, FIG. 71 illustrates aspects of an embodiment or system layout 937 of the structural channel system 100. The system layout 937 illustrates the network 530, with two programmable applications, namely a light bank 939 and an automated projection screen 941. For purposes of description, and as with FIG. 70, elements such as cross-rails, perforated structural channels, support rods and other support and hanger components (including the building support structure) are not shown in FIG. 71. Further, unlike FIG. 70, and for purposes of clarity of the illustration in FIG. 71, incoming building power is not illustrated in FIG. 71. However, the system layout 937 in FIG. 71 is substantially similar to the system layout in FIG. 70. More specifically, FIG. 71 includes a series of lengths of main rail 102A-102J. Power entry boxes 134A are located at the beginning of each main rail 102, and patch cords 907 connect the power entry boxes 134A in a daisy chain configuration. In this manner, all of the communication cables 572 are linked together, through a “backbone” as previously described with respect to FIG. 70.

As earlier stated, the system layout 937 shown in FIG. 71 includes a light bank 939, illustrated as having a series of six lights 943. The lights 943 are all linked together through cables 945, so that all of the lights 943 are either enabled or disabled together. The lights 943 are coupled to a connector module. In this instance, the connector module corresponds to a receptacle connector module 144, which provides conventional three wire AC power through a receptacle to the light bank 939. The power may be provided through a conventional AC power cord 947 which is electrically coupled to a first one of the lights 943 of the light bank 939.

Still further, it can be assumed that the light bank 939 has been “programmed” to be under control of a switch 949. The switch 949 may be any one of a number of different types of switches, such as the pressure switch 913 previously described with respect to FIG. 72A. The switch 913 is connected to the network 530 through a patch cord 932, which is interconnected through module 144 to the communication cables 572 associated with the main rail 102D. As further illustrated in FIG. 71, the connector module 144 to which the switch 939 is directly connected is associated with main rail 102D, while the receptacle connector module 144 directly coupled to the light bank 939 is associated with main rail 102C. However, the communications cables 572 of the main rails 102D and 102C are coupled together through the daisy chaining of the power entry boxes 134A associated with each of the main rails 102D and 102C. Accordingly, following appropriate “programming” of the correlation between the light bank 939 and the switch 949, enablement of the switch 949 will cause communication signals to be applied through the cables 572 associated with both main rails 102D and 102C. The processing components associated with the receptacle connector module 144 directly coupled to the light bank 939 will be responsive to these communication signals, so as to control AC power signals applied to the light bank 939.

Correspondingly, and as previously mentioned, the system layout 937 illustrated in FIG. 71 is further shown as having an automated projection screen 941. It may be assumed that the projection screen 941 is a conventional projection screen, which can be responsive to appropriate AC power signals so as to “unwind” and provide a full projection screen. Such projection screens which may be utilized as screen 941 are well known and commercially available.

The projection screen 941 is shown as being interconnected to a receptacle connector module 144 through an AC power cable 953. The receptacle module 144 is coupled to the main rail 102H. For control of the automated projection screen 941, it may be assumed that the user has “programmed” a controlling/controlled relationship between the screen 941 and a switch 925. The switch 925 may be any of a number of different types of switches, such as a pressure switch 913 as previously described with respect to FIG. 72A. In FIG. 71, the switch 925 is illustrated as being coupled through a patch cord 955 to a module 144 associated with main rail 102J. As further illustrated in FIG. 71, in the event a user activates or otherwise enables switch 925, communications signals can be applied through the patch cord 955 coupling the switch 925 to the module 144 associated with main rail 102J. These communications signals can then be further applied to main rail 102H through the patch cords 907 which couple the cables 572 of main rail 102J and 102I, and the cord 907 which couples the cables 572 of main rail 102I to those of main rail 102H. The receptacle connector module 144 on main rail 102H will be responsive to these communications signals, so as to apply (or not apply) power to the AC power cable 953 connecting the receptacle connector module 144 to the automated projection screen 941. In accordance with the foregoing, the system layout 937 of a structural channel system 100 in accordance with the invention provides means for generating and applying communications control signals among various devices associated with applications connected to the structural channel system 100, in addition to selectively applying power to various application devices.

Another aspect of system layout 937 of a structural channel system 100 in accordance with the invention should be noted. Specifically, the layout 937 has been described with respect to the use of patch cords 907. As further shown in FIG. 71, it would be possible to replace one or more of these with electronics which would provide for wireless signals 959 to be transmitted between various system components, such as power entry boxes 134A on different ones of the main rails 102. Also, wireless signals, such as wireless signals 957 shown in FIG. 71 could replace the patch cords which couple together devices such as the switch 949 to a module 144. Still further, it is apparent that numerous other device and application configurations could be utilized with a layout of the structural channel system 100, other than those illustrated in FIG. 71. In fact, an advantage of the structural channel system 100 in accordance with the invention is that it is an “open” system, and facilitates the addition of application devices, backbone equipment and the like.

To this point, discussion regarding the network portion of the structural channel system 100 has focused around the cables 572 and 574, various types of connector modules, the power entry box 134A and interconnection of various application devices to the network 530. Numerous times, however, reference has also been made to the concept of “programming” the control and reconfiguration of control relationships among various application devices which may be utilized with the structural channel system 100. As an example, the discussion regarding FIG. 71 mentioned the concept of establishing controlling/controlled relationships among switches, lights and automated projection screens.

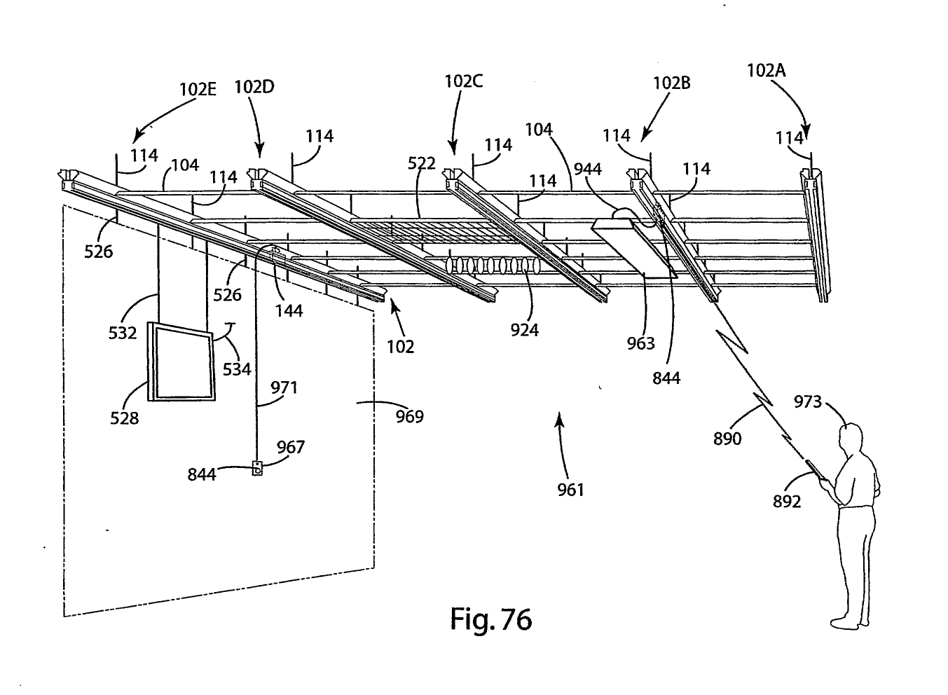

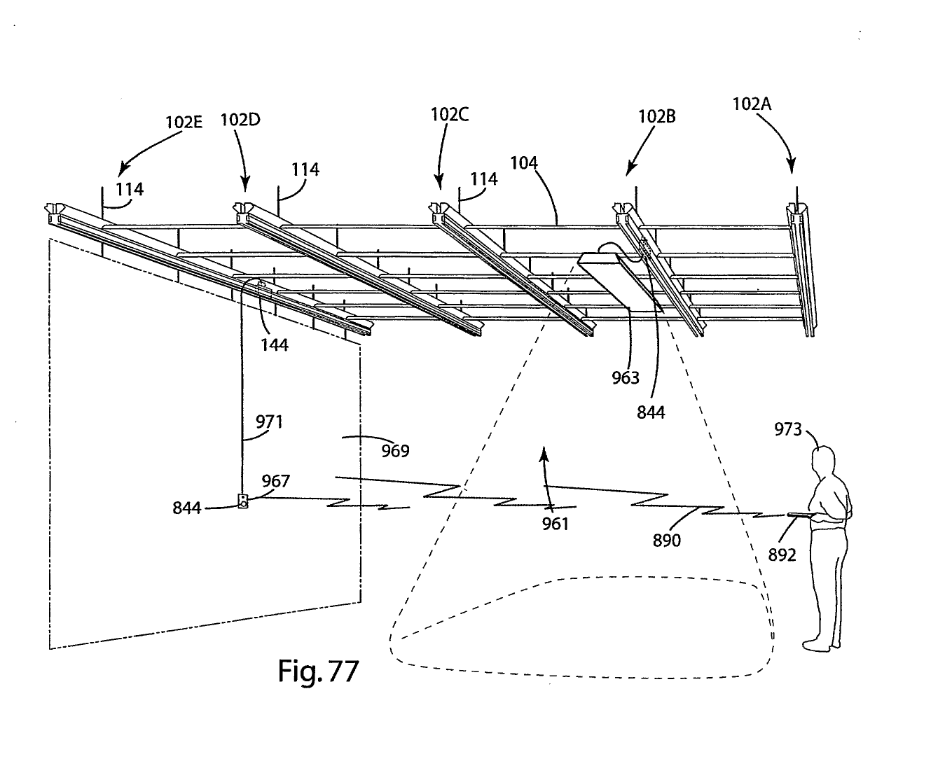

To provide an exemplary embodiment of this concept of programmable control, on a “real time” and “decentralized” basis, reference is made to FIGS. 76 and 77. Specifically, these drawings illustrate a system layout 961, employing a series of five main rails 102A-102E. Cross-channels 104 are also shown interconnecting the main rails 102, and support rods 114 are shown in part as securing the structural rails 102 to the building structure. For purposes of this description, power cables and communication cables extending between main rails 102 and similar elements are not shown. Instead, FIG. 76 also illustrates a conventional light 963. The light 963 is connected through an AC power cable 965 to a receptacle connector module 144 associated with main rail 102B. In addition, a switch 967 (which may be any one of a number of different types of switches) is illustrated as being secured to a wall 969. The switch 967 is coupled to main rail 102E through patch cord 971 and a module 144. As previously described with respect to FIGS. 70 and 71, other communications cables (not shown) and modules (not shown) can be utilized to couple the communications cables 572 associated with any one of the main rails 102 to the communications cables 572 of the other main rails 102 associated with layout 961.

Further, it can be assumed that it is the desire of a user 973 to establish a controlling/controlled relationship between the switch 967 and the light 963. For this purpose, and as shown in FIGS. 76 and 77, the user 973 is employing a “programming tool.” In this particular instance, the programming tool can be characterized as the control wand 892. The control wand 892 is utilized for purposes of transmitting spatial programming signals 890, which are capable of being received through IR receivers 844 associated with the switch 967 and the receptacle connector module 144. An example of the control wand 892 is illustrated in FIGS. 73, 74 and 75. With reference thereto, the control wand may be of an elongated configuration. At one end of the control wand 892 is a light source 975 which, preferably, would generate a substantially collimated beam of light. In addition to the light source 975, the control wand 892 may also include an infrared (IR) emitter 977, for transmitting infrared transmission signals to corresponding IR receivers 844 associated with the structural channel system 100, including the connector modules and the application devices.

The control wand 892 may also include a trigger 979, for purposes of initiating transmission of IR signals. Still further, the control wand 892 may include mode select switches, such as mode select switch 981 and mode select switch 983. These mode select switches would be utilized to allow manual selection of particular commands which may be generated utilizing the control wand 892. The control wand 892 would also utilize a controller (not shown) or similar computerized devices for purposes of providing requisite electronics within the control wand 892 for use with the trigger 979, mode select switches 981, 983, light source 975 and IR emitter 977. An example of the use of such a wand, along with attendant commands which may be generated using the same, is described in copending International Patent Application No. PCT/US03/12210, entitled “SWITCHING/LIGHTING CORRELATION SYSTEM” filed Apr. 18, 2003.

Referring back to FIG. 76, the user 973 can employ the wand 892 to transmit signals to the IR receiver 844 associated with the receptacle connector module 144. These spatial IR signals are illustrated as signals 890. For purposes of illustrating a relatively simple control sequence, it can be assumed that the user 973 wishes to have the light switch 967 control the particular lighting fixture 963. The user 973 can first configure the mode selector switches 981, 983 associated with the wand 892 so as to enable a “control set” sequence. The wand 892 can then be pointed to the IR receiver 844 associated with the receptacle connector module 144. When the wand 892 is appropriately pointed (indicated by the light source 975), the user 973 may activate the trigger 979 on the wand 892.

The user can than “point” the wand 892 to the IR receiver 844 associated with the switch 967. When the wand 892 again has an appropriate directional configuration, as indicated by the light source 975, the trigger 979 can again be activated, thereby transmitting the appropriate IR signals 890. This concept is illustrated in FIG. 77. Additional signals can then be transmitted through the wand 892, so as to indicate that the control sequence is complete and the lighting fixture 963 is to be controlled by the light switch 967.

In addition to the foregoing, signaling may be used, for purposes of changing the on and off states of various elements. For example, with RF signaling, an individual could possibly turn on all of the elements in an office or other commercial interior with a general signal, rather than with a specific switch.

With further reference to FIG. 76, a wall 969 as previously described herein (which can also be characterized as a space divider 969) is shown as being supported along one of the main rails 102E. The support occurs through the hangers 526. The hangers 526 can be characterized as connector means which are coupled to the main rail 102E for supporting a vertically disposed functional element, such as the wall or space divider 969. It should be noted that multiple space dividers 969 could also be supported in this matter. Still further, FIG. 76 illustrates a visual shield 522 which essentially comprises a panel or a similar visual shield or planar element supported through the structural channels 102 and the cross channels 104. In this manner, the system 100 in accordance with the invention has the capability of supporting functional elements such as the visual shield 522. Also shown as being supported through use of the rails 102 and the cross channels 104 is a visual shield which is often referred to as a “light bag” visual shield 524. This type of visual shield 524 can be utilized in combination with various lighting elements so as to project different lighting patterns and lighting densities.

The visual shields 522 and 524 can be characterized as horizontally disposed functional elements, supported from main rail assemblies. Still further, other types of functional elements could also be supported through use of the structural channel system 100, both above and below the plane formed by the structural channel rails 102 and the cross channels 104. For example, in addition to such functional elements as the space divider 969 and the visual shields 522, 524, elements such as a digital display 528 (as shown in FIG. 76) can also be supported through hangers 532 extending from the rail 102E. Still further, components such as visual projectors and electric motors can be supported, again either above or below the plane formed by the rails 102 and the cross channels 104. Also, it should be noted that the digital display 528 may be an application device which is controlled through the use of switches or the like associated with the structural channel system 100. Accordingly, although only shown in partial view, the digital display 528 can include a power cord 534 or other types of power means connected to the electrical network of the structural channel system 100, and controlled by switches or the like with respect to being enabled or disabled.

As described in the foregoing, the structural channel system 100 in accordance with the invention facilitates flexibility and reconfiguration in the location of various devices which may be supported and mounted in a releasable and reconfigurable manner within the structural channel system 100. The structural channel system 100 also facilitates access to locations where a commercial interior designer may wish to locate various application devices, including electrical lights and the like. The structural channel system 100 carries not only AC power (of varying voltages) but also DC power and communication signals. The communication signals are associated with a communications network structure permitting the “programming” of control relationships among various devices. The programming (or reprogramming) may be accomplished at the location of the controlled and controlling elements, and may be accomplished by a layperson without significant training or expertise.

The structural channel system 100 in accordance with the invention facilitates the reconfiguration of a commercial interior in “real time.” Not only may various functional elements be quickly relocated from a “physical” sense, but logical relationships among devices can also be altered, in accordance with the prior description relating to programming of control relationships. The structural channel system 100 in accordance with the invention presents a “totality” of concepts which provide a commercial interior readily adapted for use with various devices, and with the capability of reconfiguration without requiring additional physical wiring or substantial rewiring. With this capability of relatively rapid reconfiguration, change can be provided in a building's infrastructure quickly, ensuring that the attendant commercial interior does not require costly disassembly and reassembly, and is not “down” for any substantial period of time. Further, the structural channel system 100 in accordance with the invention, with attendant devices, permits occupants to allow their needs to “drive” the structure and function of the infrastructure and layout.

In addition to the foregoing, the structural channel system 100 in accordance with the invention overcomes other issues, particularly related to governmental and institutional codes and regulations associated with electrical power, mechanical support of overhead structures and the like. For example, it is advantageous to provide device availability throughout a number of locations within a commercial interior. The structural channel system 100 in accordance with the invention provides the advantages of an overhead structure for distributing power (both AC and DC) and communications signals. However, structural elements carrying electrical signals (either in the form of power or communications) are regulated as to mechanical load-bearing parameters. As described herein, the structural channel system 100 in accordance with the invention utilizes a suspension bracket for supporting elements such as perforated structural channels and the like throughout the overhead structure. With the use of these elements in accordance with the invention, the load resulting from these support elements is directly supported through elements coupled to the building structure of the commercial interior. Accordingly, rail elements carrying power and communication signals do not support the mechanical loads resulting from various other support and hanger components associated with the structural channel system 100. This provides significant advantages, in that regulations do not permit power and communication distribution systems to carry significant mechanical loads. That is, the structural channel system 100 in accordance with the invention provides for both power distribution and a distributed communications network, notwithstanding governmental and institutional restrictive codes and regulations.

Still other advantages exist in accordance with certain aspects of the invention. For example, the structural channel system 100 provides for carrying relatively high voltage cables, such as 277 volt AC power cables. With the use of wireways as previously described herein, such cabling can be appropriately shielded, and meet codes and regulations. Still further, the structural channel system 100 in accordance with certain other aspects of the invention carries both DC “working” power, and a communications network. DC power may be generated from building power, through AC/DC converters associated with the power entry boxes. Alternatively, and also in accordance with the invention, the electrical network 530 may be structured so that it is unnecessary for the communication cables 572 to carry any DC power, as may be required by connector modules and application devices. Instead, and as described in detail herein, such DC power may be generated through the use of the distributed AC power on cables 574, and the use of transformers within the connector modules. With the removal of the necessity of having any of the communication cables 572 carry DC power, relatively more advantageous configurations may be utilized for carrying communication signals, such as the differential signal configuration previously described herein.

Still further advantages in accordance with certain aspects of the invention relate to the carrying of both AC and DC power. Again, governmental and institutional codes and regulations include some relatively severe restrictions on mechanical structures incorporating components carrying both AC and AC power. The structural channel system 100 in accordance with the invention provides for a mechanical and electrical structure which includes distribution of AC and DC power, and which should meet most codes and regulations.

Still further, the structural channel system 100 in accordance with the invention includes the concept of providing both wireways and cableways for carrying AC and DC cables. The structural channel system 100 includes not only capability of the providing for a single set of cableways and wireways, but also provides for “stacking” of the same. Still further, other governmental and institutional codes and regulations include restrictions relating to objects which extend below a certain minimum distance above ground level, with respect to support of such objects. The structural channel system 100 in accordance with the invention provides for breakaway hanger assemblies, again for meeting certain codes and regulations. Still further, with a distributed power system such as the structural channel system 100, it is necessary to transmit power between various types of structural elements, such as different lengths of main rails. Advantageously, with the particular mechanical and electrical structure of the structural channel system 100, components such as the previously described flexible connector assembly 138 can be utilized for transmitting both power and communications from one section 540 of a modular plug assembly 130 to another section 540.

In addition to the foregoing, the structural channel system 100 can be characterized as not only a distributed power network, but also a distributed “intelligence” network. That is, when various types of application devices are connected into the network of the structural channel system 100, “smart” connectors will be utilized. It is this intelligence associated with the application devices and their connectivity to the network which permits a user to “configure” the structural channel system 100 and associated devices as desired. This is achieved without requiring any type of centralized computer or control systems. Still further, the structural channel system 100 in accordance with another aspect of the invention may be characterized as an “open” system. That is, the structural channel system 100 can readily be grown or reduced, with respect to both structural elements and functional devices.

Other advantageous concepts also exist with respect to the structural channel system 100 in accordance with the invention. For example, mechanical elements utilized for supporting the structural channel system 100 from the building structure itself permit the “height” of the structural channel system 100 from the floor to be varied. In addition, it should again be emphasized that the flexible connector assembly 138 is unidirectional, and can only be interconnected between a pair of adjacent sections 540 of the modular plug assembly 130 in one way. With respect to this concept, terminal housings are utilized which are “reversed” in structure, as shown by the prior illustrations. Also, use of the angled sections again prohibits certain incorrect interconnections of the flexible connector 138 to the sections 540 of the modular plug assembly 130.

Another concept which may be employed in the system 100 relates to the positioning and configuration of the main rails 102. It would actually be possible to “flip” a length of main rail 102. In this “upside down” configuration, the main rail 102 actually has a shape whereby the rail 102 could “cradle” one or more of the cableways 120.

In general, the individual sections 540 of the modular plug assembly 130 may be utilized in a number of different applications, independent of the main rails 102. Still within the novel concepts of the invention, a number of sections 540 of the modular plug assembly 130 could be utilized, in combination with the flexible connector assembly 138, in “stand alone” configurations where the sections 540 are secured to walls or other structures. In general, the configurations of the sections 540, including the modular plugs 576 and distribution plugs 650, provide for an advantageous structural and electrical configuration for distributing power and communications signals throughout an interior. Also, other configurations may be contemplated whereby the sections 540 of the modular plug assembly 130 are utilized with somewhat different relative structural configurations with the lengths of main rails 102. Also, the modular plug assembly 130 can be characterized as nonintegral with the rails 102.

Certain other concepts associated with the structural channel system 100 in accordance with the invention should be mentioned. First, the system can clearly be characterized as an overhead system. The system 100 can also be characterized as being used within a building infrastructure, for purposes of supporting a number of application devices. With a series of main rails 102, they can be characterized as forming a structural grid 172. The structural grid 172 can be characterized as forming at least one visual plane relative to the building infrastructure. Also, as described with respect to use of the visual shields 522 and 524, the structural grid 172 can be characterized as forming a series of panel insert areas between the structural channel rails 102 and cross channels 104. The panel insert areas can be characterized as being “open” to the building infrastructure. Further, however, a series of panels, such as the visual shields 522, can be inserted within these panel insert areas. Such panels as visual shields 522 may clearly limit access to space above the visual plane formed by the rails 102 and cross channels 104, from below the visual plane. However, as previously described herein, the main rails 102 include apertures which comprise means for permitting passage of cabling from above the visual plane to below the visual plane, without requiring any of the cabling to be passed through any apertures within any of the panels, such as the visual shields 522 or light bags 524.

In accordance with another aspect of the invention, and as previously described herein, the flexible connector assembly 138 may include an AC power flexible conduit 790 and communications flexible conduit 792. That is, the conduits 790 and 792 illustrated, for example, in FIG. 50A, may both be flexible, although formed in various desired configurations.

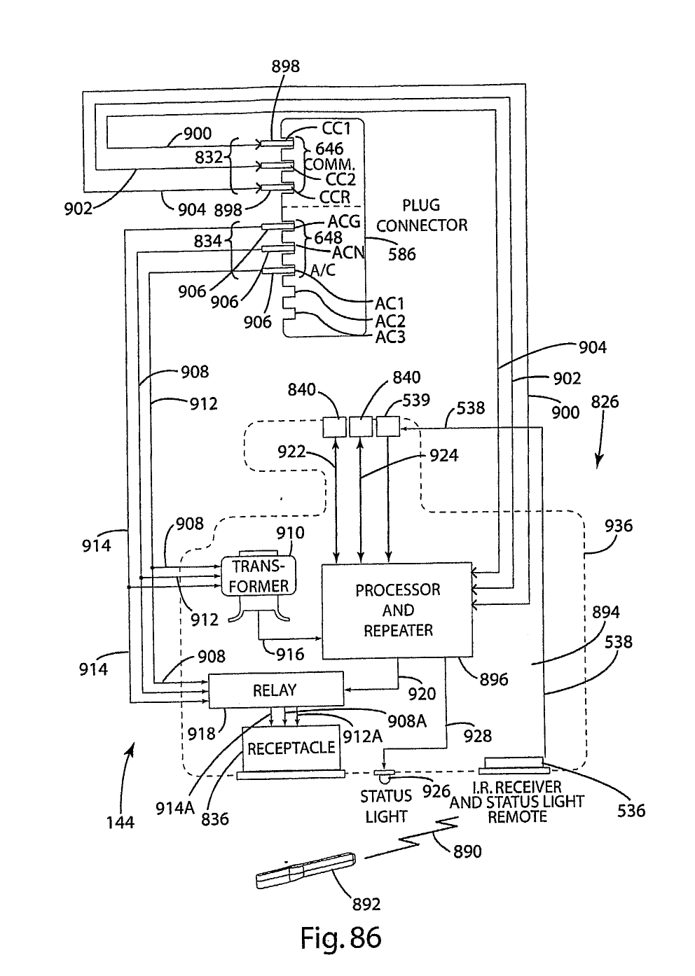

Turning to another aspect of the structural channel system 100, reference is made to FIG. 86. As shown therein, FIG. 86 illustrates a modified version of the receptacle connector module 144. The receptacle connector module 144 was previously described herein with respect to FIG. 58A, and FIG. 86 is substantially similar to FIG. 58A. However, the configuration shown in FIG. 86 includes, instead of the IR receiver 536 and status light 926, a remote IR receiver and status light 536. This remote IR receiver 536 can be positioned a substantial distance from the receptacle connector module 144. The IR receiver 536 can include appropriate electronics and the like so that rather than the IR receiver transmitting signals directly to the processor 896, the signals transmitted by the remote IR receiver 536 can be applied to a connector port 539 which may correspond to the connector ports 840. That is, the IR receiver 536 can be connected to the receptacle connector module in the same manner as a switch or other device which applies control and communication signals to connector modules through connector ports 840, 539 or similar connector ports. These signals from the remote IR receiver 536 are applied through a patch cord 538, directly connected to the connector port 539. It should be noted that this configuration is different from the previously described remote IR receiver configuration, where the IR receiver was only indicated to be positioned away from the associated connector module, but was still directly connected into the processor 896 or similar processors. In this case, the remote IR receiver 536 can be thought of as a device in and of itself, and can be used with various connector modules, and “plugged into” a connector port associated with the connector module. That is, the remote IR receiver 536 is not dedicated to a particular connector module. This provides various significant advantages.

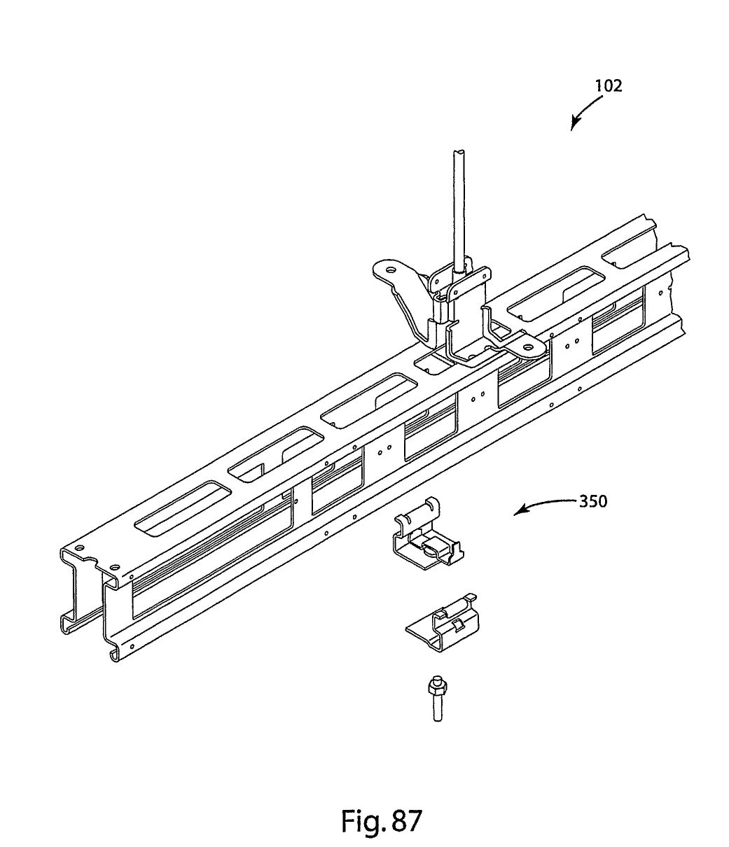

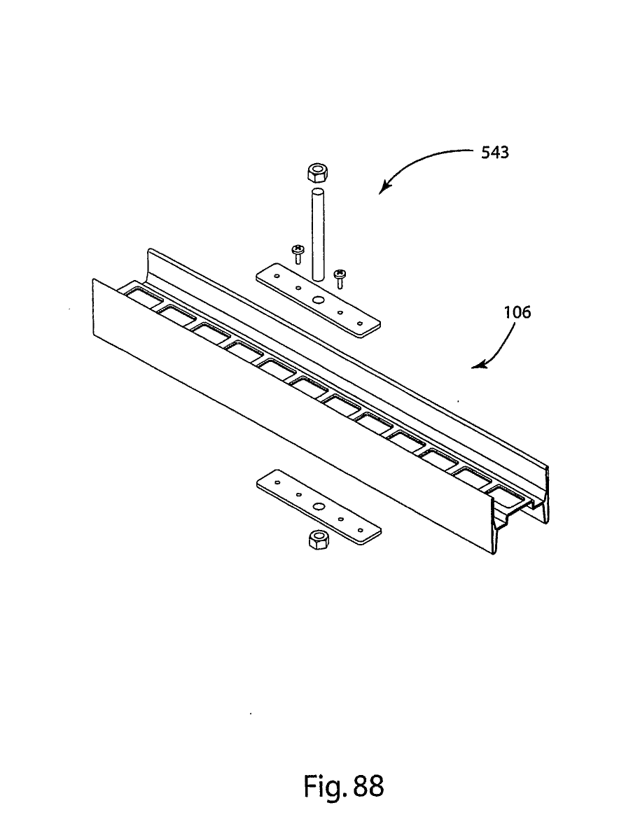

For purposes of ensuring clarity, reference is further made to FIGS. 87-92. Therein, illustrations are set forth which show additional detail of various types of connector and hanger assemblies which may be utilized with the structural channel system 100 in accordance with the invention. More specifically, FIG. 87 illustrates the universal structural channel attachment assembly 350, and further shows the assembly 350 in an exploded view as it may be attached to a rail 102. The assembly 350 includes a position lock and may be secured to a threaded rod through a hex nut as shown in FIG. 87. FIG. 88 illustrates a universal support bracket assembly 543 for use with the cross rails 106. Again, FIG. 88 illustrates an exploded view of the bracket assembly 543 as it may be utilized with the cross rail 106 to hang and stabilize objects from the cross rail 106. The objects may be supported through the use of a threaded rod associated with the bracket assembly 543.

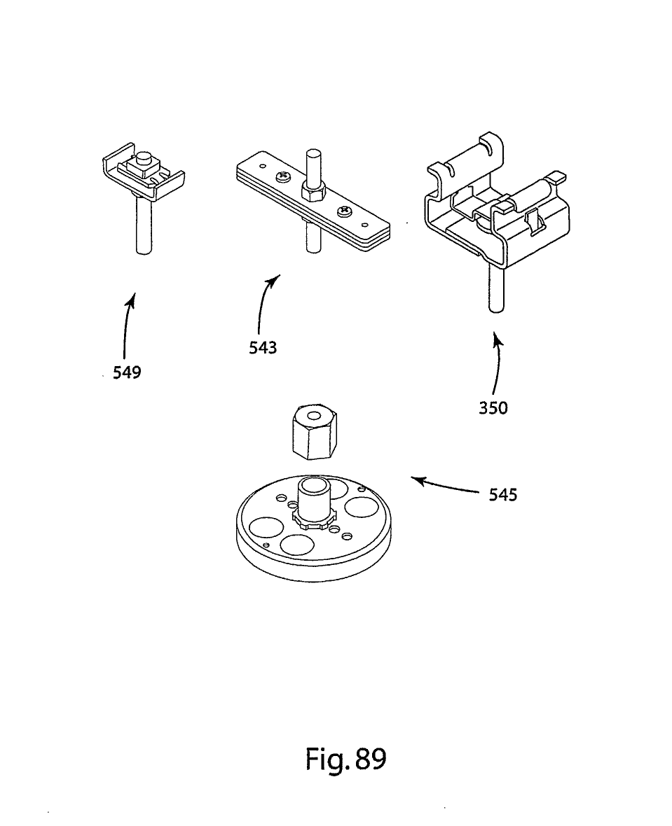

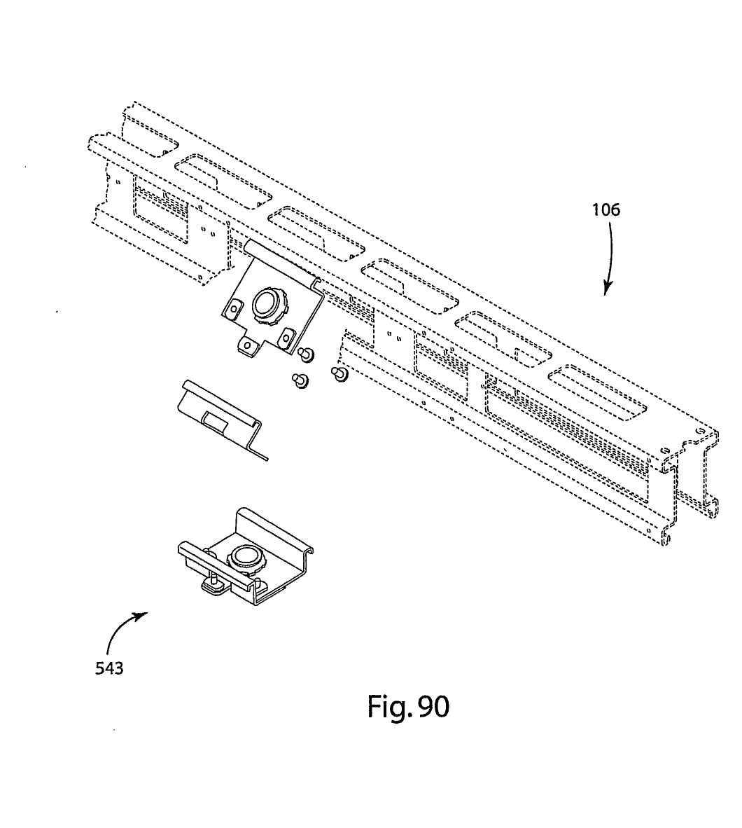

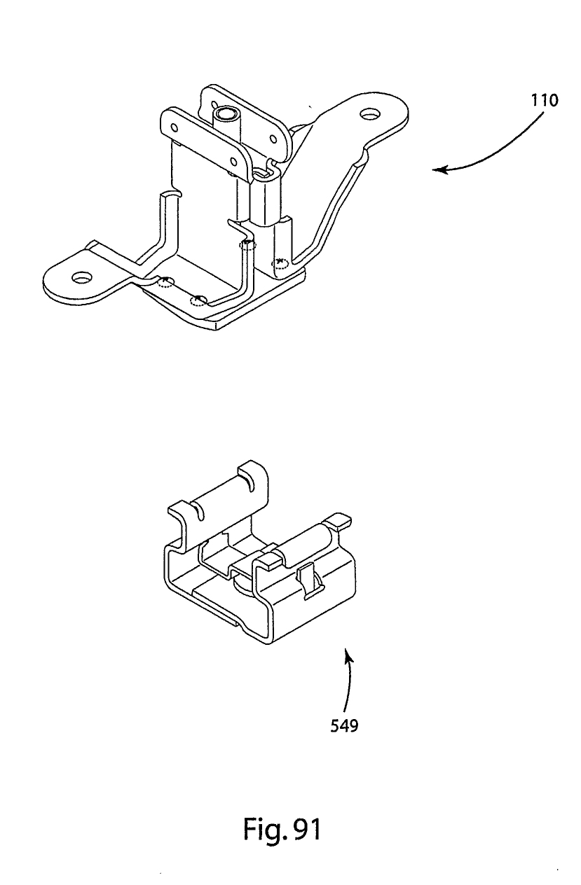

FIG. 89 illustrates a universal support bracket 549 for use with a cross channel 104, as well as the universal support bracket 543 for use with the cross rail 106. FIG. 89 also illustrates a perspective view of the universal support bracket 350 for use with the structural channel rail 102. Still further, FIG. 89 illustrates a perspective and partially exploded view of an arrangement for suspending lighting fixtures from the support brackets. The suspension configuration is identified as configuration 545. Still further, FIG. 90 illustrates additional detail of the universal support bracket assembly 543 for attachment to cross rails 106. This is shown partially in an exploded format. This configuration is further illustrated with the use of light brackets which may be alternatively used for connecting lighting fixtures directly to main structural channel rails 102. FIG. 90 also illustrates the interconnection of a light bracket to a ceiling box or light fixture.

FIG. 91 illustrates perspective views of a suspension bracket assembly 110, a suspension plate assembly and a universal support bracket 549 for use with the structural channel rail 102. Finally, FIG. 92 illustrates additional views of the universal support bracket 549 for use with the structural channel rails 102, the universal support bracket 543 for use with the cross rails 106 and an illustration of a clamp plate for use with the structural channel rails 102.

Finally, reference is again made to FIG. 58A, illustrating the use of the status light 926. As previously described herein, the status light 926 can be utilized to indicate a particular state of the connector module associated therewith, or an application device electrically coupled to the connector module. However, as also generally described herein, the status light 926 can be utilized to indicate the status of a process of effecting a control relationship among controlling and controlled devices, with at least one of the devices associated with the particular connector module. That is, the status light 926 can be utilized to indicate process stages, such as the enablement of a control relationship between a switch and a light, disablement of the relationship and the like.

It will be apparent to those skilled in the pertinent arts that other embodiments of structural channel systems in accordance with the invention may be designed. That is, the principles of a structural channel system for providing distributed power and distributed intelligence among various application devices, are not limited to the specific embodiments described herein. For example, and as earlier stated, certain types of communications which occur through the use of cables in the structural channel system 100 may be achieved through wireless configurations. Accordingly, it will be apparent to those skilled in the art that modifications and other variations of the above-described illustrative embodiments of the invention may be effected without departing from the spirit and scope of the novel concepts of the invention.

What is claimed is:

1. An overhead system for use within a building infrastructure for supporting a plurality of application devices, said system comprising:
a plurality of main rails interconnected so as to form a structural grid, said structural grid forming at least one visual plane relative to said building infrastructure;
said structural grid further forming a plurality of panel insert areas open to said building infrastructure;
a plurality of panels, said panels being inserted into said panel insert areas, said panels limiting access to space above said visual plane from below said visual plane; and
said plurality of main rails comprises means for permitting passage of cabling from above said visual plane to below said visual plane, in the absence of requiring any of said cabling to be passed through apertures of any of said panels.

2. An overhead system for use within a building infrastructure for supporting and energizing a plurality of application devices, said system comprising:
at least one main structural channel rail for providing a mechanical structure for said overhead system;
support means for supporting said one main rail from said building infrastructure;
power distribution means electrically connected to a source of electrical power, for distributing said electrical power along said main structural channel rail; and
said power distribution means comprises a plurality of modular sections connectable to each other, to said main structural channel rail, and to said source of electrical power, for providing access to said electrical power by said application devices at selected and spaced apart positions along said main structural channel rail.

3. An overhead system in accordance with claim 2, characterized in that said modular sections are selectively connectable as desired to individual lengths of said main structural channel rail.

4. An overhead system for use within a building infrastructure for supporting and energizing a plurality of application devices, said system comprising:
at least one elongated main structural channel assembly, said channel assembly comprising a plurality of main structural channel rail lengths, each of said rail lengths comprising:
a longitudinally extending upper portion;
a series of spaced apart upper apertures extending through said upper portion, and functioning so as to permit passage of cables from above and from below said rail length;
a pair of opposing side panels extending downwardly from opposing lateral edges of said upper portion, said side panels comprising first and second side panels; and
a series of spaced apart side plug assembly apertures extending through said first side panel and/or said second side panel;
at least one modular plug assembly comprising a plurality of modular plug assembly sections, each of said modular plug assembly sections comprising:
a series of spaced apart principal electrical dividers positioned along at least one elongated side of said section;
channels formed within said principal electrical dividers for carrying communication cables and power cables;
a series of modular plugs coupled to said section and spaced apart on the same side of said section as the side carrying said principal electrical dividers, said modular plugs being spaced intermediate adjacent lengths of said principal electrical dividers; and
each of said modular plugs is electrically connected to said communication cables and to said power cables, and functions so as to provide access to communication signals carried on said communication cables and to power signals carried on said power cables.

5. An overhead system for use with a building infrastructure for supporting and energizing a plurality of application devices, said system comprising:
at least one elongated main structural channel assembly, said channel assembly compromising at least a first main structural channel rail, said rail comprising:
a longitudinally extending upper portion;
a pair of opposing side panels extending downwardly from opposing lateral edges of said upper portion, said side panels compromising first and second side panels;
a series of spaced apart side plug assembly apertures extending through said first side panel and/or said second side panel; and
an end aperture extending through said first side panel and/or said second side panel at least one end of said first main structural channel rail, said end aperture being of a length greater than the lengths of said spaced apart side plug assembly apertures;
at least one modular plug assembly comprising at least one modular plug assembly section, said section comprising:
channels formed within said section for carrying communication cables and power cables; and
a series of modular plugs coupled to said section and spaced apart along said section, said modular plugs adapted to extend inwardly through said side plug assembly apertures of said first main structural channel rail, and into a spatial region formed between said pair of opposing side panels.

6. An overhead system for use within a building infrastructure for supporting and energizing a plurality of application devices, said system comprising:
at least one elongated main structural channel assembly;
power distribution means electrically connected to a source of electrical power for distributing said electrical power along said main structural channel assembly;
said power distribution means comprises means for accessing said electrical power at selected and spaced apart locations along said structural channel assembly;
communications distribution means for distributing communication signals along said main structural channel assembly; and
said communications distribution means comprises means for accessing said communication signals at selected and spaced apart locations along said structural channel assembly.

7. An overhead system in accordance with claim 6, characterized in that said system further comprises means connectible to a first subset of said application devices and to said communications distribution means for receiving communication signals from said first subset of said application devices, and means connectible to a second subset of said application devices and to said power distribution means for selectively applying said electrical power to said second subset of said application devices.

8. An overhead system in accordance with claim 6, characterized in that said system further comprises control means responsive to a subset of said communication signals for selectively controlling application of electrical power to said application devices.

9. An overhead system in accordance with claim 6, characterized in that:
said elongated main structural channel assembly comprises a plurality of main rails; and
said overhead system is an open architectural system, in that said plurality of main rails, said power distribution means and said communication distribution means can be expanded as to size, either singularly or in combination, without requiring substitution or other replacement of components of a first, original structure of said elongated main rail assembly, said power distribution means or said communications distribution means.

10. An overhead system in accordance with claim 6, characterized in that said elongated main rail assembly, said power distribution means and said communications distribution means are all reconfigurable, independent of assembly, disassembly or modifications to said building infrastructure.

11. An overhead system in accordance with claim 6, characterized in that said power distribution means comprises a plurality of connector modules electrically connected to said source of electrical power, and physically located at spaced apart positions along said elongated main structural channel assembly.

12. An overhead system in accordance with claim 11, characterized in that said plurality of connector modules comprises processor means responsive to said communication signals transmitted on said communications distribution means for controlling energization of application devices connected to said connector modules, and for effecting logical control relationships among application devices connected to said overhead system.

13. An overhead system in accordance with claim 6, characterized in that said application devices comprise controlled and controlling devices, and said overhead system comprises controlled and correlation means for selectively energizing certain of said application devices from said power distribution means, and for effecting logical control relationships among said controlled and said controlling devices, in the absence of any centralized processing means or centralized control means.

14. An overhead system for use within a building infrastructure for supporting and energizing a plurality of application devices, said system comprising:
at least one elongated main structural channel assembly;
power distribution means electrically connected to a source of electrical power for distributing said electrical power along said main structural channel assembly;
communications distribution means for distributing communication signals along said main structural channel assembly; and
said power distribution means and said communications distribution means comprise distribution components contained within modular plug assemblies.

15. An overhead system in accordance with claim 14, characterized in that:
said system comprises a plurality of individual lengths of said modular plug assemblies; and
said individual lengths of said modular plug assemblies can be selectively located at desired positions along said main structural channel assembly, without requiring said individual lengths of said modular plug assemblies to be coupled to said main structural channel assembly along an entirety of a length of said main structural channel assembly.

16. An overhead system for use within a building infrastructure for supporting and energizing a plurality of application devices, said system comprising:
at least one main structural channel assembly, said channel assembly having a plurality of spaced apart apertures extending therethrough;
power distribution means electrically connected to a source of electrical power, for distributing said electrical power along said main structural channel assembly; and
said power distribution means comprises at least one modular plug assembly, said modular plug assembly having said distributed electrical power extending therethrough, and further having means for accessing said electrical power at spaced apart locations extending through said apertures of said main structural channel assembly.

17. An overhead system in accordance with claim 16, characterized in that said modular plug assembly is completely nonintegral with said main structural channel assembly.

18. An overhead system for use within a building infrastructure for supporting and/or energizing one or more application devices from said overhead system, said system comprising:
at least one main structural channel rail for providing a mechanical structure for said overhead system;
support means for supporting said main structural channel rail from said building infrastructure;
power distribution means electrically connected to a source of electrical power, for distributing said electrical power along said structural channel rail, so as to energize said application devices; and
communications distribution means for distributing communication signals along said main structural channel rail.

19. An overhead system in accordance with claim 18, characterized in that said power distribution means comprises a plurality of modular sections connectable to each other, to said main structural channel rail, and to said source of electrical power, for providing access to said electrical power by said application devices at selected and spaced apart positions along said main structural channel rail.

20. An overhead system in accordance with claim 18, characterized in that said modular sections are selectively connectable as desired to individual lengths of said main structural channel rail.

21. An overhead system in accordance with claim 18, characterized in that said system further comprises control means responsive to a subset of said communication signals for selectively controlling application of electrical power to said application devices.

22. An overhead system in accordance with claim 18, characterized in that said power distribution means and said communications distribution means comprise distribution components contained with modular plug assemblies.

23. An overhead system in accordance with claim 22, characterized in that:
said system comprises a plurality of individual lengths of said modular plug assemblies; and
said individual lengths of said modular plug assemblies can be selectively located at desired positions along said main structural channel rail, without requiring individual lengths of said modular plug assemblies to be coupled to said main structural channel rail along an entirety of a length of said main structural channel rail.

24. An overhead system in accordance with claim 18, characterized in that:
said main structural channel rail comprises a plurality of spaced apart apertures extending therethrough; and
said power distribution means comprises at least one modular plug assembly, said modular plug assembly having said distributed electrical power extending therein, and further having means for accessing said distributed electrical power.

25. An overhead system in accordance with claim 24, characterized in that said apertures extend through lateral sides on said main structural channel rail.

26. An overhead system in accordance with claim 18, characterized in that said power distribution means further comprises a plurality of connector modules electrically connected to said source of electrical power through said power distribution means, and locatable at desired positions along said main structural channel rail, so as to be selectively connectable with said application devices to be energized.

27. An overhead system in accordance with claim 26, characterized in that said system is configured so to provide for releasable interconnection of said connector modules at spaced apart locations along said main structural channel rail.

28. An overhead system in accordance with claim 26, characterized in that each of said plurality of connector modules comprises means responsive to a subset of said communication signals for selectively controlling application of electrical power from said connector modules to said devices.

29. An overhead system in accordance with claim 26, characterized in that said power distribution means comprises DC means connected to at least one source of DC power for distributing said DC power to said plurality of connector modules.

30. An overhead system in accordance with claim 26, characterized in that a subset of said plurality of connector modules comprises means for transmitting and receiving communication signals to and from said communications distribution means and at least a subset of said application devices.

31. An overhead system in accordance with claim 25, characterized in that:
at least one structural channel rail forms a centralized and elongated channel; and
at least a subset of said plurality of connector modules are electrically coupled to said power distribution means with said subset of connector modules fitting within said channel.

32. An overhead system in accordance with claim 26, characterized in that at least a subset of said plurality of connector modules comprises DC power means for generating DC power.

33. An overhead system in accordance with claim 26, characterized in that:
said mechanical structure further comprises a plurality of structural channel rails forming a mechanical grid; and
said mechanical grid, said power distribution means, and said communications distribution means are all reconfigurable, independent of assembly, disassembly, or modifications to said infrastructure.

34. An overhead system in accordance with claim 26, characterized in that:
said overhead system comprises a plurality of main structural channel rails, each of said main structural channel rails capable of supporting components of said power distribution means and said communications distribution means; and
said overhead system is an open architectural system, in that said plurality of structural channel rails, said power distribution means, and said communications distribution means can be expanded as to size, either singularly or in combination, without requiring substitute or other replacement of components of a first, original structure of said mechanical, said power distribution means, or said communication distribution means

35. An overhead system in accordance with claim 26, characterized in that said system comprises means for distributing electrical power and for providing a distributed, intelligence system for transmitting and receiving certain of said communication signals from said application devices physically located throughout an entirety of said mechanical structure.

36. An overhead system in accordance with claim 26, characterized in that said system further comprises device connection means physically connectable to said mechanical structure, for mechanically connecting said application devices to said mechanical structure.

37. An overhead system in accordance with claim 26, characterized in that said system further comprises device connection means manually releasable and movable so as to be connected at a desired one of a plurality of different locations through said mechanical structure, and so as to provide for releasable interconnection and movement of said application devices throughout said mechanical structure.

38. An overhead system in accordance with claim 26, characterized in that said system further comprises means for positioning sets of electrical conductors in vertically disposed configurations.

39. An overhead system in accordance with claim 18, characterized in that said system further comprises one or more wireways for distributing and carrying sets of electrical cables throughout said mechanical structure.

40. An overhead system in accordance with claim 39, characterized in that said wireways comprise means for electrically isolating and shielding said electrical cables from other electrical and communication signal conductors associated with said overhead system.

41. An overhead system in accordance with claim 39, characterized in that said overhead system further comprises means for vertically stacking a plurality of said wireways, one above the other.

42. An overhead system in accordance with claim 18, characterized in that said system further comprises height adjustment means coupled to said support means, for varying the height of a general horizontal plane of said mechanical structure.

43. An overhead system in accordance with claim 18, characterized in that said system further comprises device height adjustment means for selectively varying the vertical location of selected ones of said application devices, relative to a general horizontal plane of said mechanical structure.

44. An overhead system in accordance with claim 18, characterized in that said system further comprises:
a first set of structural components comprising a plurality of said main structural channel rails, with said first set of structural components carrying components of said power distribution means and components of said communications distribution means;
a second set of structural components; and
suspension bracket means coupled to said support means and to said mechanical structure for translating gravitational loads from said second set of structural components directly to said support means, so that substantially none of said gravitational loads from said second set of structural components are carried by said first set of said structural components.

45. An overhead system in accordance with claim 44, characterized in that said suspension bracket means comprise means for translating gravitational loads of said first set of structural components directly to said support means.

46. An overhead system in accordance with claim 45, characterized in that said suspension bracket means comprise individual means for connecting to a single one of said first set of said structural components, and to a pair of said second set of said structural components.

47. An overhead system in accordance with claim 46, characterized in that gravitational loads exerted on said suspension bracket means from said pair of said second set of structural components act so as to increase coupling forces between certain components of said suspension bracket means.

48. An overhead system in accordance with claim 44, characterized in that said support means comprise a plurality of support rods, and each of said suspension bracket means comprises means for connecting to a single one of said plurality of support rods.

49. An overhead system in accordance with claim 44, characterized in that said system further comprises:
at least one wireway for distributing and carrying sets of electrical cables throughout said overhead system; and
said wireway is carried on said overhead system so that gravitational loads are carried by said support means, and not carried by either said first set of structural components or said second set of structural components.

50. An overhead system in accordance with claim 49, characterized in that:
said support means comprises a plurality of vertically disposed support rods; and
said suspension bracket means comprises a plurality of suspension brackets, each of said suspension brackets being stackable on individual ones of said support rods, with said suspension brackets being independent of any connection to said first set of structural components or said second set of structural components.

51. An overhead system in accordance with claim 49, characterized in that said suspension bracket means comprise means for vertically stacking said second set of structural components.

52. An overhead system in accordance with claim 44, characterized in that:
said support means comprise a plurality of vertically disposed support rods; and
said suspension bracket means comprise a plurality of suspension brackets, with each of said suspension brackets being connectable to any single one of said plurality of said support rods.

53. An overhead system in accordance with claim 44, characterized in that said suspension bracket means comprises a plurality of suspension brackets, each of said suspension brackets comprising:
first section means coupled to a first one of said second set of structural components;
second section means connected to a second one of said second set of structural components;
central support section means connected to a first one of said first set of structural components, said first section means, said second section means and said support means; and
said central support section means is connected to said support means so that gravitational loads from said first section means and said second section means are translated directly to said support means, and said gravitational loads are not carried by said first one of said first set of structural components.

54. An overhead system in accordance with claim 53, characterized in that:
said first section means comprises a central portion having a leg formed on one side thereof, so as to configure a capturing slot, and an arcuate arm formed on an opposing side of said central portion;
said second section means is substantially identical to said first section means; and
when assembled, said arcuate arm of said first section means is captured within said capturing slot of said section means, and said arcuate arm of said second section means is captured within said capturing slot of said first section means.

55. An overhead system in accordance with claim 53, characterized in that:
said first section means comprises a first suspension bracket section half; and
said second section means comprises a second suspension bracket section half, with said second suspension bracket section half being substantially identical to said first suspension bracket section half.

56. An overhead system in accordance with claim 55, characterized in that when one of said suspension brackets is assembled with said suspension bracket section halves being coupled together, outwardly directed forces exerted on said suspension bracket section halves of said one suspension bracket will act so as to increase coupling forces between said suspension bracket section halves.

57. An overhead system in accordance with claim 44, characterized in that:
said suspension bracket means comprise a plurality of suspension brackets, each of said suspension brackets comprising a universal suspension plate assembly connected to said support means; and
said universal suspension plate assembly is adapted to be used independently of other components of said suspension bracket, for purposes of directly securing structural elements to said support means.

58. An overhead system in accordance with claim 44, characterized in that said suspension bracket means comprises a plurality of suspension brackets, and each of said suspension brackets comprises means for mounting at least one cableway.

59. An overhead system in accordance with claim 58, characterized in that said suspension brackets comprise means for mounting said cableway so that gravitational loads of said cableway are carried by said support means, and are not carried by said first set of said structural components.

60. An overhead system in accordance with claim 44, characterized in that:
said support means comprises a plurality of support rods;
said suspension bracket means comprises a plurality of suspension brackets; and
each of said suspension brackets comprise means for being coupled to at least one of said support rods, so that individual ones of said suspension brackets are vertically stackable, one above the other on a single support rod.

61. An overhead system in accordance with claim 60, characterized in that said suspension brackets comprise means for connecting to said second set of structural components, so that elements of said second set of structural components are capable of being vertically stacked in correspondence with vertical stacking of said suspension brackets.

62. An overhead system in accordance with claim 61, characterized in that said suspension brackets comprise means for said vertical stacking of said second set of structural components, independent of any interconnection to said first set of structural components.

63. An overhead system in accordance with claim 18, characterized in that said system further comprises:
a plurality of main structural channel rails;
a plurality of structural cross channels connected between pairs of said main structural channel rails;
said support means comprises a plurality of suspension brackets and a plurality of elongated supporting elements connected to said infrastructure and further connected to at least one of said main structural channel rails; and
said plurality of main rails, said plurality of suspension brackets, said plurality of structural cross channels and said plurality of elongated supporting elements form a structural grid comprising a common base for implementing various configurations of said overhead system.

64. An overhead system in accordance with claim 63, characterized in that an overhead system of an initial structural configuration can be expanded in size so as to form a second overhead system, without modification of said initial structural configuration.

65. An overhead system in accordance with claim 63, characterized in that:
said system further comprises a plurality of suspension points or nodes, where each suspension point or node is formed at a location along one of said main structural channel rails, and where ends of a pair of said structural cross channels, one of said suspension brackets and one of said elongated supporting elements are coupled together; and
said coupling is provided by said suspension bracket supporting, at least in part, said pair of said structural cross channels, and said elongated supporting element supporting said suspension bracket, said main structural channel rail in part, and said pair of said structural cross channels.

66. An overhead system in accordance with claim 18, characterized in that said system further comprises:
a plurality of main structural channel rails; and
said plurality of main structural channel rails comprises a series of spaced apart apertures, said spaced apart apertures adapted to permit passage of electrical cables therethrough.

67. An overhead system in accordance with claim 66, characterized in that said main structural channel rails are supported by said support means, and load ratings of any given one of said structural channel rails may be varied by varying the intervals at which said structural channel rails are supported by said support means.

68. An overhead system in accordance with claim 18, characterized in that said mechanical structure further comprises:
a plurality of main structural channel rails, each of said main structural channel rails being supported by said support means; and
a plurality of cross channels, each of said cross channels being coupled to and supported by said support means.

69. An overhead system in accordance with claim 68, characterized in that each of said plurality of cross channels has opposing ends positioned adjacent to said structural channel rails, with each of said cross channels being supported by said support means.

70. An overhead system in accordance with claim 68, characterized in that each of said main structural channel rails includes a series of spaced apart apertures, said spaced apart apertures adapted to permit passage of electrical cables therethrough.

71. An overhead system in accordance with claim 18, characterized in that said mechanical structure comprises:
a plurality of main structural channel rails;
a plurality of cross channels having opposing ends positioned adjacent two of said main structural channel rails, with each of said cross channels being supported by said support means; and
a plurality of cross rails coupled to and supported by one or more of said main structural channel rails.

72. An overhead system in accordance with claim 71, characterized in that said overhead system further comprises connection means for connecting one or more of said cross rails to one or more of said cross channels.

73. An overhead system in accordance with claim 71, characterized in that said overhead system comprises connection means for connecting one or more of said cross rails to one or more of said main structural channel rails, at an acute angle relative to an elongated length of an interconnected one of said main structural channel rails.

74. An overhead system in accordance with claim 73, characterized in that said connection means comprises a cross rail connector assembly, said cross rail connector assembly comprising:
a universal structural channel attachment assembly, comprising a pair of opposing left side and right side brackets, said brackets adapted to be coupled to one of said main structural channel rails; and
a suspension rod coupled to said pair of opposing brackets and to said cross rail.

75. An overhead system in accordance with claim 18, characterized in that said system further comprises:
a plurality of main structural channel rails interconnected so as to form a structural grid, said structural grid forming at least one substantially horizontal plane relative to said building infrastructure; and
connection means connectable to components of said structural grid and to a subset of said application devices, so as to support said subset of said application devices above said substantially horizontal plane of said structural grid.

76. An overhead system in accordance with claim 18, characterized in that said power distribution means comprises:
a plurality of connector modules electrically connected to said source of electrical power through said power distribution means, and locatable at desired positions along said main structural channel rail, so as to be selectively connectable with said application devices to be energized;
plug assembly means electrically connected to said power supply, for carrying electrical power throughout said mechanical structure;
plug assembly connection means for selectively and mechanically connecting said plug assembly means to components of said mechanical structure; and
said plug assembly means comprise a plurality of tap means located at spaced apart positions along said plug assembly means, and electrically connectable to said connector modules for supplying said electrical power from said power supply means to said connector modules.

77. An overhead system in accordance with claim 76, characterized in that said plug assembly means comprises:
a plurality of modular plug assembly sections, each section having an elongated configuration and connectable to components of said mechanical structure; and
modular plug assembly connector means for electrically connecting together individual ones of said modular plug assembly sections.

78. An overhead system in accordance with claim 77, characterized in that:
each of said modular plug assembly sections carries a set of electrical power conductors, electrically connected to said power supply;
said tap means comprise a plurality of modular plugs, each of said modular plugs having terminals electrically tapped into said electrical power conductors, with said modular plugs being located at spaced apart positions along said modular plug assembly sections; and
said modular plug terminals are connectable to said connector modules.

79. An overhead system in accordance with claim 77, characterized in that said modular plug assembly sections are adapted to be used independent of any mechanical connections to components of said structural grid.

80. An overhead system in accordance with claim 77, characterized in that:
each of said modular plug assembly sections carries at least one set of communication conductors, carrying said communication signals;
each of said modular plug assembly sections carries at least one set of electrical power conductors, electrically coupled to said power supply means and to said tap means; and
said modular plug assembly sections comprise means for mechanically and electrically isolating said electrical power conductors from said communication conductors.

81. An overhead system in accordance with claim 80, characterized in that said tap means comprise means for tapping into said communication conductors, and supplying communication signals carried by said communication conductors to said connector modules.

82. An overhead system in accordance with claim 81, characterized in that said communication conductors comprise at least one conductor carrying DC power.

83. An overhead system in accordance with claim 80, characterized in that said tap means comprise:
means for tapping into said communication conductors, and supplying communication signals carried by said communication conductors to said connector modules; and
means for simultaneously tapping into said electrical power conductors, and supplying electrical signals carried by said electrical power conductors to said connector modules.

84. An overhead system in accordance with claim 77, characterized in that said modular plug assembly connector means comprise:
a right hand jumper assembly having right hand terminal means electrically and mechanically connectable to a connector plug of a first modular power assembly section;
a left hand jumper assembly having left hand terminal means electrically and mechanically connectable to a connector plug of a second one of said modular plug assembly sections; and
electrical conduit means mechanically connected to said right hand jumper assembly and said left hand jumper assembly, and carrying electrical power conductors electrically connected to said right hand terminal means and to said left hand terminal means.

85. An overhead system in accordance with claim 84, characterized in that said left hand jumper assembly and said right hand jumper assembly are configured so that said modular plug assembly connector means are unidirectional, in that said modular plug assembly connector means are capable of being electrically and physically connected to adjoining ones of said modular plug assembly sections only in one direction.

86. An overhead system in accordance with claim 84, characterized in that said modular plug assembly connector means comprise means for electrically connecting together communications signal conductors from said modular plug assembly sections.

87. An overhead system in accordance with claim 18, characterized in that said system further comprises:
a plurality of connector modules electrically connected to said source of electrical power;
wireway means for carrying high voltage and other conductors carrying electrical power and/or communication signals separate and independent of other conductors of said power distribution means and/or said communications distribution means which are carrying electrical power and/or communication signals, respectively; and
wireway access means for tapping into said high voltage and other conductors at selected locations throughout said mechanical structure, for purposes of supplying electrical power and/or communication signals to one or more of said plurality of connector modules, and/or one or more of said application devices.

88. An overhead system in accordance with claim 18, characterized in that:
said mechanical structure comprises a plurality of elongated main structural channel rails; and
said overhead system further comprises a plurality of universal suspension plate assemblies connectable to said main structural channel rails and to said support means in a first configuration for supporting said main structural channel rails from said building infrastructure.

89. An overhead system in accordance with claim 88, characterized in that each of said universal suspension plate assemblies is further adapted to be connectable to said main structural channel rails in a second configuration so as to support various elements from said main structural channel rails, with said elements being positioned below said main structural channel rails.

90. An overhead system in accordance with claim 88, characterized in that said universal suspension plate assemblies are adapted to be configured in a third configuration, whereby a single one of said universal suspension plate assemblies in said third configuration is connected to said support means and is also mechanically interconnected to adjacent ends of a pair of said main structural channel rails.

91. An overhead system in accordance with claim 18, characterized in that said system further comprises:
a plurality of main structural channel rails;
a plurality of cross channels adapted to be mechanically interconnected between two or more of said main structural channel rails, so that said main structural channel rails and said cross channels form said mechanical structure;
bracket configuration means mechanically supported on one or more of said cross channels, for purposes of supporting functional devices above a general plane of said mechanical structure; and
said bracket configuration means have a plurality of braces and a plurality of T-brackets and 90° brackets for purposes of interconnecting together two or more braces of said bracket assembly means, and for connecting said braces to said cross channels.

92. An overhead system in accordance with claim 18, characterized in that said system further comprises:
at least one cableway adapted to be positioned above said main structural channel rail, and comprising individual cableway sections for carrying conductors, with said conductors carrying power and/or communication signals; and
each of said cableway sections comprises a living hinge for access to interiors of said cableway sections.

93. An overhead system in accordance with claim 18, characterized in that:
said system further comprises a plurality of main structural channel rails adapted to support various components of said overhead system, including said power distribution means and said communication distribution means; and
said main structural channel rails are configured so as to include apertures therein, whereby space is provided for structural and electrical components of said overhead system to be extended above a general plane of said main structural channel rails through center portions of said main structural channel rails.

94. An overhead system in accordance with claim 93, characterized in that:
said support means comprises a plurality of support rods having an upper end attached to said infrastructure; and
said main structural channel rails and said support rods are positionable so that said support rods can be directly extended through said center portions of said main structural channel rails, and connected to other devices associated with said overhead system, without supporting or otherwise being connected to said structural channel rails.

95. An overhead system in accordance with claim 18, characterized in that said power distribution means further comprise power entry means directly connected to said power supply source for applying electrical power from said power supply source to other components of said system.

96. An overhead system in accordance with claim 95, characterized in that said power entry means comprise means responsive to said power supply source for generating DC power.

97. An overhead system in accordance with claim 95, characterized in that said power entry means comprise:
a plurality of power entry boxes directly connected to said power supply source, and adapted to be secured to and supported by components of said mechanical structure; and
a plurality of power box connectors, each connector associated with a corresponding one of said power entry boxes, and having means for electrically connecting said power entry boxes to other components of said power distribution means.

98. An overhead system in accordance with claim 97, characterized in that at least a subset of said plurality of said power entry boxes comprise means for receiving power of multiple voltages from said power supply source.

99. An overhead system in accordance with claim 95, characterized in that said power entry means comprise network circuit means for providing certain circuit paths for said communication signals.

100. An overhead system for use within a building infrastructure for supporting and energizing a plurality of application devices, said system comprising:
at least one main structural channel rail for providing a mechanical structure for said overhead system;
power distribution means for distributing electrical power along said main rail;
communications distribution means for distributing communication signals along said main rail;
a plurality of connector modules, with at least a subset of said plurality of connector modules comprising:
input power connection means for releasably interconnecting said connector modules to said power distribution means, and for receiving said electrical power;
output power connection means coupled to said input power connection means, and releasably connectable to one or more of said application devices, for energizing said application devices;
communication input connection means for releasably interconnecting said subset of connector modules to said communications distribution means, and for receiving a first set of communication signals;
processor means responsive to said first set of communication signals, for generating a first set of power control signals; and
said output power connection means are responsive to said first set of power control signals, so as to selectively apply electrical power as output signals from said output power connection means.

101. An overhead system in accordance with claim 100, characterized in that:
said processor means are further responsive to said received first set of communication signals, for reading data embodied within said first set of communication signals; and
said processor means are responsive to said data embodied within said first set of communication signals so as to apply said first set of communication signals or a second set of communication signals to said communications distribution means through said communication input connection means.

102. An overhead system in accordance with claim 100, characterized in that each of said subset of connector modules comprises means for receiving DC power from said communications distribution means, and using said DC power for operating components of said connector module.

103. An overhead system in accordance with claim 100, characterized in that each of said subset of said connector modules comprises means for generating DC power.

104. An overhead system in accordance with claim 100, characterized in that each of said subset of said connector modules further comprises:
spatial signal receiving means for receiving spatial control signals from external sources; and
means for applying said received spatial control signals to said processor means.

105. An overhead system in accordance with claim 104, characterized in that said processor means is responsive to said received spatial control signals so as to generate communication signals, and apply said communication signals to said communications distribution means.

106. An overhead system in accordance with claim 100, characterized in that:
said power distribution means comprise a modular plug assembly, having modular plug assembly sections with a plurality of modular plugs thereon;
said modular plug assembly sections are mechanically connected to said main structural channel rail; and
each of said subset of connector modules comprises a latch assembly manually operable so as to releasably secure said connector module to one of said modular plug assembly sections.

107. An overhead system in accordance with claim 100, characterized in that each of said subset of connector modules further comprises at least one connector port for transmitting and for receiving communication signals directly from application devices.

108. An overhead system in accordance with claim 107, characterized in that said connector port further comprises means for transmitting DC power to a subset of said application devices.

109. An overhead system in accordance with claim 100, characterized in that said output power connection means comprises at least one outlet receptacle adapted to releasably receive a conventional AC plug from an application device.

110. An overhead system in accordance with claim 100, characterized in that said output power connection means comprise at least one universal connector adapted to receive a multi-terminal mating power connector associated with at least one of said application devices.

111. An overhead system in accordance with claim 100, characterized in that said output power connection means comprises at least one multiple voltage relay adapted to be releasably connected to a multiple voltage switch of one of said application devices.

112. An overhead system in accordance with claim 100, characterized in that each of said subset of connector modules comprises visual means for visually indicating to a user a status of said connector module.

113. An overhead system in accordance with claim 100, characterized in that said system further comprises spatial signal receiver means for receiving spatial control signals from a user, with said receiver means being remote from a subset of said plurality of said connector modules.

114. An overhead system in accordance with claim 100, characterized in that at least a subset of said communication signals are utilized to control and reconfigure control among various ones of said application devices.

115. An overhead system in accordance with claim 100, characterized in that said system provides for reconfiguration in real time of control relationships between and among at least a subset of said application devices.

116. An overhead system in accordance with claim 100, characterized in that:
at least a subset of said plurality of connector modules are electrically coupled to certain of said application devices; and
said connector modules comprise processor means and associated circuitry responsive to a subset of said communication signals, so as to selectively control said interconnected application devices, in response to certain of said communication signals being received from others of said application devices.

117. An overhead system in accordance with claim 100, characterized in that said system comprises means for distributing electrical power and for providing a distributed intelligence system for transmitting and receiving certain of said communication signals from application devices physically located throughout the entirety of said structural grid.

118. An overhead system in accordance with claim 100, characterized in that a subset of said plurality of connector modules comprise means for transmitting and receiving communication signals to and from said communications distribution means and at least a subset of said application devices.

119. An overhead system in accordance with claim 100, characterized in that:
said application devices comprise at least one controlling device, said controlling device having signal generating means for generating a first set of said communication signals;
said application devices further comprise at least one controlled device, said controlled device being associated with one of said plurality of connector modules, and having at least first and second states; and
said first set of said communication signals is utilized to effect a logical control relationship between said controlling device and said controlled device, so that said controlling device controls whether said controlled device is in said first state or said second state.

120. An overhead system in accordance with claim 119, characterized in that said logical control relationship between said controlling device and said controlled device is capable of reconfiguration at least in part with a second set of said communication signals, in the absence of any physical relocation of any physical rewiring associated with said controlling device and said controlled device.

121. An overhead system in accordance with claim 119, characterized in that said controlling device is communicatively coupled to a first one of said connector modules, and said first set of said communication signals is applied to said communications distribution means through said first connector module.

122. An overhead system in accordance with claim 121, characterized in that said controlled device is electrically coupled to a second one of said connector modules, and said second one of said connector modules is responsive to said first set of said communication signals to selectively apply electrical power to said controlled device, so as to cause said controlled device to function in either said first state or said second state.

123. An overhead system in accordance with claim 119, characterized in that said controlling device comprises processor means responsive to external control signals for generating communication signals so as to effect said logical control relationship between said controlling device and said controlled device.

124. An overhead system in accordance with claim 119, characterized in that said controlling device is electrically coupled to a first connector module through a series of connector ports and at least one patch cord.

125. An overhead system in accordance with claim 124, characterized in that said patch cord and said connector ports are adapted to apply DC power from said first connector module to said controlling device.

126. An overhead system in accordance with claim 119, characterized in that:
said first set of said communication signals generated from said controlling device are applied as input signals to a first one of said connector modules; and
said first connector module comprises processor means responsive to said first set of communication signals, for applying said first set of said communication signals to said communications distribution means.

127. An overhead system in accordance with claim 126, characterized in that:
said controlled device is electrically coupled to a second one of said connector modules;
said second connector module comprises means for receiving said first set of communication signals; and
said second connector module further comprises processor means responsive to said first set of communication signals for generating control signals and a second set of communication signals indicative of whether said controlled device is to be controlled by said controlling device.

128. An overhead system in accordance with claim 119, characterized in that said communication signals carried on said communications distribution means are in a differential signal format.

129. An overhead system in accordance with claim 119, characterized in that at least a subset of said connector modules comprises processor means programmable by a user so as to initiate or otherwise modify said logical control relationship among said controlling and controlled devices.

130. An overhead system in accordance with claim 119, characterized in that said system comprises remote programming means for transmitting spatial signals to one or more of said connector modules.

131. An overhead system in accordance with claim 130, characterized in that said remote programming means further comprises means for transmitting spatial signals to said controlling device, thereby causing said controlling device to be assigned as a control for said first connector module.

132. An overhead system in accordance with claim 130, characterized in that said spatial signals transmitted to said first connector module announce to said communications distribution means that said first connector module is available for purposes of control.

133. An overhead system in accordance with claim 119, characterized in that said first set of said communication signals generated by said controlling device are applied to said communications distribution means as wireless signals.

134. An overhead system in accordance with claim 119, characterized in that said system comprises a first manually operable programming means for transmitting programming signals to said controlling device and to said connector module associated with said controlled device, said programming signals acting so as to effect said logical control relationship.

135. An overhead system in accordance with claim 134, characterized in that said programming means comprise a hand-held device.

136. An overhead system in accordance with claim 119, characterized in that:
said mechanical structure comprises a plurality of structural channel rail sections;
said power distribution means comprises a modular plug assembly having a plurality of plug assembly sections, each section having a plurality of modular plugs adapted to be physically and electrically connected to said connector modules;
said controlling devices comprise a plurality of switches, including a first switch; and
said controlled devices comprise a plurality of lighting fixtures and other powered devices.

137. An overhead system in accordance with claim 136, characterized in that:
said mechanical structure comprises a first set of said structural channel rail sections, with at least two of said rail sections having a longitudinally aligned configuration;
said power distribution means comprises a plurality of power entry boxes, with at least a subset of said structural channel rail sections having a power entry box connected to each of said subset of rail sections; and
said power entry boxes having electrical power cables and outgoing communication cables, with said power cables and said communication cables being connected to plug assembly sections of said modular plug assembly.

138. An overhead system in accordance with claim 137, characterized in that:
said power entry boxes comprise network circuits forming circuit paths for said communication signals; and
said system further comprises means for daisy chaining together individual ones of said power entry boxes, so as to link said network circuits together to form said communications distribution means.

139. An overhead system in accordance with claim 138, characterized in that said system further comprises:
flexible connectors for interconnecting appropriate ones of said plug assembly sections;
said first switch is communicatively coupled to said communications distribution means through a first connector module located on a first one of said structural channel rail sections; and
said light fixtures are interconnected to one or more of said connector modules, located on either the same or different ones of said main structural channel rail sections, relative to the main structural channel rail section to which said first connector module coupled to said first switch is located.

140. An overhead system in accordance with claim 139, characterized in that:
said communications distribution means has been programmed so that said first switch controls said light fixtures as to individual states of said light fixtures; and
programming of correlation between said light fixtures and said first switch results in enablement of said first switch causing communication signals to be applied through said first connector module coupled to said first switch and to said connector modules coupled to said light fixtures.

141. An overhead system in accordance with claim 119, characterized in that said connector module coupled to said controlled device is programmable so as to have a unique address identifiable through said communications distribution means.

142. An overhead system for use with a building infrastructure for supporting and energizing a plurality of application devices, said system comprising:
at least one main structural channel rail for providing a mechanical structure for said overhead system, said main structural channel rail comprising first and second opposing lateral sides, with a series of spaced apart apertures extending through each of said opposing lateral sides;
support means for supporting said one main rail from said building infrastructure;
at least one modular plug assembly electrically connected to power supply means and extending along said main structural channel rail, said modular plug assembly comprising:
power distribution means electrically connected to said power supply means for distributing electrical power along said main structural channel rail;
communications distribution means for distributing communication signals along said main structural channel rail;
said power distribution means comprises a series of modular plugs electrically connected to said power supply means and adapted to extend through said apertures of said main structural channel rail; and
said communication signals are carried within said modular plugs.

143. An overhead system for use with a building infrastructure for supporting and energizing a plurality of application devices, said system comprising:
a plurality of main structural channel rails for providing a mechanical structure for said overhead system;
a plurality of cross channels connected between pairs of said plurality of main structural channel rails;
support means for supporting said main structural channel rails and said cross channels from said building infrastructure;
power distribution means electrically connected to power supply means for distributing electrical power along said main structural channel rail;
communications distribution means for distributing communication signals along said main structural channel rail;
a plurality of suspension brackets coupled to said support means and to said mechanical structure for translating gravitational loads from said cross channels to said support means, so that substantially none of said gravitational loads from said cross channels are carried by said main structural channel rails; and
modular means connected to said power supply means and extending at least in part along said main structural channel rails, for carrying said power distribution means and said communication distribution means.

144. An overhead system for use with a building infrastructure for supporting and energizing a plurality of application devices, said system comprising:
a plurality of main structural channel rails for providing a mechanical structure for said overhead system;
support means for supporting said structural channel rails from said building infrastructure;
power distribution means electrically connected to power supply means for distributing electrical power along said main structural channel rails;
communications distribution means for distributing communication signals along said main structural channel rails; and
a plurality of cross rails coupled to and supported by one or more of said main structural channel rails.

145. An overhead system in accordance with claim 143, characterized in that said system further comprises connection means for connecting one or more of said cross rails to one or more of said main structural channel rails, at an acute angle relative to an elongated length of an interconnected one of said main structural channel rails.

146. An overhead system in accordance with claim 145, characterized in that said connection means comprises a cross rail connector assembly, said cross rail connector assembly comprising:
a universal structural channel attachment assembly, comprising a pair of opposing left side and right side brackets, said brackets adapted to be coupled to one of said main structural channel rails; and
a suspension rod coupled to said pair of opposing brackets and to said cross rail.

147. An overhead system for use with a building infrastructure for supporting and energizing a plurality of application devices, said system comprising:
at least one main rail for providing a mechanical structure for said overhead system;
support means for supporting said one main rail from said infrastructure;
power distribution means electrically connected to power supply means for distributing electrical power along said main rail;
communications distribution means for distributing communication signals along said main rail;
a wireway adapted to carry electrical cables at a position above a general plane of said mechanical structure;
said wireway comprising a plurality of elongated wireway sections, each section having means for electrically and physically isolating said electrical cables from other electrical components associated with said overhead system; and
said wireway further comprises joiner sections for mechanically interconnecting ends of pairs of adjacent wireway sections, so as to maintain electrical isolation of said electrical cables as said electrical cables pass from one of said wireway sections to an adjacent one of said wireway sections.

148. An overhead system in accordance with claim 147, characterized in that each of said wireway sections comprises a hinged cover for providing access to said electrical cables, while also selectively maintaining an isolating covering for each of said wireway sections.

149. An overhead system in accordance with claim 148, characterized in that:
said mechanical structure further comprises a plurality of suspension brackets, for mechanically coupling other components of said mechanical structure to said support means;
each of said wireways is sized and configured so as to be supported on said suspension brackets; and
said wireways and said suspension brackets comprise means for securing said wireways to said suspension brackets.

150. An overhead system for use with a building infrastructure for supporting and energizing a plurality of application devices coupled to said overhead system, said system comprising:
a plurality of elongated main rails forming a mechanical structure;
power distribution means electrically connected to a source of electrical power for distributing said electrical power throughout said mechanical structure;
communication distribution means for distributing communication signals throughout said mechanical structure;
power entry means comprising network circuits forming circuit paths for said communication signals; and
means for daisy chaining together individual ones of said power entry means, so as to link said network circuits together to form a communications network.

151. An overhead system in accordance with claim 11, characterized in that said system further comprises:
flexible connectors for electrically interconnecting appropriate ones of said main rails;
a first switch communicatively coupled to said communication distribution means through a first connector module located on a first one of said main rails; and
light fixtures interconnected to one or more connector modules, located on either the same or different ones of said main rails, relative to said main rail to which said first connector module coupled to said first switch is located.

152. An overhead system in accordance with claim 151, characterized in that:
said communication distribution means are programmed so that said first switch controls said light fixtures as to individual states of said light fixtures; and
programming of correlation between said light fixtures and said first switch results in enablement of said first switch causing communication signals to be applied through said first connector module coupled to said first switch and to said connector modules coupled to said light fixtures.

153. A suspension bracket system for suspending a plurality of structural elements from a building structure, said system comprising:
at least one suspension bracket;
support means connected to said suspension bracket for supporting said suspension bracket; and
said plurality of structural elements comprising:
a first set of first structural elements comprising at least one first structural element; and
a second set of second structural elements comprising at least a pair of said second structural elements;
said suspension bracket comprises first connection means for releasably connecting said suspension bracket to said at least one first structural element;
said suspension bracket further comprises second connection means for releasably connecting said suspension bracket to said at least one pair of said second structural elements; and
when said suspension bracket is connected to said at least one first structural element and said at least a pair of second structural elements, said first connection means and said second connection means act so as to cause at least a portion of gravitational loads of said pair of second structural elements to be carried by said support means, to cause at least a portion of said gravitational loads of said at least one first structural element to be carried by said support means, and to prevent substantially any gravitational loads of said pair of second structural elements from being carried by said at least one first structural element.

154. A suspension bracket in accordance with claim 153, characterized in that gravitational loads exerted on said suspension bracket from said pair of said second set of second structural elements act so as to increase coupling forces between certain components of said suspension bracket.

155. An overhead system in accordance with claim 153, characterized in that said support means comprise a plurality of support rods, and said suspension bracket comprises means for connecting to a single one of said plurality of support rods.

156. A suspension bracket system in accordance with claim 153, characterized in that said system further comprises:
at least one wireway for distributing and carrying sets of electrical cables; and
said at least one wireway is supported so that gravitational loads are carried by said support means, and not carried by either said first set of structural elements or said second set of structural elements.

157. A suspension bracket system in accordance with claim 153, characterized in that:
said support means comprises a plurality of vertically disposed support rods; and
said system further comprises a plurality of said suspension brackets, each of said suspension brackets being stackable on individual ones of said support rods, with said suspension brackets being independent of any connection to said first set of structural elements or said second set of structural elements.

158. A suspension bracket system in accordance with claim 153, characterized in that said suspension bracket comprises:
first section means coupled to a first one of said second set of structural elements;
second section means connected to a second one of said second set of structural elements;
central support section means connected to a first one of said first set of structural elements, said first section means, said second section means and said support means; and
said central support section means is connected to said support means so that gravitational loads from said first section means and said second section means are translated directly to said support means, and said gravitational loads are not carried by said first one of said first set of structural components.

159. A suspension bracket system in accordance with claim 158, characterized in that:
said first section means comprises a central portion having a leg formed on one side thereof, so as to configure a capturing slot, and an arcuate arm formed on an opposing side of said central portion;
said second section means is substantially identical to said first section means; and
when assembled, said arcuate arm of said first section means is captured within said capturing slot of said second section means, and said arcuate arm of said second section means is captured within said capturing slot of said first section means.

160. A suspension bracket system in accordance with claim 158 characterized in that:
said first section means comprises a first suspension bracket section half; and
said second section means comprises a second suspension bracket section half, with said second suspension bracket section half being substantially identical to said first suspension bracket section half.

161. A suspension bracket system in accordance with claim 159 characterized in that when one of said suspension brackets is assembled with said suspension bracket section halves being coupled together, outwardly directed forces exerted on said suspension bracket section half of said one suspension bracket will act so as to increase coupling forces between said suspension bracket section halves.

162. An overhead system for use within a building infrastructure for supporting a plurality of application devices, said system comprising:
a structural grid comprising a plurality of main structural channel rails and a plurality of cross channels;
a plurality of suspension brackets;
a plurality of supporting elements connected to said building infrastructure and to said structural grid;
said structural grid comprises a plurality of suspension nodes, each node comprising a spatial location where one of said suspension brackets is connected to one of said supporting elements, one of said main structural channel rails and a pair of said cross channels; and
said suspension nodes are formed so that said structural grid can physically support ceiling coverings, space dividers, lighting fixtures, ductwork and other application devices, with said suspension nodes providing for gravitational loads of said main structural channel rails, said cross channels, said ceiling coverings, said space dividers and said application devices being carried by said plurality of supporting elements.

163. An overhead system for use within a building infrastructure for supporting and energizing a plurality of application devices, said system comprising:
at least one main structural channel rail for providing a mechanical structure for said overhead system;
power distribution means for distributing electrical power along said main rail;
communications distribution means for distributing communication signals along said main rail;
a plurality of connector modules, with at least a subset of said plurality of connector modules comprising:
input power connection means for releasably interconnecting said connector modules to said power distribution means, and for receiving said electrical power;
communication input connection means for releasably interconnecting said subset of connector modules to said communications distribution means, and for receiving said communication signals;
processor means responsive to said communication signals, for generating application device control signals for controlling application of power to interconnected ones of said application devices;
spatial signal receiver means for receiving spatial control signals from a user;
cable means connecting said spatial signal receiver means directly to a first connector module to be controlled by said spatial control signals; and
said cable means is connected to said first connector module to be controlled by said spatial control signals so that said spatial control signals are received by said first connector module in the same manner as said first connector module receives said communication signals from said communications distribution means.

164. An overhead system in accordance with claim 2, characterized in that said system further comprises connector means coupled to said at least one main structural channel rail for supporting vertically disposed functional elements below said main structural channel rail.

165. An overhead system in accordance with claim 164, characterized in that said functional elements comprise one or more space dividers.

166. An overhead system in accordance with claim 2, characterized in that said system further comprises:
a plurality of main structural channel rails; and
connector means connected to said main structural channel rails for supporting horizontally disposed functional elements from said main structural channel rails.

167. An overhead system in accordance with claim 166, characterized in that said functional elements comprise visual shields.

168. An overhead system in accordance with claim 2, characterized in that said system further comprises:
a plurality of main structural channel rails;
connector means connected to said main structural channel rails for supporting a plurality of functional elements above and/or below said main structural channel rails; and
said functional elements consist of one or more of the following group: space dividers; visual shields; projection screens; visual projectors; and electric motors.

169. An overhead system in accordance with claim 5, characterized in that said system further comprises:
said electrical connector means for connecting said modular plug assembly to other electrical components of said overhead system; and
said electrical connector means comprises a connector plug assembly extending through said end aperture and electrically coupled to one of said modular plugs which also extends through said end aperture.
